(19) United States
(12) Patent Application Publication
(10) Pub. No.: US 2014/0058742 A1
(43) Pub. Date: Feb. 27, 2014

(54) METHODS AND SYSTEMS FOR INTERACTIVE IMPLEMENTATION OF MEDICAL GUIDELINES

(71) Applicant: DYNAMIC HEALTH INITIATIVES, Toronto (CA)

(72) Inventors: Seshadri M. CHARI, Toronto (CA); Teresa B.C. TRAN, Toronto (CA); Kelly N. DYER, Toronto (CA)

(21) Appl. No.: 13/895,873

(22) Filed: May 16, 2013

Related U.S. Application Data
(60) Provisional application No. 61/647,861, filed on May 16, 2012.
(60) Provisional application No. 61/647,876, filed on May 16, 2012.
(60) Provisional application No. 61/691,497, filed on Aug. 21, 2012.
(60) Provisional application No. 61/691,505, filed on Aug. 21, 2012.

(51) Int. Cl. G06F 19/00

(52) U.S. Cl. CPC G06F 19/345
USPC 705/2

(57) ABSTRACT

Methods and systems for interactive implementation of medical guidelines.

### FIELD OF TECHNOLOGY

The present disclosure relates generally to methods and systems for interactive implementation of medical guidelines, in particular clinical practice guidelines.

### BACKGROUND

Chronic disease is a current burden to the world both in terms of the human cost and economic loss. It is projected by the World Economic Forum that five chronic conditions—diabetes, mental illness, heart disease, respiratory illness and cancer—will cost the global economy $47 trillion over the next 20 years. Presently, these five conditions kill 36 million people per year (of the 57 million deaths in total) and it is projected that by 2030, non-communicable diseases will account for 52 million deaths or 80% of all mortality. In addition to deaths caused, chronic disease leaves hundreds of millions of people in a disabled state, unable to work and participate in society.

Over the last number of decades, there have been numerous developments in the field of medicine and pharmacology to enable the diagnosis and effective management of patients with chronic diseases. New diagnostic tests have been developed to assist the physician with the diagnosis and reassessment of the patient. An example is the HbA₁C which allows physicians to estimate the level of glucose control achieved by a patient over the last three months. A vast array of new drugs has been formulated for the management of numerous diseases including diabetes, hypertension and dyslipidemia. These drugs enable patients to attain a quality of life quite comparable to those without these illnesses.

A further development has been the creation of clinical practice guidelines (CPGs). CPGs exist for a variety of conditions (e.g. diabetes, hypertension, congestive heart failure and osteoporosis, among others) and are typically written by a group of specialists in a medical professional society that is relevant to the disease in question. For example, in Canada, the CPGs for the management of dyslipidemia and diabetes are written by specialists from the Canadian Cardiovascular Society and the Canadian Diabetes Association, respectively. CPGs provide recommendations to physicians on the diagnosis and management of patients based on the best data currently available on these conditions. CPGs represent the standard of care for the medical treatment of that specific condition.

In the United States, The Agency for Healthcare Research and Quality (AHRQ) provides an online database of summaries and references for CPGs that have been published internationally. At present, the AHRQ has over 2500 summaries in its database. The AHRQ is one of 12 agencies of the United States Department of Health and Human Services and its mission is to improve the quality, safety, efficiency of healthcare for Americans.

Despite these aids for patient management, there still exists a large gap in the treatment of patients with chronic disease. This significantly contributes to the mortality and morbidity caused by these diseases. There are numerous instances of this treatment gap. For example, the following has been observed in Canada in the treatment of chronic diseases.

Diabetes mellitus is a disease in which the patient has elevated blood glucose levels. The target for reasonable control of blood glucose levels is a HbA₁C level of lower than 7.0%. The target for tight control is 6.5% or lower. It has been established that the frequency of complications decreases along with the level of the HbA₁C. It is estimated, however, that 50% of patients fail to achieve a HbA₁C of lower than 7.0% and 85% fail to reach 6.5% despite the availability of the means to treat diabetes.

Atrial fibrillation (AF) is a condition in which patients have an irregular heart beat caused by an electrical disturbance in the heart. AF is a significant risk factor for strokes. Instituting anticoagulation therapy for patients with AF is the recommended prophylaxis against the occurrence of strokes. However, it is estimated that 75% of patients with AF are either not on any anticoagulation therapy or are not being treated to a sufficient degree.

Chronic obstructive pulmonary disease (COPD) is a condition causing shortness of breath, cough and excess mucous production primarily in cigarette smokers. It is the fourth leading cause of death in Canada and is the only major cause that has increased significantly over the past few decades. It is estimated that 50% of patients with chronic obstructive pulmonary disease are undiagnosed.

Hypertension is a condition in which patients have a raised blood pressure. This confers an increased risk for stroke, heart attack and kidney disease. It is estimated that 66% are treated and controlled. However, hypertension has a very high prevalence with an estimated 1 in 4 Canadians affected and greater than 50% prevalence in those patients over 50. Therefore the 34% of patients who are not adequately treated represent a very large number of individuals.

In the examples described above, there are treatments available and clinical practice guidelines which detail the management for the particular condition. However, there are still large treatment gaps for each of the conditions outlined. A likely reason for these gaps is the difficulty in employing the CPGs in the everyday practice of physicians. CPGs, to be applied to a patient, typically require data inputs with respect to the patient. Such required data may be relatively detailed and may require regular updates. Such data may include, for example: physical exam results, lab values, past medical history, current and/or past medical states, current and/or past medications, family history and allergies, among others.

The rules of typical CPGs require a physician to gather such required data inputs and then to work through the algorithms prescribed by the CPG to arrive at recommendations for the management of that patient. As CPGs can be rather large and cumbersome (e.g., greater than 100 pages in some cases), this can be difficult to do in the relatively short period of time that a physician often has with a particular patient during an office visit. Commitment of the CPGs to memory is not a practical approach due to the sheer volume of the material involved and the risk of error due to inaccurate application of the guideline rules. Therefore a situation exists in which CPGs, which represent the current standard of knowledge for the management of patients based on a vast amount of research and expert opinion, are rendered impractical for routine use by physicians.

It may be useful to provide a way for practical implementation of CPGs for use by the physicians, which may help to reduce or eliminate the treatment gap for chronic diseases (e.g., including those described above), and may help to reduce morbidity and mortality for patients worldwide.

### SUMMARY

In some example aspects, the present disclosure provides a system for interactive implementation of medical guidelines, the system may include a processor; wherein the processor may be configured to implement a guideline module that, when executed, causes the system to: apply at least one predefined medical guideline to a set of data associated with a patient to determine at least one medical condition of the patient, the at least one predefined medical guideline including at least one rule defining the medical condition and at least one rule defining a medical recommendation according to the defined medical condition; determine at least one medical recommendation for the patient, based on the at least one medical condition of the patient and the at least one predefined medical guideline; and generate output signals representing the at least one medical recommendation; and wherein the processor may be configured to implement an interface module that, when executed, causes the system to: provide an interface for receiving input signals representing data associated with the patient; and provide an interface for presenting the at least one medical recommendation.

A medical condition may be any data relating to a patient and may include, without limitation, physical or mental examination results, lab and radiological results, past medical history, current and/or past medical states and/or diagnoses, current and/or past medications, family history and allergies, among others.

In some examples, the system may include a patient database for storing the set of data associated with the patient, wherein the processor may be configured to receive the set of data from the patient database.

In some examples, the at least one medical guideline may include at least one medical guideline for a medical condition selected from: Allergy, Alzheimer's disease, Atrial fibrillation, Cancer of various etiologies, Chronic, kidney disease, Chronic obstructive pulmonary disease, Congestive heart failure, Dementia, Depression, Diabetes, Drug interactions, Dyslipidemia, Hepatitis, HIV, Hypertension, Infectious diseases, Inflammatory bowel disease, Ischemic heart disease, Obesity, Osteoarthritis, Osteoporosis, Rheumatoid arthritis and Stroke.

In some examples, applying the at least one medical guideline may include calculating a criteria for determining the medical condition according to at least one rule defined by the medical guideline.

In some examples, when the data is insufficient to apply the medical guideline, the interface module may cause the system to provide a prompt for requesting and receiving more input data.

In some examples, communication of input and output signals may include communication of signals through at least one of: a wired connection, a wireless connection, a server, an intranet, the Internet and a local network.

In some examples, the at least one medical guideline may be applied in response to input data received for at least one other medical guideline.

In some examples, the at least one medical guideline may be applied in response to an internally generated update of data stored in the patient database.

In some examples, the processor may be configured to receive the set of data from a patient database of the same or another system.

In some examples, the interface module may cause the system to provide an interface through another system.

In some examples, data associated with the patient may be received from an external device.

In some examples, communication between the external device and the system may take place over a secure communication channel.

In some example aspects, the present disclosure provides a method in a processor for interactive implementation of medical guidelines, the method may include: applying at least one predefined medical guideline to a set of data associated with a patient to determine at least one medical condition of the patient, the at least one predefined medical guideline including at least one rule defining the medical condition and at least one rule defining a medical recommendation according to the defined medical condition; determining at least one medical recommendation for the patient, based on the at least one medical condition of the patient and the at least one predefined medical guideline; and generating output signals representing the at least one medical recommendation.

In some examples, the method may include receiving input signals representing data associated with the patient.

In some examples, the method may include providing an interface for at least one of: receiving input signals representing data associated with the patient and presenting the at least one medical recommendation.

In some examples, applying the at least one medical guideline may include calculating a criteria for determining the medical condition according to at least one rule defined by the medical guideline.

In some examples, the method may include, when the data is insufficient to apply the medical guideline, providing a prompt for requesting and receiving more input data.

In some examples, the at least one medical guideline may be applied in response to input data received for at least one other medical guideline.

In some examples, the at least one medical guideline may be applied in response to an internally generated update of the data associated with the patient.

In some examples, the method of claim may include logging in a user and providing the user with information about one or more patients associated with the user, including any medical recommendations for the one or more patients.

In some examples, the method may include determining any new or updated medical recommendations for the one or more patients since a last log in of the user, and providing identification of any new or updated medical recommendations to the user.

In some examples, the method may include storing information about the at least one medical recommendation and associating the information about the at least one medical recommendation with the patient.

In some examples, the method may include, in response to signals representing a received input indicating that the at least one medical recommendation has been fulfilled, removing the information about the at least one medical recommendation from storage.

In some examples, the method may include, in response to signals representing a received input indicating rejection of the at least one medical recommendation, removing the information about the at least one medical recommendation from storage.

In some examples, the method may include, in response to signals representing a received input indicating a request for a different medical recommendation, generating an alternative medical recommendation according to the request.

In some examples, the at least one medical recommendation may include a recommendation for further patient assessment.

In some examples, the recommendation for further patient assessment may include at least one of: a recommendation for a routine assessment based on a medical guideline defining a time interval for routine assessment; a recommendation for a follow-up assessment based on a medical guideline defining a requirement for follow-up assessment; and a recommendation for a follow-up assessment based on updated patient data meeting the criteria of a medical guideline.

In some examples, the at least one medical recommendation may include at least one medication for treatment of the patient.

In some examples, the data associated with the patient is indexed to rules of the at least one medical guideline or vice versa.

In some examples, the data associated with the patient is indexed to rules of at least two medical guidelines or vice versa.

In some examples, the data associated with the patient is inputted by a user, patient or laboratory, an output of a rule from at least one medical guideline, or internally updated.

In some examples, a rule associated with the at least one medical guideline implements one or more rules from a second medical guideline. In some examples, the one or more rules from the second medical guideline comprises all of rules associated with the second medical guideline. In other examples, the one or more rules from the second medical guideline comprises a portion of the rules associated with the second medical guideline.

In some example aspects, there is provided a method in a processor for interactive implementation of a medical tool, the medical tool for determining a medical recommendation, the method comprising:
applying at least one rule from each of a plurality of predefined medical guidelines to a set of data associated with a patient, each rule defining either a medical condition or a medical recommendation according to the defined medical condition;
determining at least one medical output for the patient, the medical output comprising a medical recommendation or a medical condition based on the at least one rule from each of the plurality of predefined medical guidelines; and
generating output signals representing the at least one medical output.

In some example aspects, there is provided any of the systems described herein, wherein the processor executes instructions corresponding to any of the methods described herein.

### BRIEF DESCRIPTION OF FIGURES

FIG. 1 is a schematic diagram illustrating an example of the disclosed systems for interactive implementation of medical guidelines;

FIG. 2 is a schematic diagram illustrating an example of the modules executed by the processor of FIG. 1;

FIG. 3 is a schematic diagram illustrating another example of the disclosed systems where the system operates independently;

FIGS. 4 and 5 are schematic diagrams illustrating other examples of the disclosed systems where the system interfaces with a patient database of an EMR;

FIG. 6A is a schematic diagram illustrating another example of the disclosed systems where the system is incorporated into an EMR;

FIG. 6B is a flowchart illustrating an example of the disclosed methods for interactive implementation of medical guidelines;

FIGS. 6C and 6D are example output interfaces provided in examples of the disclosed methods and systems;

FIG. 7 is a schematic diagram illustrating example inputs into the system of FIG. 3;

FIG. 8 is a schematic diagram illustrating example inputs into the system of FIG. 4;

FIG. 9 is a schematic diagram illustrating example inputs into the system of FIG. 6A;

FIGS. 10A and 10B shows the first and second parts, respectively, of an example input interface provided in an example of the present disclosure;

FIG. 11 is a flowchart illustrating an example progression of input/output GUIs that may be presented to a user in an example of the present disclosure;

FIG. 12 an example input interface for receiving input data for implementing a dyslipidemia CPG in an example of the present disclosure;

FIG. 13 is a flowchart illustrating a high-level representation of an example method to implement the dyslipidemia CPG in an example of the present disclosure;

FIG. 14 shows an example output interface presenting simplified recommendations where the patient data indicates evidence of cardiovascular disease, in an example of the present disclosure;

FIG. 15 illustrates example details of the risk level determination described in the method of FIG. 13;

FIG. 16a illustrates an example progression of input/output GUIs that may be presented to a user in which one or more CPGDs are automatically triggered by entry of data by the user.

FIG. 16b illustrates an example progression of input/output GUIs that may be presented to a user in which one or more CPGDs are automatically triggered in addition to a user-selected CPGD.

FIG. 16c illustrates an example progression of input/output GUIs that may be presented to a physician in which one or more CPGDs are automatically triggered by outputs from a first CPGD.

FIG. 17 is a flowchart illustrating an example progression of input/output GUIs that may be presented to various users in which one or more CPGDs are automatically triggered in response to data received from a patient or from the laboratory, in an example of the present disclosure;

FIG. 18 is a table illustrating an example of guidelines to determine the frequency of data updates required for mammograms and fecal occult blood testing that may be implemented in an example of the present disclosure;

FIG. 19 shows an example table of medication that may be provided as a recommendation, in an example of the present disclosure;

FIGS. 20-32 show example interfaces that may be presented to a user in an example of the present disclosure;

FIG. 33 is a flowchart illustrating example operation of the disclosed methods and systems;

FIG. 34 is a schematic diagram illustrating an example CPGD, in an example of the present disclosure;

FIG. 35A is a schematic diagram illustrating an example of how outputs of CPGDs may be used a inputs of other CPGDs, in an example of the present disclosure;

FIGS. 35B-D are schematic diagrams illustrating examples of interlacing of CPGs, in an example of the present disclosure;

FIG. 36 is a schematic diagram illustrating an example of a guideline module, in an example of the present disclosure;

FIG. 37 is a schematic diagram illustrating an example of the disclosed systems;

FIGS. 38-77 show example interfaces of an insulin prescription tool provided by an example of the disclosed methods and systems, illustrating an example operation of the tool;

FIGS. 78-93b are flowcharts illustrating an overview of an example implementation of a dyslipidemia CPG, in an example of the present disclosure;

FIGS. 94a-114d are flowcharts illustrating details of the example implementation of the dyslipidemia CPG of FIGS. 78-93b; and

FIG. 115 is a flowchart illustrating an overview of an example automatically triggered call-up of a tool.

### DETAILED DESCRIPTION

The present disclosure describes methods and systems in which CPGs, or portions thereof, may be implemented using computer-implemented CPG Definitions (CPGDs), which will be described further below, through interactions between the physician and the system. Such interactions may take place during and/or between patient visits, and may help to increase the quickness and/or efficiency in the use of the CPGs by the physician. Although the disclosed methods and systems may be used by any user, including medical personnel (e.g., physicians, nurse practitioners, nurses and care-givers) and non-medical personnel (e.g., patients, policy makers and statisticians), for simplicity the present disclosure will refer to the use of the methods and systems by a physician.

The rules contained in the various CPGDs may be stored in a database of the system. The system may assist the physician in implementing the rules of the CPGDs by accepting data on patients (e.g., inputted by the physician and/or retrieved from a patient database), determining one or more medical conditions or medical recommendations on the medical management of the patient according to the rules of applicable CPGDs, and providing these recommendations to the physician (e.g., by displaying on a screen or by providing a printout).

These recommendations include but are not limited to, for example, targets for treatment, lifestyle measures recommended for the patient, recommendations for pharmacotherapy and recommendations for follow-up assessments. The recommendations determined for each patient may be stored in a database of the system, and may be linked and/or cross-referenced to the respective patient.

In some examples, the various recommendations determined from the application of CPGDs may be organized and presented in a way for ease of reference. For example, the physician may be provided with an interface to view all patients with recommendations pending and view in detail any of the recommendations pending for any patient. The physician may be provided with an option (e.g., via the interface presented by the system) to remove recommendations for any patient (e.g., when the recommendation is fulfilled).

Data used by the disclosed methods and systems may be received as input via input devices directly (e.g., integrated or physically connected) or indirectly (e.g., via the Internet, an intranet or wirelessly) connected to the system. Data may be received from any geographic location, for example the physician's office, from a laboratory and from the patient's home, among others.

In some examples, the system may be a centralized system accessible by one or more external devices. For example, the system may be implemented in one or more servers that may be accessed (with appropriate security protocols where necessary) by one or more users using external device(s). External devices that may access and communicate with the system include, for example, desktop devices, laptop devices, tablet devices, handheld devices, smartphones and any other suitable computing devices. The external devices may each access and/or run interfaces and/or software applications of the system appropriate to the respective device.

Any CPG may be implemented using the disclosed methods and systems. Examples of CPGs that may be implemented include, for example, CPGs for managing diabetes mellitus, hypertension, dyslipidemia, chronic obstructive pulmonary disease, osteoporosis, congestive heart failure, depression, atrial fibrillation and drug interactions, among others.

In some examples, the disclosed methods and devices may provide one or more of the following features, the details of which may be found further below.

In some examples, the present disclosure may allow for numerous CPGs to be implemented by a single system and/or application software.

In some examples, the present disclosure may allow a physician to employ a CPGD by selecting the CPGD and entering the appropriate input data into an input screen or input interface. The input interface may include prompts requesting input of any further required data. The disclosed methods and systems may make any appropriate calculations as stipulated by the rules contained in the CPGDs and may present any generated recommendations to the physician based on the employed CPGD.

In some examples, the present disclosure may allow for multiple CPGDs to be under surveillance on an ongoing basis and/or for the rules, results and/or recommendations of multiple CPGDs to interact and interlace with each other. For example, if data for one CPGD is entered by the physician, the disclosed methods and systems may enable checking of all other CPGDs as to whether the inputted data is relevant for any other CPGD and, if so, implement the other relevant CPGDs and generate recommendations from the other relevant CPGDs based on the inputted data. In some examples, output (e.g., calculated values and/or generated recommendations) from one CPGD may serve as input for one or more other CPGD. In some examples, input from a physician (e.g. a prescription) into one CPGD may be also used as input for one or more other CPGDs, for example a drug interaction CPGD.

In an example, a first recommendation generated using one CPGD may be checked against another CPGD to ensure the first generated recommendation does not conflict with a second recommendation generated by the other CPGD or a rule defined in the other CPGD (e.g., medications recommended by different CPGDs may have unexpected or adverse drug interactions that may be detected through such interaction of CPGDs and avoided accordingly). In another example, if a diagnosis is generated by one CPGD (e.g., a diagnosis of hypertension for a patient), this diagnosis may be provided as input data into one or more other CPGDs using such data as input.

In some examples, implementation of one CPGD may include calling up another CPGD (e.g., a dyslipidemia CPGD may require calculations according to a Reynold's Risk Score CPGD). In another example, a first CPGD may call on the functions/calculations of a second CPGD in order to implement the rules of the first CPGD (e.g., a dyslipidemia CPGD may be called on by a diabetes CPGD in order to determine the presence of dyslipidemia in a patient, which may impact the management of diabetes for that patient).

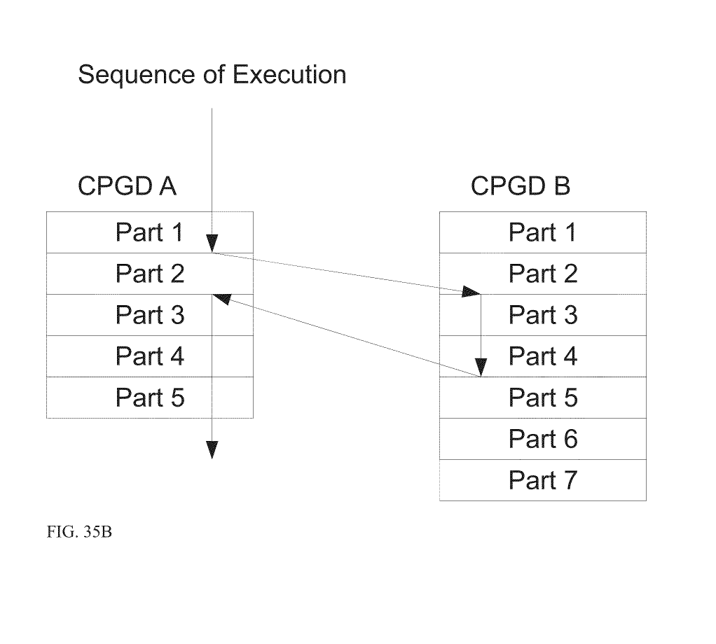

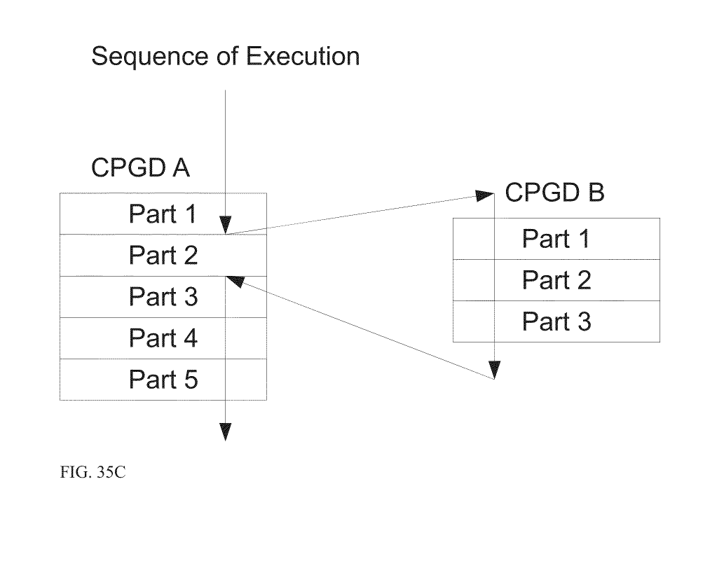

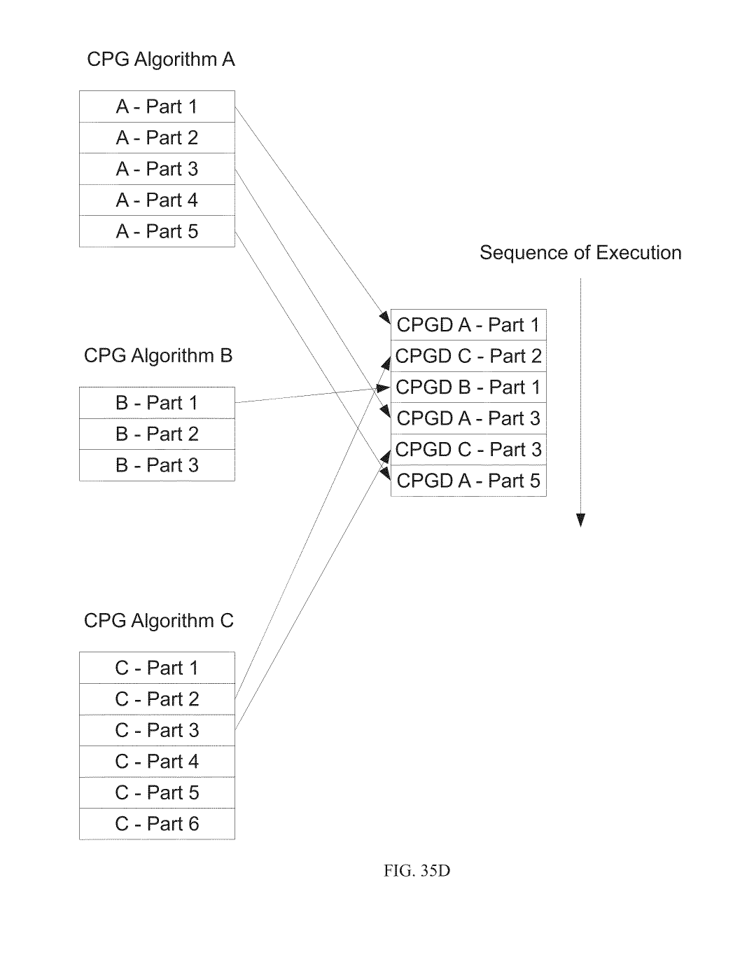

Examples of how interlacing of CPGs may be implemented in accordance with the present disclosure are illustrated in FIGS. 35B-D. The interlacing of the dyslipidemia CPG with the diabetes CPG may be an instance of the interlacing exemplified in FIG. 35B; the interlacing of the dyslipidemia CPG with the RRS CPG may be an instance of the interlacing exemplified in FIG. 35C; and the interlacing of different CPGs in the insulin prescription tool (described elsewhere in the disclosure) may be an instance of the interlacing exemplified in FIG. 35D.

In the example of FIG. 35B, example CPGD A is executed partway (e.g., to the end of part 1) and then, midway through execution of CPGD A, part 2 involves calling up execution of a portion of example CPGD B (e.g., only parts 3 and 4 of CPGD B). Once the portion of CPGD B has been executed, the process returns to CPGD A (e.g., including the results of the execution of the portion of CPGD B, such as any calculations) to complete execution of CPGD A.

In the example of FIG. 35C, similarly to FIG. 35B, example CPGD A is executed partway and, midway through execution of CPGD A, part 2 involves calling up execution of CPGD B. However in this example the whole of CPGD B is executed before the process returns to CPGD A (e.g., including the results of the execution of CPGD B, such as any calculations) to complete execution of CPGD A.

In the example of FIG. 35D, separate portions of different CPGD algorithms (in this examples, algorithms from CPGDs A, B and C) are combined and executed together. Although this example shows only portions of the algorithms being combined, in some examples one or more whole algorithms from one or more CPGDs may be combined and executed together with portions of algorithms from other CPGDs.

CPGs may be interlaced in other various manners. For example, the same portion of a CPGD may be called on by other CPGDs, and a portion of a CPGD may be repeatedly called on by another CPGD. Portions of CPGDs may be combined in different orders, which may be different from the order in which they would be normally executed (e.g., may execute part 2 of CPGD A, then part 5 of CPGD B, then part 1 of CPGD A).

Thus, interlacing of CPGs, as described in the present disclosure, may include implementation or execution of the rules of a plurality of CPGs, in which the sequence of execution contains the rules of a part (e.g., less than the whole) of at least one CPG. Interlacing may also include implementation of execution of the rules of a plurality of CPGs in which only a part of the rules of one CPG is executed before the sequence moves to the rules contained in another CPG.

In some examples, the present disclosure may allow for data input from the patient through, for example, local communication or the Internet, among other methods. The disclosed methods and systems may apply the rules contained in the CPGDs to the received data and generate recommendations for the management of that patient. Where appropriate necessary calculations may be performed on the received data such that the data is suitable for use in implementing the rules of the applicable CPGD.

In some examples, the present disclosure may allow for data input from application software used by the patient. Such data may be transmitted via the internet, for example, and received by a software interface of the disclosed systems.

In some examples, the present disclosure may allow for data input through a secure connection from a laboratory. The rules contained in the CPGDs may be applied to the received data to generate recommendations for the management of a patient.

In some examples, the present disclosure may allow for monitoring of all data values relevant to the CPGDs and may generate recommendations based on spontaneous changes in those data values. For example, an increase in age may cause a patient to move into the high risk category for a particular CPGD and may result in a new set of management recommendations being generated. These may be displayed as a new recommendation for that particular patient. The new recommendations may include patient management recommendations.

In some examples, the present disclosure may allow all recommendations pending for each patient from multiple CPGDs to be presented to a physician as output.

In some examples, the present disclosure may present as output a list of all patients with recommendations pending. For each patient, a list of all recommendations pending may be presented. In this manner, the physician may be enabled to view all CPGD-generated recommendations for all the patients in the physician's practice.

In some examples, the present disclosure may present recommendations in a summary manner for each patient such that the entire list may be easily viewable by the physician and may be expandable to full size upon clicking on them.

In some examples, the present disclosure may classify recommendations as new if they were generated during the last patient visit or during the time after the last patient visit.

In some examples, the present disclosure may provide an interface in which the area on a patient screen displaying recommendations may display recommendations that are new since the last time the patient was called up. The new recommendations may be displayed such that they may be clearly differentiated from previous recommendations.

In some examples, the present disclosure may present a list of all patients with new recommendations pending. For each patient, a list of all new recommendations pending may be presented. The new recommendations may be differentiated from the previous by being at the top of the list and/or by being displayed in a different color, for example. In this manner, the physician may be enabled to view all CPGD-generated new recommendations for all the patients in the physician's practice.

In some examples, the present disclosure may enable recommendations to be removable by the physician clicking on a button which indicates the fulfillment of the recommendation.

In some examples, the present disclosure may generate recommendations for follow-up assessments based on the routine assessments required for any patient of a specific age and gender. Examples of such routine assessments may include mammograms and fecal occult blood testing, among others. These may be presented as new recommendations for the patient in an interface.

In some examples, the present disclosure may generate recommendations for a patient for follow-up further assessments according to the rules contained in CPGDs. For example, if a patient is diabetic and needs HbA1c every three months, this requirement may be added to the recommendations for the patient and may be presented as a new recommendation in an interface.

In some examples, the present disclosure may generate recommendations for a patient for follow-up assessments as a data value for a patient changes spontaneously, leading to a new recommendation according to the rules of one or more CPGD. For example, if a change in the patient's age produces a new recommendation stating that a patient requires a particular assessment as per the rules contained in a CPGD, this recommendation may be added to the list of recommendations for the patient. These may include recommendations regarding further follow-up.

In some examples, the present disclosure may keep track of and present to the physician all of the consultations that are required for the patient as recommended by the CPGDs.

In some examples, the present disclosure may enable combination of recommendations for further follow-up assessments from multiple CPGDs for one patient. Such recommendations may be presented in one convenient list on an interface. Once recommendations are accepted by a physician on a patient, these may be displayed on screen. Recommendations on a patient's file may continue to be displayed until they are removed by the physician (e.g., as they are completed).

In some examples, the present disclosure may present a Medical Management Screen or similar interface, which may include a clear indicator that new results are present. The physician may be enabled to view all new results. A list of all patients with new results may be made available to the physician. Selecting a patient on this list may display the result for that patient.

The present disclosure may provide advantages and/or features not found in conventional systems and methods. For example, U.S. Pat. No. 8,121,862 appears to describe a system and method for management of patients; U.S. Pat. No. 6,081,786 appears to describe a system and method for guiding the selection of a therapeutic treatment regimen for a disease; and U.S. Pat. No. 6,283,761 appears to describe an apparatus and method for providing diagnostic and treatment information for a patient. However, in these documents, there does not appear to be description of any interlacing of multiple CPGs with each other (e.g., such that the system may spontaneously move from one guideline to another as required in the management of a patient). There does not appear to be any ability for the output for one CPG to be used as the input of another CPG, nor any ability for generation of a recommendations for patient treatment using input other than direct inputs from the physician (e.g., input from the patient or a lab, input from the results of other CPGs, triggering of scheduled CPG operation, or triggered CPG implementation to detect contraindicated medication).

### Example System

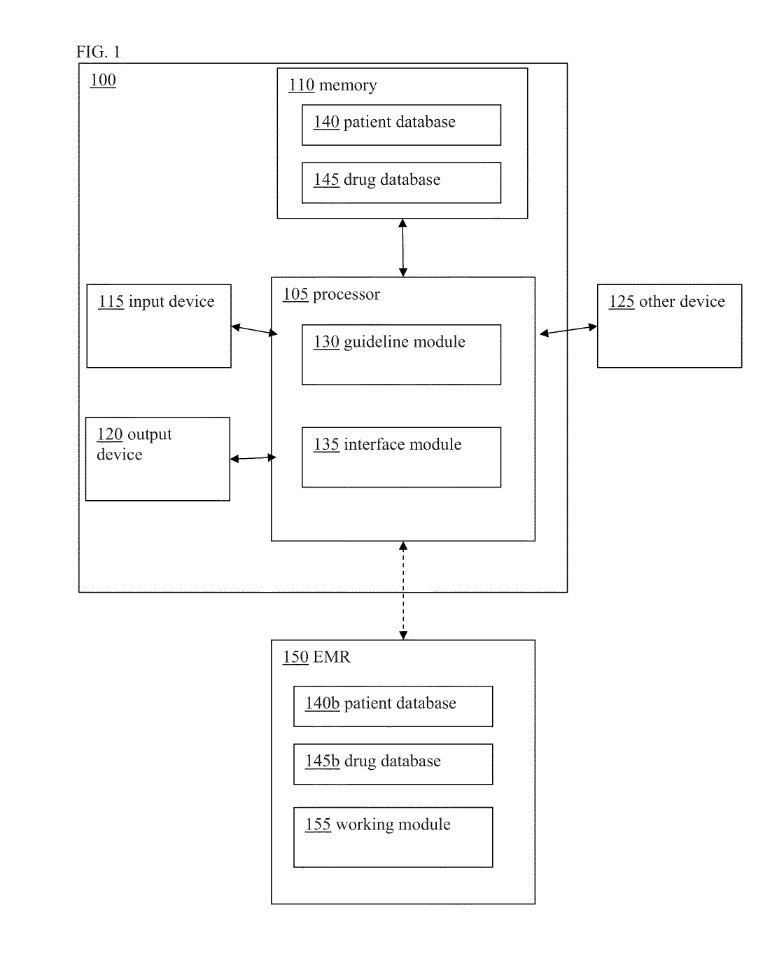

An example system for interactive implementation of medical guidelines is now described with reference to FIG. 1. The system 100 of FIG. 1 may illustrate a generalized example of the disclosed systems while other figures may illustrate more detailed or specialized examples of the disclosed systems.

The system 100 includes one or more processors 105 that may communicate with one or more memories 110. Although one processor 105 is shown, it should be understood that the system 100 may be implemented by two or more processors 105 that may communicate with each other. The processor(s) 105 may be provided in the form of, for example, server(s), desktop device(s), laptop device(s), handheld device(s), tablet device(s), smartphone(s) and any other suitable computing devices. Although one memory 110 is shown, it should be understood that the processor(s) 105 may communicate with two or more memories 110. The memory(ies) 110 may be internal (e.g., RAM, ROM or flash drive) to the device(s) embodying the processor(s) 105 and/or may be external (e.g., external hard drive or stored on an external server) to the processor(s) 105. Communication between the processor(s) 105 and the memory(ies) 110 may be direct (e.g., through internal or wired connection) or indirect (e.g., through the Internet, an intranet and/or via server(s)).

The processor(s) 105 may receive input via one or more input devices 115 and may provide output via one or more output devices 120. Although one input device 115 and one output device 120 is shown, it should be understood that there may be more than one input device 115 and/or output device 120. The input device(s) 115 and/or the output device(s) 120 may be internal (e.g., integrated keyboard and/or screen) to the device(s) embodying the processor(s) 105 and/or may be external (e.g., external keyboard and/or screen). The input device(s) 115 may include, for example, keyboards, pointing devices, scroll buttons, touch-sensitive screens, microphones, buttons and any other suitable input devices. The output device(s) 120 may include, for example, display screens, speakers, lights, vibration devices and any other suitable output devices. The input device(s) 115 and output device(s) 120 may allow local access to the processor(s) 105, for example by an administrator or a physician. In some examples, such as where the processor(s) 105 is embodied in server(s), there may be no input device 115 and/or no output device 120, and input and/or output may be communicated through other means, such as described below.

The processor(s) 105 may also communicate with one or more other devices 125 for receiving input and/or providing output. Although one other device 125 is shown, it should be understood that two or more other devices 125 may communicate with the processor(s) 105 independently and in parallel. The other device(s) 125 may provide remote access to the processor(s) 105 (e.g., where the processor(s) is a centralized server or located in a centralized location) through direct (e.g., through a wired connection, a USB connection or a Bluetooth connection) and/or indirect (e.g., through a wireless connection, such as through the Internet, an intranet) communication. The other device(s) 125 may include any suitable computing device, for example servers, desktop devices, handheld devices, laptop devices, tablet devices or smartphones, among others. The other device(s) 125 may allow input/output communication with users at other locations, for example at a laboratory (e.g., a lab technician), at a home (e.g., a patient, a nurse, a caregiver or a physician on a house call), at a remote office (e.g., a physician at a physician's office), at a mobile station (e.g., a physician at a military or remote station). The other device(s) 125 may also allow input/output transference of data using, for example, a Bluetooth device or a USB device, among others. Suitable authentication and security protocols (e.g., passwords, logins, passcards, PIN, fingerprinting, voice recognition, encryption and digital certificates) may be used to ensure secure and authenticated communication with the other device(s) 125, where appropriate.

The processor(s) 105 may be configured to implement one or more modules in order to implement the present disclosure. Although the modules are shown as being internal to the processor(s) 105, it should be understood that one or more modules may be external to the processor(s) 105. In the example shown, the processor(s) 105 may be configured to implement a guideline module 130 and an interface module 135. The guideline module 130 may provide instructions to cause the processor(s) 105 to determine and apply appropriate CPGDs, and generate appropriate recommendations, as will be described below. The interface module 135 may provide instructions to cause the processor(s) 105 to provide one or more interfaces for receiving input and providing output (e.g., via the input device(s) 115, output device(s) 120 and/or other device(s) 125), as will be described below.

The memory(ies) 110 may include one or more databases storing information accessible by the processor(s) 105 in order to implement the present disclosure. Although the databases are shown as being provided one memory 110, it should be understood that one or more databases may be entirely or partially provided by one or more different memory(ies) 110. In the example shown, the memory(ies) 110 may include a patient database 140 storing information associated with one or more patients and a drug database 145 storing information associated with one or more drugs. The processor(s) 105 may read and/or write data to the databases 140, 145 as appropriate. Further details about the databases 140, 145 will be provided below.

The definition and properties of CPGDs are now discussed. A CPGD may include a set of rules and/or algorithms for implementing a CPG. In some examples, rules may represented or organized by algorithms. While a CPG may be written in the form of a paper or medical text, a CPGD may implement directives, including rules, of the CPG algorithmically. Relationships, calculations and/or steps that may not be explicitly stated in the CPG and/or that may require reference to other medical texts may be made algorithmically explicit in a CPGD.

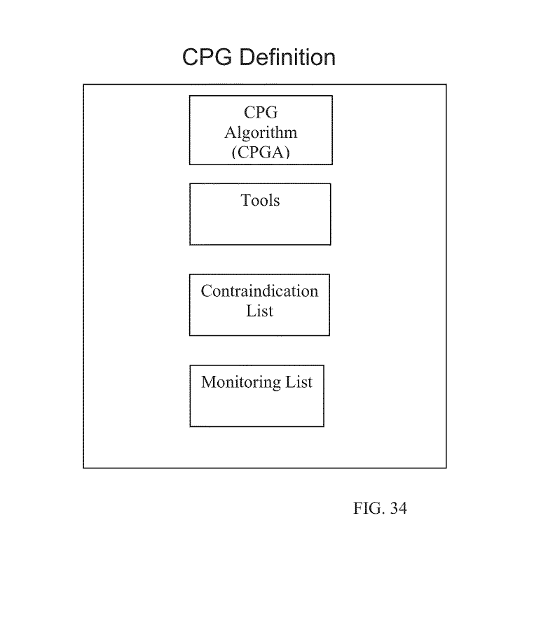

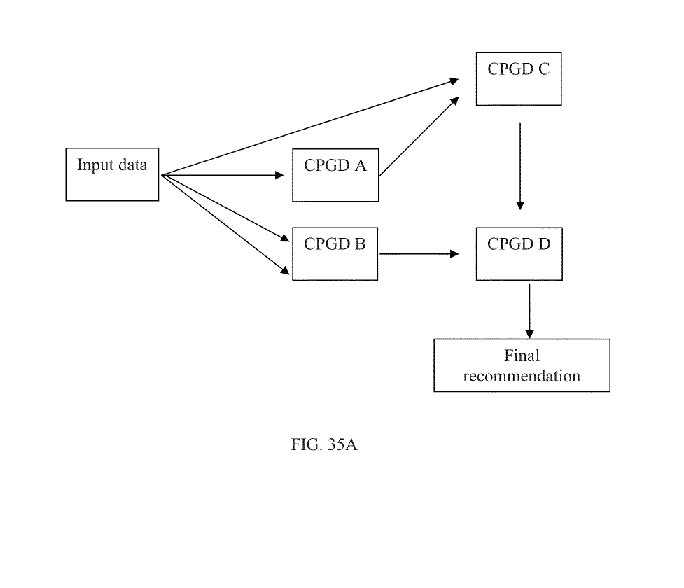

For example, a CPGD may include one or more algorithms (which may include rules for implementing one or more given CPGs) along with data such as a contraindication list (e.g., a list of contraindications for certain drugs) and a monitoring list (e.g., a list of follow up events for patients). A CPGD may also include one or more tools (described elsewhere in the disclosure). An example CPGD is shown in FIG. 34.

An example of a CPGD for implementing a given CPG (or multiple CPGs) is shown in FIG. 34. In this example, the CPGD may include an algorithm (which may be referred to as a CPG algorithm for implementing the given CPG), which may be called upon by other elements of the system (e.g., by components of the guideline module) to implement the rules of the given CPG. The algorithm may include one or more rules defined according to the directions in a single given CPG. In some examples, the algorithm may implement multiple CPGs that may be written as separate documents in text form. In order to generate recommendations for the medical management of a patient, the system may (e.g., depending on the patient's disease conditions) employ a single CPG algorithm or multiple CPG algorithms for generating the recommendations. For example, where multiple CPG algorithms are employed, these algorithms may be executed in a sequence that calls on different algorithms or algorithm portions, for example moving from any point of a first algorithm of one CPGD to any point of a second algorithm of another CPGD, and may call on each algorithm or algorithm portion more than once.

When one or more algorithms are executed requiring some or all of the content of two or more CPGs, these CPGs may be interlaced with each other. For example, these CPGs may be interlaced within a single algorithm or interlaced by executing two or more algorithms in combination. In some examples, interlacing of CPGs, as described in the present disclosure, may include implementation or execution of the directives of two or more CPGs, in which the sequence of execution of the corresponding algorithms may include implementation of rules based on a portion (i.e., less than the whole) of at least one CPG. In some examples, interlacing may also include implementation of rules of multiple CPGs, where only a portion of the rules based on one CPG may be executed before the execution sequence proceeds to the rules based on another CPG.

Such interlacing may enable the system to implement the directives of the applicable CPGs in a more accurate manner, to help improve patient care. Such interlacing of CPGs may also allow for improvements in efficiency, scheduling, accuracy and/or autonomy of the system. For example, this may allow for reduction in processing time and/or reduction in incidences of intermediate (spurious) recommendations. Interlacing of CPGs may also allow for the proper employment of CPGs (and thus better care of a patient), as CPGs may not be intended to be used in isolation yet the relationships between CPGs may not be clear or explicitly stated in the CPG documents.

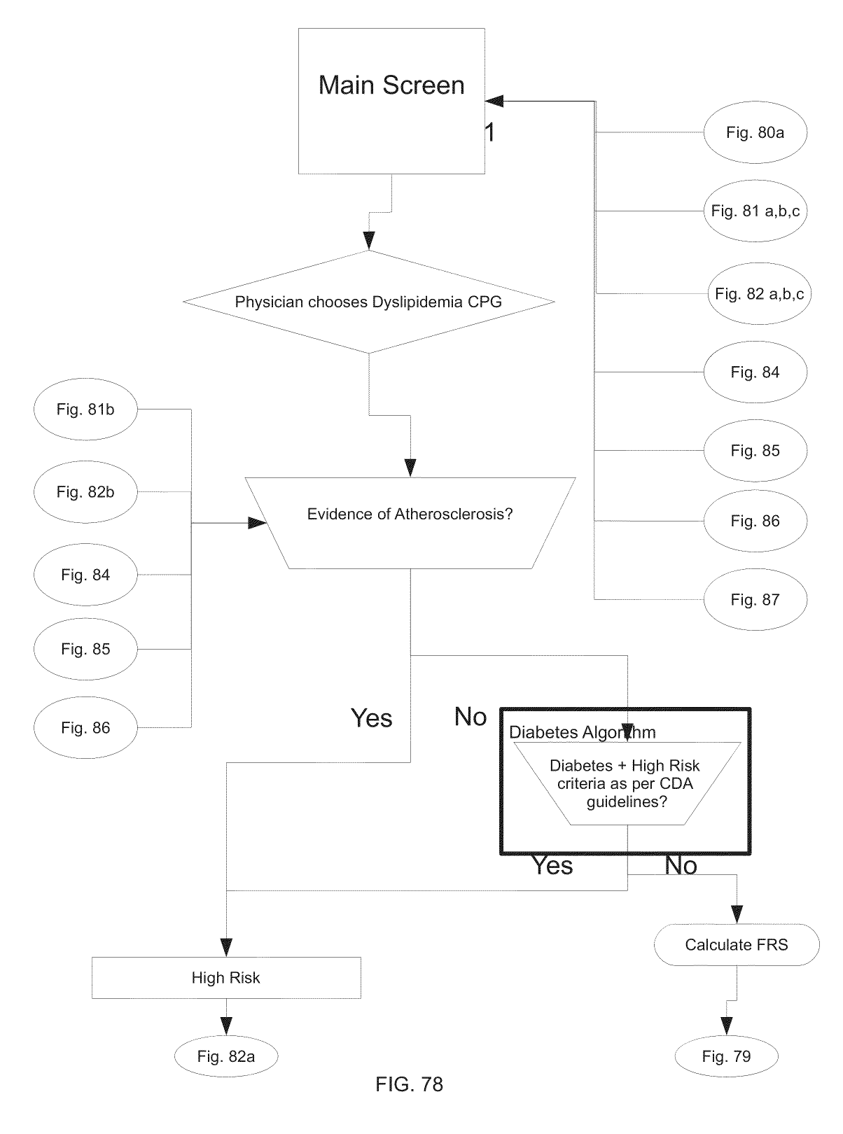

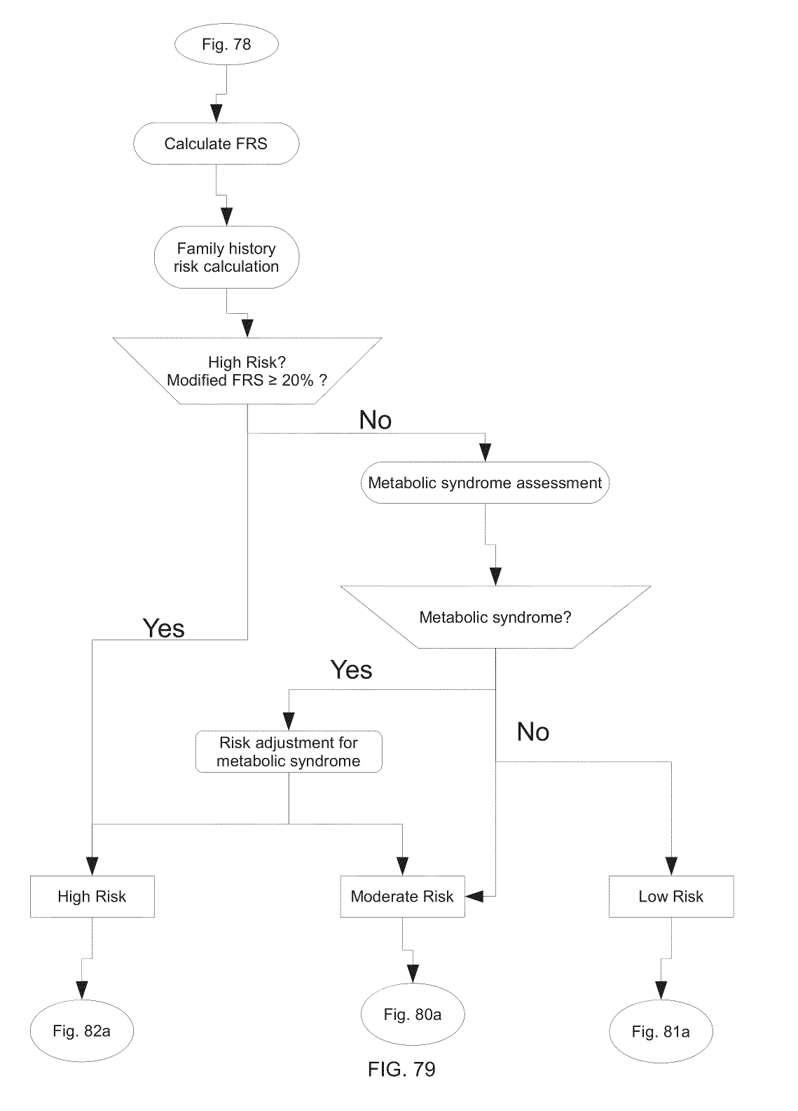

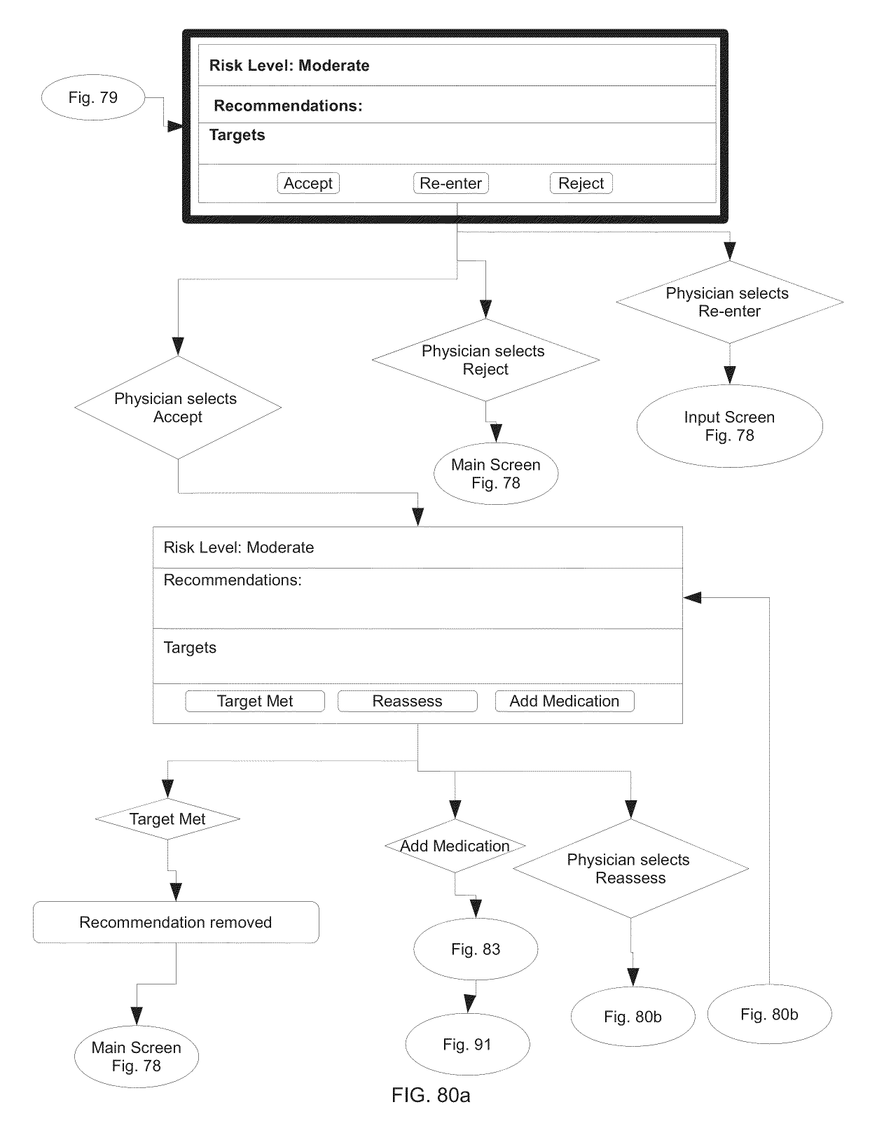

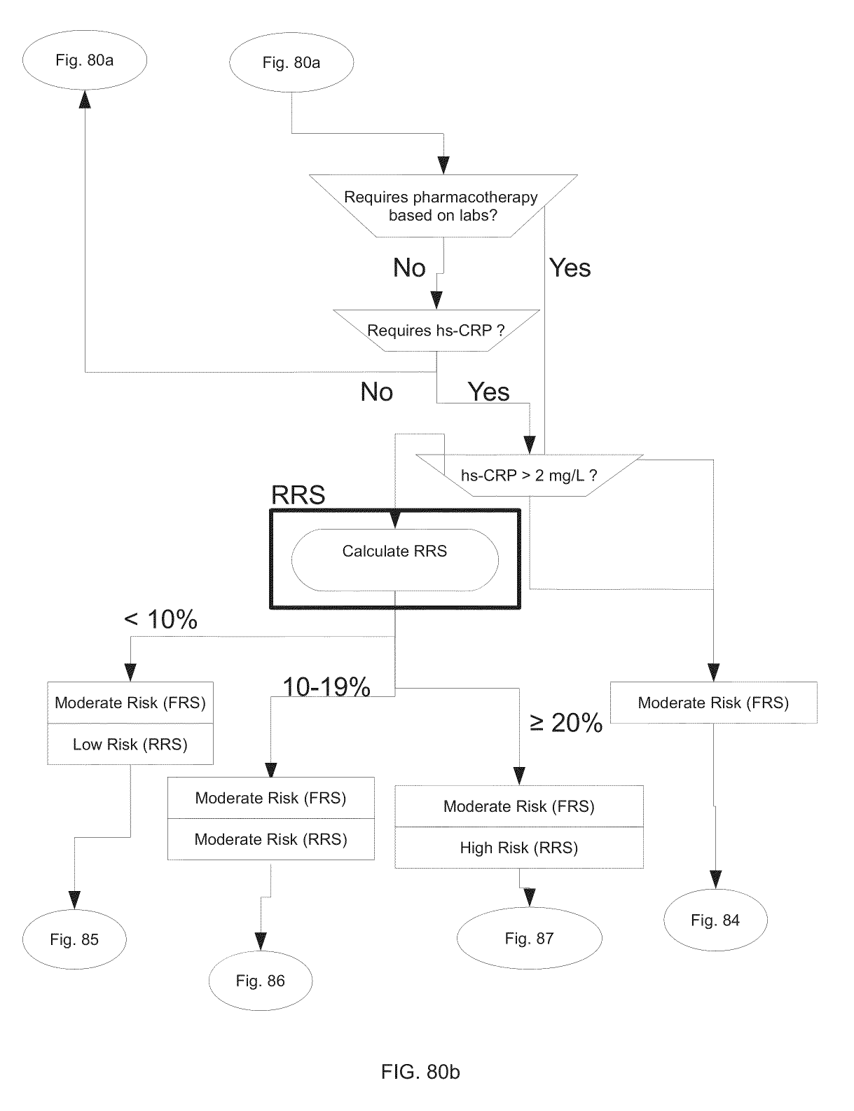

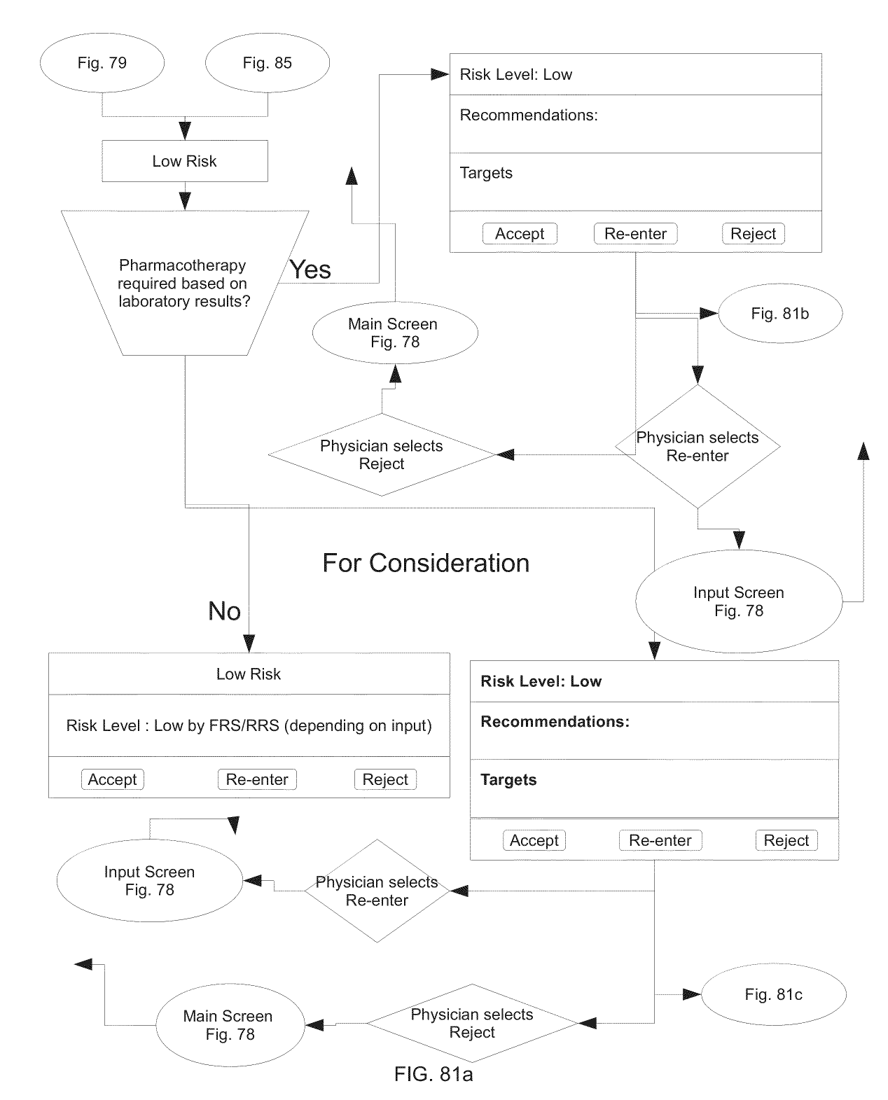

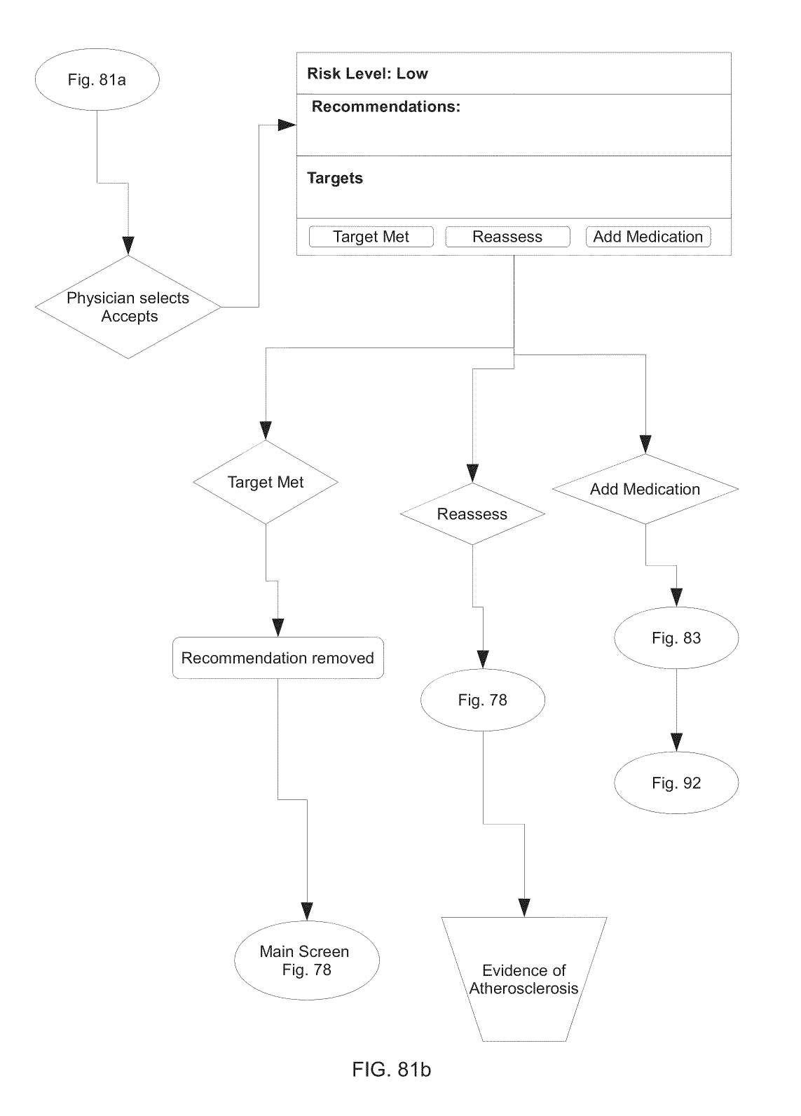

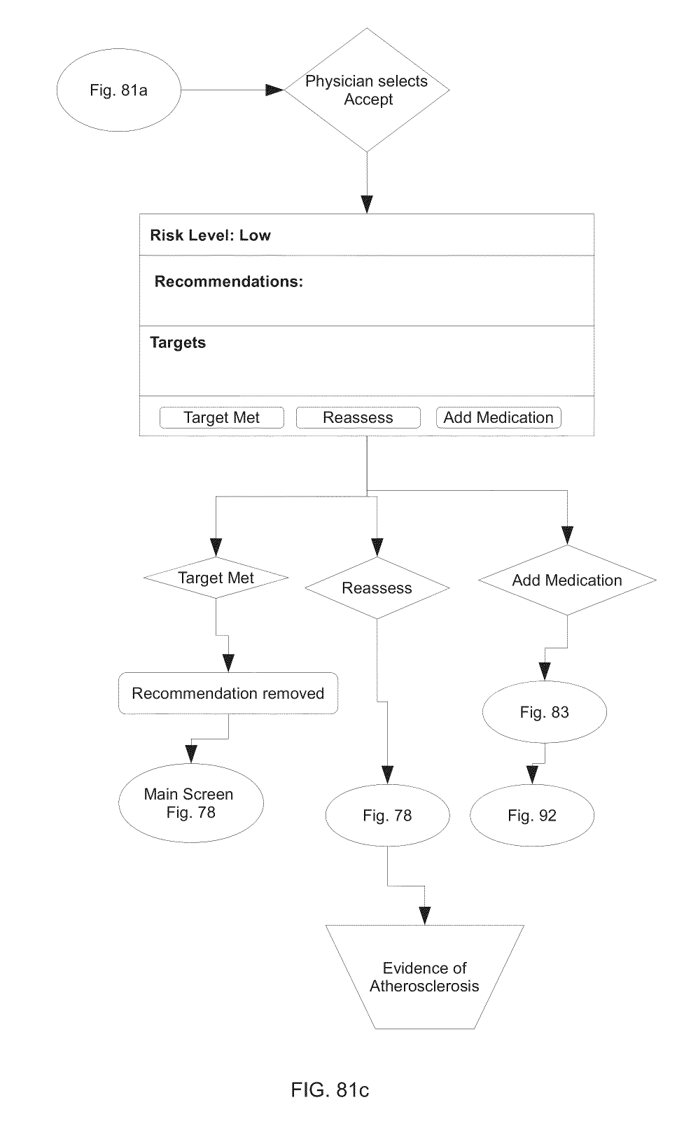

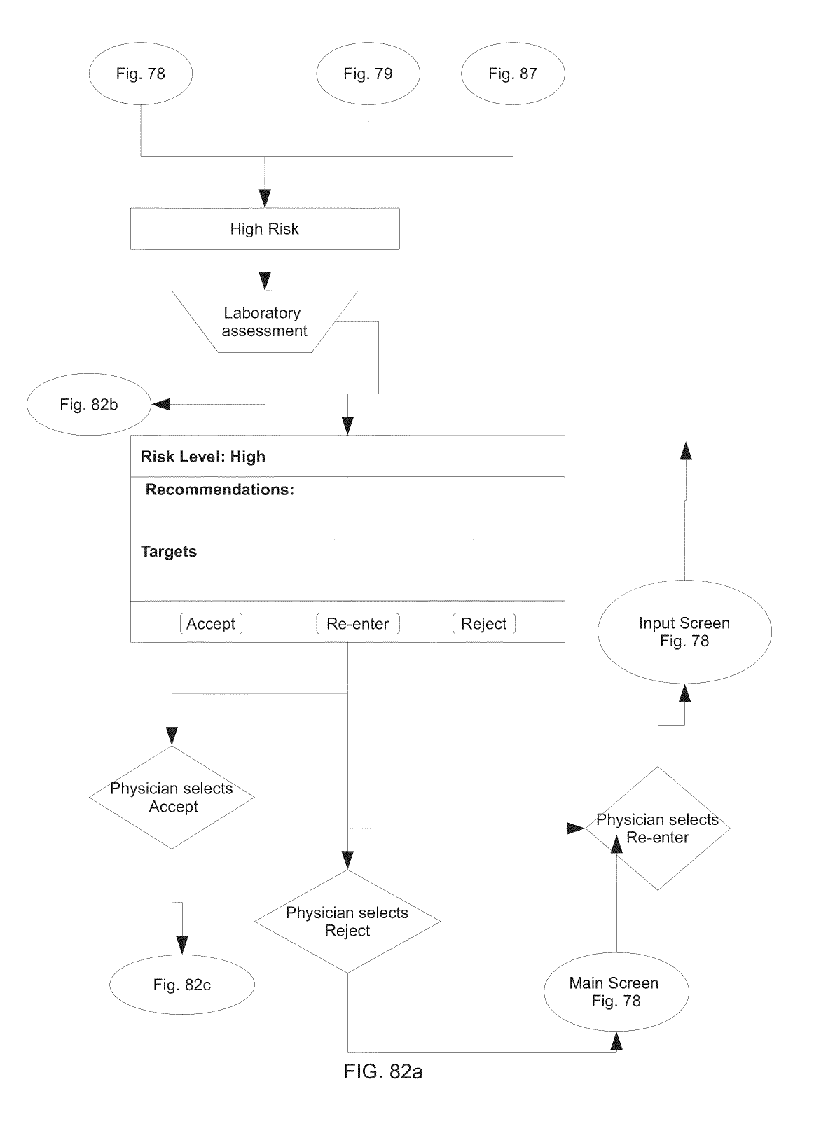

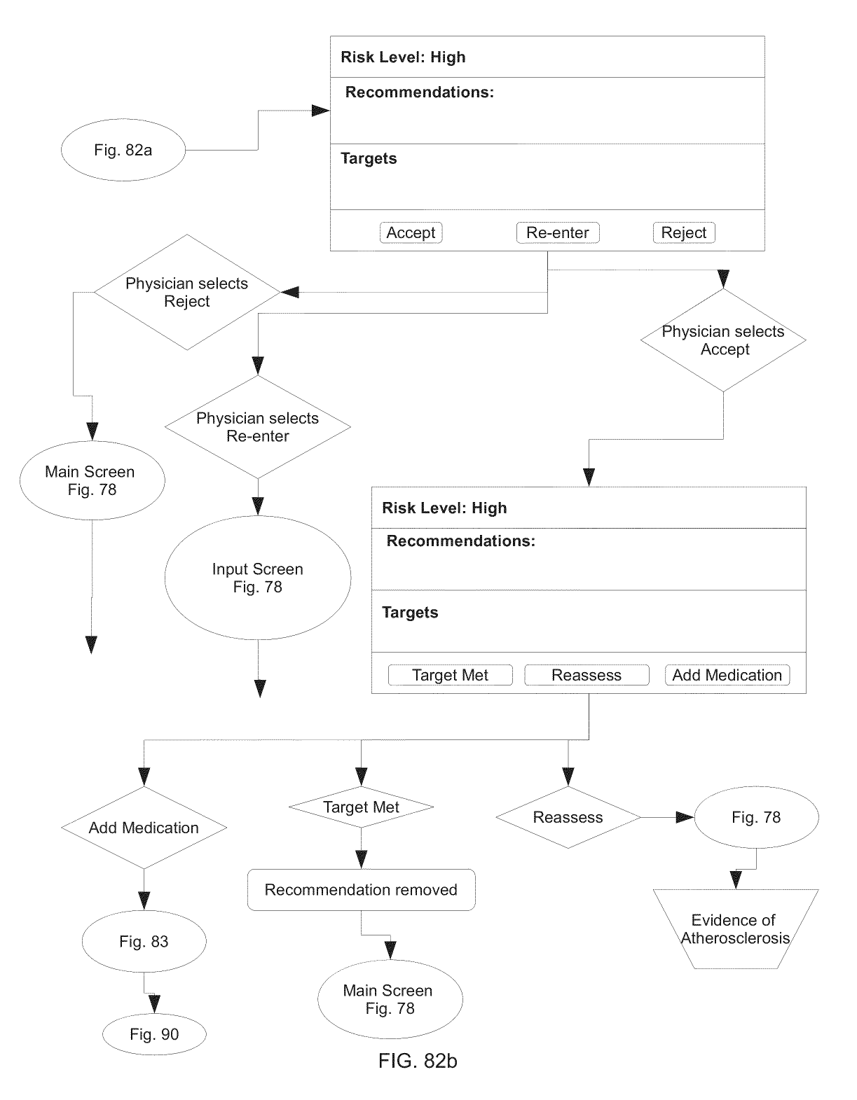

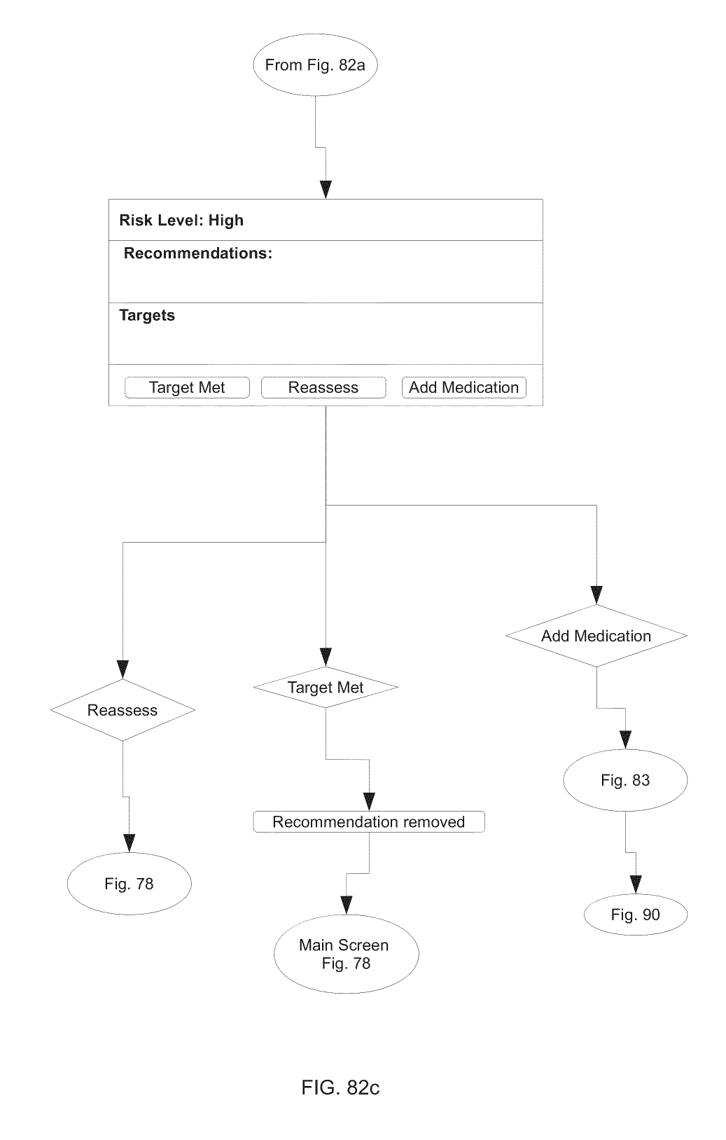

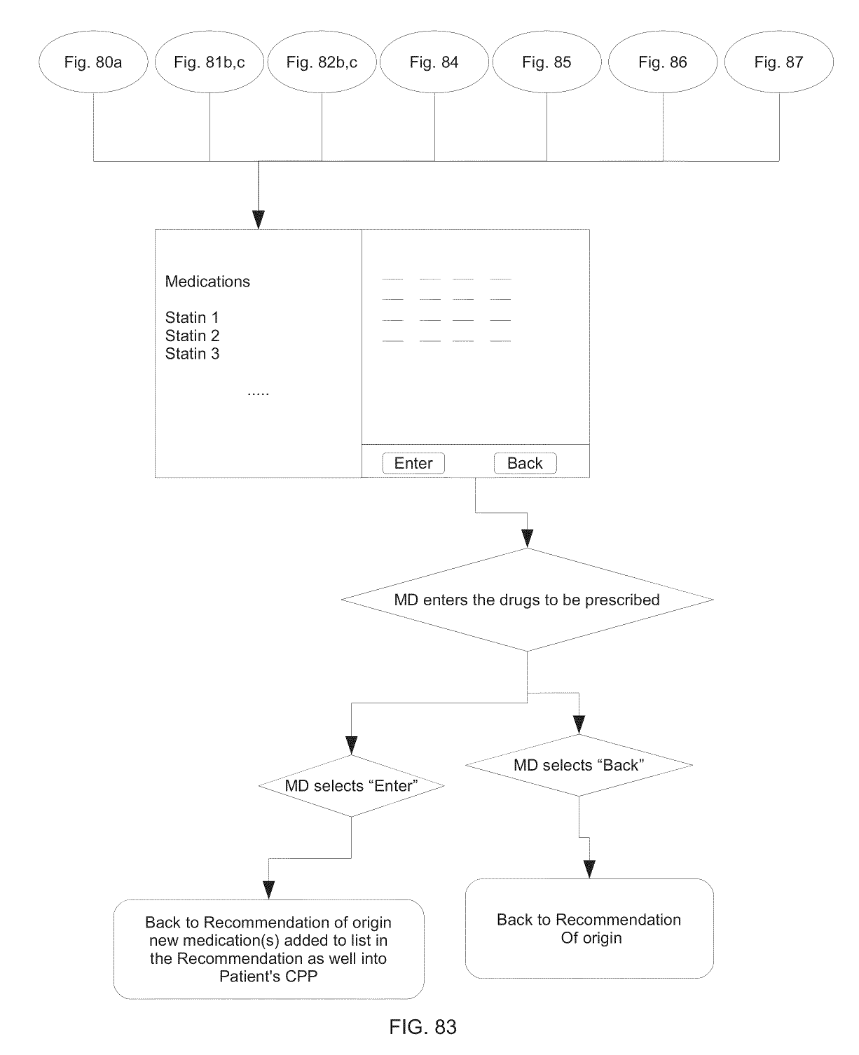

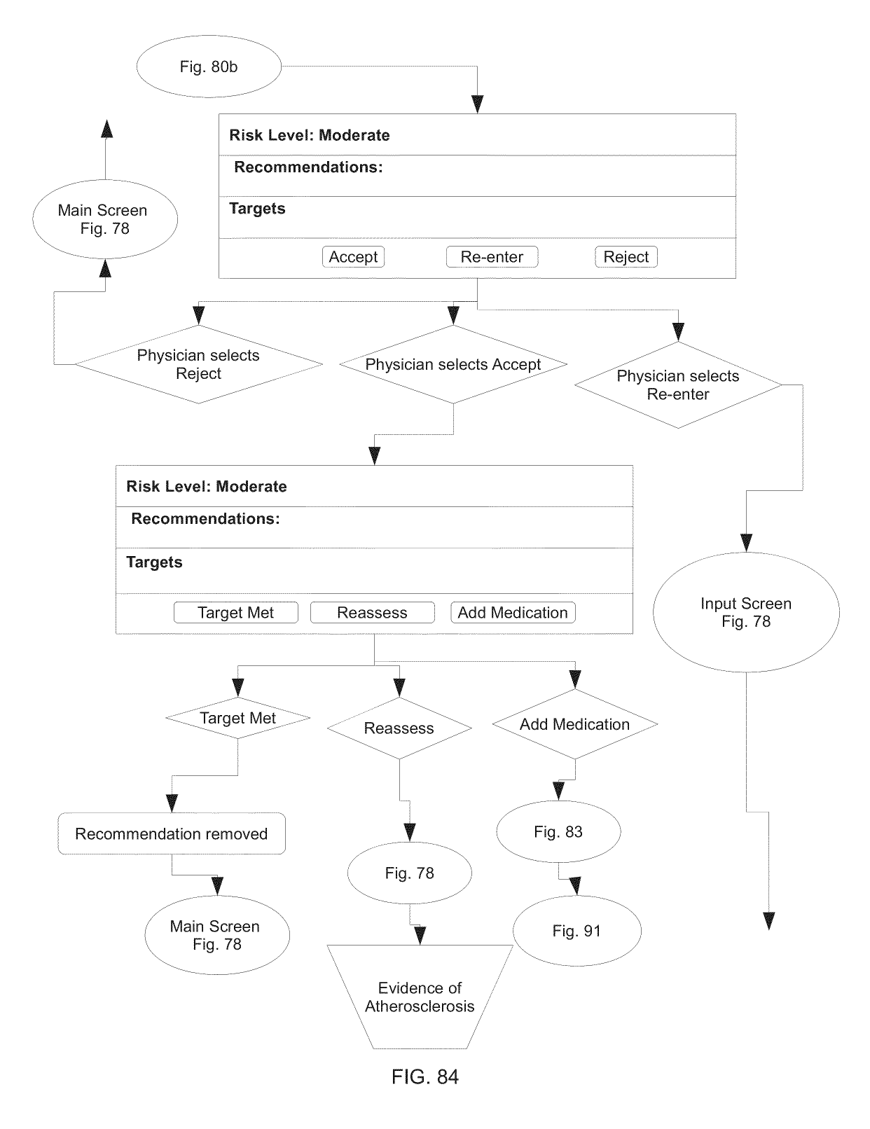

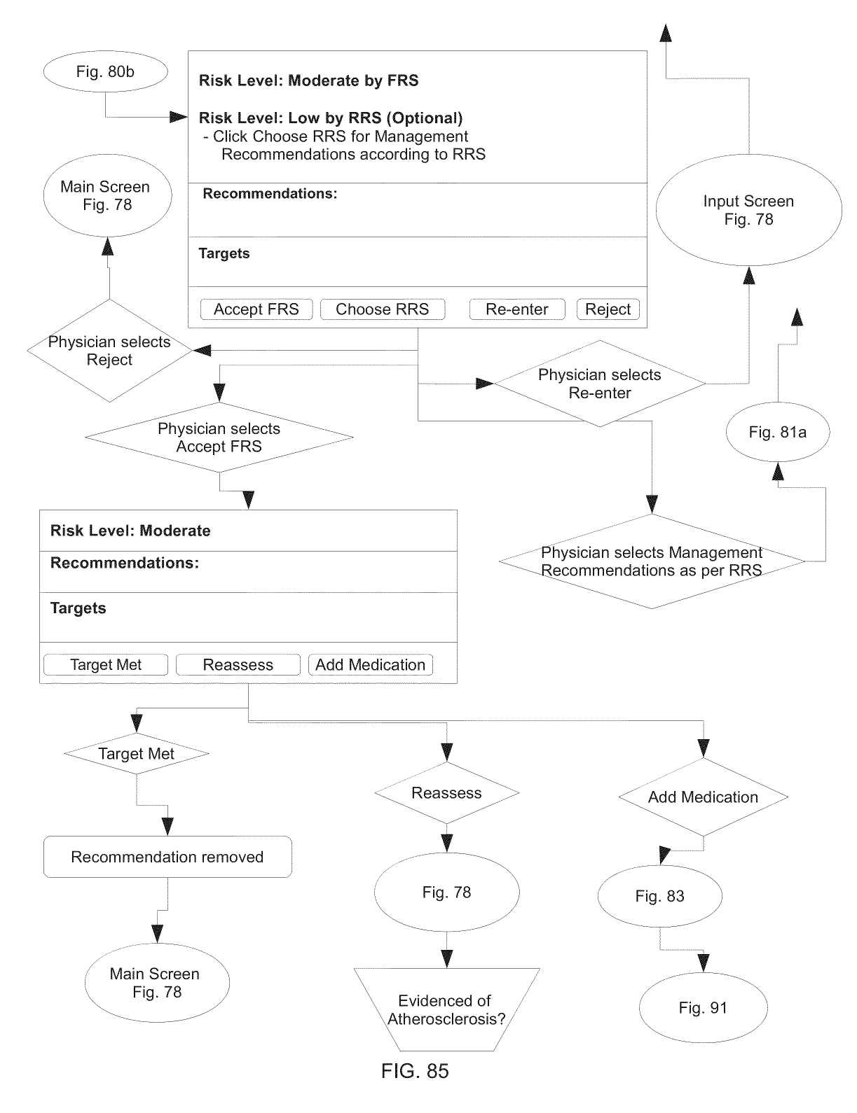

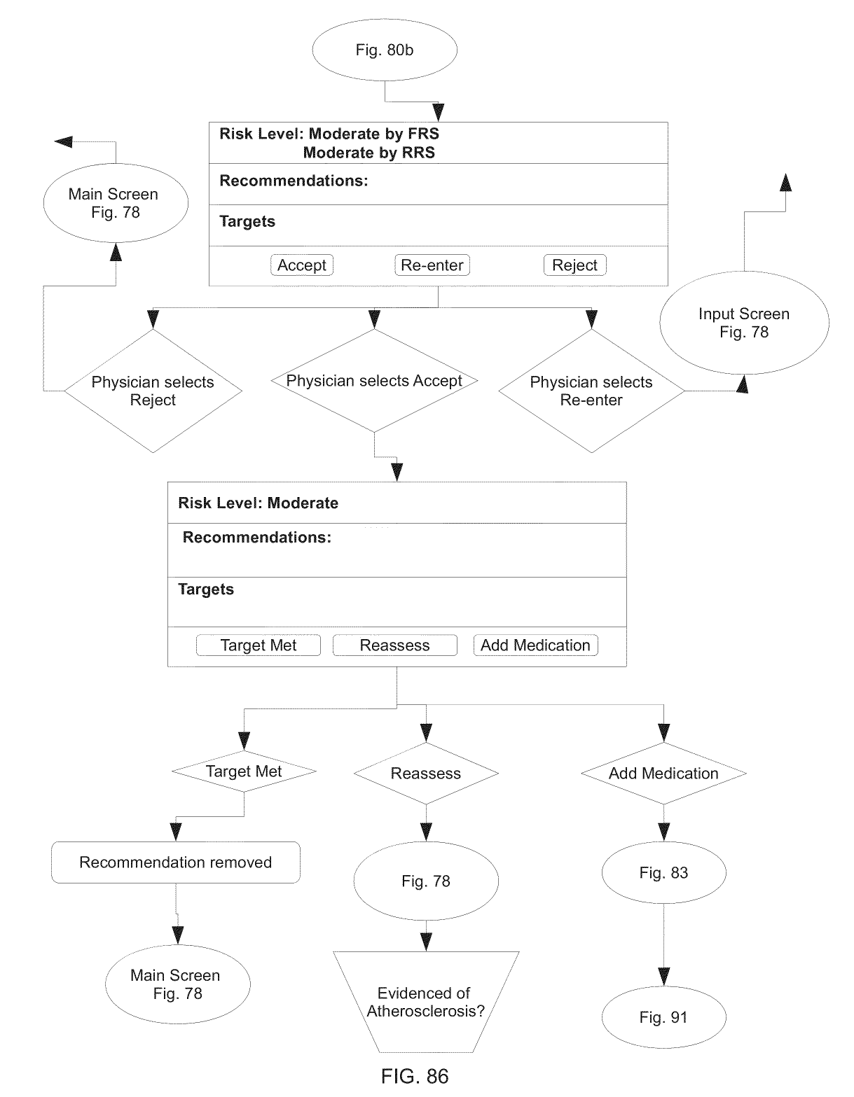

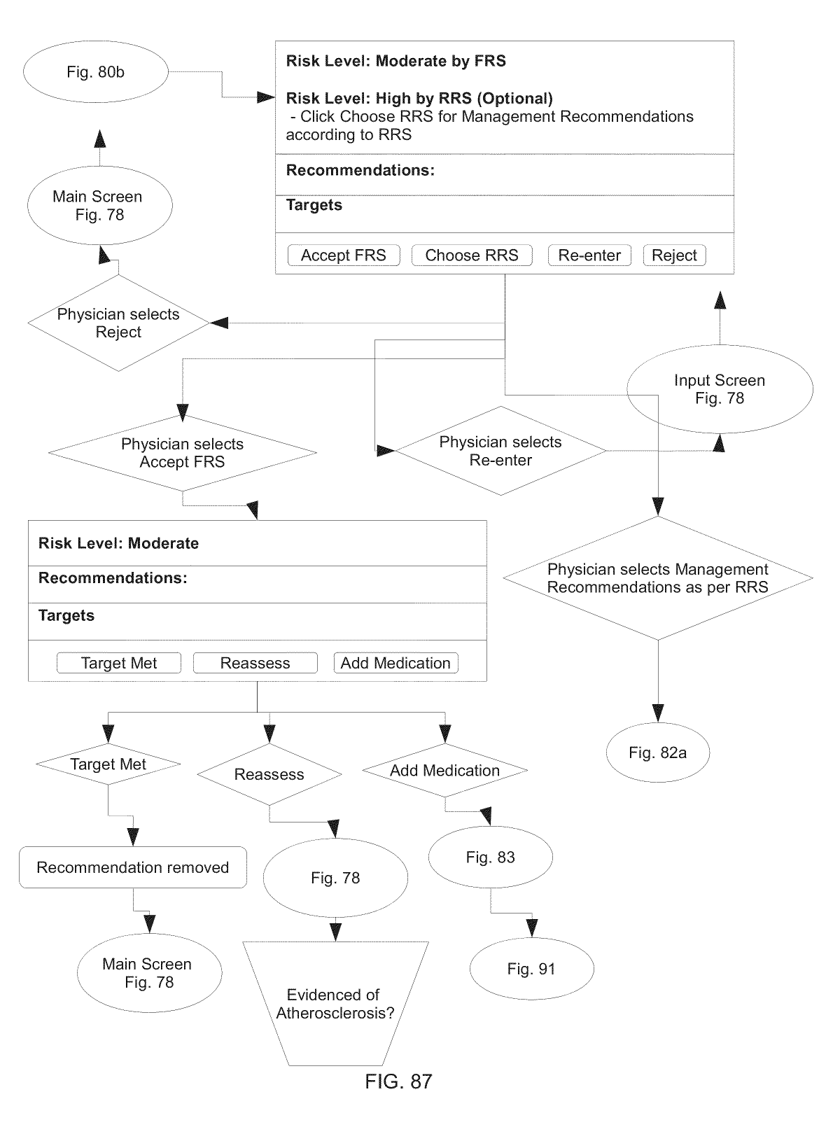

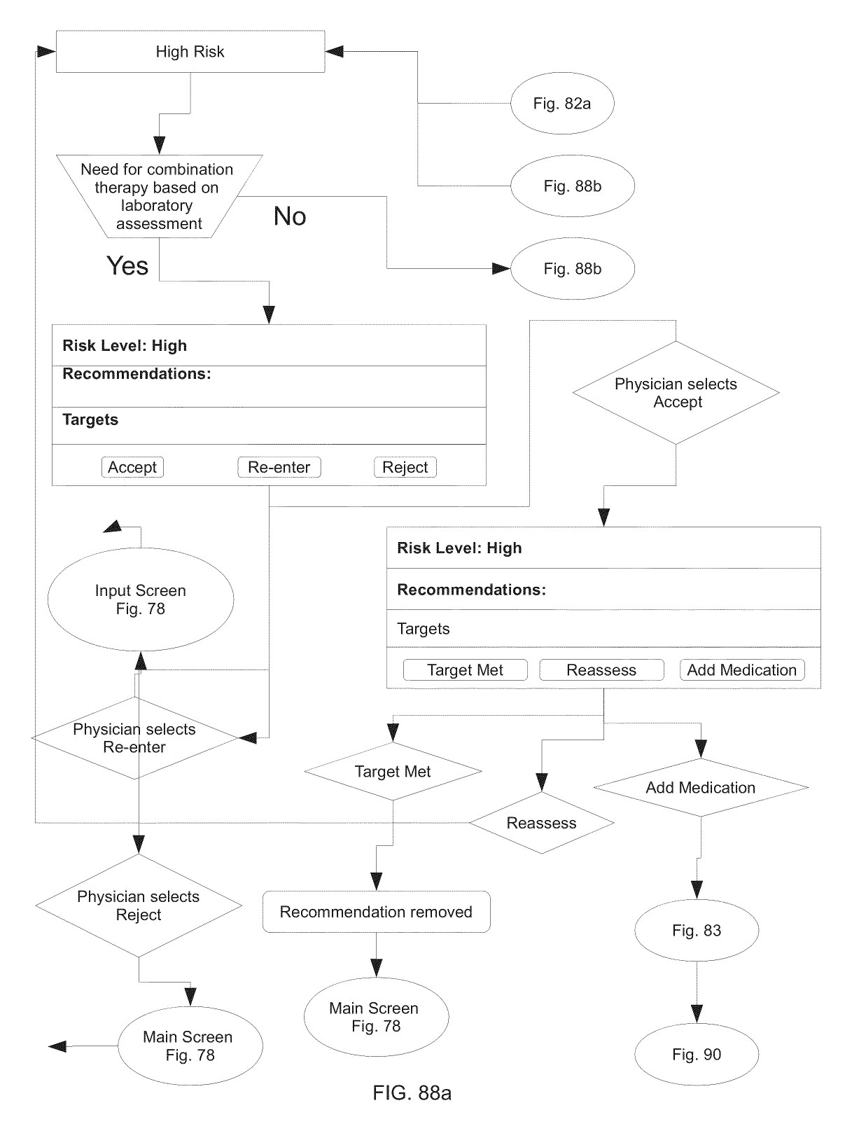

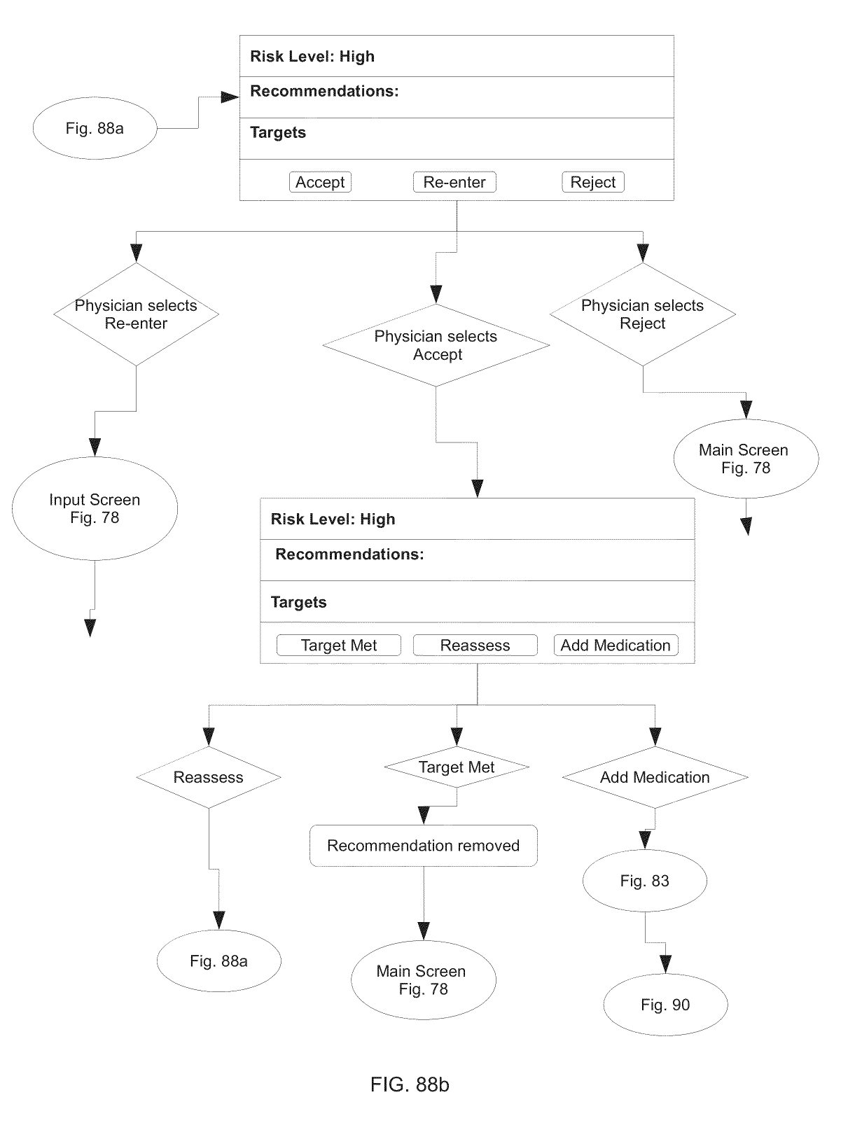

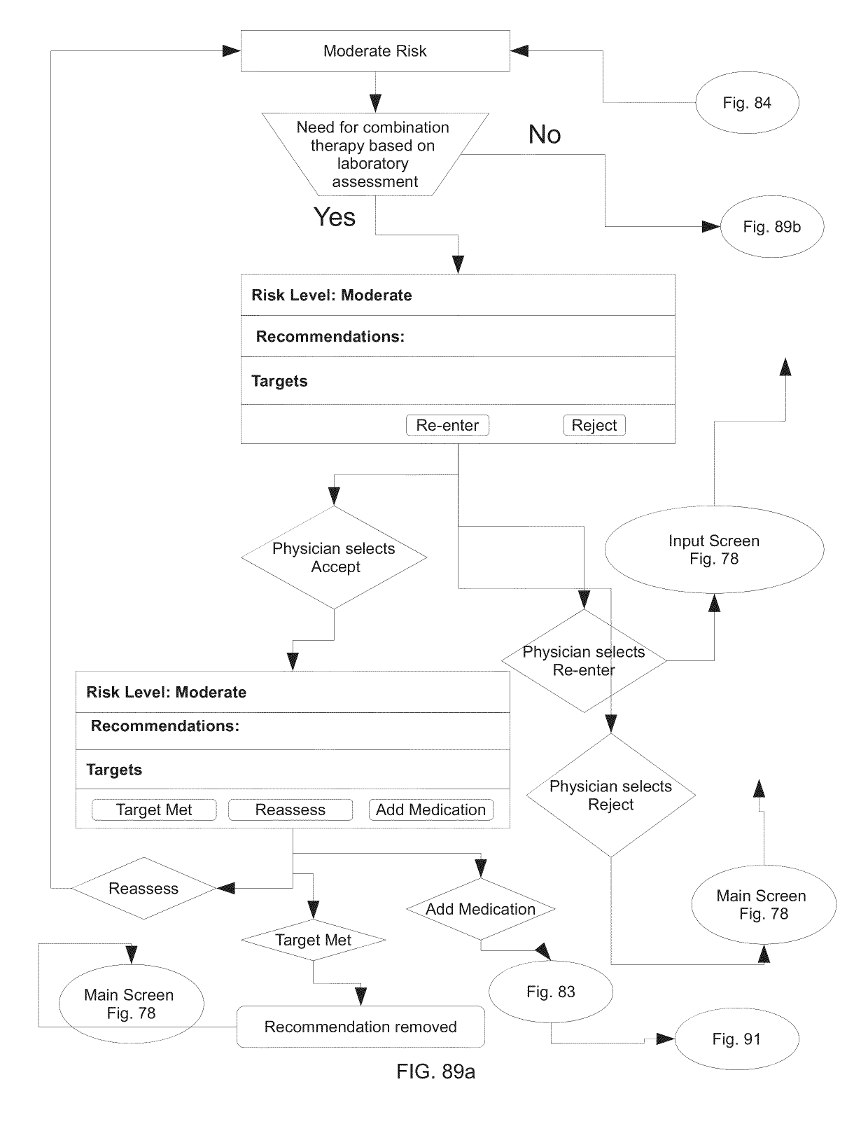

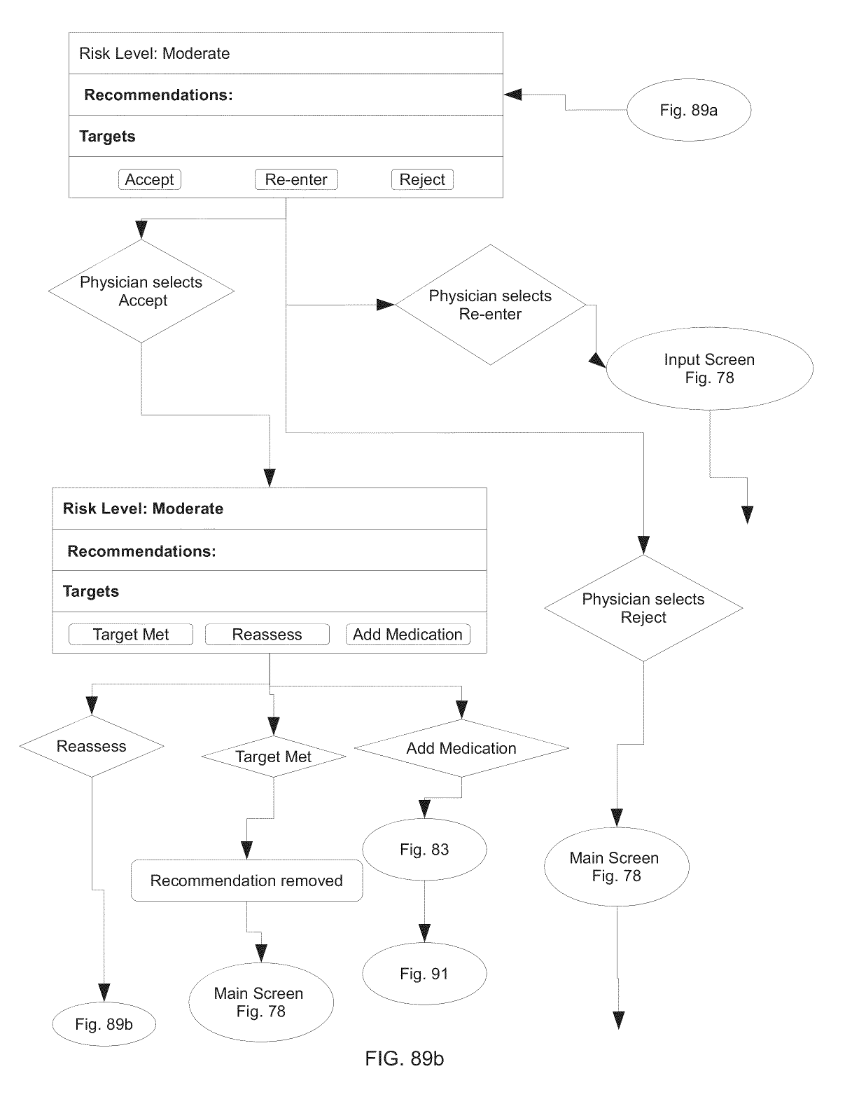

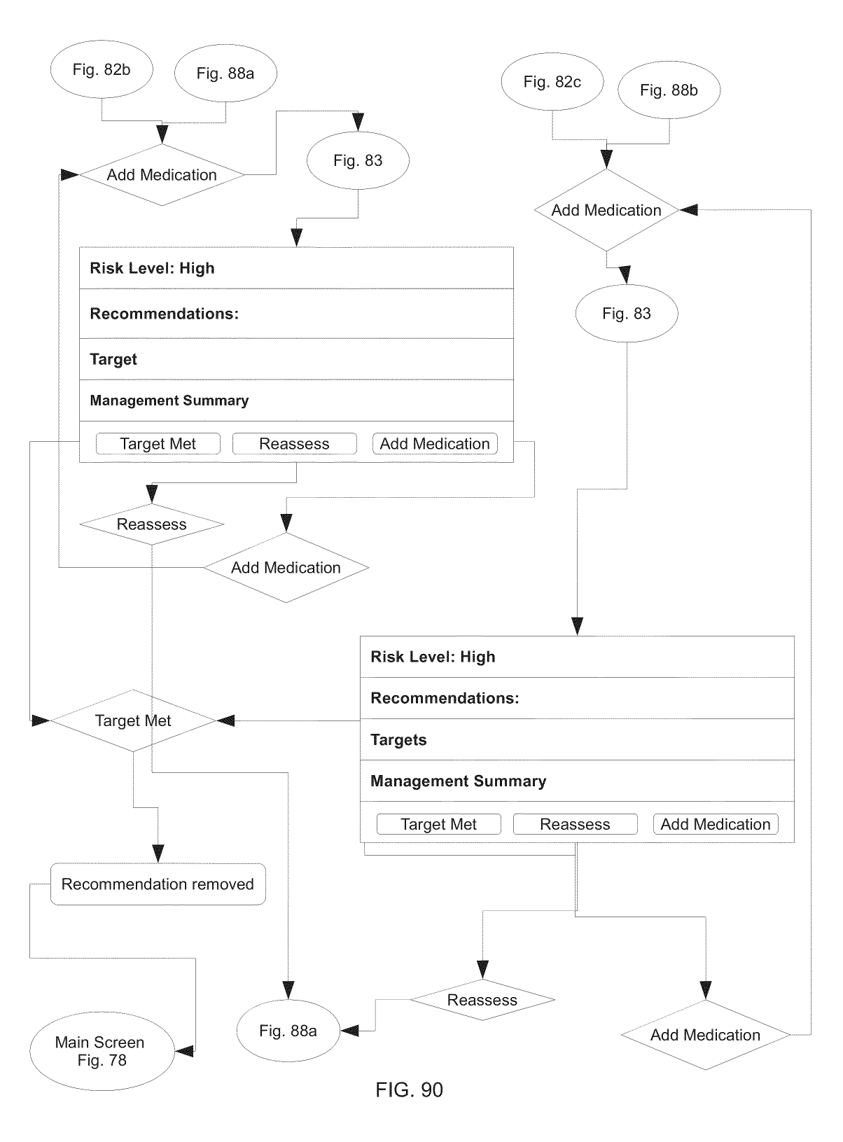

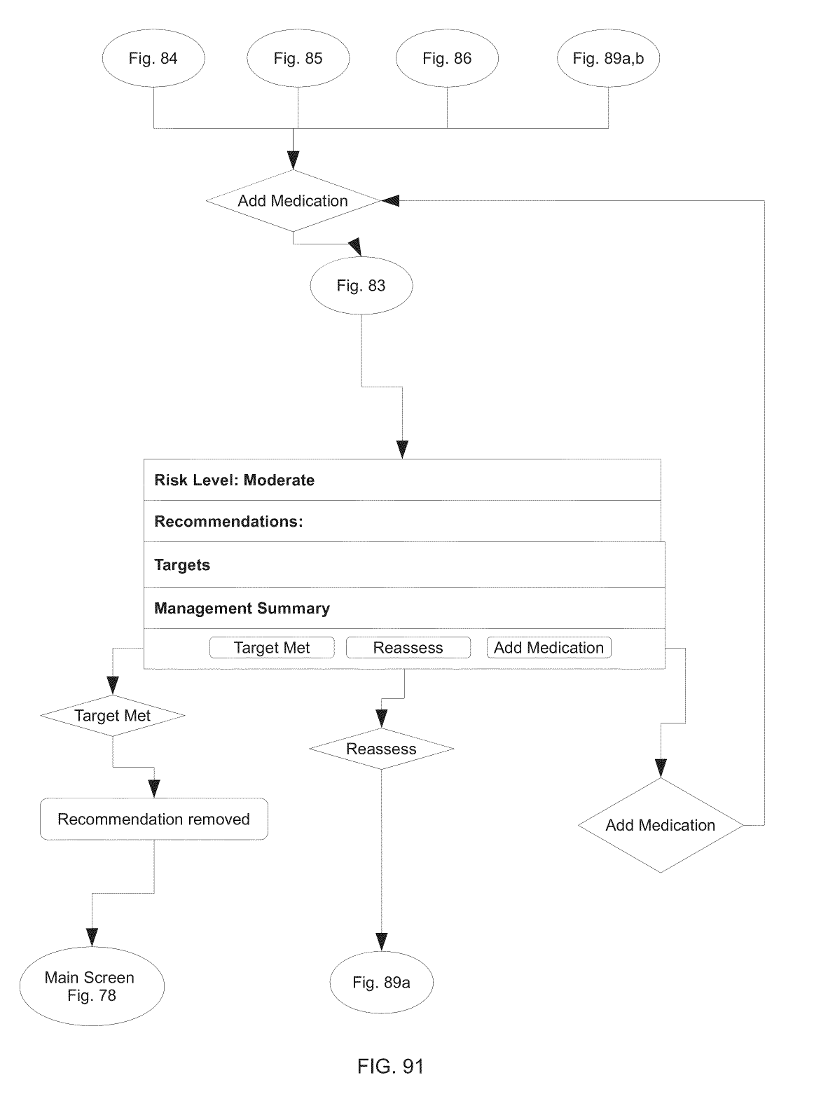

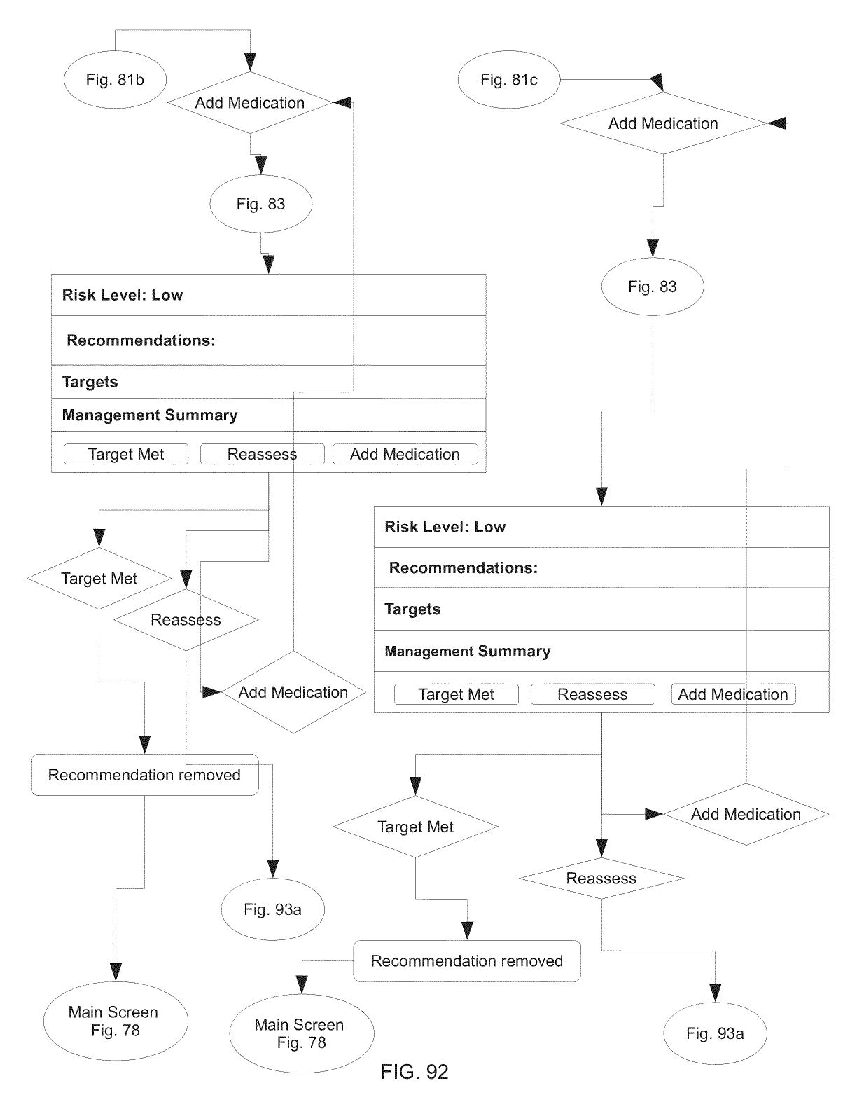

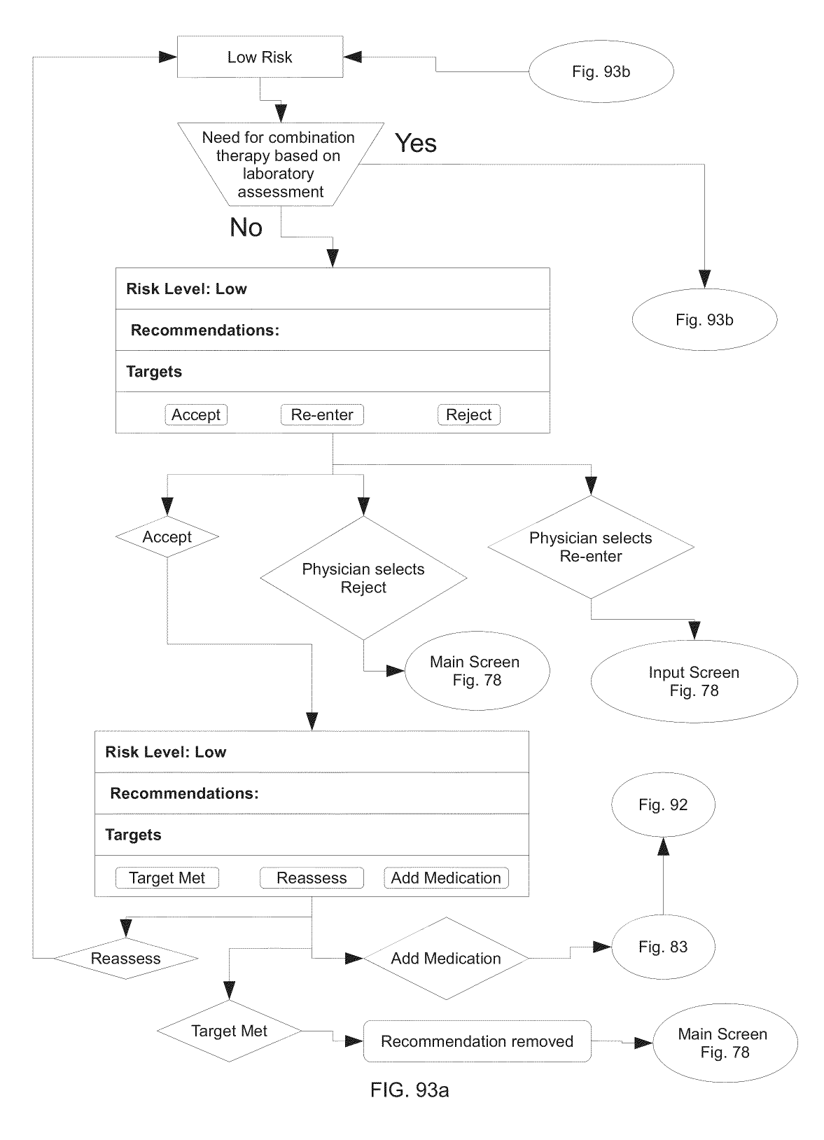

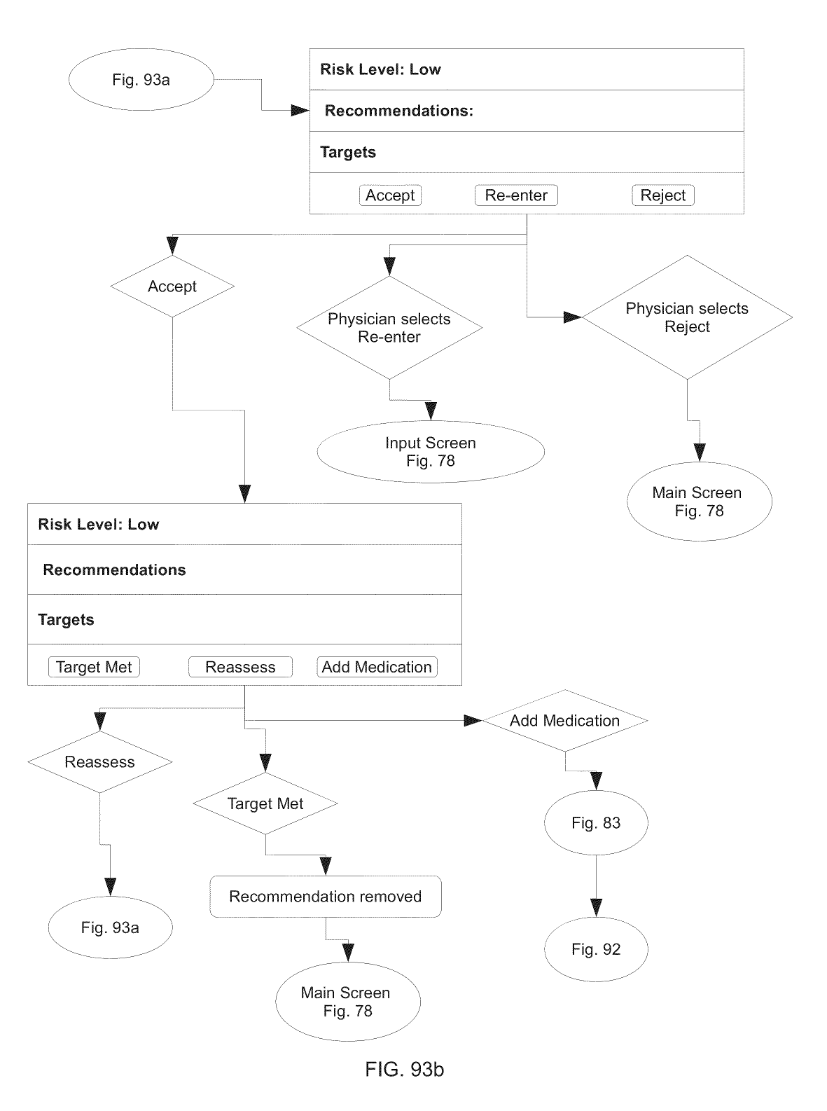

An example of such interlacing may be seen in implementation of the dyslipidemia guideline. The current CPG for dyslipidemia is the document “2009 Canadian Cardiovascular Society/Canadian guidelines for the diagnosis and treatment of dyslipidemia and prevention of cardiovascular disease in the adult—2009 recommendations”. FIGS. 94c and 95, and FIG. 78 illustrate a portion of an example algorithm for implementing the directions of the CPG aforementioned document. As shown, the algorithm may include querying whether the patient has diabetes. If the answer is yes, a series of queries may be further posed with the result that a positive answer to any of these queries may place the patient at high risk, with recommendations generated based on this risk stratification. These queries are not from the above-noted CPG for dyslipidemia but rather from the document “Canadian Diabetes Association 2008 Clinical Practice Guidelines for the Prevention and Management of Diabetes in Canada”, which is a CPG for diabetes. For example, this is indicated by the parallelogram outlining the steps borne from the diabetes guideline along with the label “Diabetes Algorithm”. Only a portion of this diabetes CPG may be interlaced with the dyslipidemia CPG. Upon conclusion of these steps from the diabetes algorithm, the process may return to steps of the dyslipidemia algorithm. Thus, in this example the CPG algorithm for dyslipidemia may, midway through, lead to the CPG algorithm for diabetes, and may return back to the CPG algorithm for dyslipidemia.

In some examples, the algorithm may be coded with rules for both dyslipidemia and diabetes (i.e., incorporating portions of both the CPG for dyslipidemia and the CPG for diabetes) and/or the algorithm may be coded with rules only for dyslipidemia and may call on a separate algorithm for diabetes as necessary.

The interlacing of the dyslipidemia CPG and the diabetes CPG may be an example of the type of interlacing exemplified in FIG. 35B, described elsewhere in this disclosure.

Another example may be the utilization of the of Reynold's risk calculation into the dyslipidemia CPGD. FIG. 97d and FIG. 80b illustrate a portion of an example algorithm for the dyslipidemia CPGD. The algorithm may include a step for the calculation of Reynolds Risk Score (RRS) (indicated in the figures as “RRS”). This calculation is not provided in the currently used dyslipidemia CPG but rather in two separate references, namely: Ridker P M, Buring J E, Rifai N, Cook N R. “Development and validation of improved algorithms for the assessment of global cardiovascular risk in women: The Reynolds Risk Score”. JAMA, 2007; 297:611-9; and Ridker P M, Paynter N P, Rifai N, Gaziano J M, Cook N R. “C-reactive protein and parental history improve global cardiovascular risk prediction: The Reynolds Risk Score for men”. Circulation 2008;118:2243-51.

In this example, the dyslipidemia algorithm may lead to the calculation for the RRS as prescribed in the above two references. The calculated RRS may be used by the algorithm to stratify the patient at a risk level and to make recommendations to the physician on the management of the patient. After calculation of the RRS, the process returns to the dyslipidemia algorithm. The entire RRS CPG may be interlaced with the dyslipidemia CPG.

The interlacing of the dyslipidemia CPG and the RRS CPG may be an example of the interlacing exemplified in FIG. 35C, described elsewhere in this disclosure.

CPG algorithms may also be a combination of various CPGs currently written as separate documents in text form. For example, when a CPG algorithm is a combination of two or more CPGs, the rules of the component CPGs may be interlaced with each other, with the result that the two or more CPGs may interact with each other to produce recommendations for the physician. Such interlacing may also be found in tools that may be provided in examples of the disclosed methods and systems.

In some examples, the system may provide the physician with one or more tools as aids in the medical management of the patient. These tools may allow the physician to execute one or more specific tasks such as medication selection, diet control or exercise prescription for the patient, among others. Tools may not be directed towards a particular disease condition such as hypertension, diabetes or dyslipidemia. For example, the same tool may be employed in conjunction with two or more CPGDs. For example, a medication selection tool may be used in selecting medication, through the course of working through various CPGDs. Such tools may include components of one or more CPGs. In the case where the components of more than one CPG are found in a tool, the components of the different CPGs may be interlaced. As shown in FIG. 34, a CPGD may include one or more tools. For example, where the same tool may be employed in conjunction with more than on CPGD, each of these CPGDs may include the same tool. A CPGD may not include any tools, for example where there is no tool employed in conjunction with that CPGD. Tools may also be stored in the system separate from CPGDs, as appropriate.

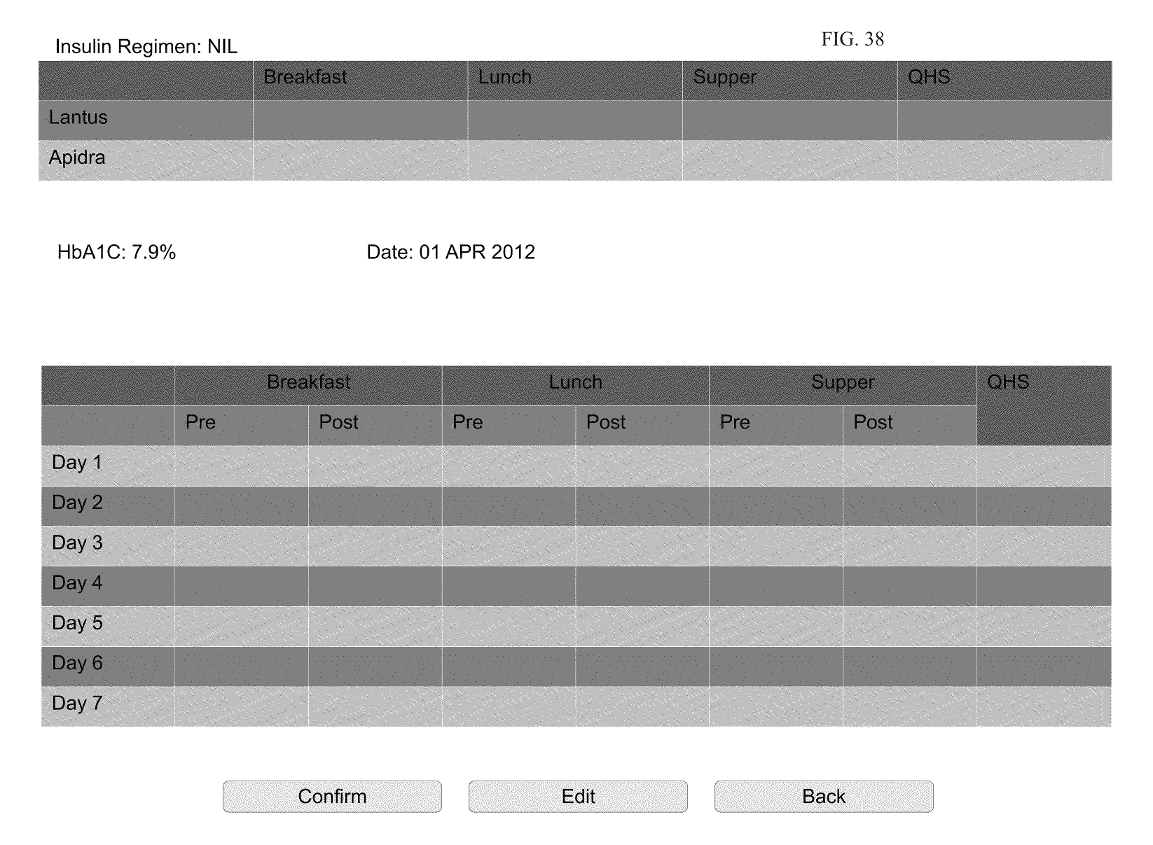

An example of a tool, which may involve interlacing more than one CPG, is an insulin prescription tool, illustrated in FIGS. 38-77 and described further below. The interlacing of CPGs in the insulin prescription tool may be an example of the type of interlacing exemplified in FIG. 35D, described elsewhere in this disclosure.

Thus, a single CPGD may allow for interlacing and/or interaction of multiple CPGs by having one CPGD call on the functions of one or more other CPGDs and/or by one CPGD having an algorithm that implements the directives of more than one CPG (e.g., one CPG and at least a portion of another CPG).

The CPGD may also include a contraindication list. The contraindication list may include a compilation of one or more medications that may be contraindicated for certain conditions of a patient. As described elsewhere in this disclosure, the contraindication list may be employed by a contraindication module and/or patient manager to generate an alert to a physician that a medication that the physician intends to prescribe is contraindicated for a patient, for example.

The CPGD may also include a monitoring list. The monitoring list may be a compilation of one or more upcoming management interventions and follow-up assessments for patients. As described elsewhere in this disclosure, the monitoring list may be employed by a CPG monitor module and/or the patient manager to generate one or more recommendations to the physician as to any upcoming management interventions and follow-up assessments for a patient, for example.

In some examples, each CPGD may include its own contraindication list and monitoring list, storing any contraindications and/or monitoring events generated by that CPGD. In some examples, the contraindication lists and/or monitoring lists of each CPGD may be amalgamated into a common contraindication list and/or a common monitoring list that may be shared among the CPGDs.

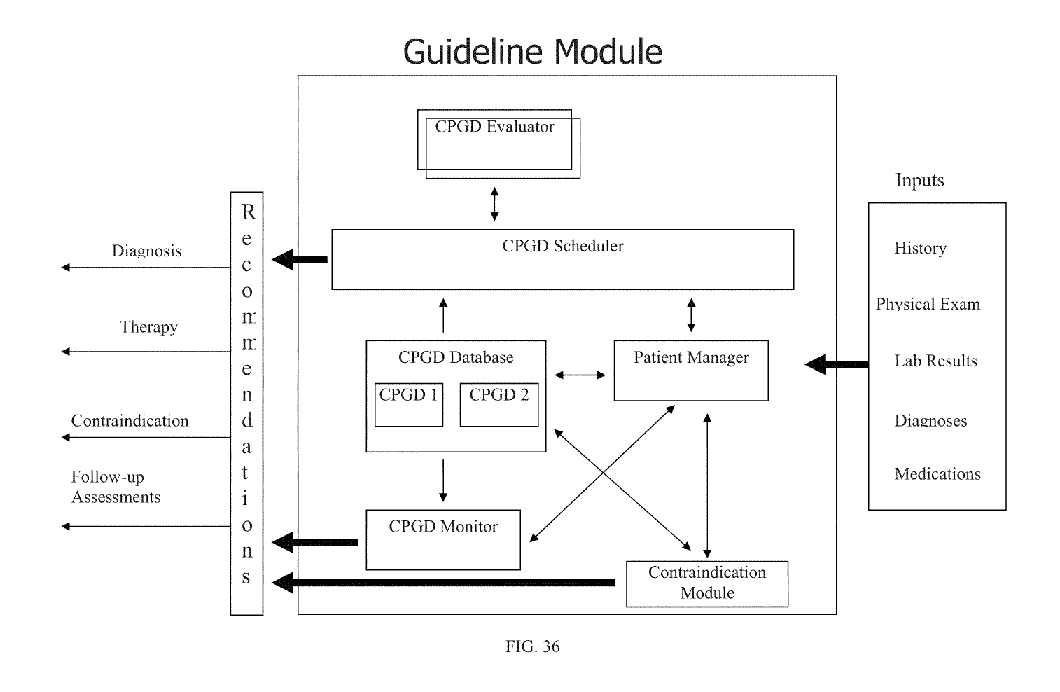

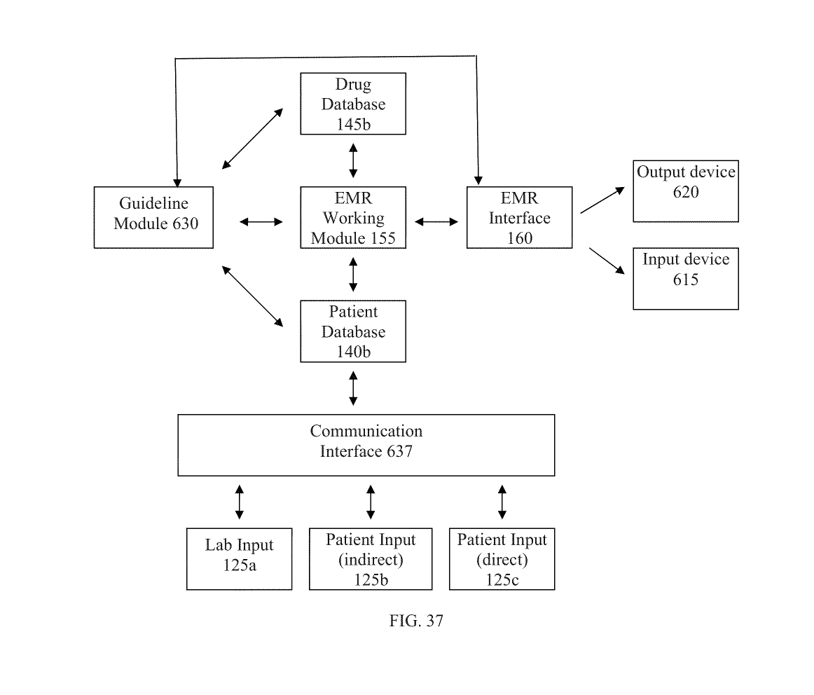

FIG. 36 illustrates an example of the guideline module, including sub-modules within the guideline module.

The guideline module may include a CPGD database. The CPGD database may store available (e.g., both old and new versions) CPGDs and may provide CPGDs to the CPGD scheduler and CPGD monitor components (e.g., in response to a query). The CPGD database may further interact with the patient manager and the contraindication module.

The guideline module may also include a patient manager. The patient manager may store data associated with each patient and may also track spontaneously changing and/or inherent data (e.g., age) of each patient. The patient manager may receive as input data associated with a patient including, for example, patient history, physical exam results, lab results, diagnoses, and/or prescriptions for medications. The patient manager may determine a list of CPGDs and/or their rules that may be relevant for each patient based on the input fields of all the CPGDs stored in the CPGD database and the received input. The result is the indexing of the CPGDs and their rules. Indexing and its relevance to automatically triggered employment of CPGDs is discussed later. The patient manager may also query CPGDs to use one or more inclusion criteria in the CPGDs to determine which CPGDs should be applied to each patient.

The list of relevant CPGDs for a given patient may be transmitted to the CPGD scheduler to be used for determining an appropriate order of implementation of the listed CPGDs for that patient.

The guideline module may also include a CPGD scheduler. The CPGD scheduler may receive data (e.g., a tuple of patient data, additional inputs, and list of relevant CPGDs) from the patient manager. The CPGD scheduler may also receive data directly from a user (e.g., a physician if a CPGD is explicitly invoked by a physician). The CPGD scheduler may also determine any dependencies and/or interactions between two or more candidate CPGDs (e.g., whether potential output from one CPGD may act as input to another CPGD). The CPGD scheduler may also invokes one or more CPGD evaluators as needed.

For example, after receiving the list of relevant CPGDs from the patient manager, the CPGD scheduler may create a pathway of execution of the CPGDs. An example of such a pathway is schematically illustrated in FIG. 35A. In this example, inputs are received by CPGDs A, B and C. CPGD A generates an output which is input to CPGD C. CPGD B generates output which is input to CPGD D and CPGD C generates output which is an input to CPGD D. CPGD D may then generate the final recommendation to be provided to the physician.

The CPG scheduler may use predefined rules to set the order of implementation of the CPGDs. These rules may allow for more efficient processing of CPGDs, reduction in redundancies and/or reduction in re-processing of CPGDs, for example.

For example, in the case in which there are multiple inputs to a CPGD (e.g., inputs from another CPGD and/or inputs from a user), any received inputs from other CPGDs may be processed first to generate any new recommendations. External data inputs (e.g., from a user) may then be processed by the CPGD to generate any additional recommendations. In FIG. 35A, this may be illustrated by the case of CPGD C.

In another example, where a CPGD receives as input multiple outputs from other CPGDs, such input may be processed together to generate any recommendations. In FIG. 35A, this may be illustrated by the case of CPGD D.

In another example, where a CPGD receives as input multiple external data input, such input may be processed together to generate any recommendations. In FIG. 35A, this may be illustrated by the case of CPGD B.

In an example of scheduling by the CPGD scheduler (e.g., based on the rules described above), the flow of CPGDs in FIG. 35A may be processed as follows:
1. External input data processed by CPGDs A and B
2. Output of CPGD A processed as input to CPGD C
3. External input data processed by CPGD C
4. Outputs from CPGD B and CPGD C processed as input to CPGD D

In some examples, interlacing of CPGs, for example as described above, may also be involved. For example, execution of CPGD C may include interlacing with CPGD E (not shown). Such interlacing may not require scheduling by the CPGD scheduler.

The CPGD scheduler may retrieve the appropriate CPGDs from the CPGD database and may employ the CPGD evaluator to implement the CPGDs in the determined sequence. The CPGD scheduler may transmit the resultant recommendation(s) to be provided to the physician.

The guideline module may also include a CPGD evaluator. The CPGD evaluator may execute an individual CPGD. There may be many instances of an evaluator (e.g., one for each stored CPGD) present in the system. Results may be transmitted to the CPGD scheduler.

The guideline module may also include a CPGD monitor. The CPGD monitor may manage the scheduling of patient events (e.g., regular patient visits, tests, inoculations, etc.), for at least some patients (e.g., patients associated with recommendations indicating ongoing maintenance is required). The CPGD monitor may manage the planning of such events and may generate alerts, notifications and/or new event recommendations as appropriate (e.g., according to the rules of one or more CPGD).

The CPGD monitor may interact with the patient manager. For example, the patient manager may determine any recommendations for each patient that include management tasks or follow-up assessments (e.g., to be performed after a set time interval). Such recommendations may be generated by one or more CPGDs. The patient manager may provide this list to be added to the monitoring lists of the appropriate CPGDs. The patient manager may also provide, for each patient, a list of routine tests along with the due date for these tests. Routine tests may be those tests that are required for all patients of the same gender and certain age groups, for example. Examples of these tests may include fecal occult blood testing and mammograms, among others. This list of routine tests along with due dates may be provided to the monitoring lists of the various CPGDs. The CPGD monitor may index this list of upcoming tasks (e.g., according to the due date of the task) and by progressively moving down this list may generate notifications and/or recommendations to the physician in advance of the due date of the pending tasks. The amount of advance notice provided by the CPGD monitor may be adjustable (e.g., by the physician). In some examples, the monitoring list for routine tasks may be separate from the monitoring list for CPGD-recommended tasks, or both types of tasks may be found in the same monitoring list.

The guideline module may also include a contraindication module. The patient manager may determine one or more medications that are contraindicated for each patient and may populate the contraindication list of each CPGD with these medications. All medications prescribed (e.g., as entered by a physician) for the patient may be compared by the contraindication module to the contraindication list to determine whether the prescribed medication is contraindicated for that patient. If the medication prescribed is found in the contraindication list, then that medication is determined by the contraindication module to be contraindicated or advised against for that patient, and a recommendation may be generated to use a different medication. Medications prescribed for the patient may also be inputted by the contraindication module into a drug interactions CPGD to determine any drug-drug interactions with any medication presently being taken by the patient. Any medication contraindicated or advised against may be provided to the physician as a recommendation.

Physicians are increasingly utilizing electronic medical records (EMRs), also known as electronic health records (EHRs) in the care of their patients. EMRs may include software programs that can be installed on a variety of hardware devices (e.g. desktop computers, laptops, tablet computers) which allow the physician and/or other medical staff to perform functions relevant to patient visits. Common functions include billing and patient scheduling, for example. EMRs may also implement contain modules for chronic disease management which typically include templates to enter patient information. These templates are typically custom made by the physician as the EMR program may provide the ability for the physician to create these templates. EMRs typically will also contain flowsheets enabling the physician to track patient parameters over time. In addition, EMRs may include copies of CPGs within their program, which may be presented to the physician in their entirety either as a static document or by reference as a link to a static document. In either case, the CPGs are presented in a static format by the EMR no different than if the physician were to refer to them on paper. Conventional EMRs do not make any determination of which CPGs may be appropriate, nor do they perform calculations/determinations for assessing a patient and generating recommendations according to the CPGs.

In some examples, the processor(s) 105 may further communicate with one or more other medical systems, such as one or more EMRs 150. In the example shown, the EMR(s) 150 may not be part of the system 100. However, in other examples, some or all of the system 100 may be incorporated into the EMR(s) 150 or vice versa. The EMR(s) 150 may be any conventional electronic system for managing patient information, and may be specific to one or more patients, specific to one or more hospitals, localized to a city, municipality, province or state, or may be national or international. The EMR(s) 150 may provide its own interfaces and management tools, which will not be discussed in detail in the present disclosure. The EMR(s) 150 may include one or more databases, such as a patient database 140b and a drug database 145b, which may be internal or external to the EMR(s) 150, and may be similar to the respective patient database 140 and drug database 145 stored in the memory(ies) 110. The EMR(s) 150 may also implement one or more working modules 155, the details of which will not be addressed in the present disclosure.

Communication between the processor(s) 105 and the EMR(s) 150 may allow the processor(s) 105 to have access to information stored in the patient database 140b and/or the drug database 145b. In some examples, it may not be necessary for the memory(ies) 110 to store a separate patient database 140 and/or a separate drug database 145, but rather information provided in the patient database 140b and/or the drug database 145b may be sufficient. While it may be possible to have separate patient databases 140, 140b simultaneously in the EMR(s) 150 and the system 100, this may result in unnecessary duplication of information, which may be a possible source of error (e.g., if data is updated in only one database and not the other) and/or an unnecessary use of processing and memory resources. It may be more effective to have a single patent database 140 or 140b. Even where there is more than one patient database 140, 140b used, the data fields for each database 140, 140b may be unique to that database 140, 140b, to avoid overlap and redundancy of information.

Communication between the processor(s) 105 and the EMR(s) 150 may allow a user accessing the system 100 to have access to the working module(s) 155 of the EMR(s) 150 and may also allow a user accessing the EMR(s) 150 to have access to the guideline module 130 and interface module 135 of the system 100. In some examples, as will be described below, the guideline module 130, interface module 135 and working module(s) 155 may work in concert, in a complementary and integrated manner.

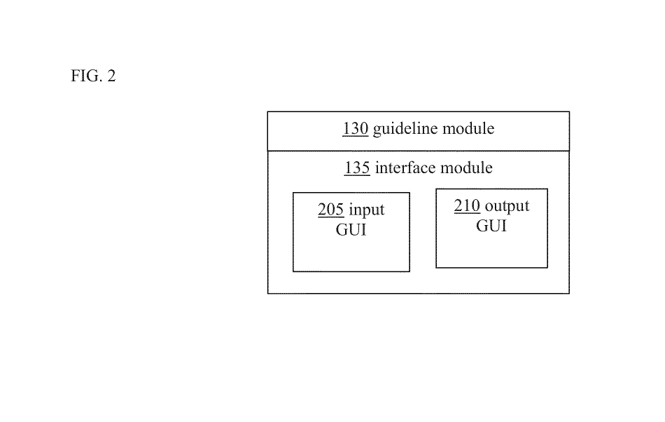

FIG. 2 illustrates an example of the modules implemented by the processor(s) 105. In this example, there is the guideline module 130 and the interface module 135. The interface module 135 may provide one or more graphical user interfaces (GUIs) for interacting with one or more users, in order to receive input data and/or provide output data. In this example, the interface module 135 may provide one or more input GUIs 205 and one or more output GUIs 210. It should be understood that there may be a plurality of input GUIs 205 and/or output GUIs 210, each of which may be tailored to suit the user, application and/or information presented.

The disclosed methods and systems may allow a user (e.g., a physician) to input relevant data on a patient, with the system (e.g., using the guideline module 130) making some, most or all of the appropriate determinations/calculations and presenting appropriate recommendations to the physician regarding the management of the patient based on the rules of the appropriate CPGD(s). The system may also prompt the physician for any data that is required in order for the rules prescribed by the CPGDs to be implemented. The system may provide the recommendations (e.g., via a display screen) at multiple points during the physician's interaction with the system in order to provide reinforcement to the physician to follow the recommendations determined from the CPGDs.

Specific examples of the disclosed systems and methods are now described. In the following description, the example system may be referred to generally as the CPGD system or the CPGD software. Although the term “software” may be used, it should be understood that the system may include more than software per se. In the following description, the guideline module may also be referred to as a working module of the CPGD system.

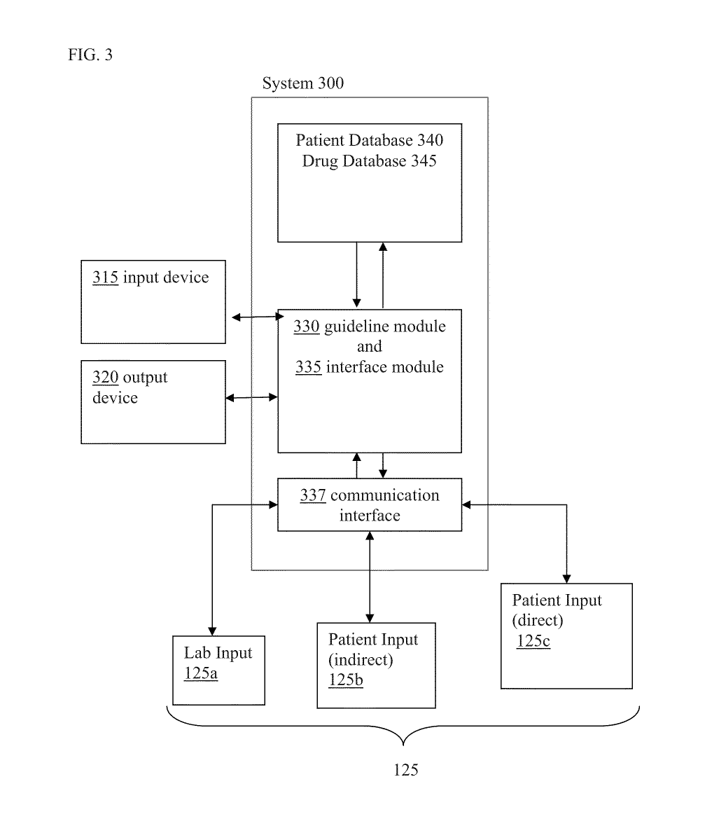

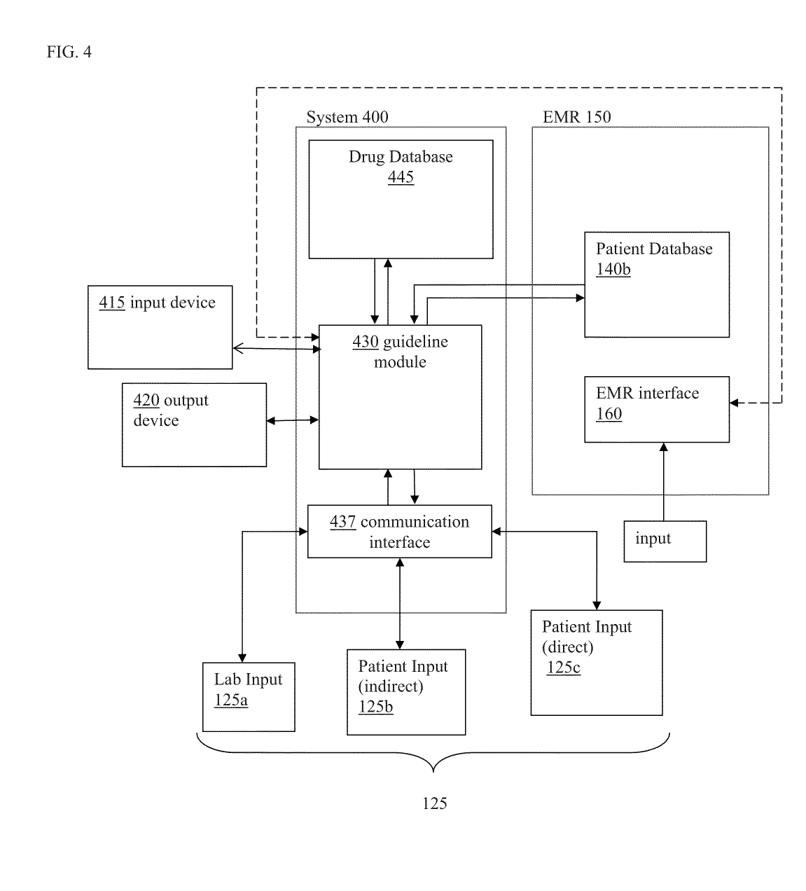

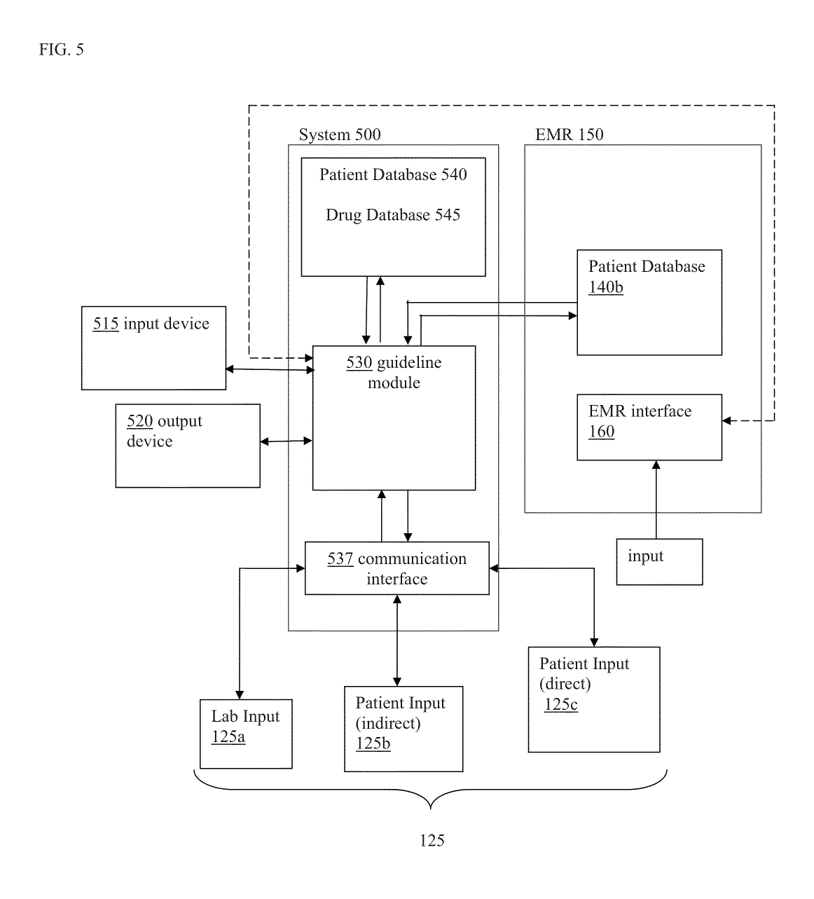

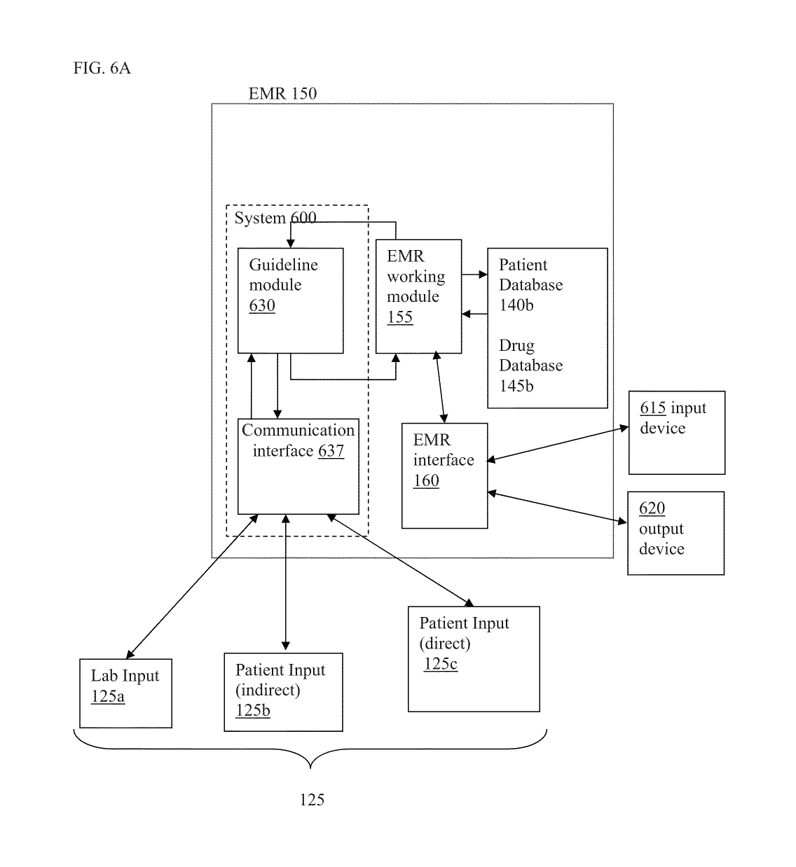

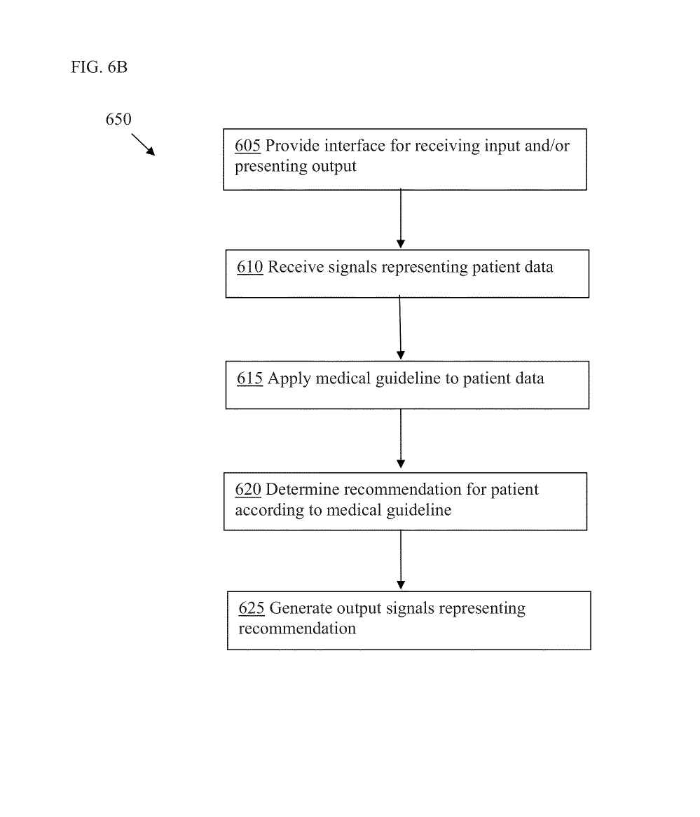

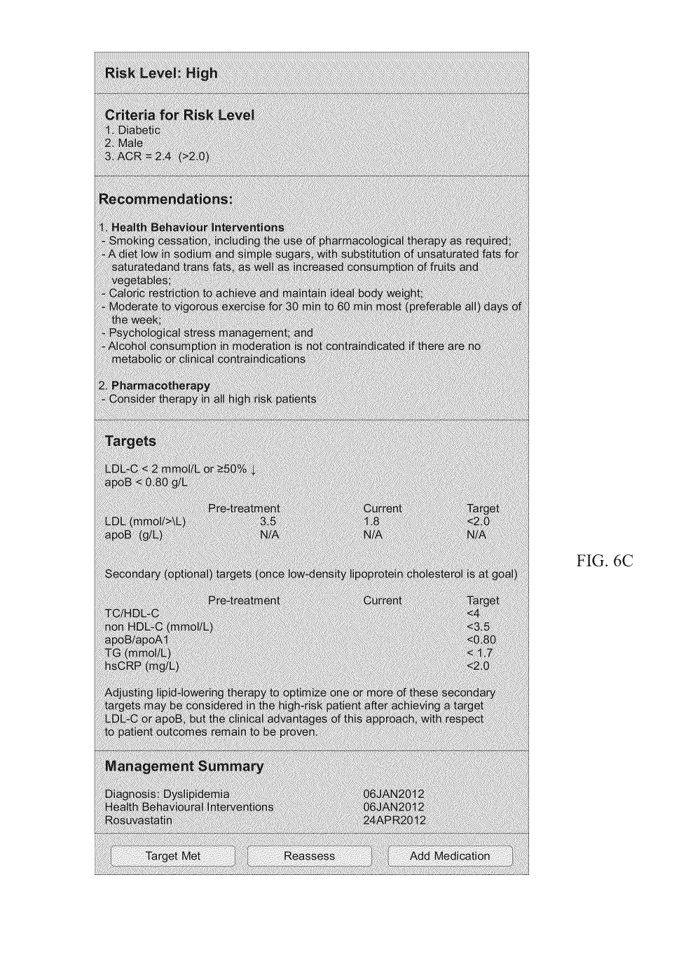

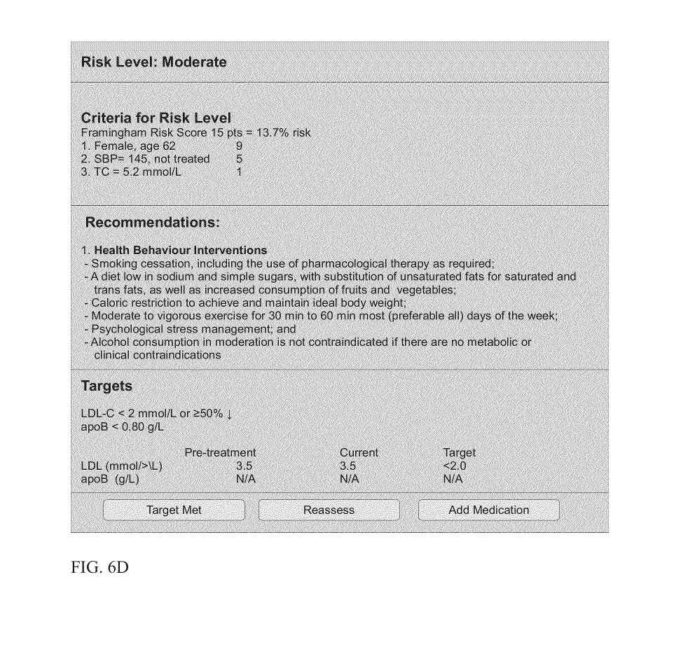

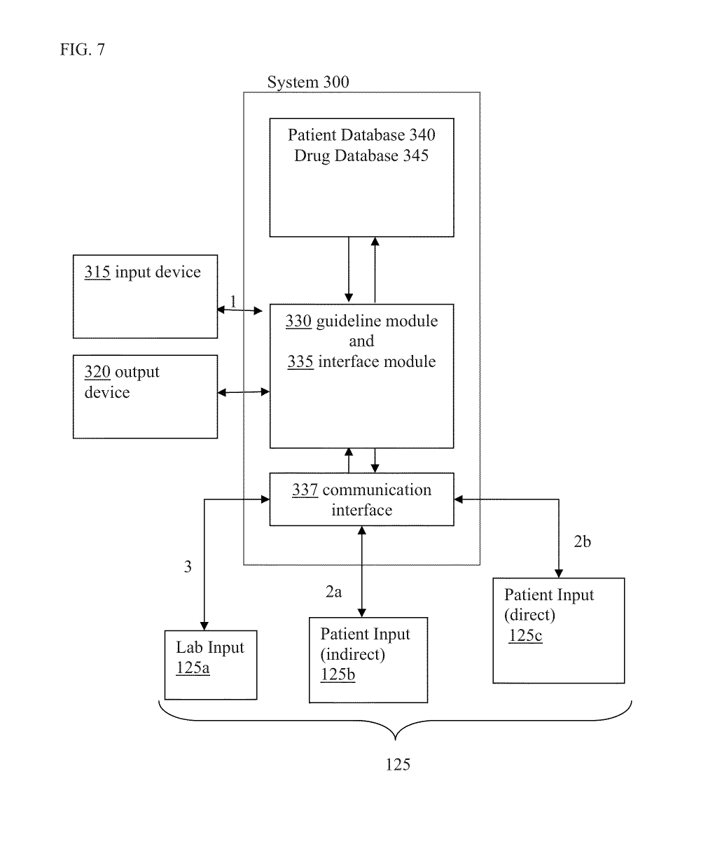

Three particular example embodiments of the disclosed systems and methods are now described, in which: the CPGD system operates independently (see FIG. 3); the CPGD system interfaces with an EMR using the patient database of the EMR (see FIGS. 4 and 5); and the CPGD system is incorporated into the EMR (see FIG. 6A).

FIG. 3 illustrates an example where the CPGD system 300 is a standalone system (i.e., without communication with any EMR). The system 300 may include a guideline module 330 similar to the guideline module 130 described above, an interface module 335 similar to the interface module 135 described above, a patient database 340 and a drug database 345 similar to the respective databases 140, 145 described above, and an input device 315 and an output device 320 similar to the respective input and output devices 115, 120 described above. The system 300 may also include one or more communication interfaces 337 for managing communication with one or more other devices 125. In the example shown, examples of other devices 125 that may communicate with the system 300 include: a laboratory device 125a (e.g., a laboratory computer or workstation) for communicating data to/from a laboratory; an indirect patient device 125b (e.g., a patient's personal computer at home) for indirectly communicating data to/from a patient (e.g., via the Internet); and a direct patient device 125c (e.g., a patient's USB or Bluetooth device) for directly communicating data to/from a patient (e.g., via a physical connection or a local wireless connection).

The user (e.g., a physician) may be presented with an appropriate input GUI 205 (see FIG. 2, for example) (e.g., via the interface module 335) to provide data (typically patient data). The received data may be stored in the patient database 340 that is part of the system 300 for future use. Alternatively or in addition, the received data may be immediately used by the guideline module 330 to perform the relevant determinations/calculations according to the appropriate CPGD(s) and to generate recommendation(s). Where the received data is immediately used, such data may be stored in the patient database 340 before, during or after use or some or all of the data may be discarded after use (e.g., where the data is temporary, such as the time of the patient visit). The generated recommendation(s) may then be presented to the physician using an appropriate output GUI 210 (see FIG. 2, for example).

FIGS. 4 and 5 illustrate example systems 400, 500 where the CPGD system may interface with one or more EMRs 150. The EMR(s) 150 in these examples may be similar to the EMR(s) 150 described above, and may include the patient database 140b as well as an EMR interface module 160 for providing a user interface to the EMR(s) 150.

In the system 400, the guideline module 430 may be similar to the guideline module 130, 330 described above, the communication interface 437 may be similar to the communication interface 337 described above, and the input and output devices 415, 420 may be similar to the respective input and output devices 115, 315, 120, 320 described above. The system 400 may include only a drug database 445, similar to the drug database 145, 345 described above, but not a patient database. The system 400 may instead communicate with the EMR(s) 150 to access the patient database 140b of the EMR(s) 150.

The system 500 may be similar to the system 400, with a similar guideline module 530, similar communication interface 537, similar input and output devices 515, 520 and similar drug database 545. However, the system 500 may additionally include a patient database 540 that may complement or overlap with the patient database 140b of the EMR(s) 150. The patient database 540 may contain only information not found in the patient database 140b, with appropriate links and/or cross-reference to the patient database 140b. For example, patient A may have standard patient information stored in the patient database 140b. However, implementation of one or more CPGDs may require additional information not normally collected by the EMR(s) 150. Such additional information may be stored in the patient database 540 and may be linked and/or cross-referenced to patient A's information in the patient database 140b.

The user may use the interface provided by the EMR(s) 160 to access the systems 400, 500. For example, the user may enter data using the interface of the EMR(s) 160, which data may be stored as appropriate (e.g., in the patient database 140b and/or the patient database 540) and may be used by the guideline module 430, 530 to implement the appropriate CPGD(s) and generate the appropriate recommendation(s). Such recommendation(s) may then be provided to the user via the EMR interface module 160.

In the example of FIG. 6A, the system 600 may be integrated into the EMR(s) 150 such that the systems 600, 150 operate as one integrated system. In this example, the guideline module 630 and communication interface 637 of the system 600 may be similar to the guideline module 130, 330, 430, 530 described above and the communication interface 337, 437, 537 described above, but may be implemented by one or more processors of the EMR(s) 150. However, the guideline module 630 may communicate directly with the working module 155 of the EMR(s) 155 to implement the CPGDs.

For example, the working module 155 of the EMR(s) 150 may receive input data via the interface module 160. This data may in turn be accessed by the guideline module 630 via the working module 155. Similarly, recommendations generated by the guideline module 630 may be communicated to the working module 155 and in turn presented as output by the interface module 160. Communications between the guideline module 630 and the patient and drug databases 140b, 145b may also be via the working module 155. Although in the example shown the other devices 125 communicate with the system 600 via the communication interface 637 of the system, it should be understood that in other examples the other devices 125 may communicate with the EMR(s) 150 instead via other communication interface(s) provided by the EMR(s) 150.

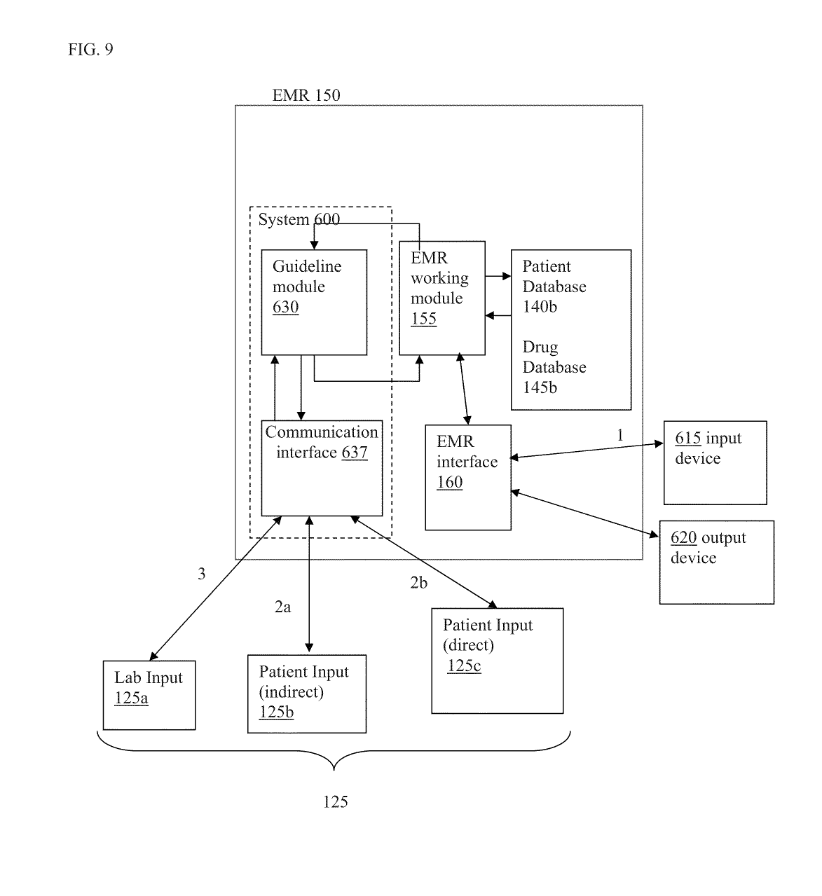

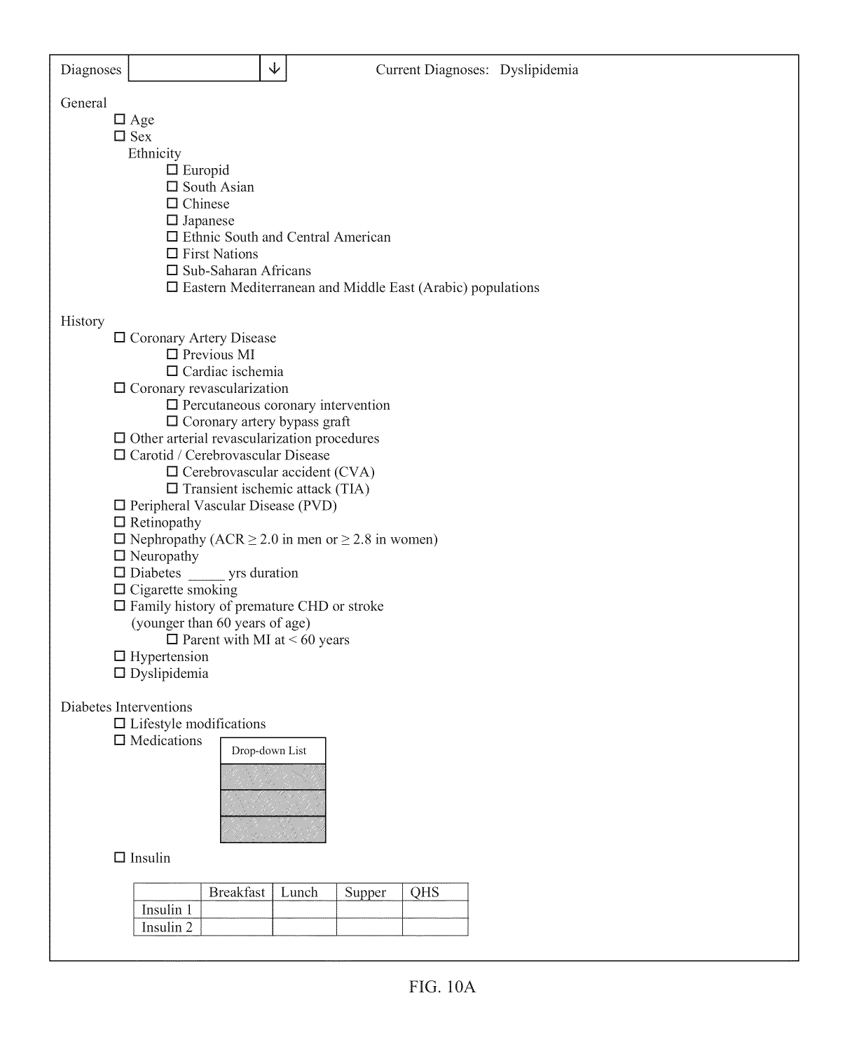

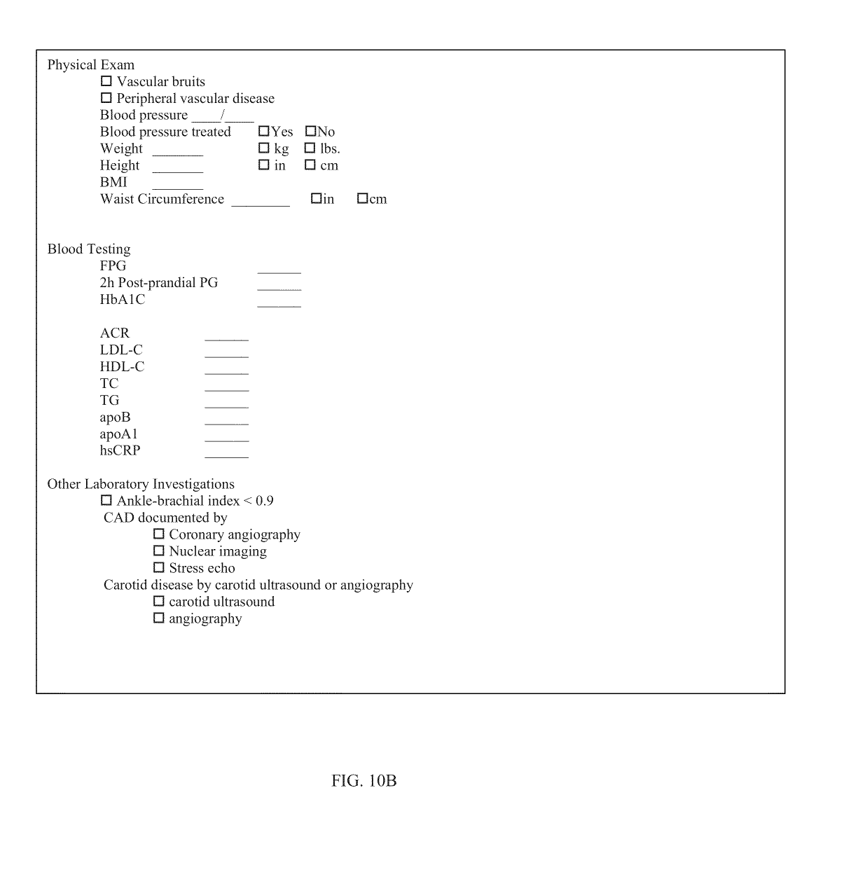

In some examples, as shown in FIG. 37, the guideline module 630 may not need to communicate via the working module 155 of the EMR(s) 150. For example, input data received at the interface module 160 may be provided directly to both the guideline module 630 and the working module 155. Similarly, both the guideline module 630 and the working module 155 may have direct access to the patient and/or drug databases 140b, 145b. In this example, lab input 125a, patient input 125b and patient input 125c may all communicate with the communication interface 637 which may communicate with the patient database 140b and/or the drug database 145b, which in turn may communicate with both the guideline module 630 and the working module 155. The guideline module 630 may be considered intrinsically a part of the EMR(s) 150. In this case, inputs and outputs may be handled through the EMR(s) 150 (e.g., as shown in FIG. 9).

Example Method

Reference is now made to FIG. 6B illustrating an example method 650 for interactive implementation of medical guidelines. The method 650 may be implemented by any suitable system including, for example, the system 100, 300, 400, 500, 600 described above. The method 650 may be implemented by one or more processors as appropriate.

At 605, an interface may be provided (e.g., a graphical user interface displayed on an output device) for receiving input and/or providing output. The received input may include patient data (e.g., entered by a physician or provided from a lab), for example as described elsewhere in the present disclosure. The provided output may include any generated recommendations for a patient, for example as described elsewhere in the present disclosure.

At 610, signals may be received representing the patient data. For example, such signals may be received from the input device (e.g., where the input is from a user), from another system (e.g., where patient data is received from a separate EMR system), and/or may be internally generated (e.g., where patient data has been automatically updated, such as patient age). Patient data may be received from internal sources (e.g., an internal database) and/or external sources (e.g., input from a user, such as a medical personnel or a patient, input from a lab or from an external database).

At 615, one or more CPGDs may be applied to the patient data. The CPGD(s) may include rule(s) for determining one or more medical conditions of the patient. The CPGD(s) may also include rule(s) for determining one or more medical recommendations. CPGDs may be applied to the patient data for making calculations and evaluating the patient, for example as described elsewhere in the present disclosure.

Various CPGDs may be applicable including, for example, CPGDs for: diabetes mellitus, hypertension, dyslipidemia, chronic obstructive pulmonary disease, osteoporosis, congestive heart failure, depression, atrial fibrillation and drug interactions, among others.

In some examples, applying a CPGD may include calculating a criteria (e.g., calculating a patient value according to a definition in the CPGD, the value to be representative of the patient's medical condition and to be compared to a threshold value defined in the CPGD) for determining the medical condition of the patient according to the rules of the CPGD. This criteria may then be used to determine a medical recommendation for the patient according to the rules of the CPGD.

In some examples, where the patient data is insufficient to apply the CPGD, a prompt may be provided (e.g., via the output device) to request and receive more input data. One or more internal and/or external patient databases may also be queried in order to obtain the required patient data.

In some examples, one or more CPGDs may be applied in response to input data received for a different CPGD. For example, certain types of patient data may be common across two or more CPGDs, and when such patient data is newly received or updated using an input template for one CPGD, such data may be propagated to the other CPGDs that use such data, in order to allow the other CPGDs to also be applied.

In some examples, the CPGD may be applied in response to an internally or externally generated update of the data associated with the patient. For example, an update of a patient's age may be internally generated (e.g., according to an internal system calendar) and this update may trigger application of the CPGD.

At 620, one or more medical recommendations may be determined for the patient, based on the medical condition(s) of the patient according to the applicable CPGD(s).

Such recommendations may include, for example, recommendations for lifestyle changes, medications and/or further patient assessment/monitoring. Examples of further patient assessment that may be recommended include, for example, a recommendation for a routine assessment (e.g., where a CPGD includes a rule defining a time interval for routine assessment), a recommendation for a follow-up assessment (e.g., where a CPGD includes a rule defining a requirement for follow-up assessment), and a recommendation for a follow-up assessment trigged by an internal and/or external update of patient data, among others.

At 625, output signals representing one or more medical recommendations for the patient may be generated. Such output signals may be stored (e.g., associated with the patient and stored in the patient database) for future use and/or may be used to present the medical recommendation(s) to a user (e.g., via an output device such as a display).

In some examples, the medical recommendation(s) may also include the evidence (e.g., raw patient data), according to the CPGD that was used, by which the recommendation(s) was made. For example, as shown in FIG. 6C, in implementation of a dyslipidemia CPGD, a high risk recommendation may be generated if the patient is diabetic, is male and has an albumin/creatinine ratio of greater than 2.0. The evidence for the determination of high risk (e.g., patient data showing the patient is diabetic, is male and has an albumin/creatinine ratio greater than 2.0) may be provided with the recommendation that the patient is at high risk. In another example, as shown in FIG. 6D, in implementation of a dyslipidemia CPGD, a patient may be determined to be at moderate risk. In the example output interface shown, the patient's Framingham risk score is presented as being 15 points, which, according to the rules of the CPGD, is associated with 13.7% of developing heart disease over the next 10 years. A risk value from 10% to 19% places an individual at moderate risk according to the CPGD. Below the risk value, there is an explanation provided of the factors which sum to the Framingham risk score of 15 points.

In some examples, such supporting evidence or data may be provided in response to an input by the physician. For example, the physician may be provided with an option (e.g., a button, a hyperlink or other suitable interface) for viewing such supporting data. In an example, when presenting the high risk recommendation, the displayed phrase “High Risk” may include a hyperlink. Selecting (e.g., clicking) on the link or hovering a cursor over the link may cause a dialog box to be displayed providing the supporting evidence or data for the recommendation. Alternatively or in addition, each recommendation may have an associated button or other indicator displayed on the screen that may be selectable to view the supporting evidence or data for each of the recommendations.

In some examples, the method 650 may also include logging in a user (e.g., a physician). The user log in may be secure and may be used to identify the user (e.g., using a PIN). The interface may be tailored to the user (e.g., a physician may be provided with a more detailed interface than a patient) and/or may be customized by the user. The interface may provide the user with information about any patients associated with the user (e.g., where the user is a physician), including any medical recommendations for the patients. Any new or updated recommendations generated since the user's last log in may be indicated as new or updated (e.g., using font color, highlighting, listing in a “new” list or any other suitable method).

The interface may allow the user to: indicate that a recommendation has been fulfilled, reject a recommendation, or request a different recommendation, for example. When the user indicates that a recommendation has been fulfilled, that recommendation may be disassociated from the patient and/or removed from the patient database, although in some cases old fulfilled recommendations may still be stored in the patient database as a historical record for that patient. When the user indicates that a recommendation is rejected, that recommendation may be disassociated from the patient and/or removed from the patient database. The user may choose a different recommendation, and may indicate this using the interface. For example, when the generated recommendation is a lifestyle change, the physician may still choose to request a different recommendation that uses medication. In some examples, this may result in an applicable CPGD(s) being used to determine the medication that may be suitable for the patient.

In some examples, the system may be able to accommodate a physician's selection of a treatment path that differs from the recommendation generated by the system. For example, if the system generates only one recommendation for the physician, the physician may indicate that a different treatment path is desired. The system may then use the physician's selection of a different treatment path to generate recommendations and/or options (e.g., recommended routine tests) according to the physician's selection.

An example is seen in FIG. 80a and FIGS. 97a, b. In this example, the algorithm has arrived at the recommendation that the patient is at moderate risk, that health behavior interventions are required and that medication is not immediately required. This is illustrated by the outlined box at the top of FIGS. 80a and 97a, showing an example output GUI. The physician may be able to reject this recommendation by selecting a “Reject” option which, upon selection, results in the algorithm returning to the Main Screen. The physician may be also able to enter this recommendation into the patient record (e.g., as illustrated by the outlined box on the left side of FIG. 97b) but may exercise clinical judgment by initiating medication immediately. This would be achieved by the physician selecting the “Add Medication” option which may take the physician to a display listing the available tools for selection of medication. In this manner, the physician may be able to follow a clinical path which may be different from the course of action in the generated recommendation, but still use the system as an aid to the management of the patient.

In some examples, a usage log may be created and stored for each user, in order to track how each user uses the disclosed methods and systems. A usage log may be useful for liability and/or traceability purposes, for example.

### Example Operation

Operation of the disclosed methods and systems is now described with reference to particular details and implementation. It should be understood that these examples are provided for the purpose of illustration only and are not intended to be limiting. The examples of operation may be specific instances of the method 650. The examples of operation may be implemented using any of the system 100, 300, 400, 500, 600 as appropriate, including any suitable variation thereof.

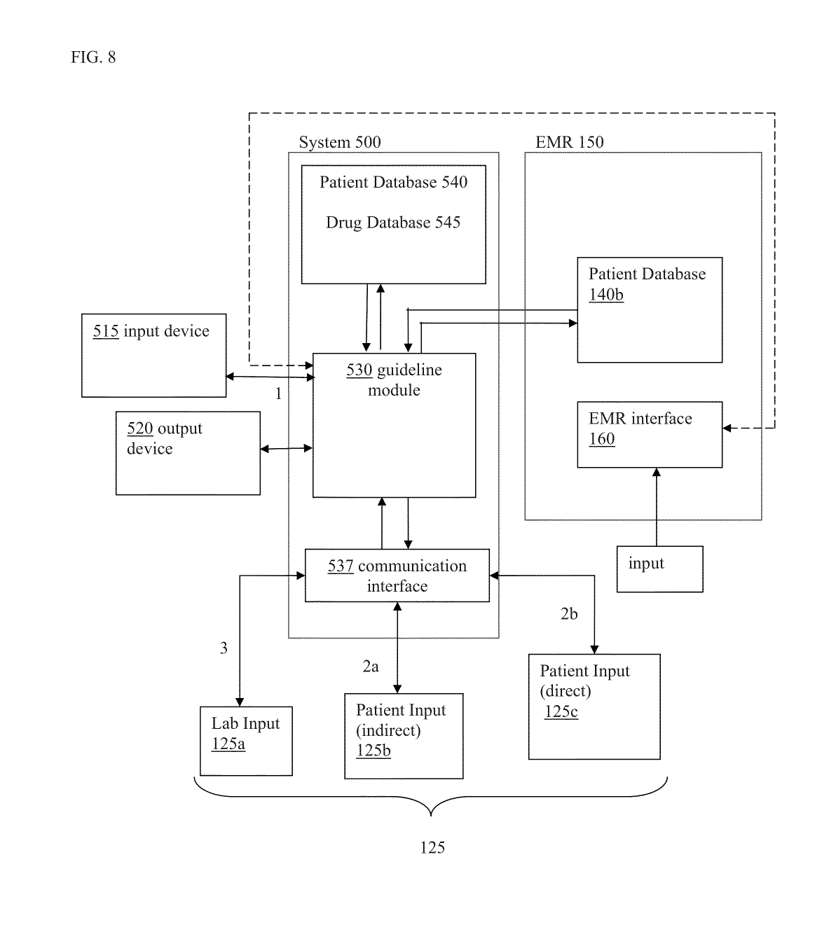

Examples of possible inputs are now described. The following types of inputs are illustrated with respect to the system 300 (see FIG. 7), the system 500 (see FIG. 8) and the system 600 (see FIG. 9), although it should be understood that similar inputs may be applicable to other embodiments of the disclosed systems. In FIGS. 7-9, the inputs are illustrated as numbered arrows, as described below.

Arrow 1 indicates input from a physician. The physician may enter data (typically patient data) using appropriate input devices (e.g., input device 115, 315, 415, 515) such as a keyboard, mouse, voice recognition software or other means. The data may be entered using an input GUI (e.g., input GUI 205 provided by the interface module 135, or via the interface module 160 of the EMR 150) and may be stored in the appropriate patient database 140, 140b, 340, 540. As will be shown in example interfaces described below, the input GUI may be accessed by user selection of a CPGD from a drop-down list resulting from selection of a tab marked “Clinical Practice Guidelines”. Although the input 1 is illustrated as direct input (e.g., via a physically connected keyboard), it should be understood that the input 1 may also be indirect (e.g., from a remote location).

Arrows 2a and 2b indicates input from a patient. Such input may be indirect as (e.g., via the Internet, arrow 2a) or direct (e.g., via a USB or Bluetooth connection, arrow 2b). In the case of indirect input 2a (e.g., via the Internet), the patient may enter data at a remote location (e.g., the patient's home) from any suitable device (e.g., any other device 125, such as desktop computer, laptop computer, tablet computer, smartphone or other suitable device). In the case of direct input 2b (e.g., via a USB or Bluetooth connection), the patient may enter data at a local location (e.g., the doctor's office) from any suitable device (e.g., any other device 125, such as a smartphone or other portable device) via, for example USB or Bluetooth connectivity. Whether directly or indirectly entered, the data may be received by the communication interface 337, 437, 537, 637 and processed and/or stored appropriately. The patient may or may not be presented with an input GUI for entering this data. In some examples, such as where the other device 125 is dedicated to collection of patient data (e.g., a heartbeat monitor), such data may be automatically uploaded upon connection to the system 100, 300, 400, 500, 600 and/or the EMR 150, without further direction by the patient.

Arrow 3 indicates input from a laboratory. Input 3 may be communicated from a laboratory directly using any suitable device (e.g., other devices 125), for example through a secure channel. The data may be received by the communication interface 337, 437, 537, 637 and processed and/or stored appropriately. There may or may not be an input GUI presented for entering data from a laboratory.

The disclosed systems and methods may process patient data according to the appropriate CPGDs. The disclosed systems and methods may also provide prompts (e.g., via a pop-up display or a voice alert) requesting patient data necessary to implement the appropriate CPGDs. The ability for the patient to enter patient data, outside of visits to a physician or laboratory may be useful.

For example, if the CPGD for hypertension requires that the average of one week's worth of blood pressure measurements be used to assess the patient, then the disclosed methods and systems may obtain the blood pressure measurements that have been entered by the patient over the week, calculate the average and, where appropriate store the average into the patient database. This value may be used in the implementation of the CPGD for hypertension and other CPGDs. This average measurement is impossible for the physician to obtain in a single visit with the patient. The algorithm for making such calculations may reside in the guideline module and/or the communication interface of the disclosed system.

Another example of data that may be obtained by the patient and sent to the physician is blood glucose values. Typically the patient may perform blood glucose measurements on him/herself at multiple times during the day. These times may be, for example, in the early morning upon waking, before and/or after each meal and before going to sleep. The values obtained for each of these measurements may be important to the physician in order to make adjustments to the patient's diet, activity level and/or medication. These values may be entered by the patient into the system which may then provide these results to the physician for assessment, without requiring an in-person patient visit. The system may also implement the rules contained in the CPGDs, using the data inputted by the patient, to produce recommendations to the physician on the management of the patient.

Other examples of data that may be entered by a patient and utilized by the system in the implementation of the rules of the CPGDs include, for example, activity level from a pedometer and weight from a weigh scale, among others. Therefore, the system may provide the ability to receive data directly from the patient without an in-person visit, and use that data in the implementation of the rules of the CPGDs to produce recommendations for the management of the patient.

For receiving input from the patient, a variety of interfaces may be utilized by the patient remotely with results and/or progress reports sent (e.g., via the Internet) to the system. These interfaces may be provided by the interface module 135, 335 and/or the communication interface 337, 437, 537, 637. These interfaces may be provided as separate application software that may be separately installed on a patient's device. In some examples, such interfaces may not be part of the system, but may be any conventional interface (e.g., conventional pedometer software) that may be instructed to communicate with the system. Such application software may reside, for example, on a desktop computer, a laptop computer, a tablet computer, a smartphone or other suitable patient device.

An example of such an interface is a diet monitoring program. It is known that the approach of giving a patient a diet to follow which is very dissimilar to their current diet is often unsuccessful. Rather, it is usually a better approach to modify the patient's current diet in such a way that the amount of calories, fat and other elements consumed are appropriate in consideration of the health goals for the patient. The diet monitoring interface may enable the patient to enter specific food items as input and obtain values for the nutritional content of the food as output. The patient may thus be able to keep track of various parameters of the food in his/her diet.

Examples of parameters which may be monitored include calories, protein, fat (including omega-3 fat), servings of fruits and/or vegetables, fiber, minerals (e.g., sodium, calcium, iron), sodium, potassium and sodium/potassium ratio, and antioxidant intake, among others.

The diet information may be automatically (e.g., after every entry or at preset time intervals) sent to the system through the use of wireless technology (e.g., the Internet). The information may be provided in its raw form to the physician, dietician or other health care professional, and may also be used in the implementation of appropriate CPGDs by the system for the medical management of the patient. For example, the system may provide the physician or other health care professional to receive repeatedly updated information on the patient's diet, prescribe the appropriate diet changes and reassess the progress of the patient over time. Prescribed diet changes may be communicated to the patient via the diet monitoring interface provided by the system. Thus, the system may enable the physician or other health care professional to modify the existing diet of the patient to achieve the lifestyle modifications goals set for the patient.

In another example, an interface may monitor the patient's activity between visits to the physician. Such an interface may include application software that may be installed on a patient's smartphone, for example, and employ the accelerometer and/or global positioning system (GPS) of the smartphone to calculate the distance travelled by the patient as part of his/her exercise program. Using data captured by the accelerometer, the interface may distinguish between the distances travelled as a result of walking/running versus that travelled by vehicular transport. This distinction may be made since walking or running typically produces an impulse as the feet strike the ground which can be detected by the accelerometer, which impulse is typically not present in vehicular transport. In addition to distance, the interface may also calculate speed and/or the approximate number of calories consumed by the patient. This information may be transmitted to the system and stored and/or processed by the guideline module. This information may be employed in the implementation of the rules of various CPGDs in which recommendations concerning exercise are made. Such recommendations and/or the raw activity data may be provided to the patient's physician.

Another example of a patient interface is that used to detect an abnormal pulse rate. Atrial fibrillation is a disease typically characterized by an irregular heart rate. Atrial fibrillation is a cause of patient morbidity, most notably strokes. Currently, software applications exist which use the camera in a smartphone or a tablet computer to read an individual's pulse rate. This is typically achieved by the individual placing her finger over the camera of the device. The collected information on the pulse rate may be sent to the system. The system may process and/or store this data, and may analyze the data to detect any irregular heart rates. The system may provide an alert to the patient's physician if the pulse is irregular. In this manner, patients with atrial fibrillation may be identified and their condition may be brought to the attention of a physician. The system may implement the CPGD for Atrial Fibrillation to assess the patient and generate recommendations for the appropriate steps towards management of the patient.

Another example of a patient interface may include an interface provided by a video game console having an internet connection. In this manner, a software program such as one providing instruction to the patient on exercise routines can be played in the game console similar to a video game to be used in that console. The patient may perform the prescribed exercise routine by following the video. A video game console (e.g., Kinect by Microsoft®) may be capable of identifying and capturing the movements of the patient while performing the exercise routine. By use of this type of console, the patient may be identified, the duration and/or type of activity may be recorded, the number of calories consumed may be calculated and recorded, and other parameters may be recorded. All this data may be sent via the internet to the system. This data may be processed and/or stored as appropriate for the management of the patient.

Although the examples shown in the figures indicate that communication with the patient database is through the guideline module, in some examples data may be inputted into the patient database (e.g., via the interface module and/or the communication interface) without involvement of the guideline module. The guideline module may determine there is new data available (e.g., a notification may be generated by the patient database and/or the interface and transmitted to the guideline module) and may proceed to make the relevant calculations and produce the resultant recommendations using the appropriate CPGDs.

In some examples, the system may provide different input GUIs for receiving data specific to different CPGDs. This may be the case for receiving input from the physician. For example, at a general or home GUI (e.g., a GUI showing a main screen or home screen), the physician may choose a particular CPGD or CPGDs that are relevant to the diagnosed conditions on that patient, or all CPGDs. If a particular CPGD is chosen, an input GUI that is tailored to that particular CPGD may be presented. The tailored input GUI may include data fields relevant to that CPGD only.

The physician may also select all the CPGDs that are relevant to a particular patient. If this option is chosen, the input GUI may include all data fields necessary for all the CPGDs that are associated with all the diagnosed conditions for that patient. The conditions that have been diagnosed for each patient may be displayed as part of the input GUI as “Current Diagnoses”.

The physician may also select all available CPGDs in the system. If all CPGDs are selected, an input GUI including data fields relevant to all CPGDs may be presented for completion by the physician.

FIGS. 10A and 10B show an example of an input GUI specific for one particular CPGD, in this case the CPGD for diabetes. The “Diagnoses” field may allow the physician to add diagnoses for the patient by name and/or diagnostic code number. The field may be searchable and/or may employ text prediction algorithms, such that with every character the physician enters, the drop-down list may be updated with the diagnoses that are applicable. The physician may select a diagnosis from the drop-down list. Once selected, that diagnosis may appear in a list under “Current Diagnoses”. In some examples, in addition to manual selection by a physician, when a specific CPGD is selected and applied to a patient, if the patient is determined to have the condition as per the criteria of the CPGD (in some examples the physician may further confirm the diagnosis), that diagnosis may be automatically displayed in the list for “Current Diagnoses”. In the example shown, dyslipidemia is displayed in the list of “Current Diagnoses”. Once another diagnosis is determined (by the physician or by automated implementation of a CPGD) for the patient, the new diagnosis may be associated with that patient and stored in the patient's information in the patient database, and may be listed under “Current Diagnoses”. The list of “Current Diagnoses” may be included in the input GUI for every CPGD, which may help the physician to keep track of the patient's conditions. The physician may also manually remove a diagnosis from the list of “Current Diagnoses” (e.g., using a “Remove” option). The system may also automatically remove a diagnosis from the list of “Current Diagnoses” (with or without confirmation from the physician) when it is determined that the patient no longer has that particular diagnosis, according to the applicable CPGD.

### Example Interaction Progression

Examples of how a user (e.g., a physician) may interact with the disclosed methods and systems are now described. Example interactions include: manual selection and employment of CPGDs; automatically triggered employment of CPGDs; automatically triggered call-up of tools; and routine surveillance.

### Manual Selection and Employment of CPGDs

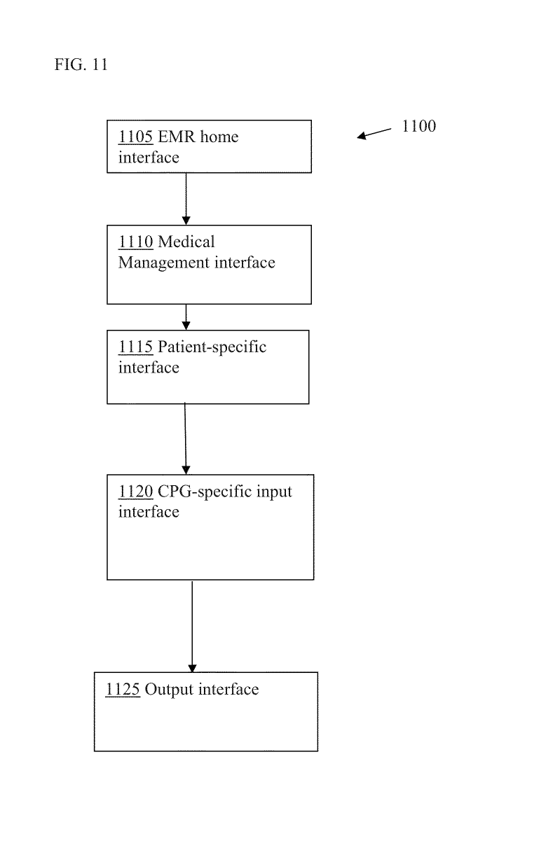

FIG. 11 illustrates an example progression of input/output GUIs that may be presented to a user (typically a physician) for manually selecting a specific CPGD. In the example 1100, the system may be similar to the system 400, 500, 600 in which some of the interface may be provided by the EMR.

At 1105, the initial EMR home interface may be presented. This may be the default interface presented when a user first logs into the EMR. This interface may be provided by the EMR. The user may select an option to proceed to a medical management interface.

At 1110, the medical management interface may be presented. It should be understood that in some examples the medical management interface may be the initial EMR interface, and step 1105 may not be necessary. The medical management interface may be provided by the EMR.

At the medical management interface, the user may select a patient (e.g., using a “Patient Search Column” function as described elsewhere in the present disclosure), to proceed to a patient-specific interface.

At 1115, the patient-specific interface may be presented. The patient-specific interface may be provided by the EMR, but may also include interface components from the disclosed system. This may be the case where the EMR has been adapted to operate with the disclosed system. For example, the patient-specific interface may be a conventional patient-specific interface for the EMR, but may additionally include a selectable list provided by the system listing the CPGDs that may be implemented by the system. Alternatively, the patient-specific interface may be provided by the disclosed system. The user may select a specific CPGD (e.g., a CPGD for hypertension, diabetes, dyslipidemia, osteoporosis, COPD or others) for the patient.

At 1120, a CPGD-specific input interface may be presented for the selected CPGD. This interface may be provided by the disclosed system. The input interface may provide a form for the user to enter data. The user may enter patient data into the interface (e.g., using standard input device such as keyboard, mouse, voice recognition program, USB connection to a local device or Bluetooth connection to a mobile device). The entered data may be stored in the appropriate patient database and may also be processed by the guideline module. The guideline module may perform all necessary calculations as prescribed by the selected CPGD and may generate recommendations based on that CPGD. Where appropriate, the CPGD-specific interface may prompt the user for further data or other task execution. Where appropriate, the system may retrieve stored patient data from the patient database rather than requiring input from the user. Stored data retrieved from the patient database may also be used to automatically populate the appropriate data fields of the input interface. Alternatively or in addition, some or all of such already stored data may be omitted from the input interface For example, where the input interface includes age and sex as input data fields, such data may already be stored in the patient database for that patient and may be automatically filled in the input interface or may be omitted from the input interface. Where the total data (entered by the user and/or stored in the patient database) is not sufficient to implement the selected CPGD, the interface may generate a notification that the selected CPGD could not be implemented and no recommendations may be outputted.

At 1125, an output interface may be presented, including any recommendations determined by the guideline module for the selected CPGD. The output presented may be printed, stored and/or transmitted to other systems.

In some examples, at 1115, rather than the user selecting one specific CPGD, the user may select a “Relevant CPGs” option. Selection of this option may result in presentation of an input interface including data fields for all CPGDs relevant to the determined current diagnoses of the patient. Upon receipt of patient data in the data fields, the guideline module may make calculations and recommendations based on all CPGDs determined to be relevant to the current diagnoses of the patient. Where appropriate, the input interface may prompt the user for more data. Where there is insufficient data for some of the CPGDs, a notification may be generated informing the user that those CPGDs could not be implemented and recommendations for those CPGDs may not be outputted.

In some examples, at 1115, the user may select an “All CPGs” option. With this choice, an Input Screen with data fields for all CPGDs will appear for population by the physician. Selection of this option may result in presentation of an input interface including data fields for all CPGDs available in the system. Upon receipt of patient data in the data fields, the guideline module may make calculations and recommendations based on all CPGDs. Where appropriate, the input interface may prompt the user for more data. Where there is insufficient data for some of the CPGDs, a notification may be generated informing the user that those CPGDs could not be implemented and recommendations for those CPGDs may not be outputted.

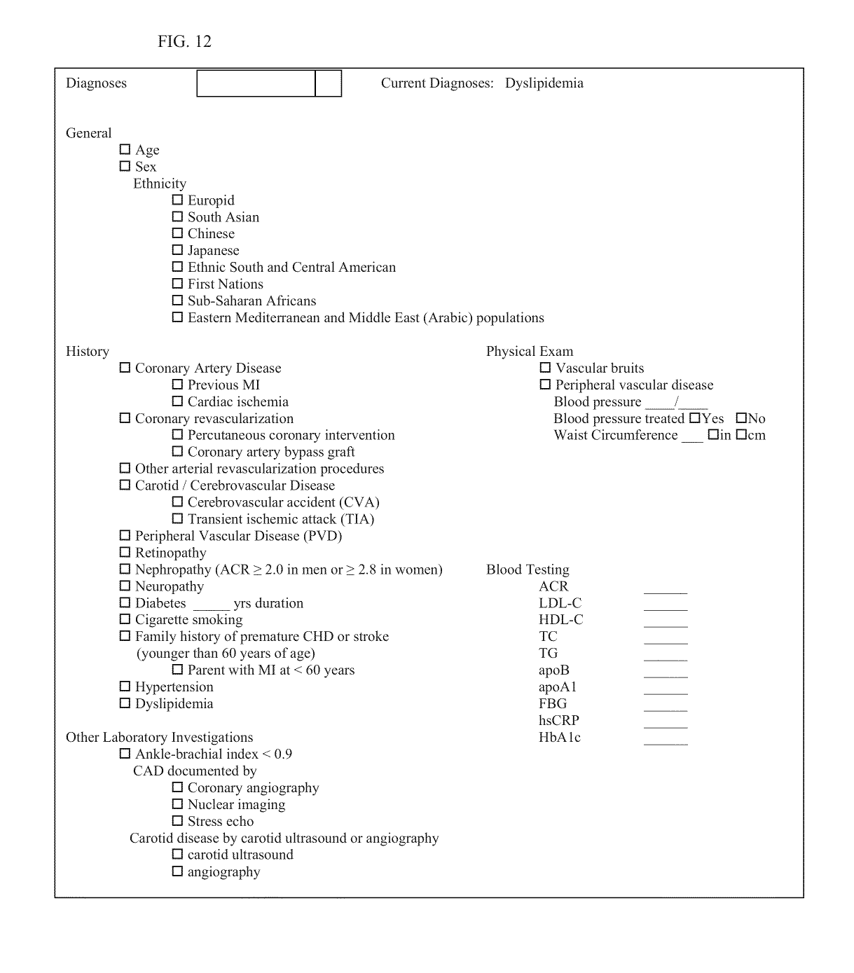

FIG. 12 shows an example CPGD-specific input interface for receiving input data for implementing the dyslipidemia CPGD. Data input may be achieved by any suitable method. For example, the user may enter the data via keyboard, mouse, voice recognition software or other suitable means. The received data, in addition to any patient data retrieved from the patient database as appropriate, may be processed by the guideline module by applying the rules prescribed by the dyslipidemia CPGD. In the example of dyslipidemia, the guideline module may, according to the rules of the dyslipidemia CPGD, stratify the patient into high, medium or low risk for having a cardiovascular event and generate recommendations on the treatment of the patient based on the risk stratification. The generated recommendations may be presented to the user at the output interface.

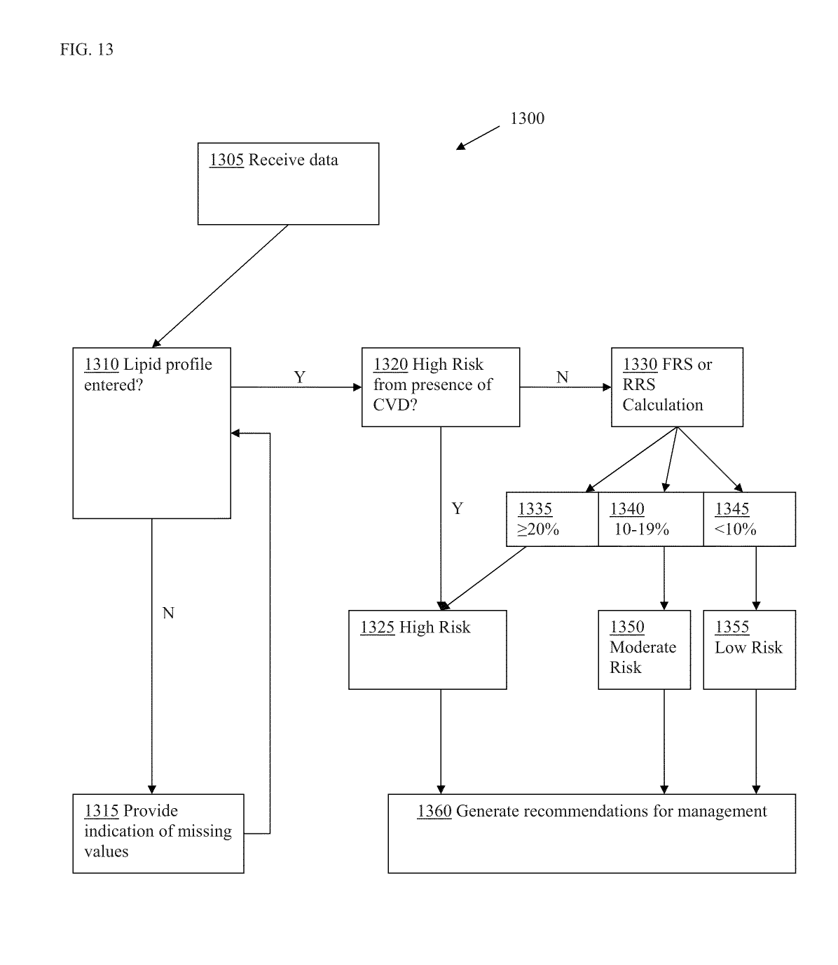

FIG. 13 illustrates high-level representation of an example method 1300 carried out by the guideline module to implement the dyslipidemia CPGD.

At 1305, data is received at the guideline module. The data may be received through input by the user, patient or laboratory (e.g., using an input interface as described above) and/or through querying a patient database.

At 1310, it is determined whether data on the patient's lipid profile has been received (whether through input from the user or through querying the patient database).

At 1315, if the full lipid profile (e.g., LDL, HDL and TC data) has not been received, an indication may be provided (e.g., display of a prompt) that the lipid values need to be entered by the user. The indication may indicate which lipid values are missing and may also offer the option of entering the values or cancelling implementation of the dyslipidemia CPGD. If the option to cancel implementation of the dyslipidemia CPGD is selected, the method 1300 ends.

At 1320, when data on all the lipid values have been received, then the guideline module may implement the rules of the dyslipidemia CPGD to determine whether the patient should be classified as high risk based on the presence of cardiovascular disease (CVD). According to the rules of the dyslipidemia CPGD, the patient may be classified as high risk if, according to the received data, any of the following conditions are true:
vascular bruits present;
ankle-brachial index of less than 0.9;
documented CAD by invasive or noninvasive testing, coronary angiography, nuclear imaging or stress echocardiography;
previous MI, coronary revascularization (percutaneous coronary intervention, coronary artery bypass graft surgery) or other arterial revascularization procedures;
history of a cerebrovascular accident, including transient ischemic attack;
evidence of carotid disease by carotid ultrasonography or angiography;
peripheral vascular disease present;
the patient is a diabetic male at or older than 45 years or diabetic female at or older than 50 years;
the patient is a diabetic male less than 45 years of age or diabetic female less than 50 years of age with any of:
   macrovascular disease (e.g. silent myocardial infarction or ischemia, evidence of peripheral arterial disease, carotid arterial disease or cerebrovascular disease), microvascular disease (especially nephropathy and retinopathy)
   multiple additional risk factors, especially with a family history of premature coronary or cerebrovascular disease in a first-degree relative
   extreme level of a single risk factor (e.g. low density lipoprotein-cholesterol (LDL-C)>5.0 mmol/L, systolic blood pressure (BP)>180 mm Hg)
   duration of diabetes >15 years with age >30 years

At 1325, if any of the above conditions are met, the patient may be classified as high risk.

At 1330, if there is no evidence of cardiovascular disease, the guideline module may perform a calculation of the Framingham Risk Score (FRS) and/or the Reynolds Risk Score (RRS). The FRS may be calculated according to appropriate methods (e.g., as outlined in the Supplementary Information section of the 2009 Canadian Cardiovascular Society/Canadian Guidelines for the diagnosis and treatment of dyslipidemia and prevention of cardiovascular disease in the adult—2009 recommendations). The RRS may be calculated according to appropriate methods (e.g., as per the method prescribed in the above-mentioned references). Typically, the FRS may be the primary method of calculation of risk, while the RRS may be additionally calculated only where selected by the user. Both the FRS and the RRS may be used to estimate the 10 year risk of developing cardiovascular disease in a patient, based on rules defined by the dyslipidemia CPGD.

At 1335, the FRS and/or the RRS may be determined to be greater than or equal to 20%. This may result in a determination that the patient should be classified as high risk and the method 1300 proceeds to 1325.

At 1340, the FRS and/or the RRS may be determined to be 10-19%. This may result in a determination that the patient should be classified as moderate risk and the method 1300 proceeds to 1350.

At 1345, the FRS and/or the RRS may be determined to be less than 10%. This may result in a determination that the patient should be classified as low risk and the method 1300 proceeds to 1355.

At each of 1325, 1350 and 1355, the risk level of the patient may be stored in the patient database for future use.

At 1360, the guideline module uses the rules of the dyslipidemia CPGD to generate one or more recommendations based on the determined patient risk level. Such recommendations may be provided to the user via the output interface. The recommendations may also be stored in the patient database for future reference.

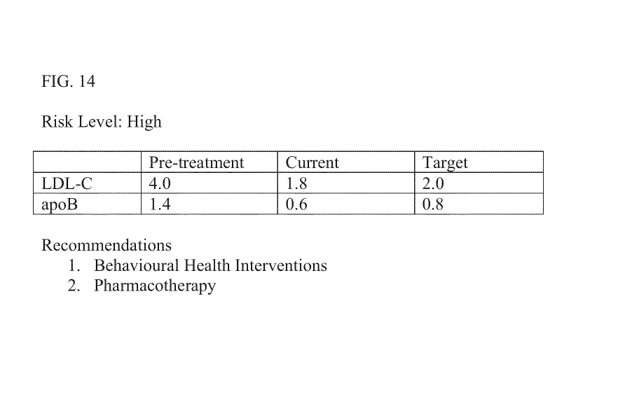

FIG. 14 illustrates an example output interface presenting simplified recommendations where the patient data indicates evidence of cardiovascular disease (i.e., the patient is classified as high risk). In this example, the guideline module calculates pre-treatment, current and target values for LDL-C and apolipoprotein B (apoB), both being important parameters in the management of dyslipidemia. The guideline module calculates the target values for LDL-C as the higher of 2.0 mmol/L or 0.50×pre-treatment value of LDL-C. The target value of apoB is set at 0.80 g/dl as per the CPGD. If there is no current value of apoB, N/A is displayed as the target value for apoB. These example target values are derived from the CPG titled “2009 Canadian Cardiovascular Society/Canadian guidelines for the diagnosis and treatment of dyslipidemia and prevention of cardiovascular disease in the adult—2009 recommendations”. Other target values may be determined according to other appropriate CPGDs. The output interface then may present a table showing pre-treatment, current and target values for LDL-C and apoB, with treatment recommendations (in this example, including behavioral health interventions and pharmacotherapy).

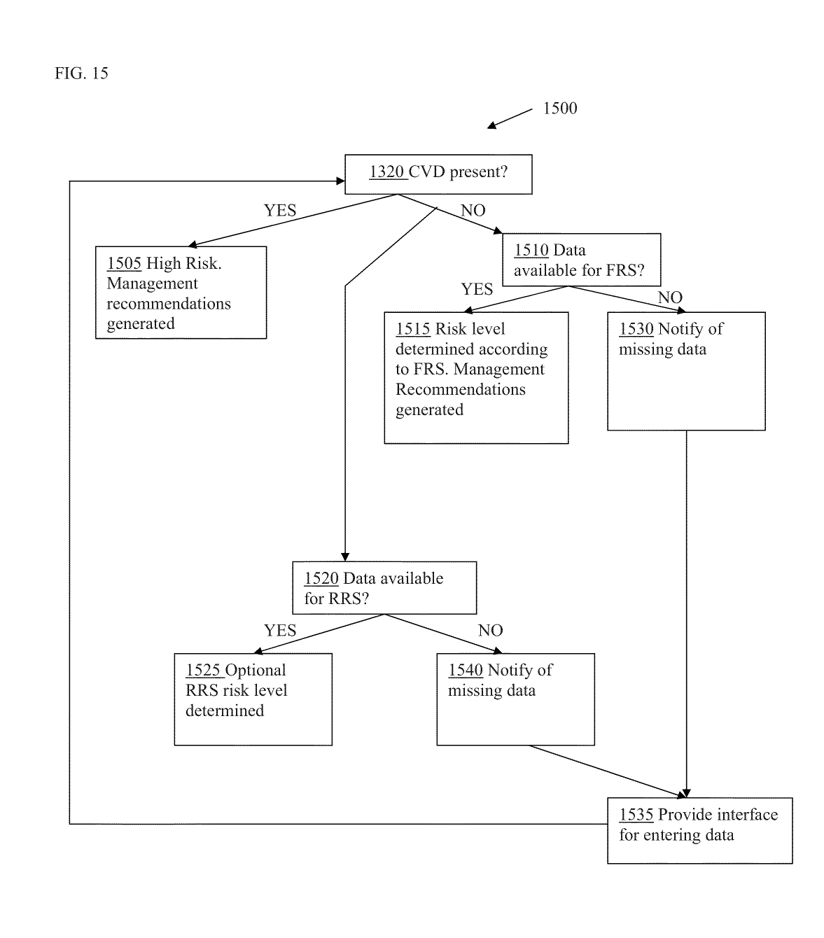

FIG. 15 illustrates example details of the risk level determination described in the method 1300. The example method 1500 may be incorporated into the method 1300 and may share steps with the method 1300.

In the example method 1500, the FRS may be the primary assessment tool for determining risk level and the management recommendations determined by the guideline module may be a consequence of this risk level. The RRS may be an optional measure and its value may be displayed alongside the FRS but indicated as an optional measure which the user may choose to consider or not.

The method 1500 may begin with 1320, where it is determined whether CVD is present, as described above.

At 1505, if CVD is determined to be present, recommendations may be generated based on the determination that the patient is classified as high risk and provided to the user. The user may be provided with an option to accept/confirm the recommendations, in which case the recommendations may be associated with the patient and stored in the patient database. The user may also be provided with an option to request a redo/reject the recommendations, in which case the recommendations may be discarded and the methods 1300, 1500 may be repeated (typically with different or new data).

At 1510, if CVD is determined to be not present, the guideline module may perform an evaluation as to whether there is sufficient data to calculate the FRS.

At 1515, if there is sufficient data to calculate the FRS, then the patient's risk level may be determined according to the calculated FRS and recommendations may be generated based on the determined risk level of the patient. The recommendations may be provided to the user via the output interface. The user may be provided with an option to accept/confirm the recommendations, in which case the recommendations may be associated with the patient and stored in the patient database. The user may also be provided with an option to request a redo/reject the recommendations, in which case the recommendations may be discarded and the methods 1300, 1500 may be repeated (typically with different or new data).

Optionally, at 1520, if CVD is determined to be not present, the guideline module may also make an assessment as to whether there is sufficient information to calculate risk based on the RRS. This assessment may be carried out together with 1510.

At 1525, if there is sufficient data to calculate the RRS, the patient's risk level according to the RRS may be calculated and the calculated RRS may be provided as output along with recommendations based on the FRS (as in 1515). The user may be provided with an option to select to generate recommendations based on the risk level determined by the RRS. If this option is selected, the patient's risk level may be determined according to the RRS, the appropriate recommendations generated and provided to the user. Where the risk level determined according to the FRS differs from that determined according to the RRS, the determination based on the FRS may take precedence, the recommendations for the different risk levels may be presented and/or the user may be notified of the discrepancy and provided with an option to prioritize the FRS or the RRS.

At 1530, if it is determined (at 1510) that there is insufficient data to calculate the FRS, the user may be notified of the missing data and, at 1535, provided with an input interface to input the missing data. The user may also be provided with an option of aborting this CPGD, which if selected ends the methods 1300 and 1500. No recommendations may be generated.

At 1540, if it is determined (at 1520) that there is insufficient data to calculate the RRS, the user may be notified of the missing data and, at 1535, provided with the same or different input interface to input the missing data. The user may also be provided with an option of aborting this CPGD, which if selected ends the methods 1300 and 1500. Where there is sufficient data to calculate the FRS, recommendations may be still generated and provided according to the calculated FRS.

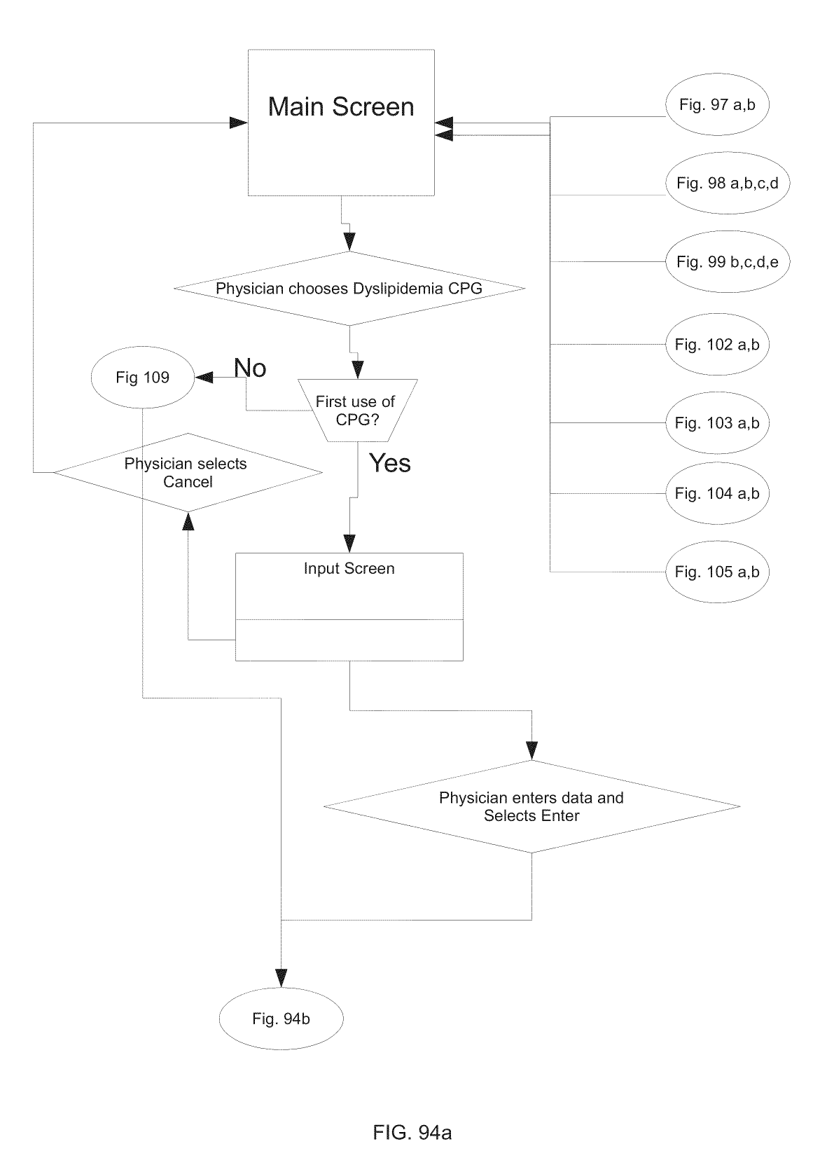

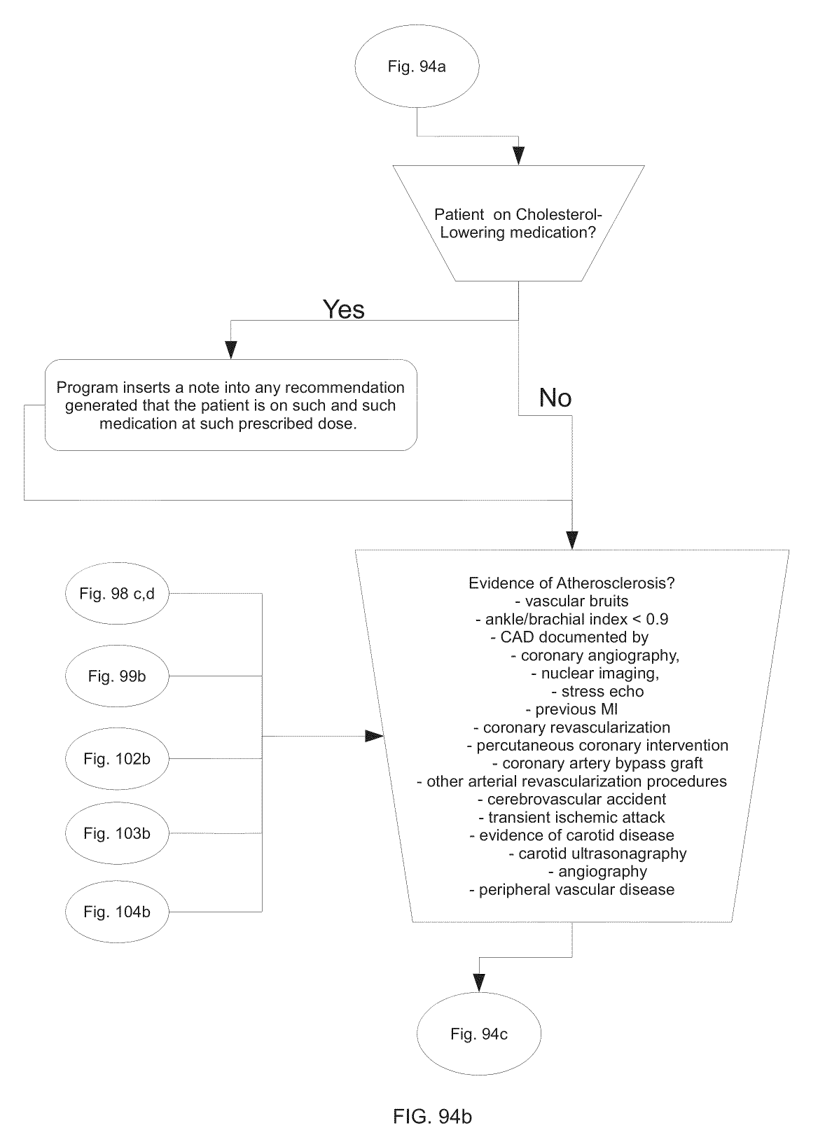

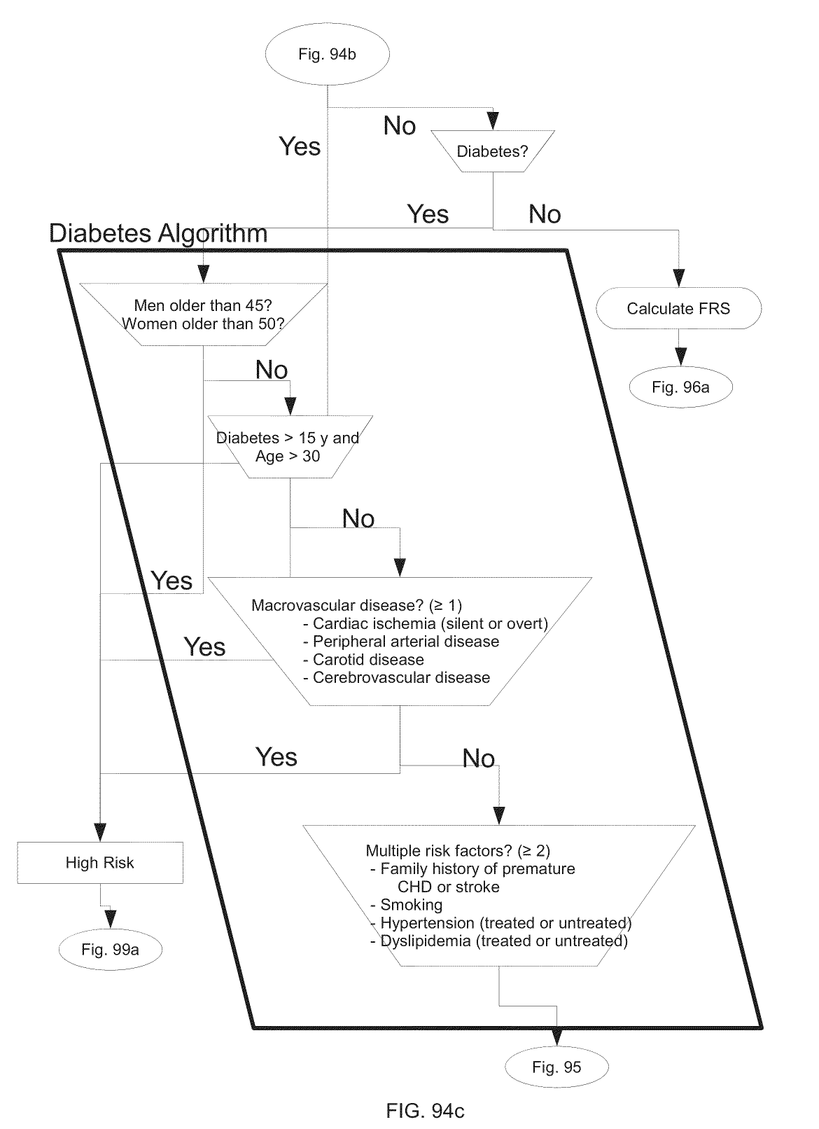

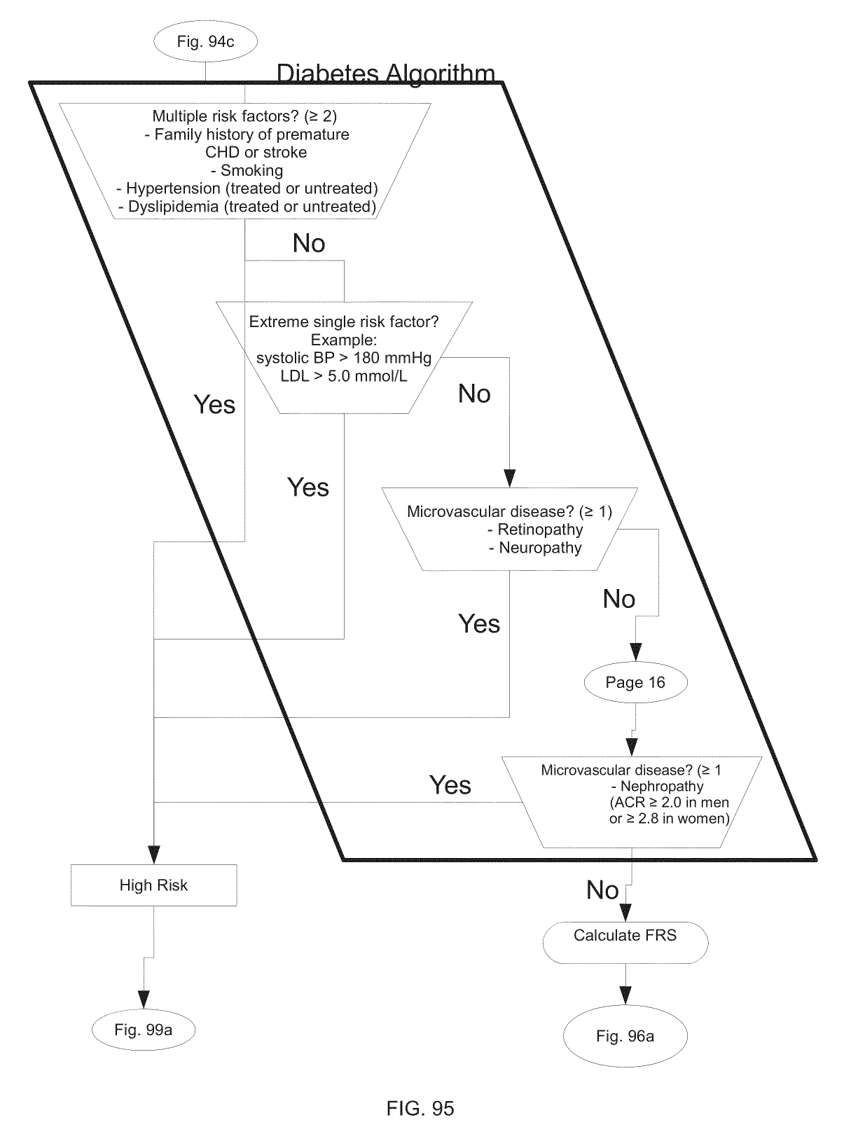

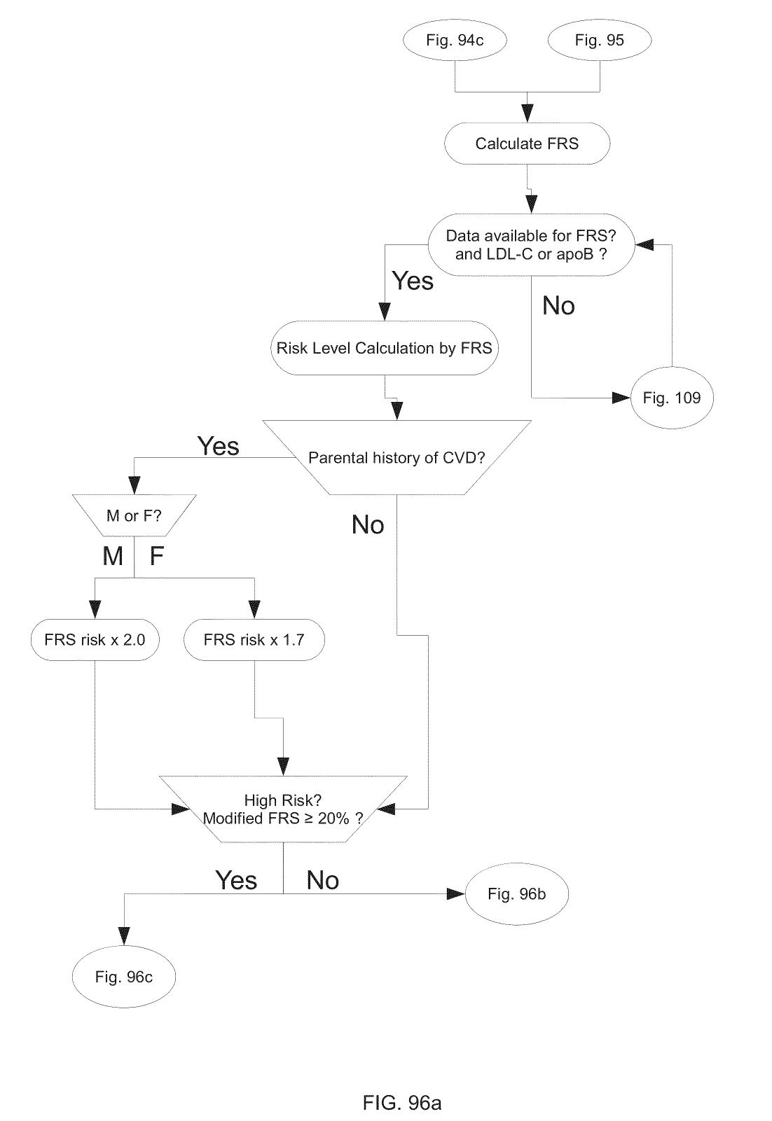

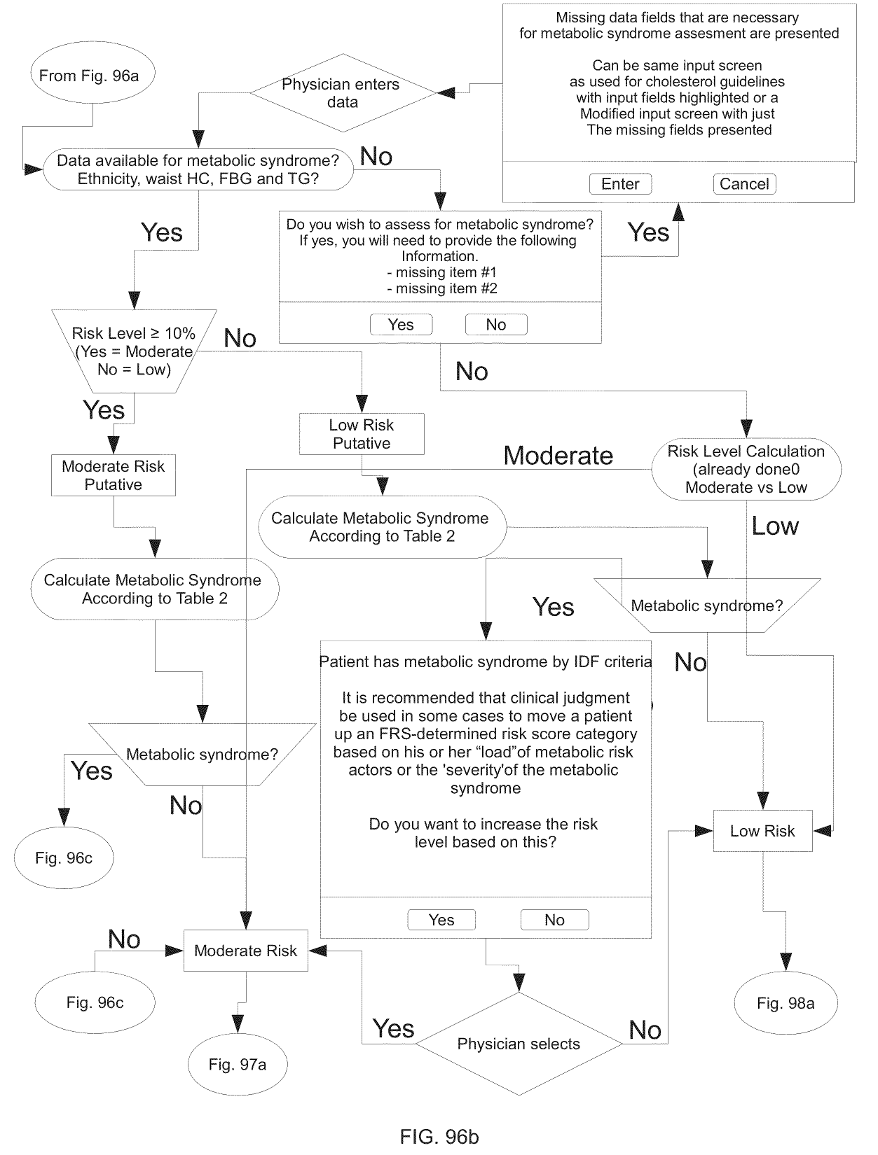

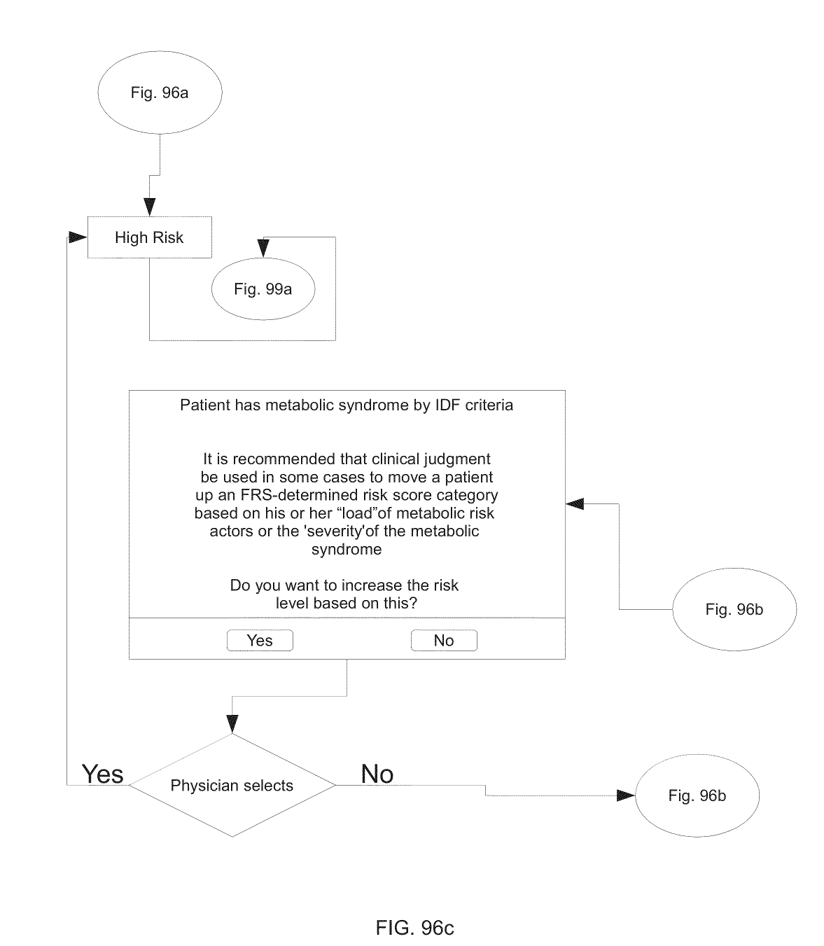

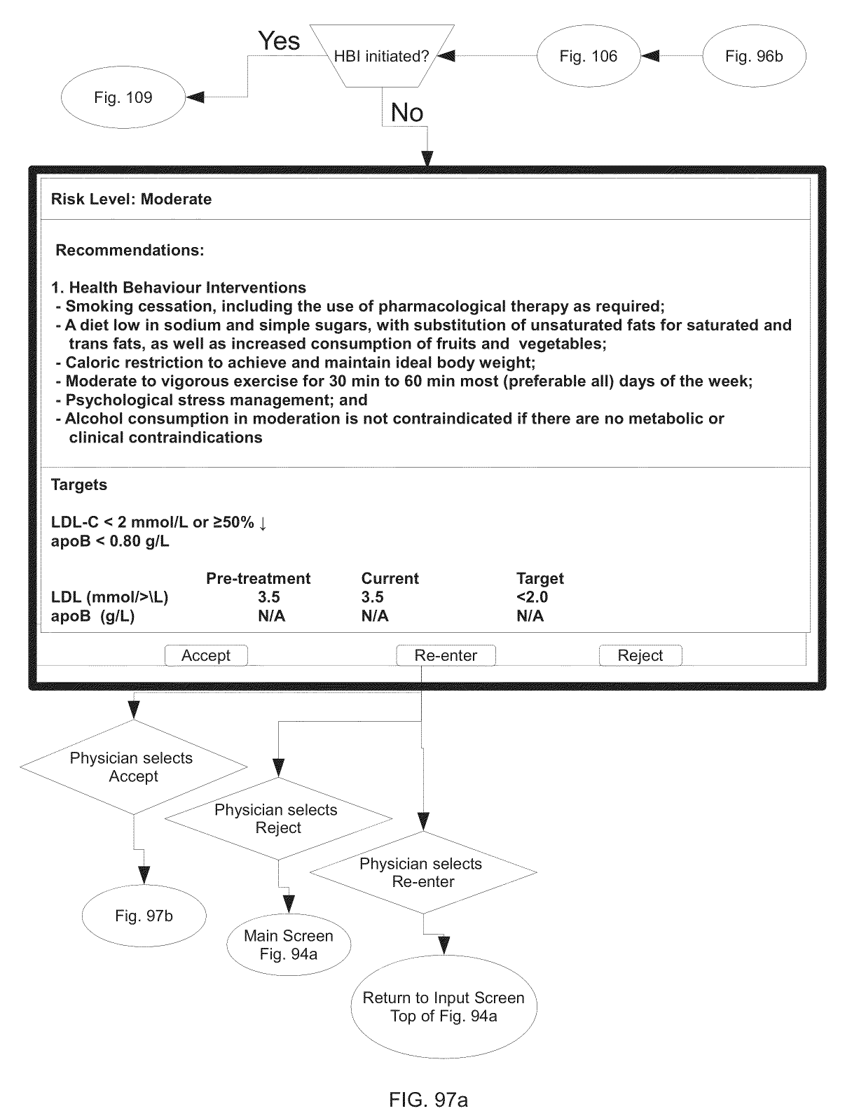

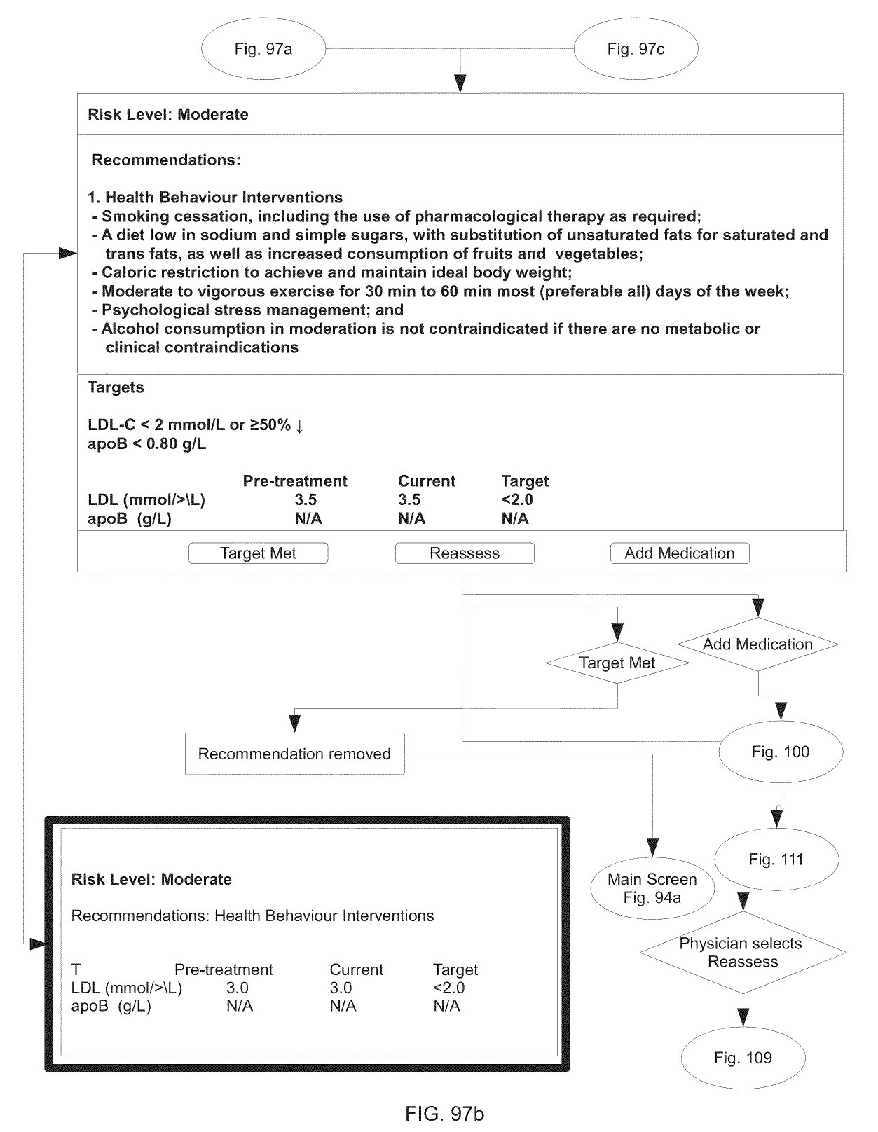

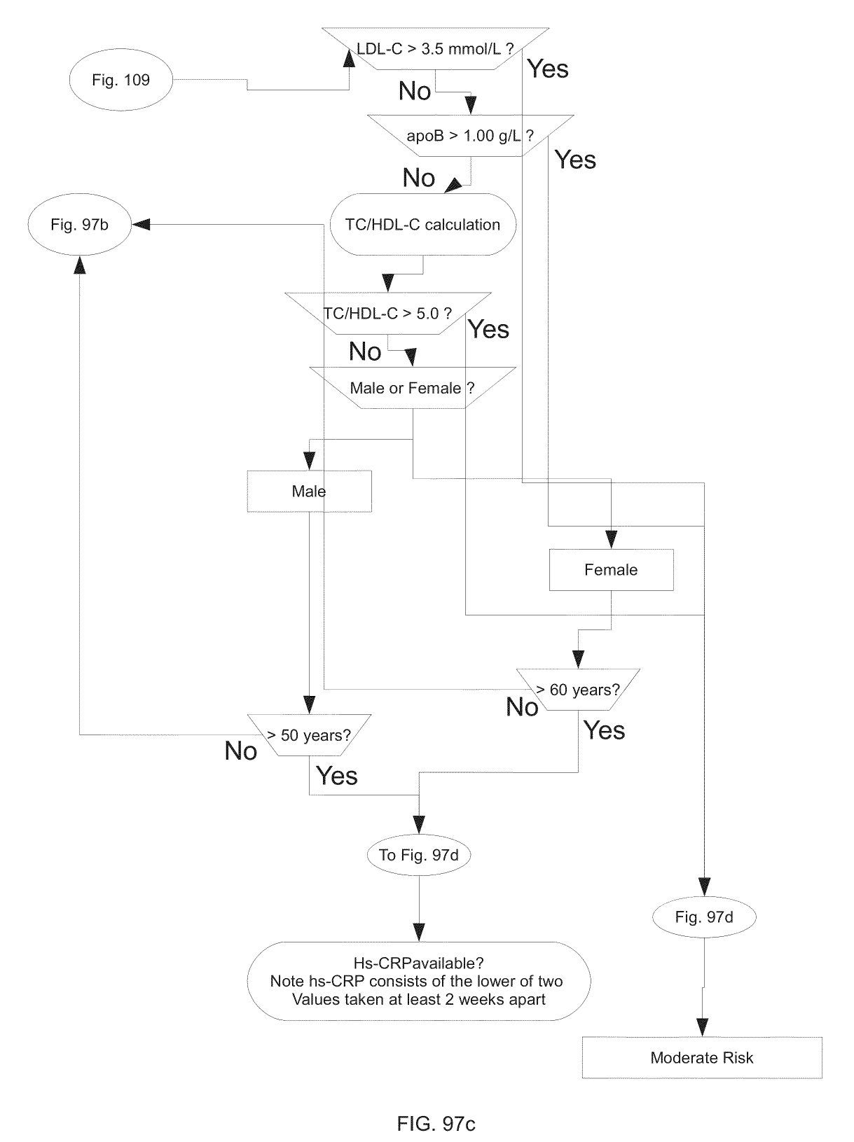

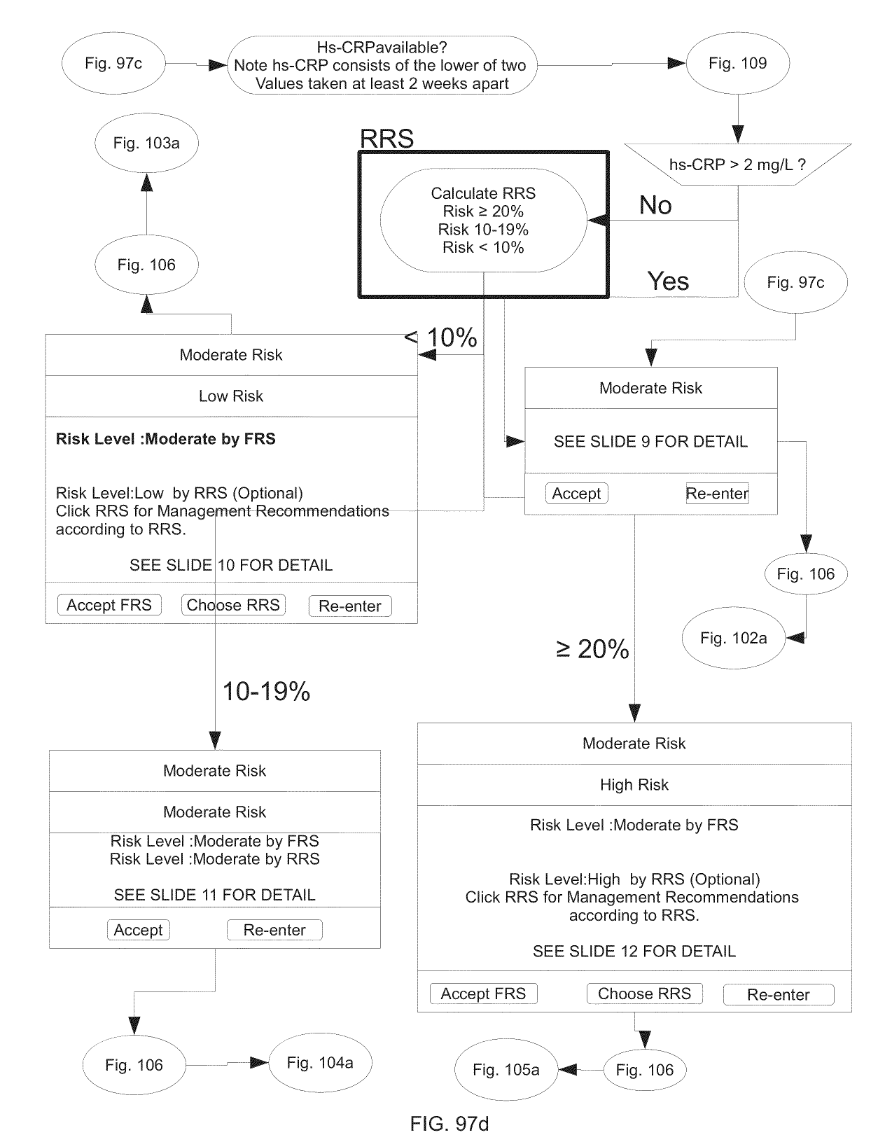

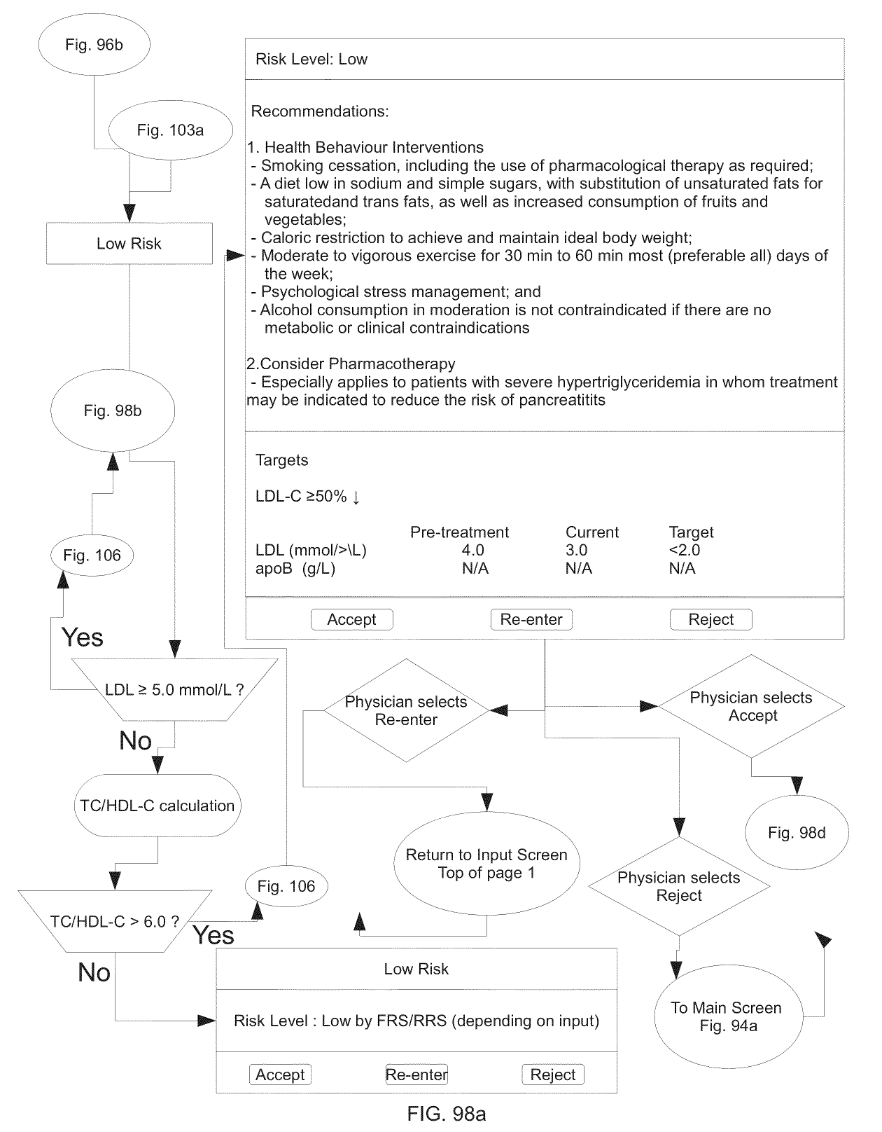

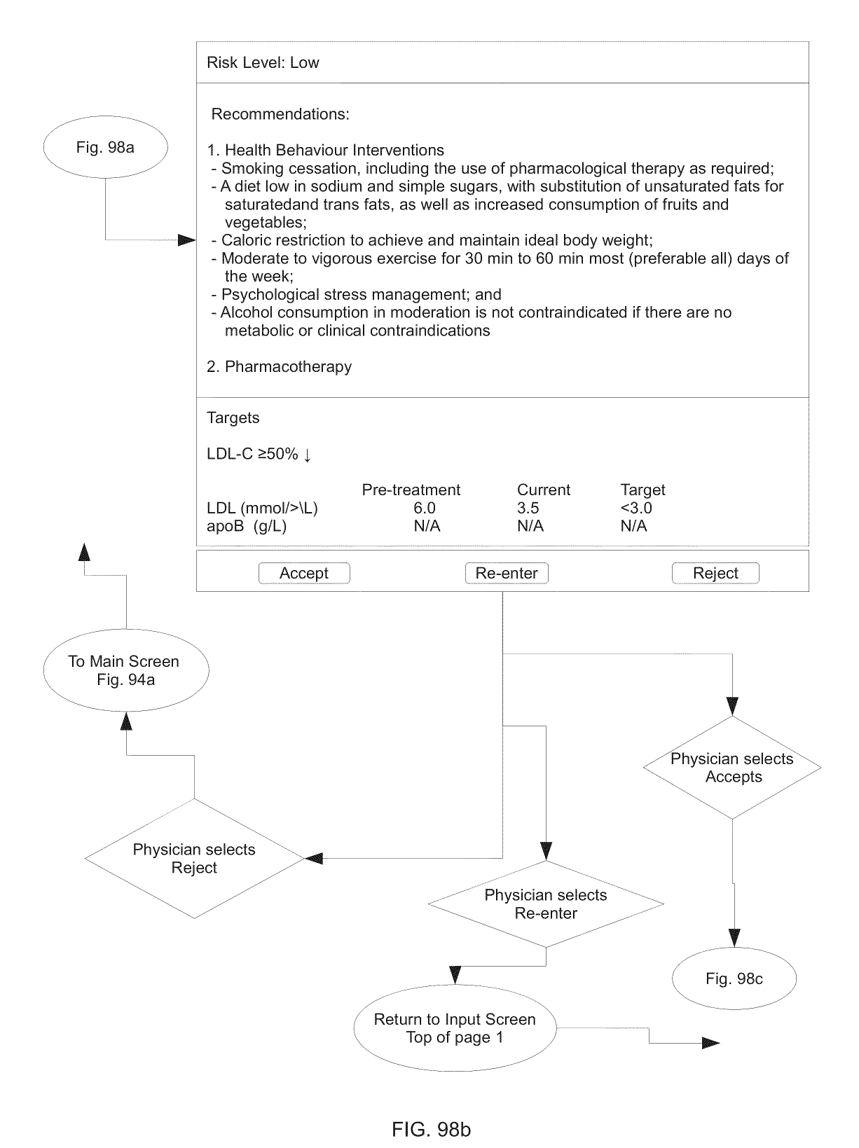

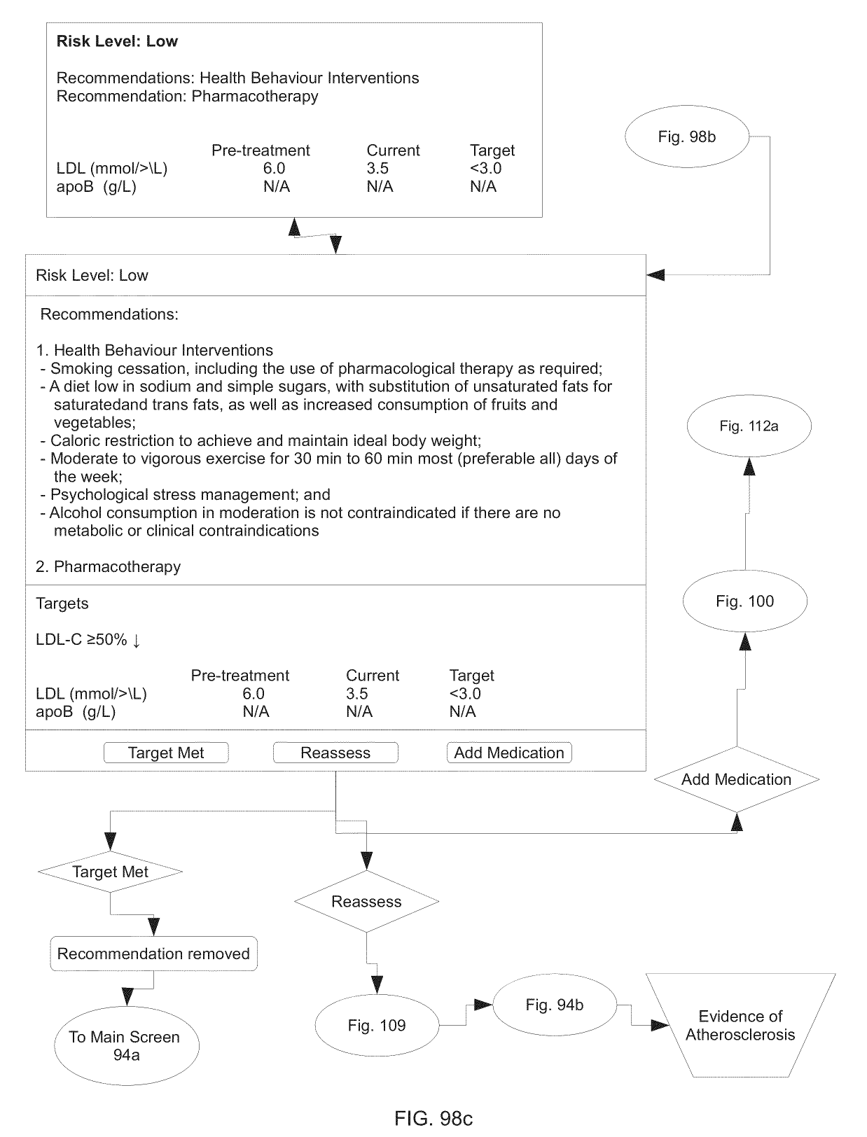

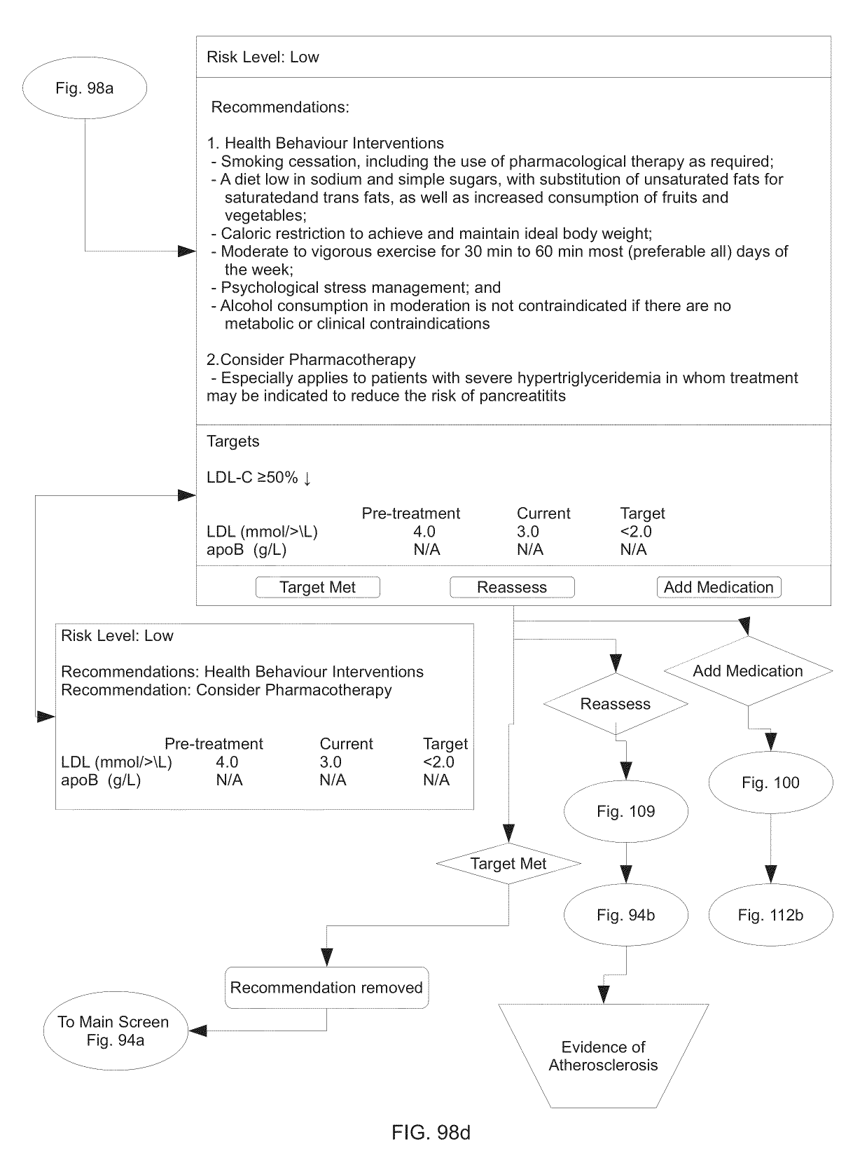

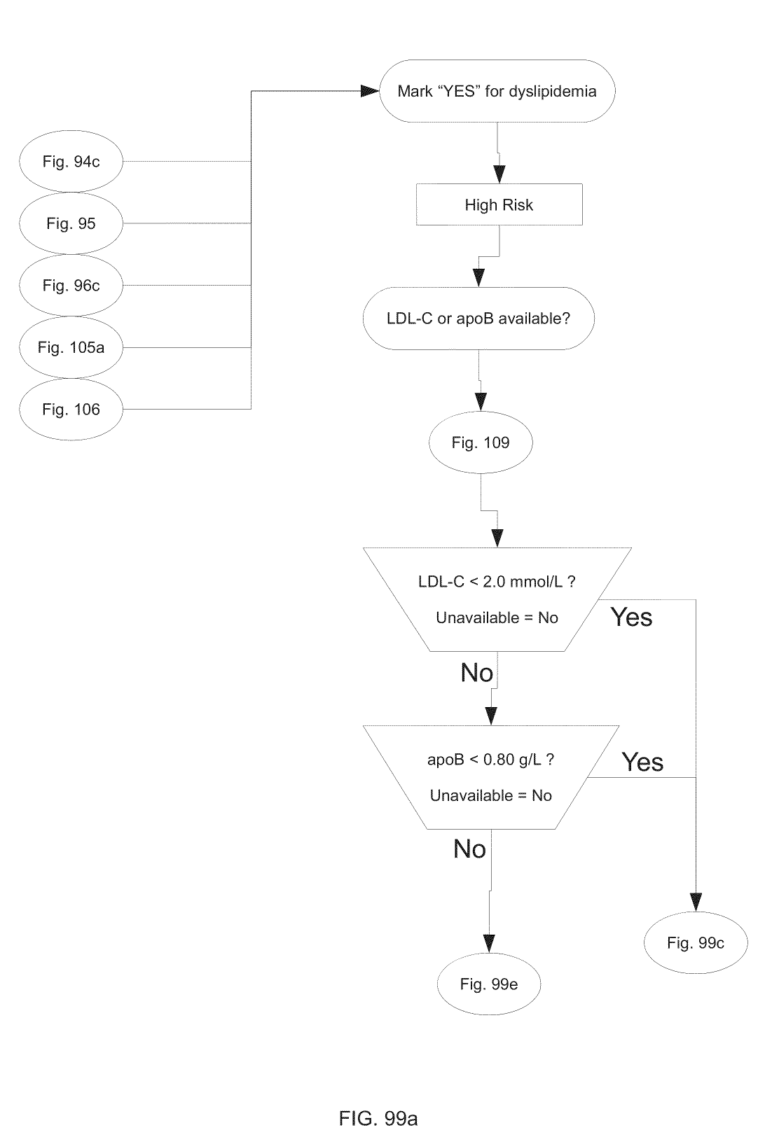

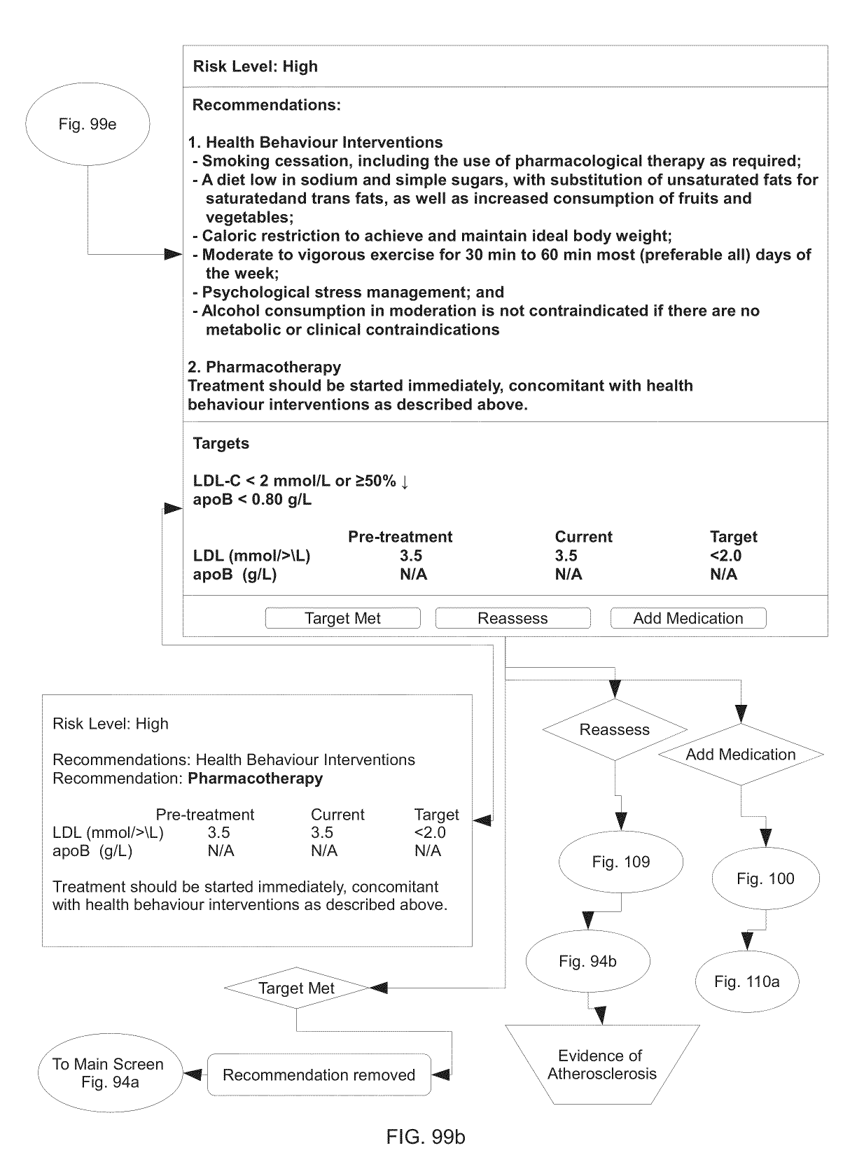

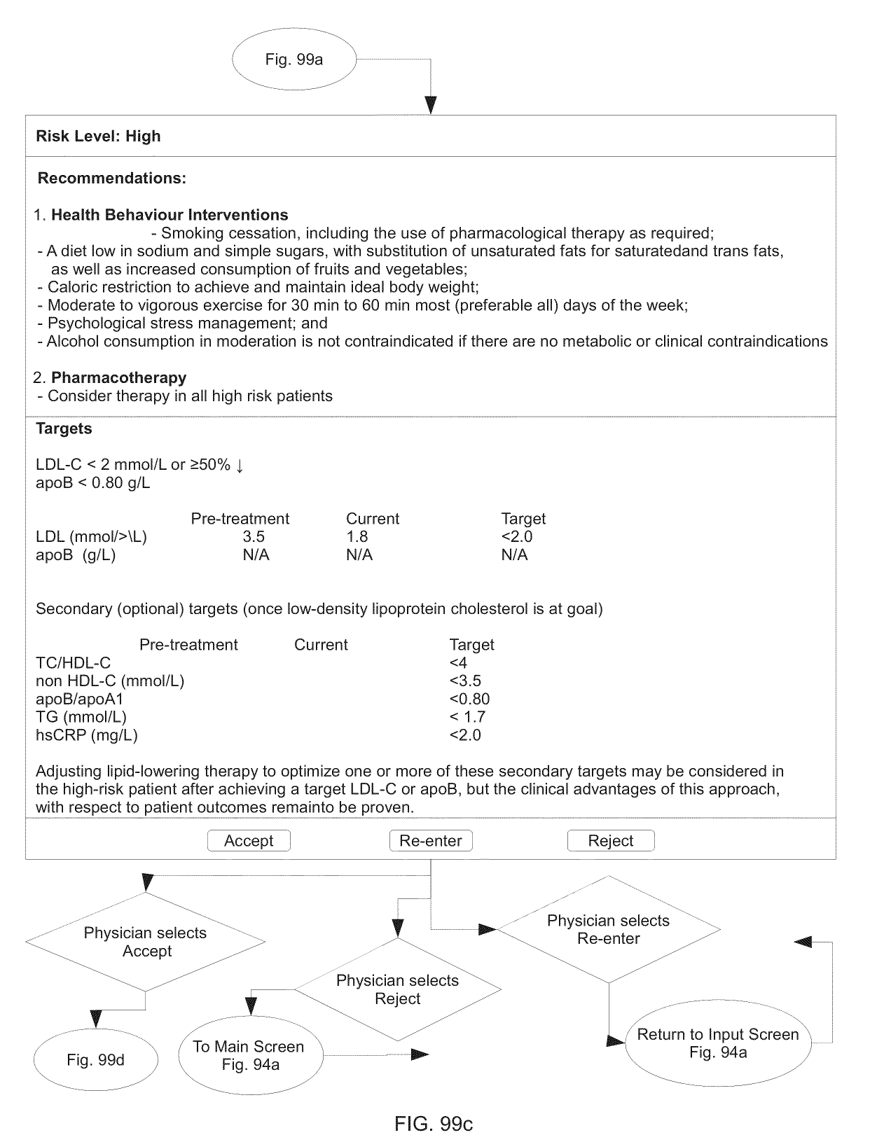

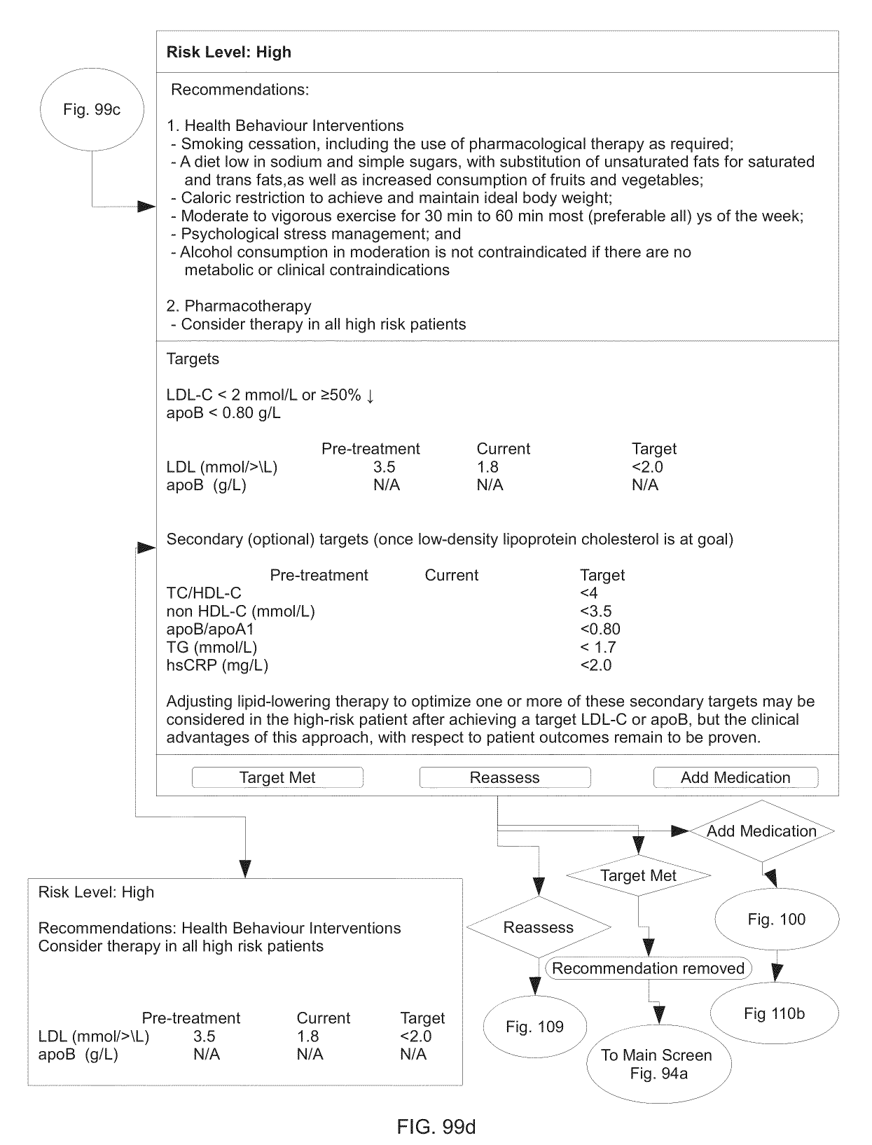

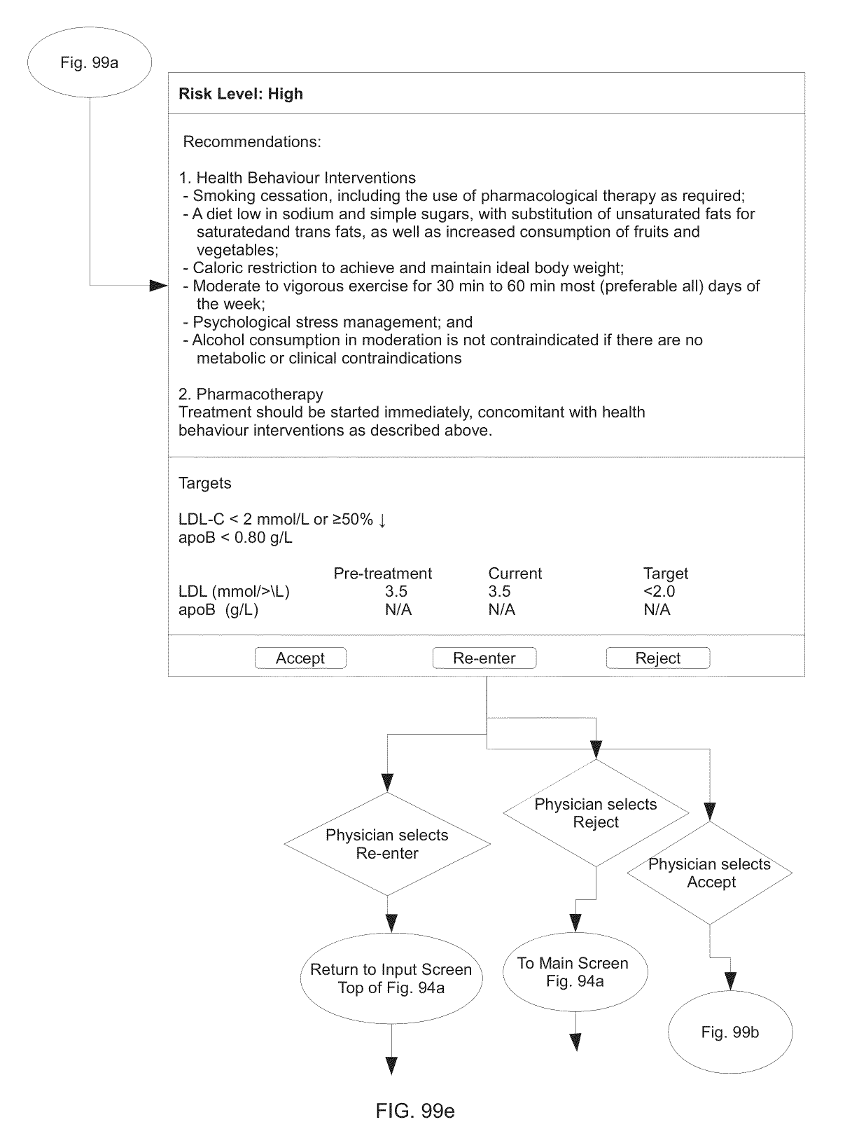

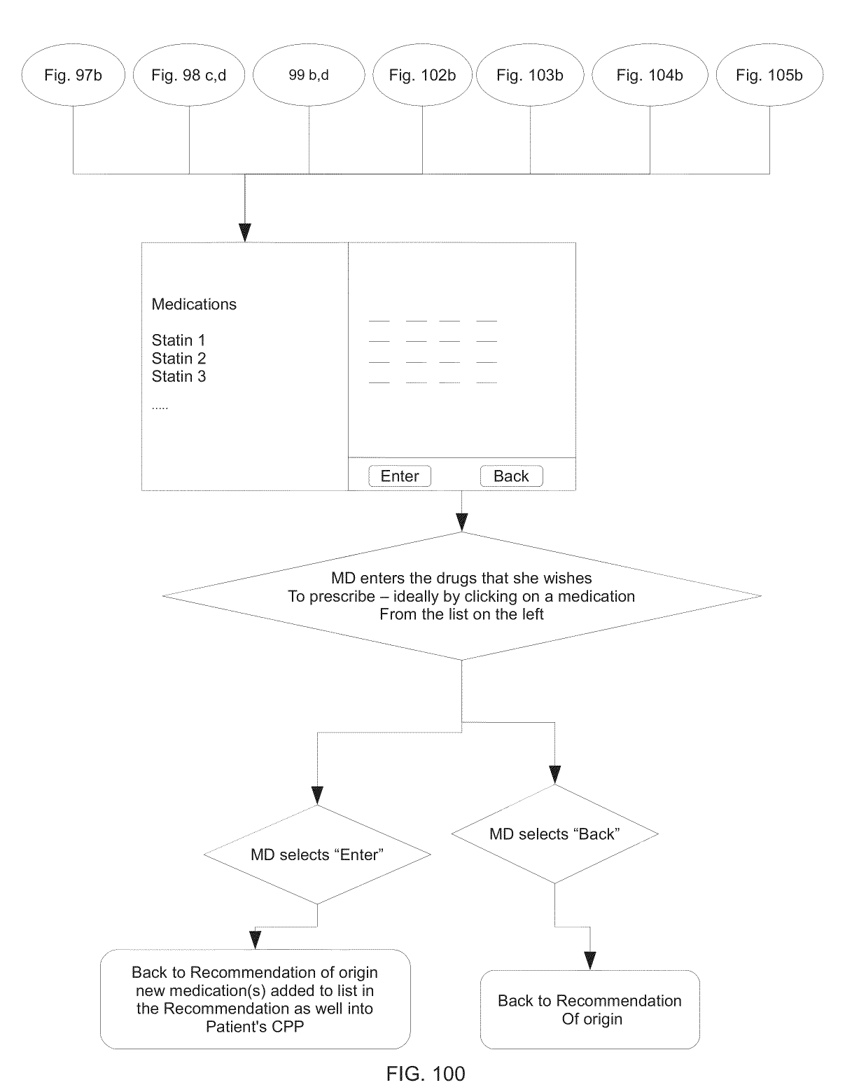

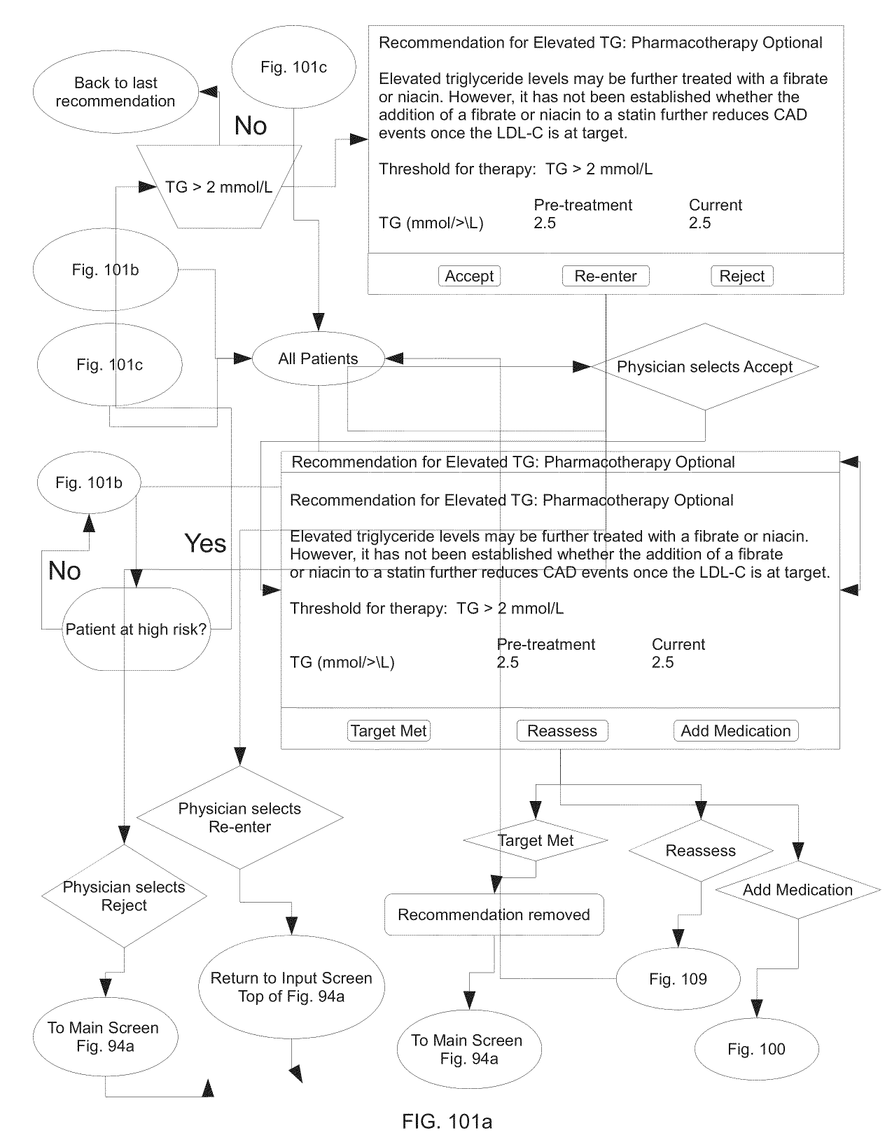

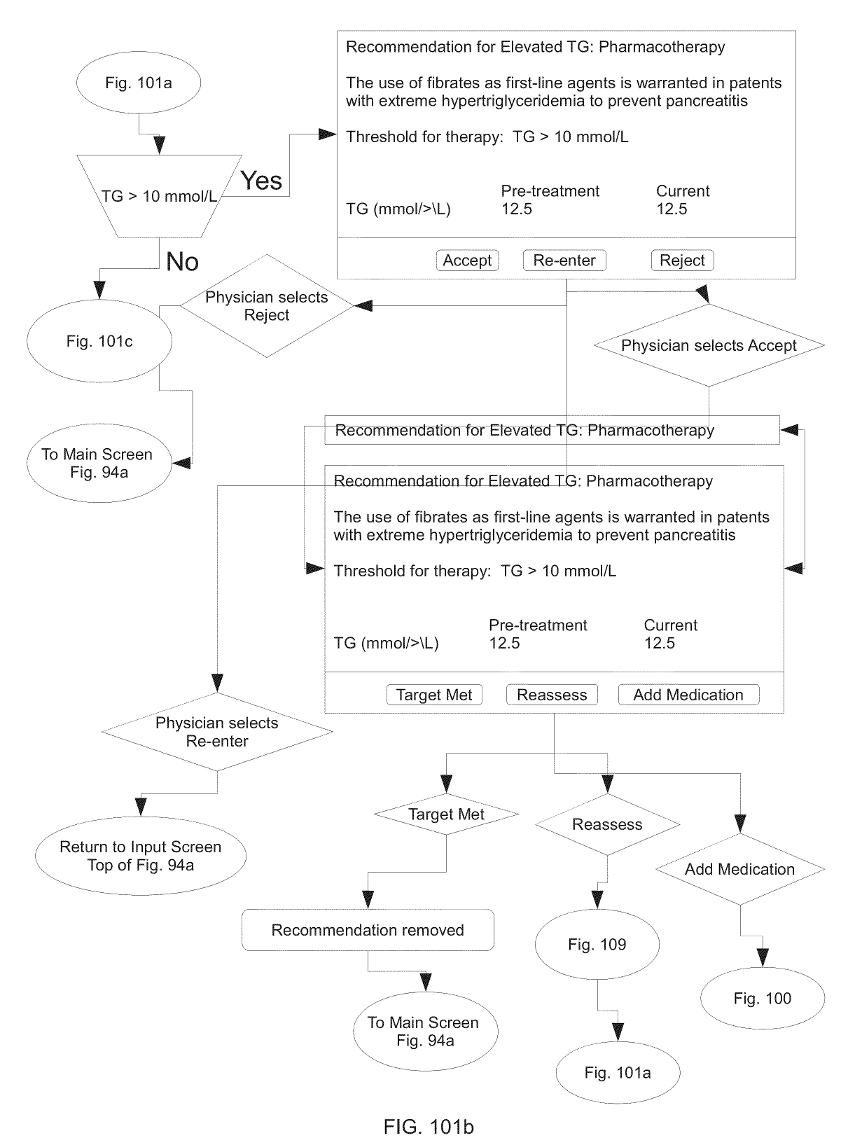

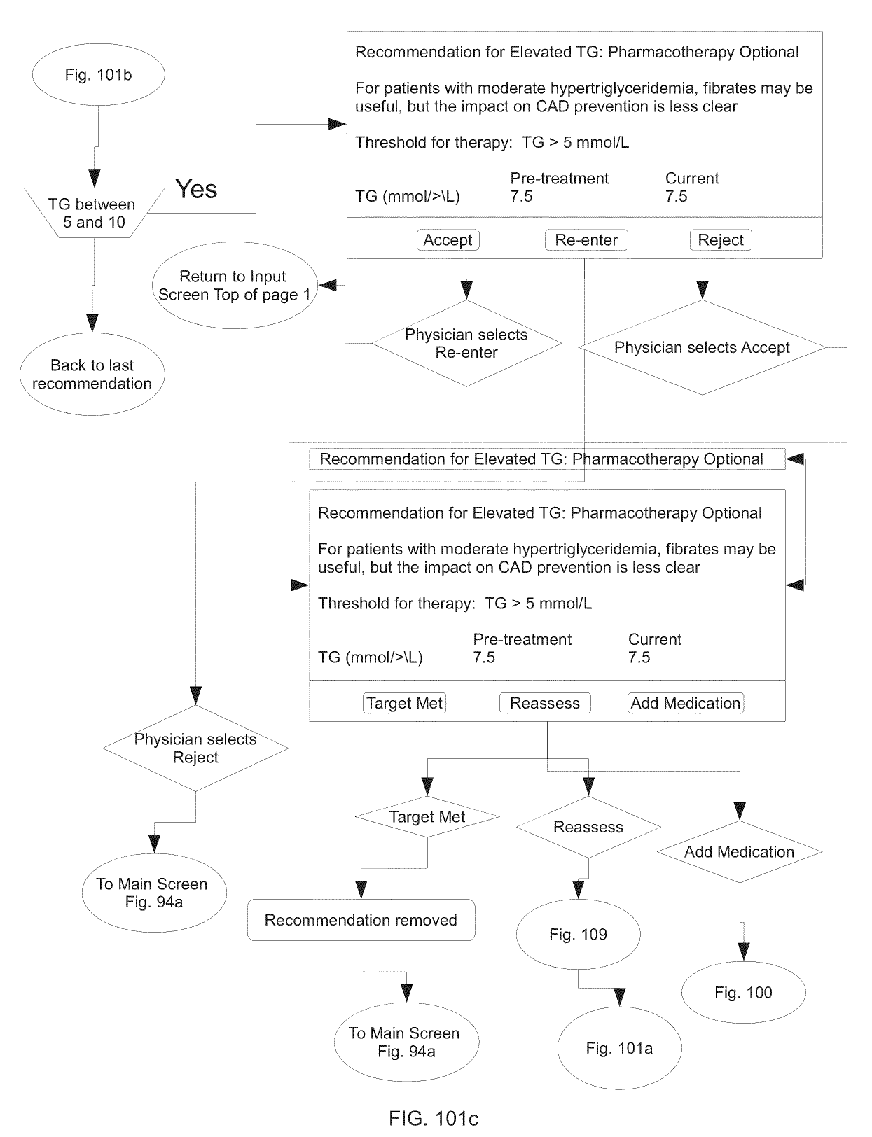

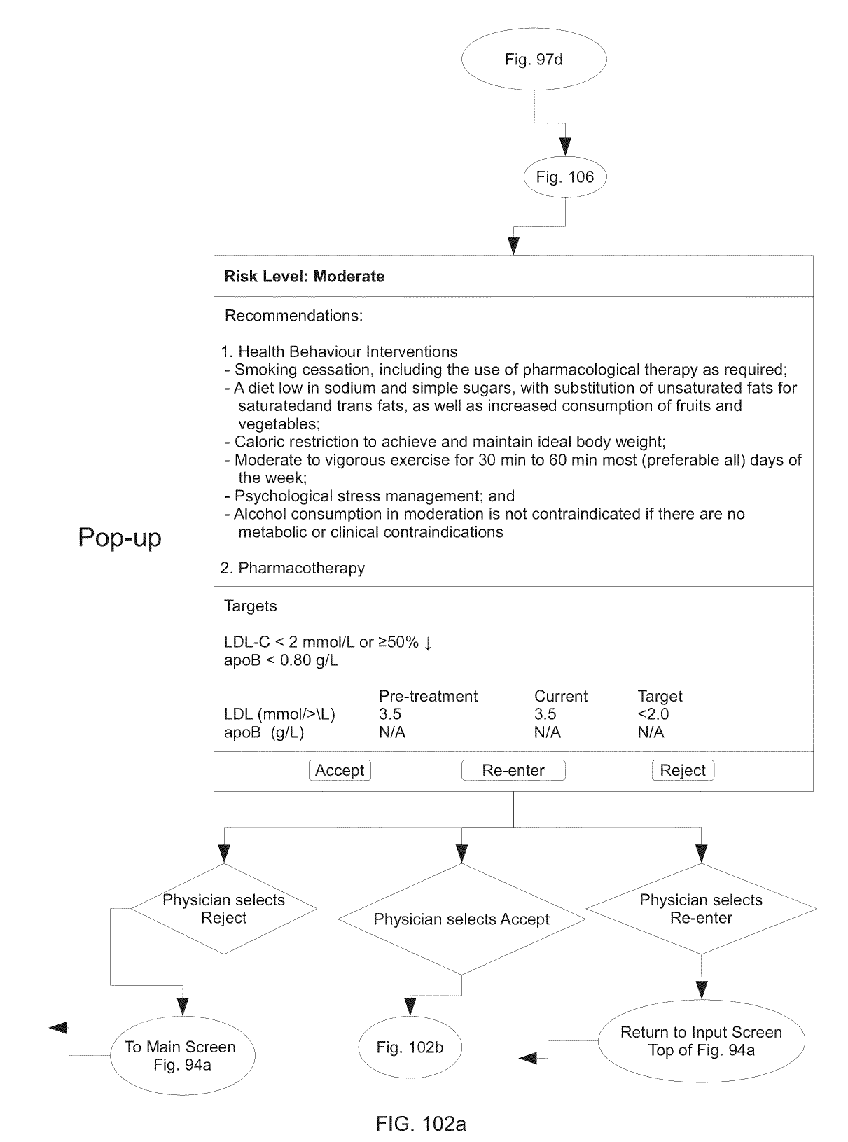

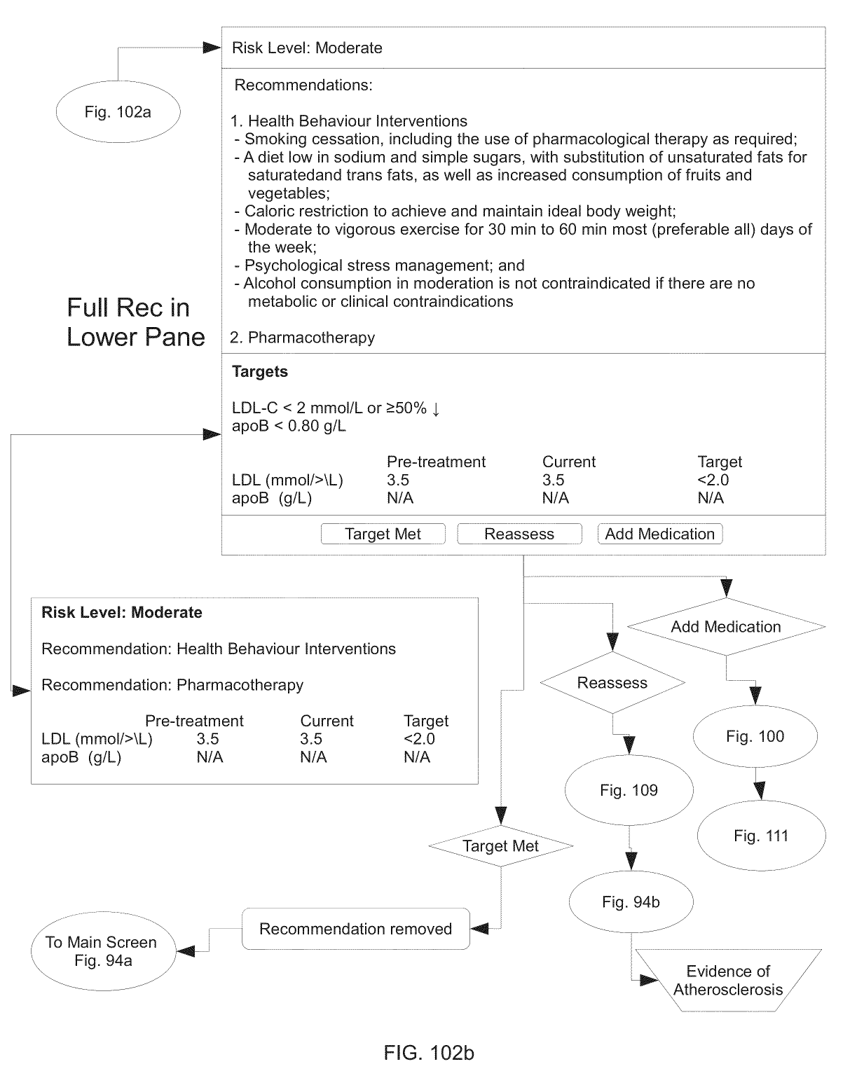

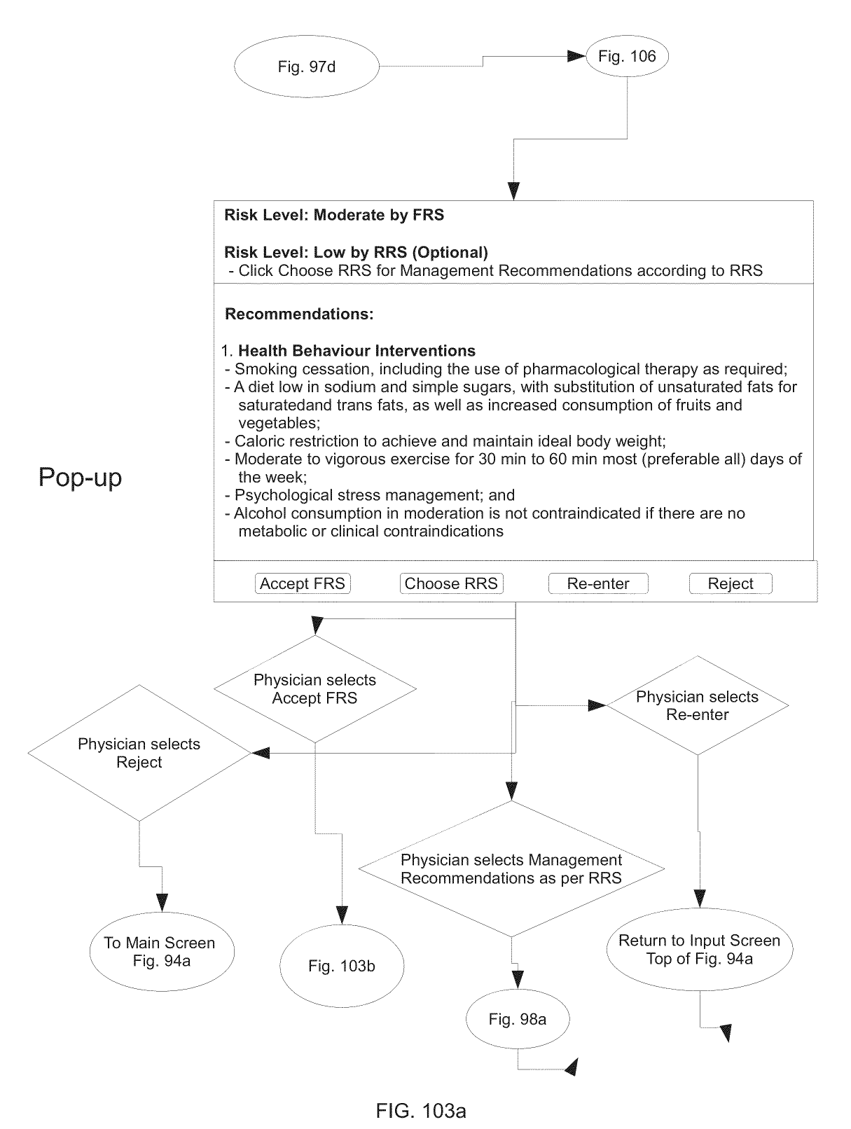

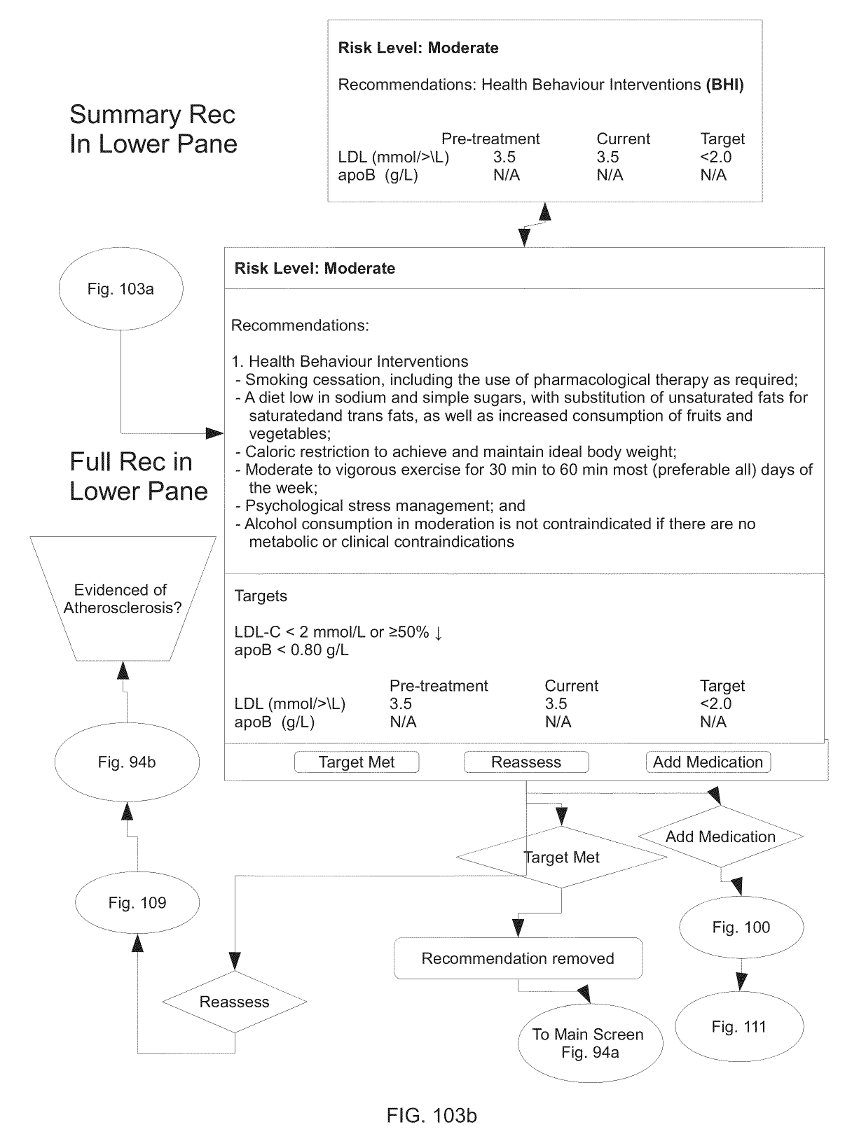

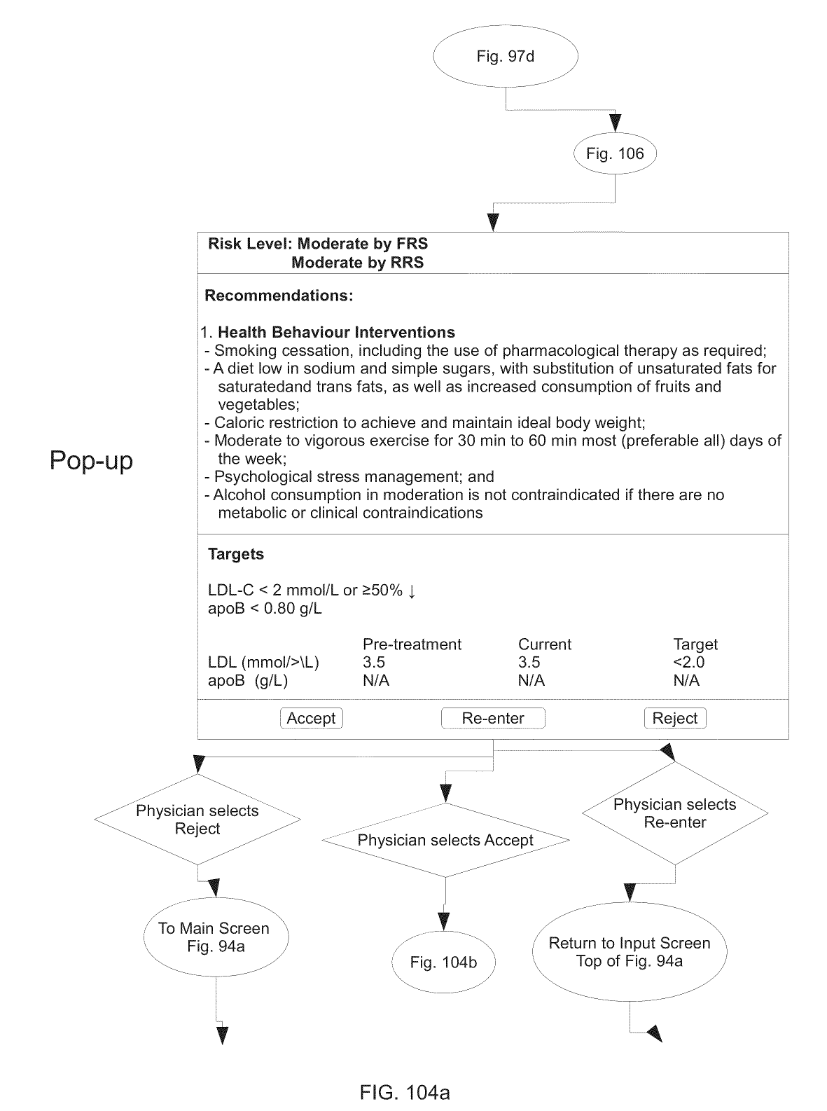

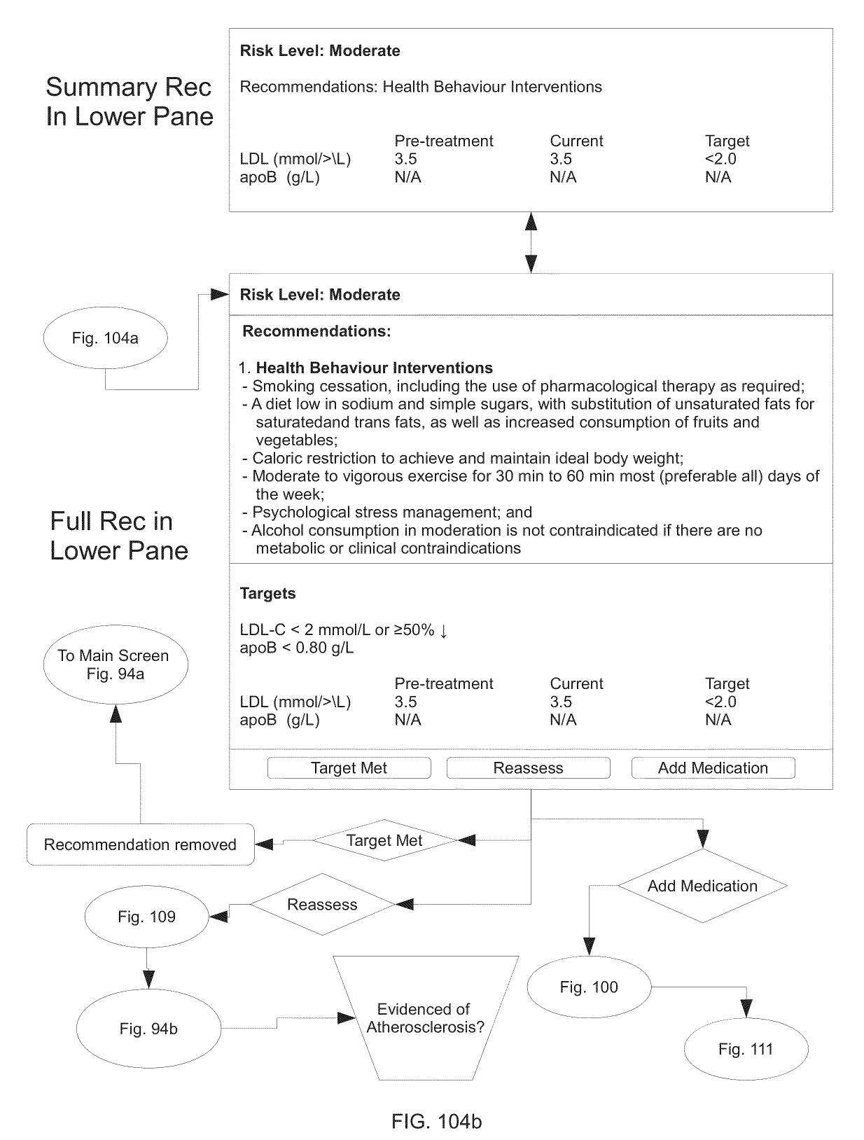

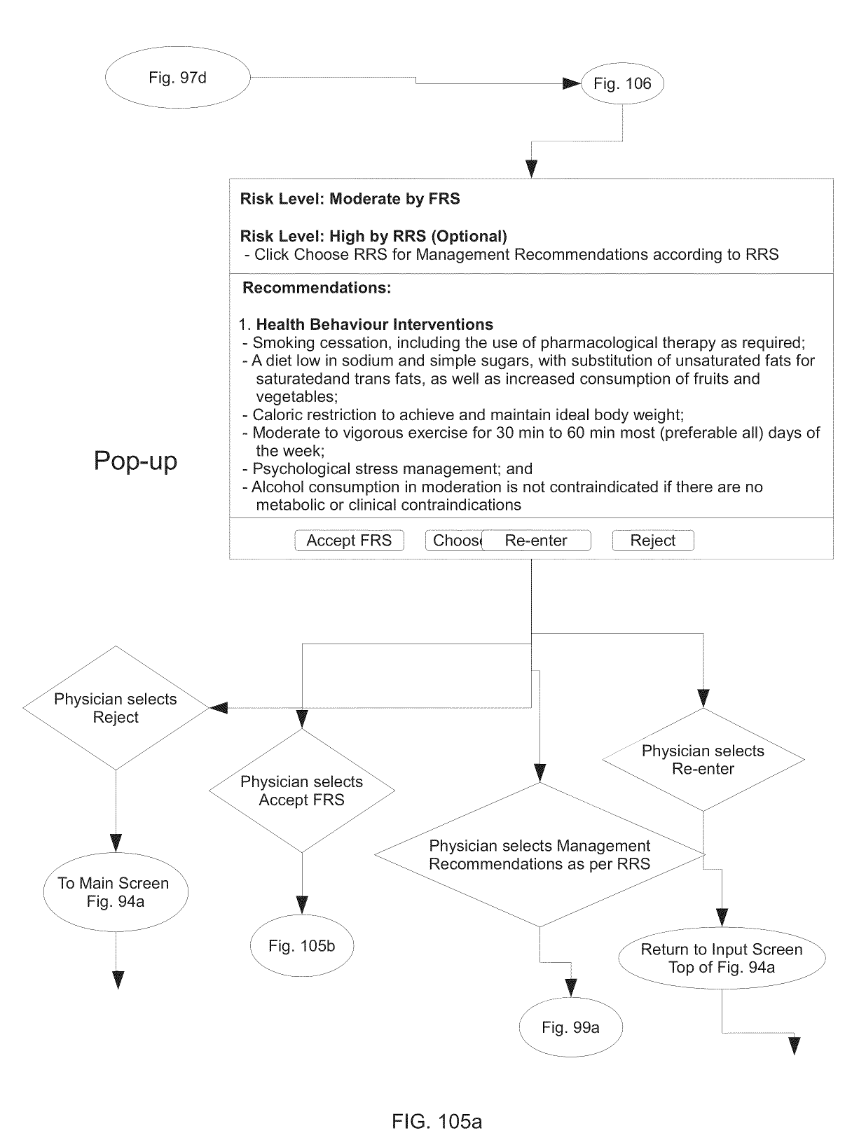

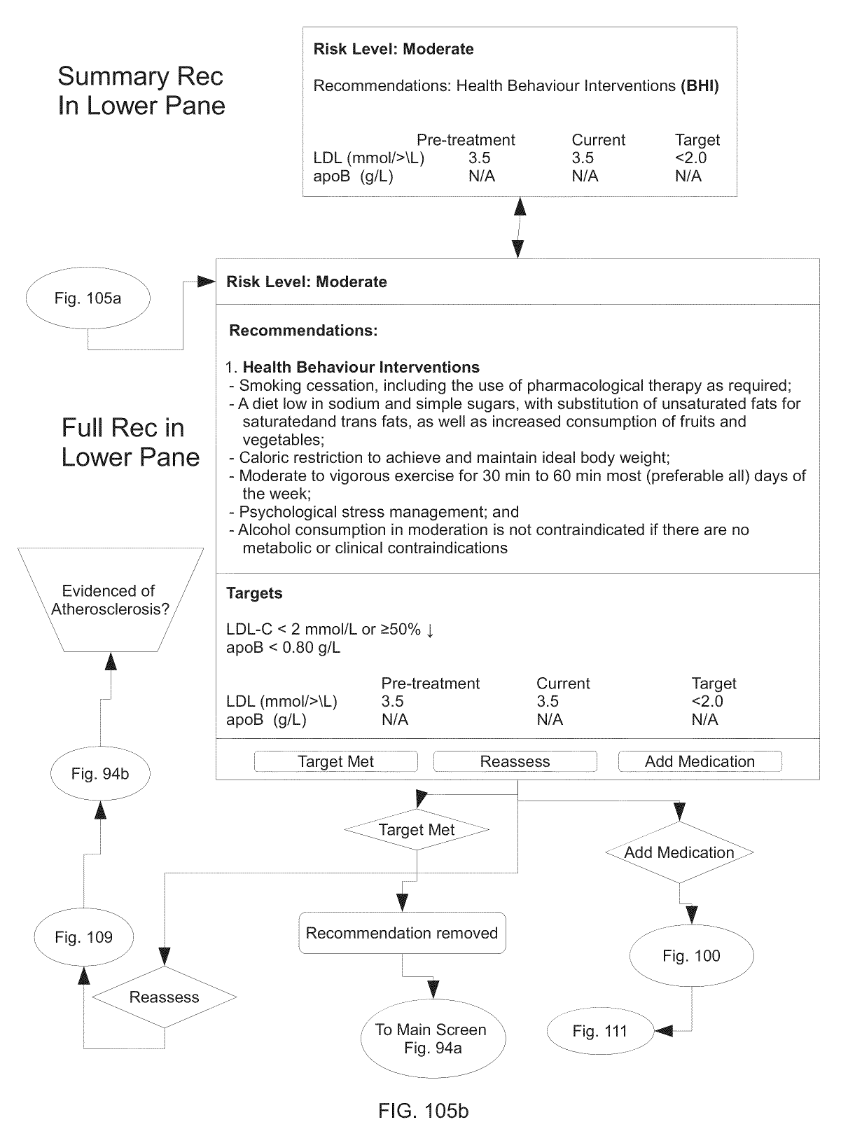

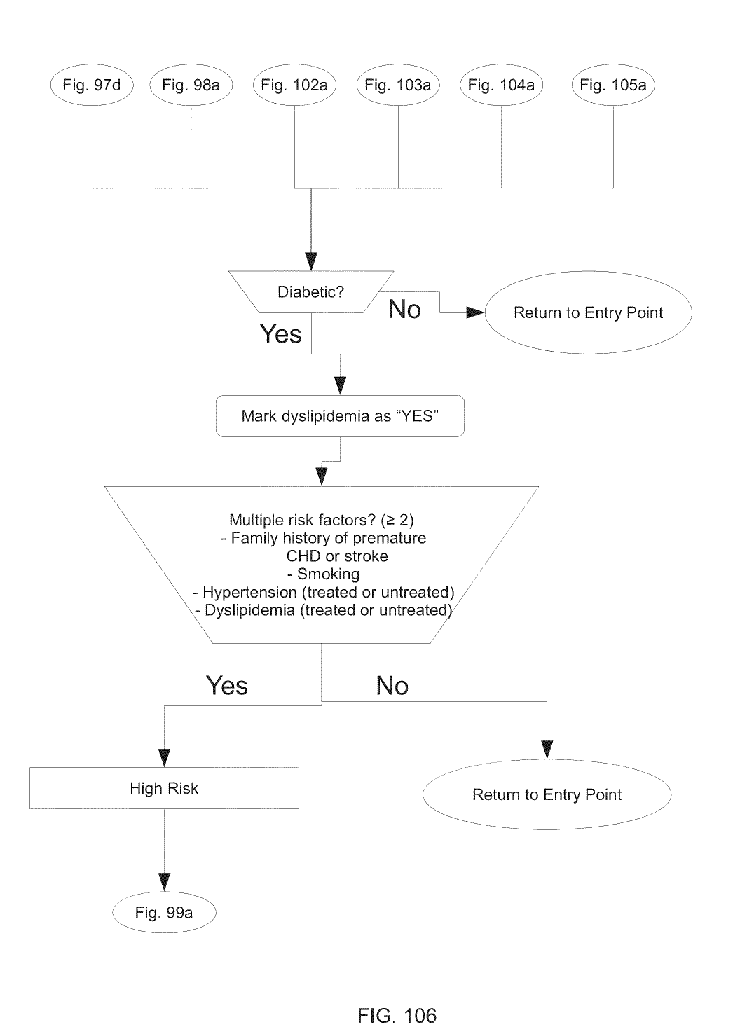

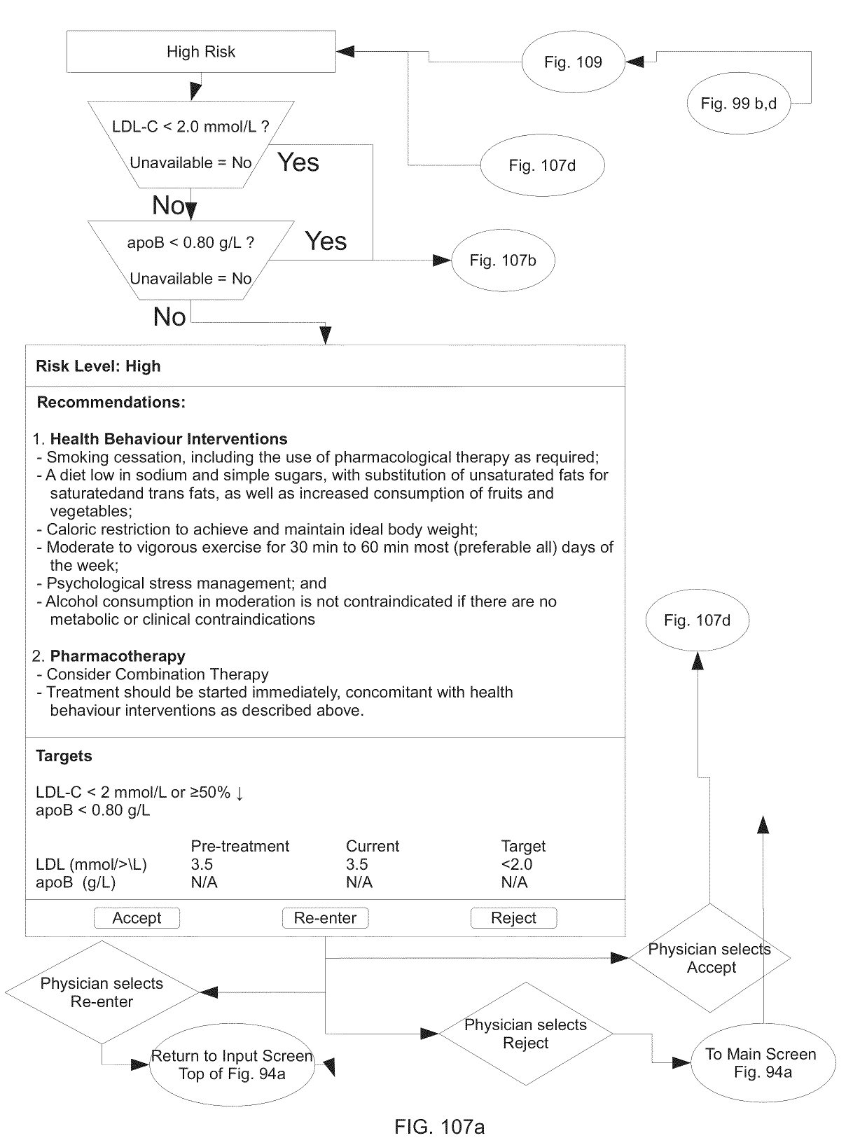

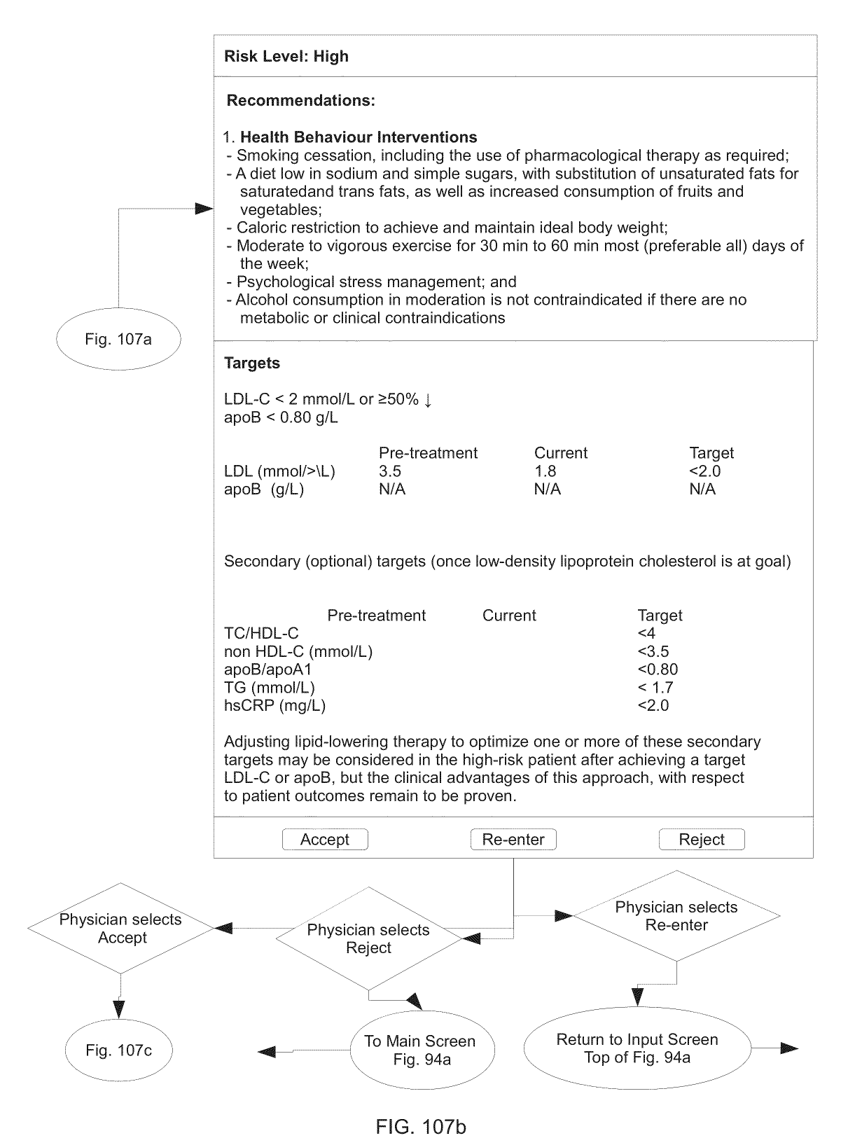

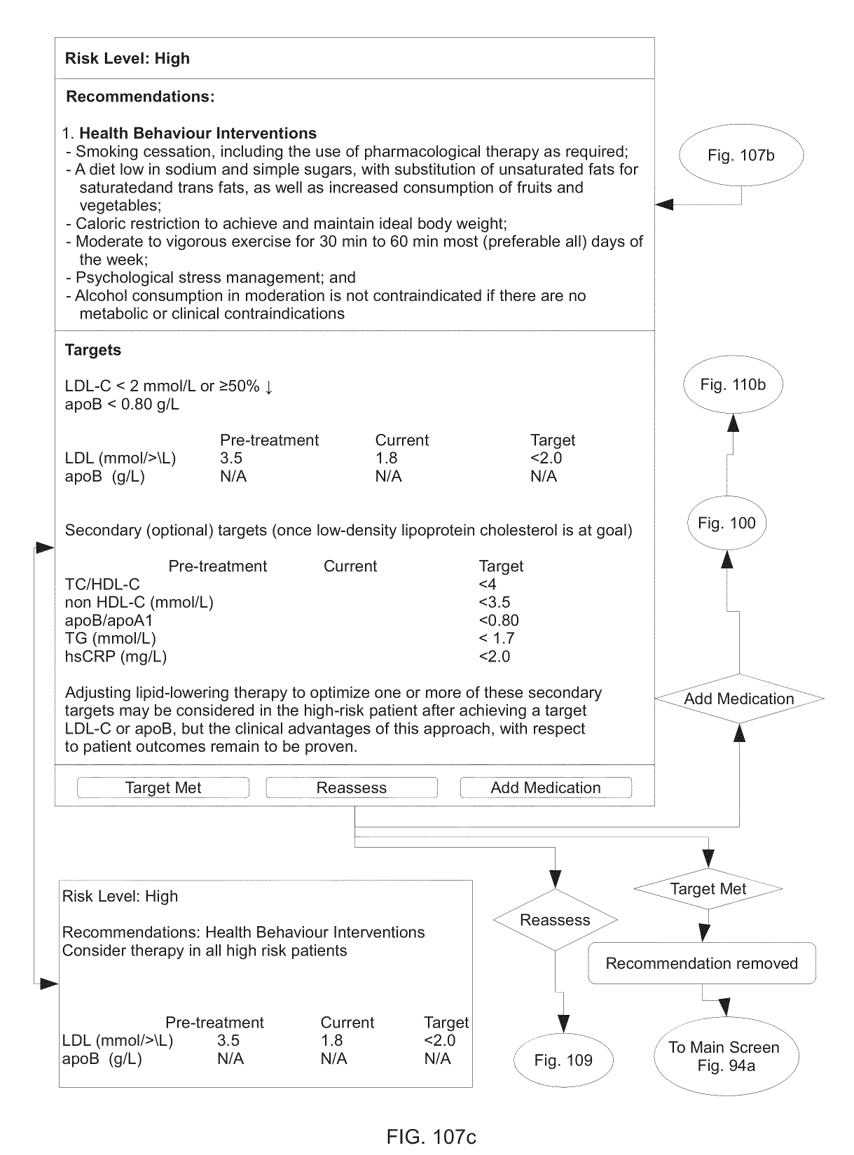

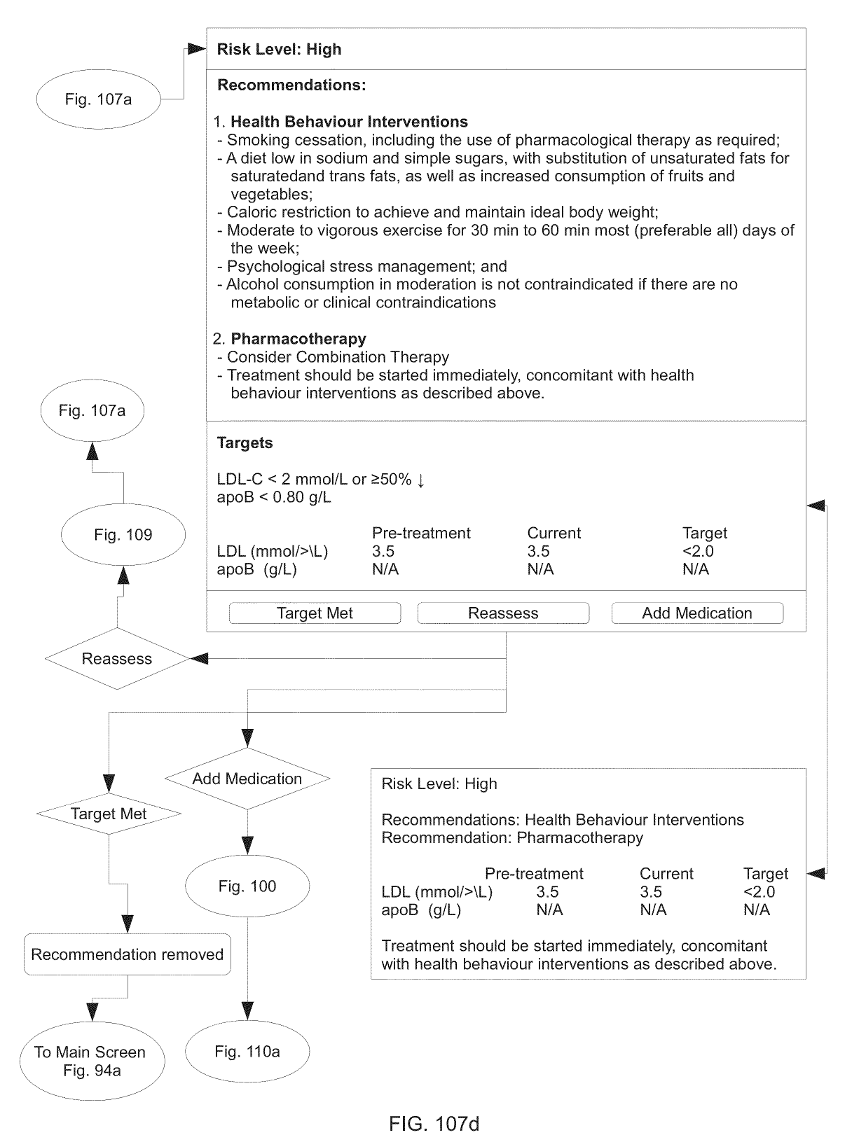

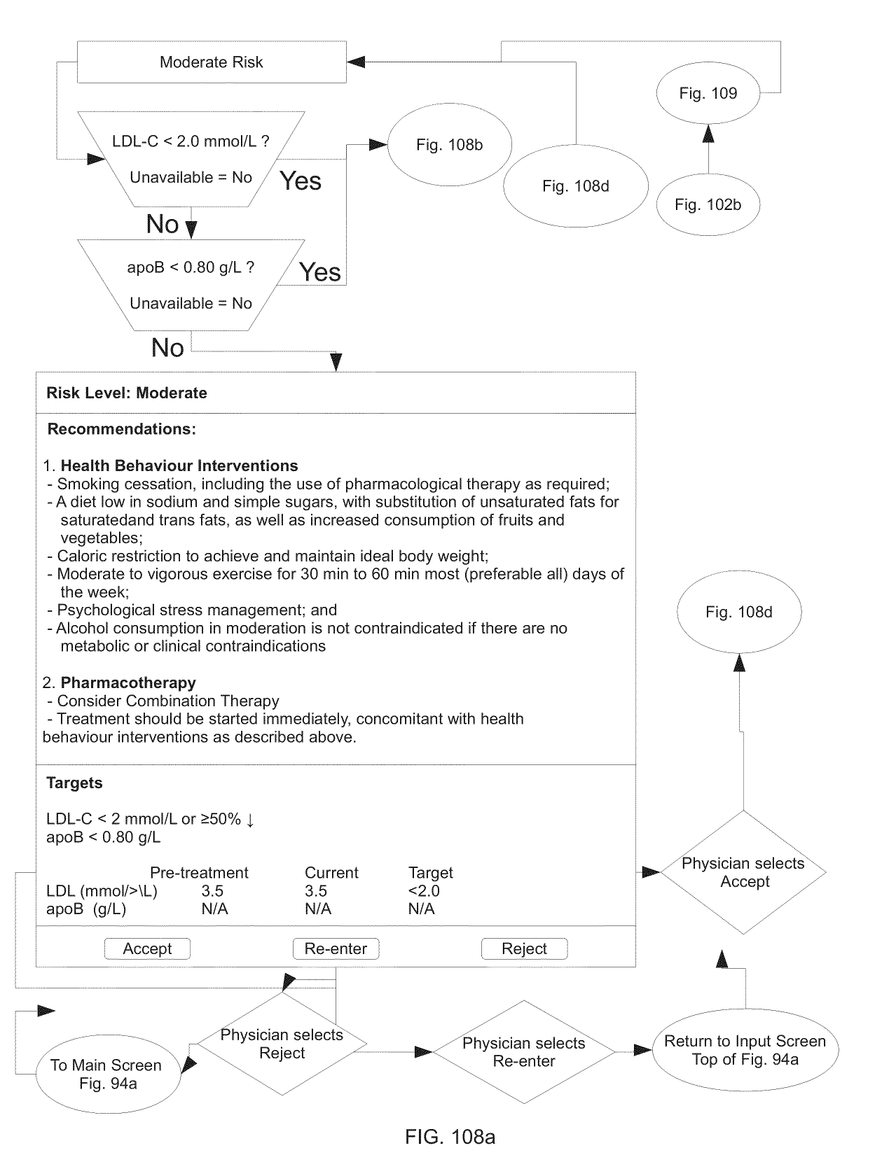

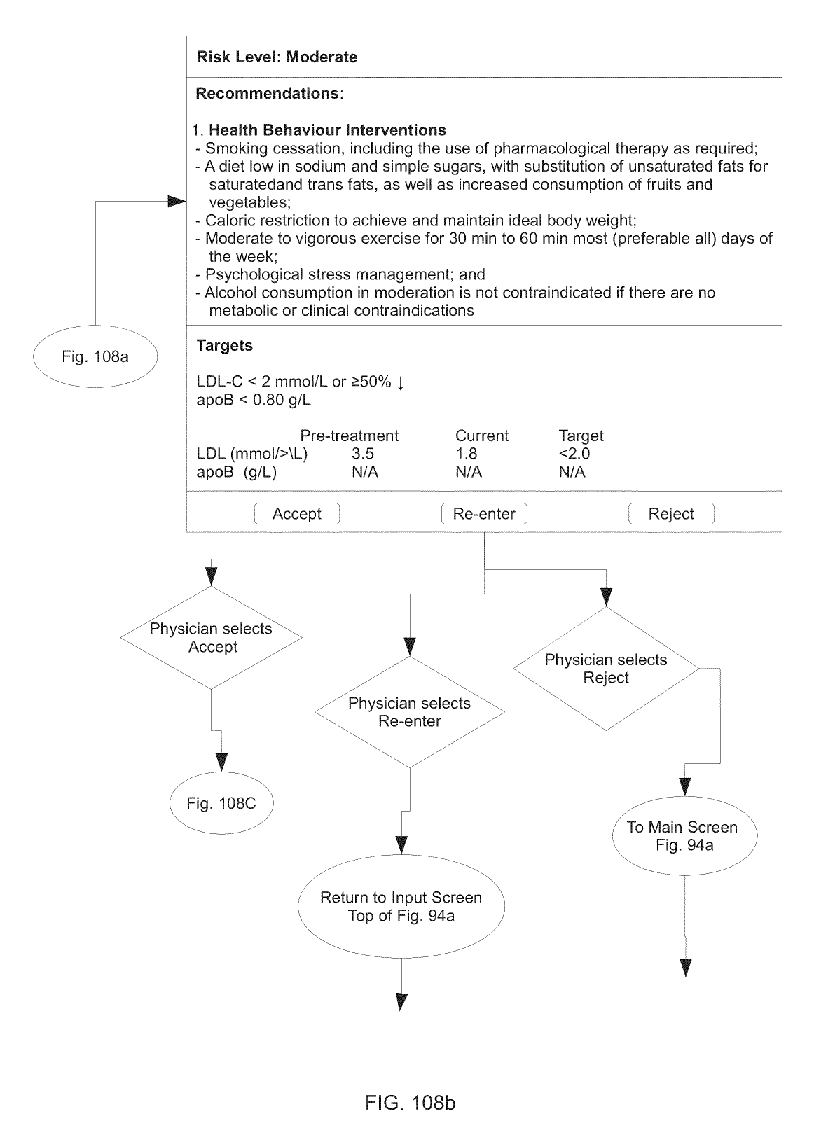

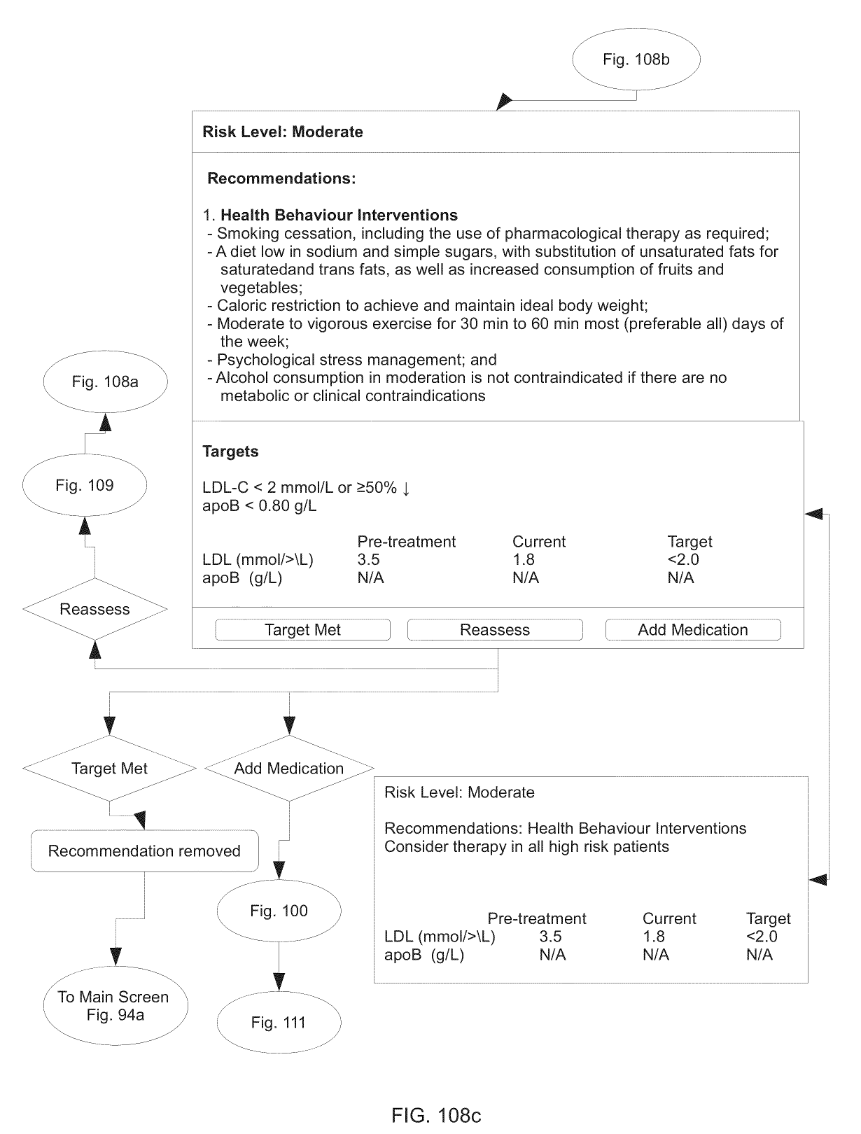

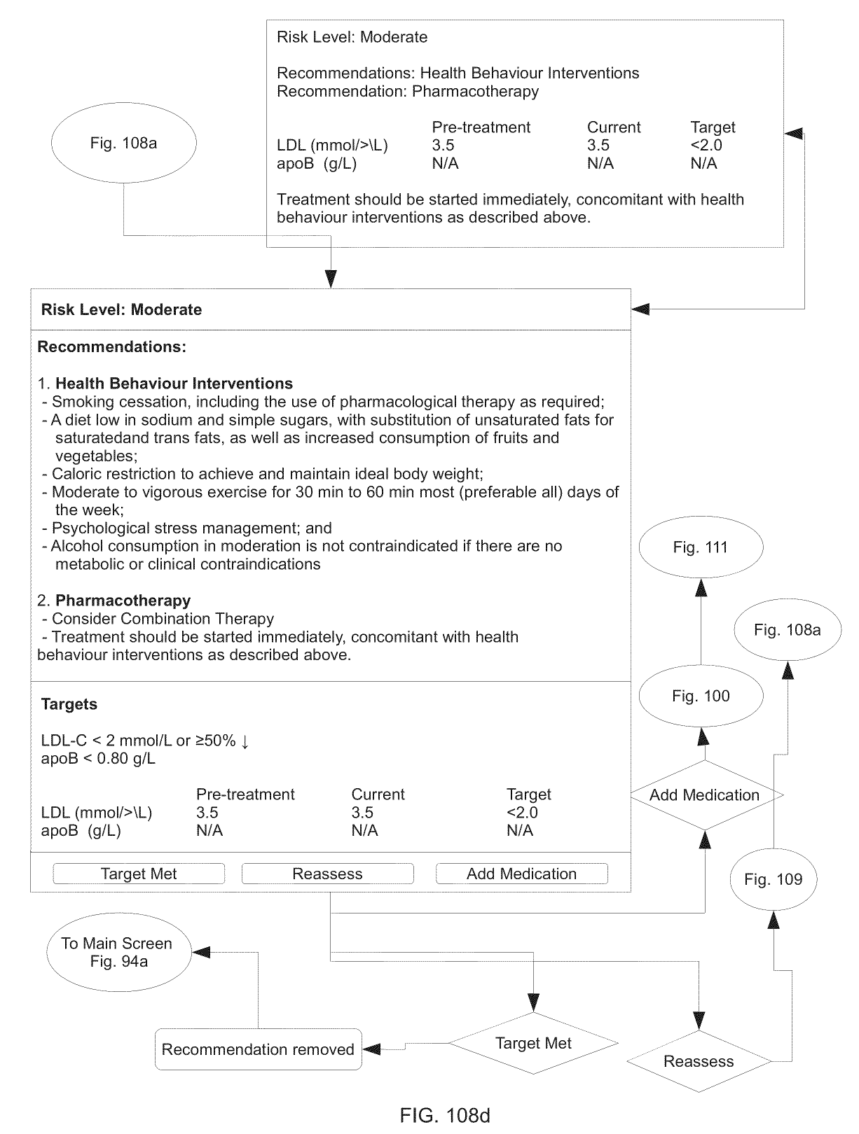

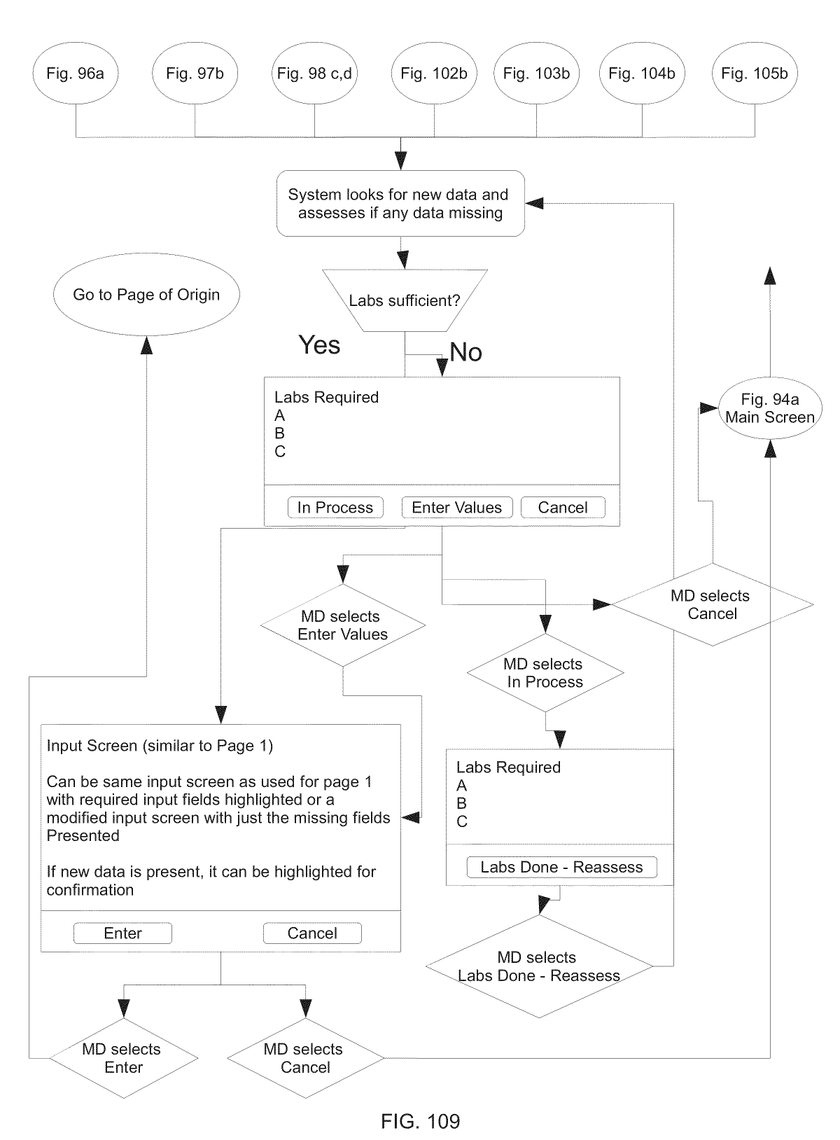

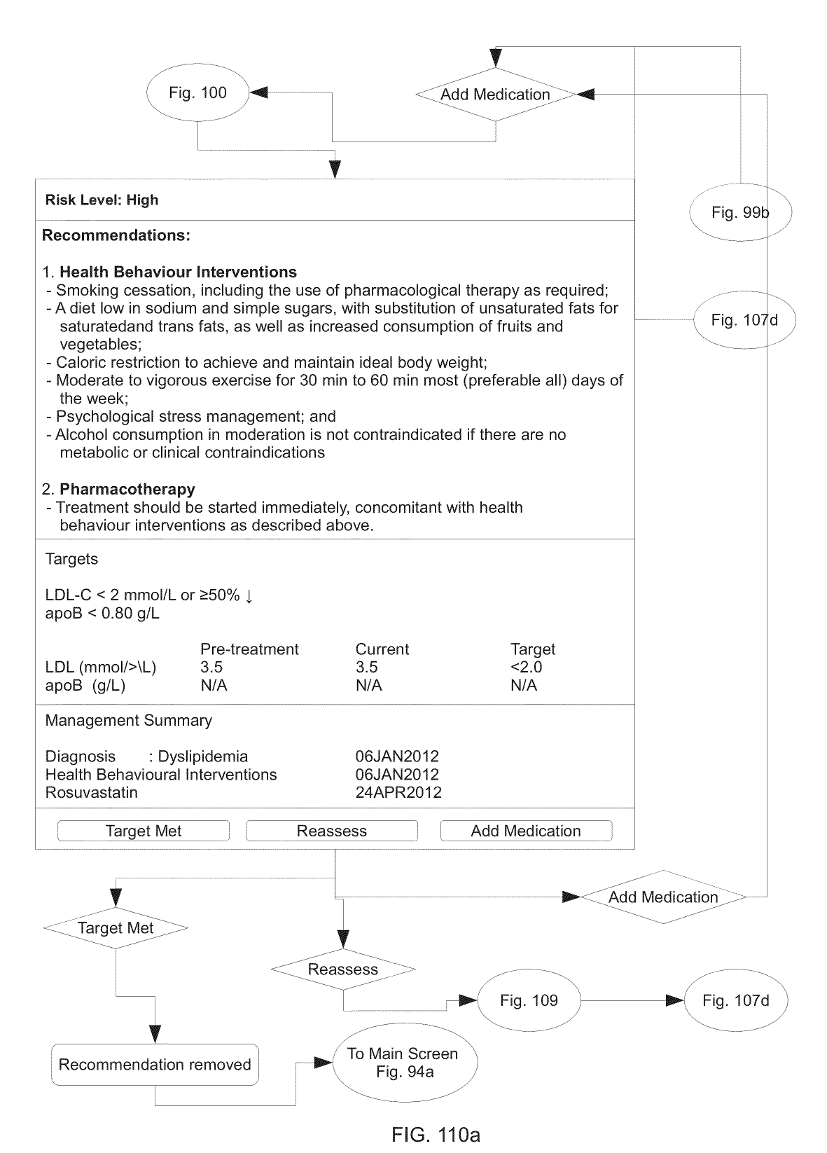

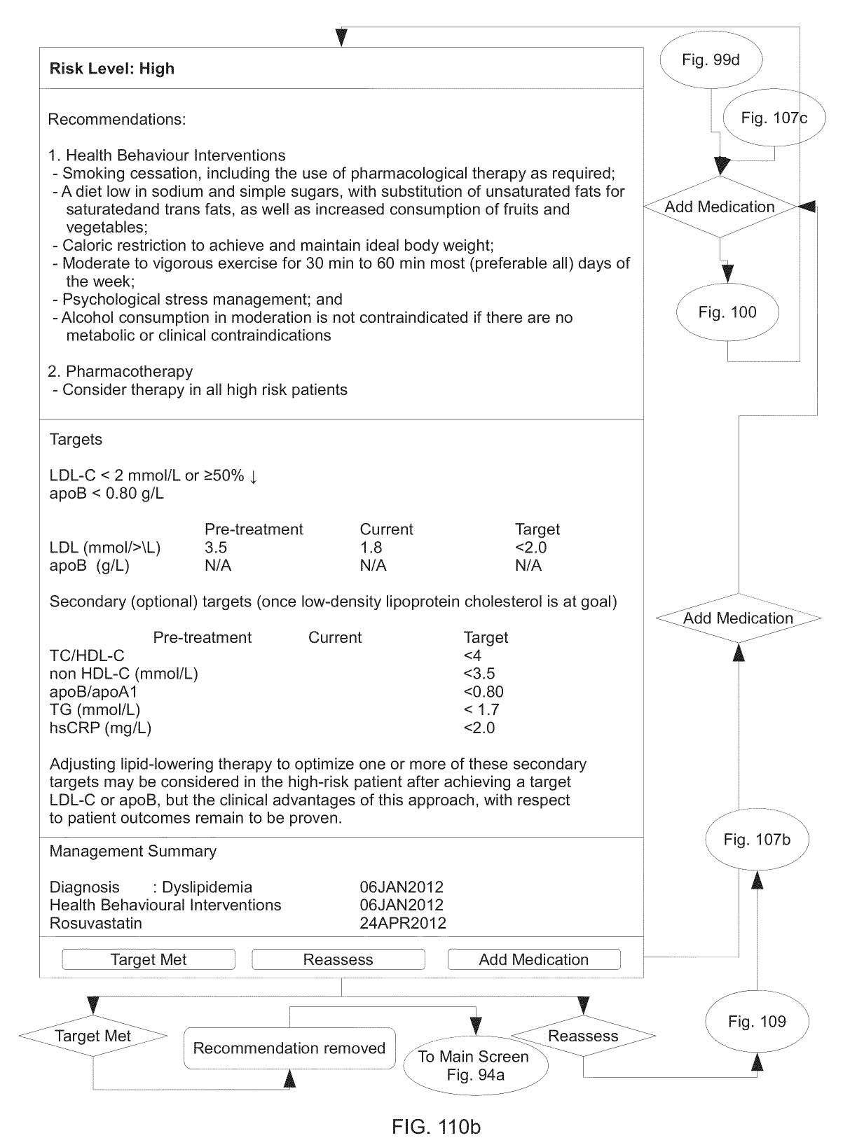

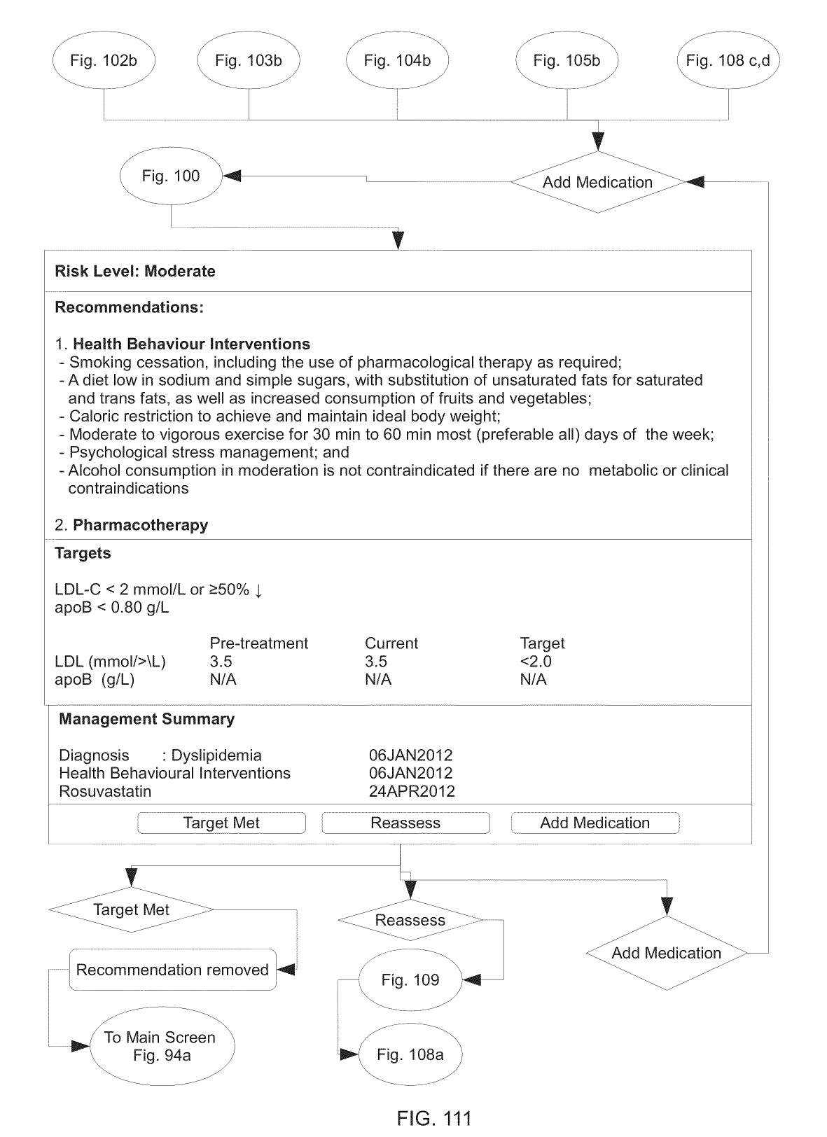

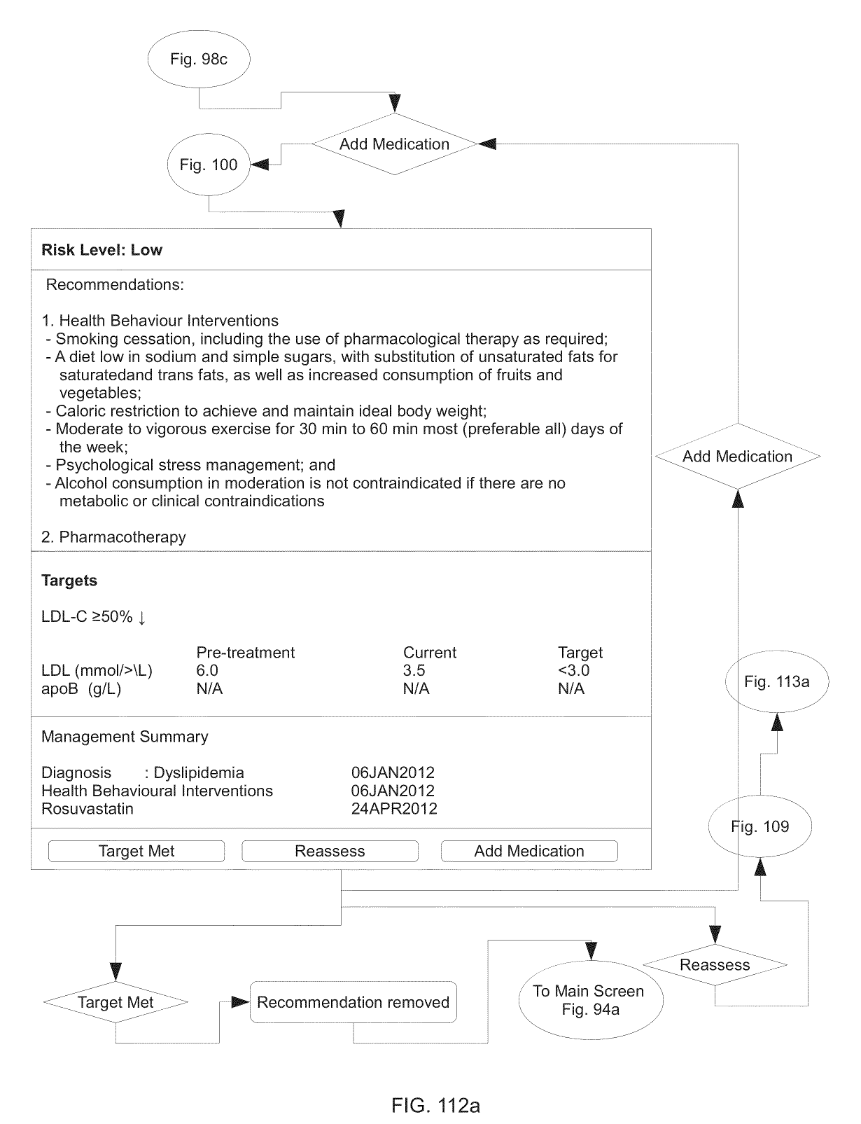

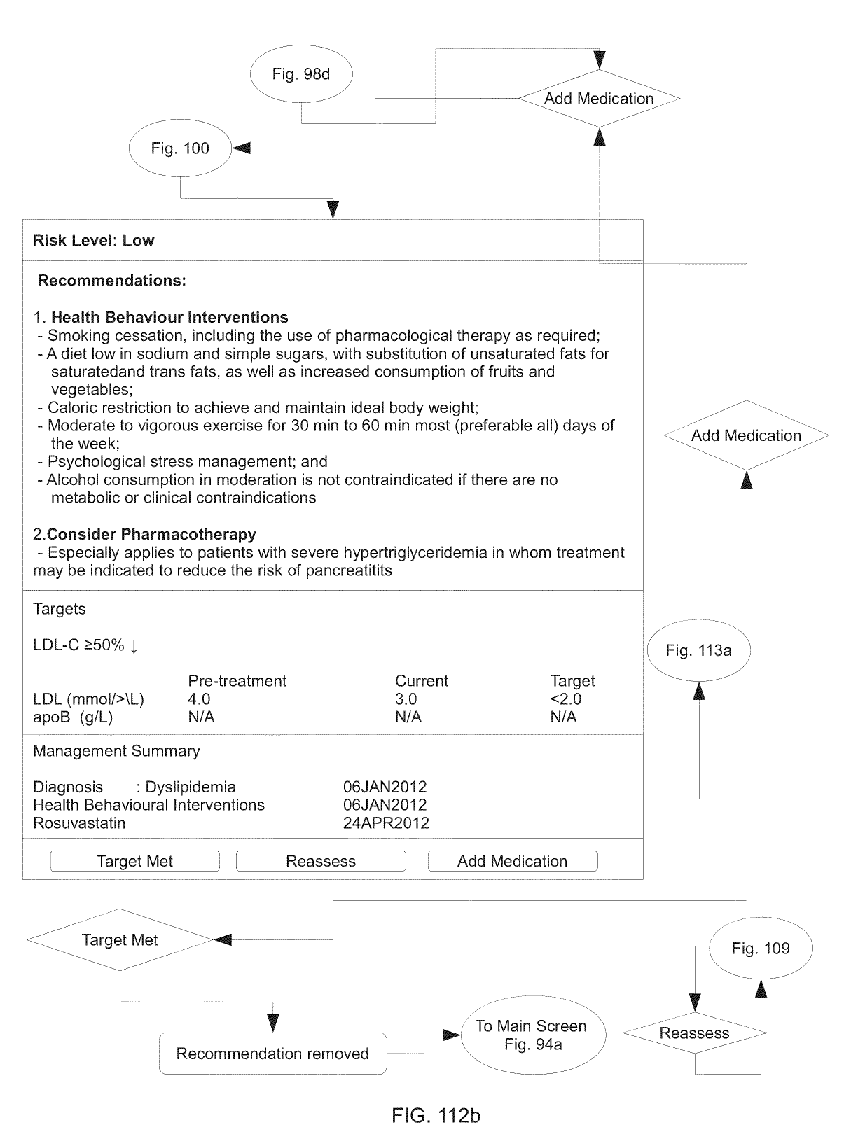

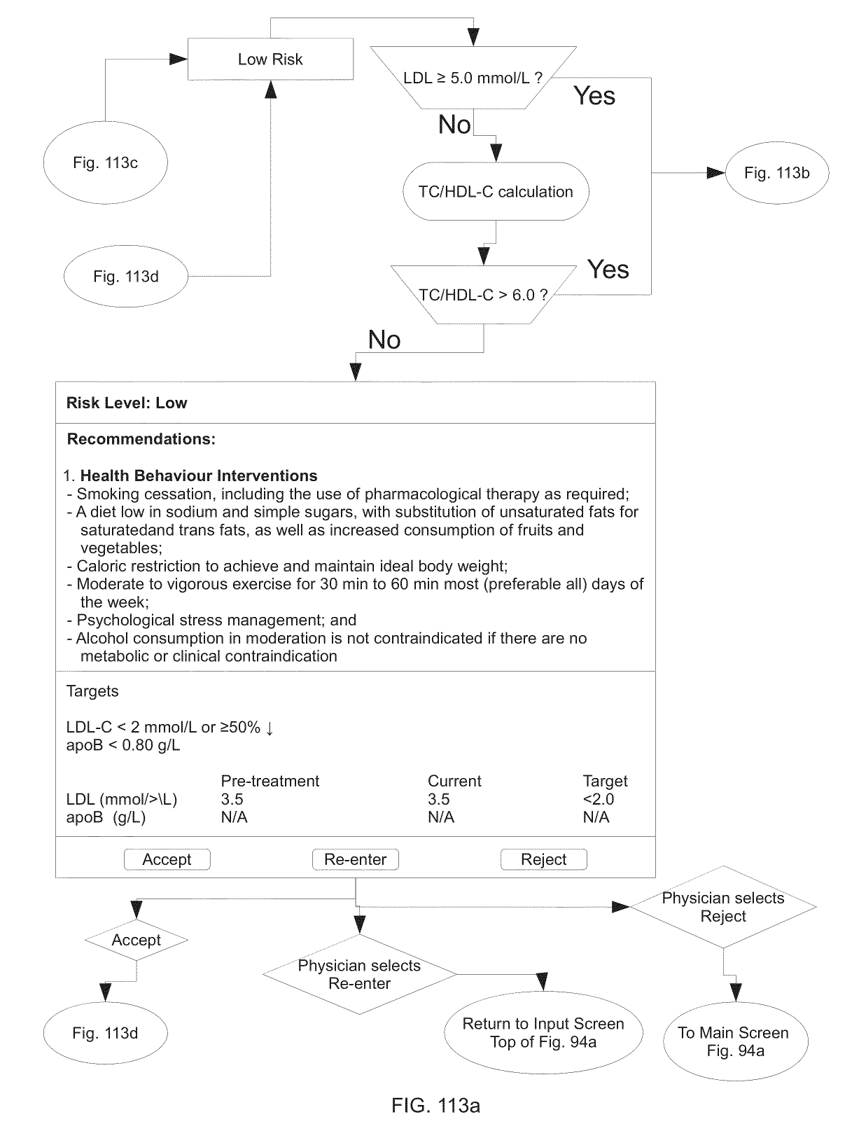

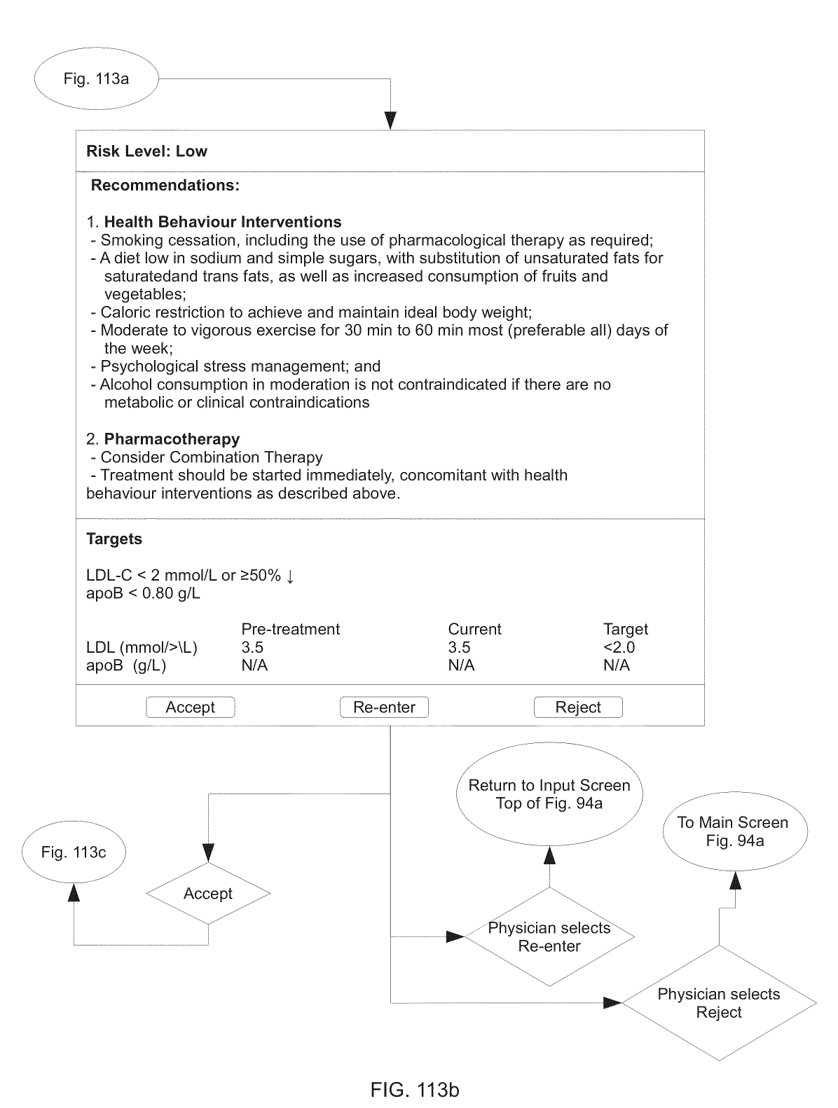

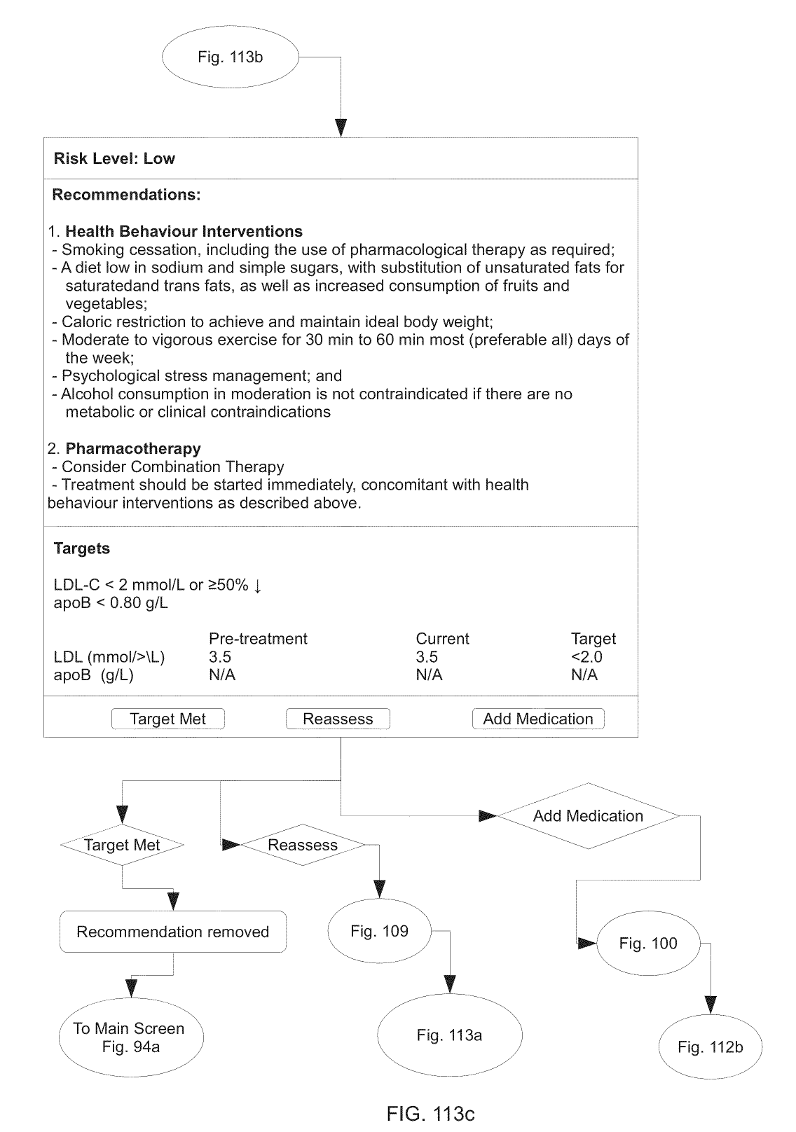

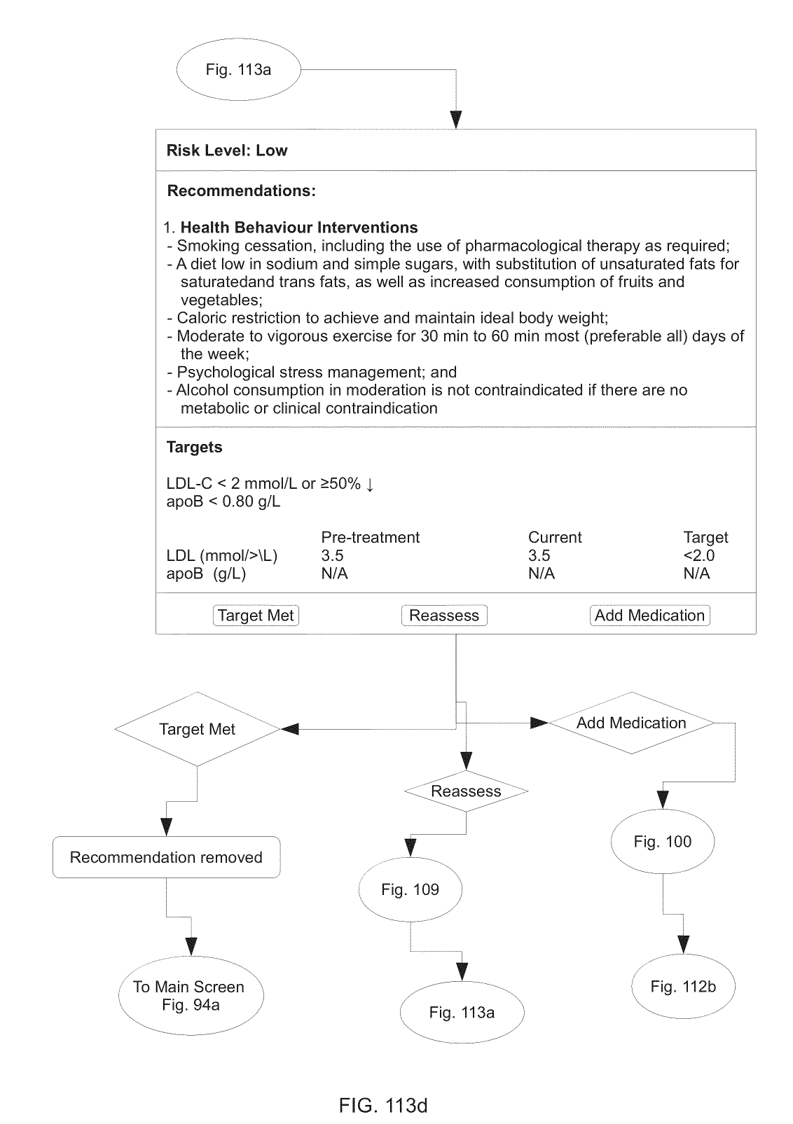

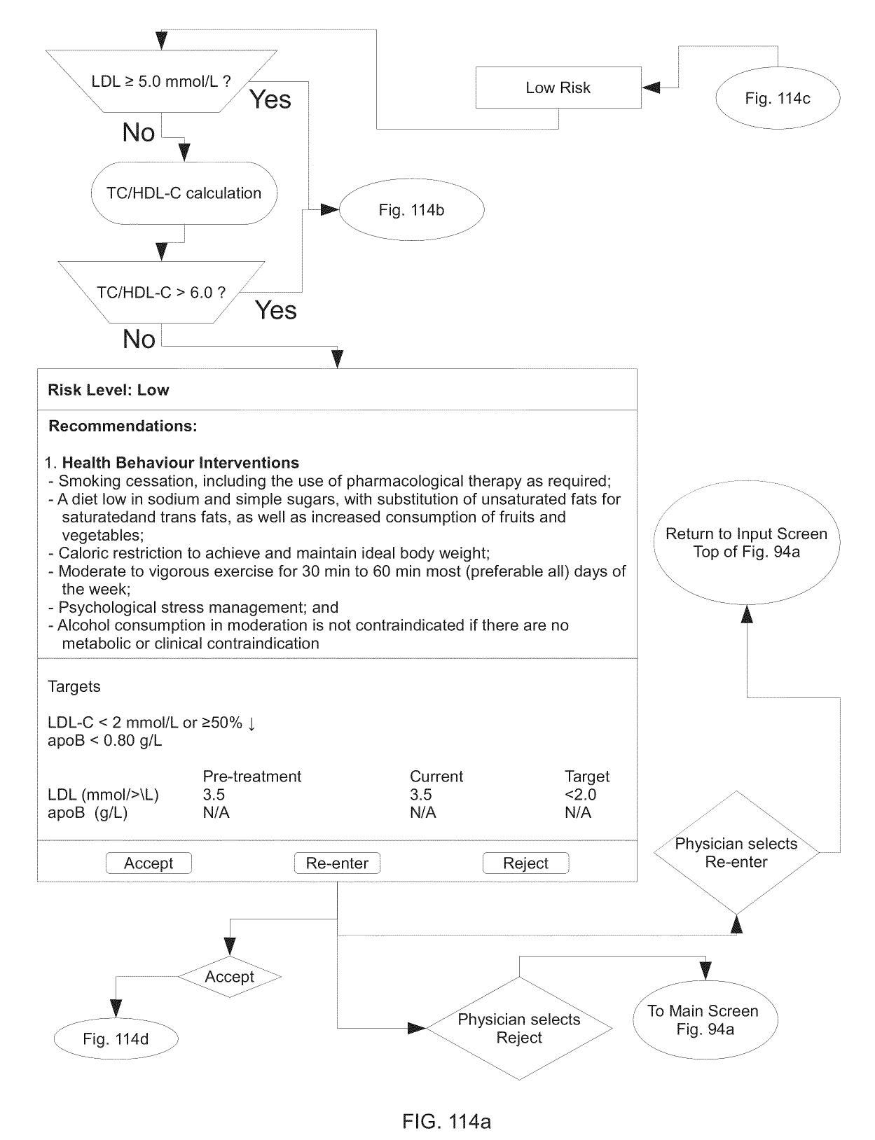

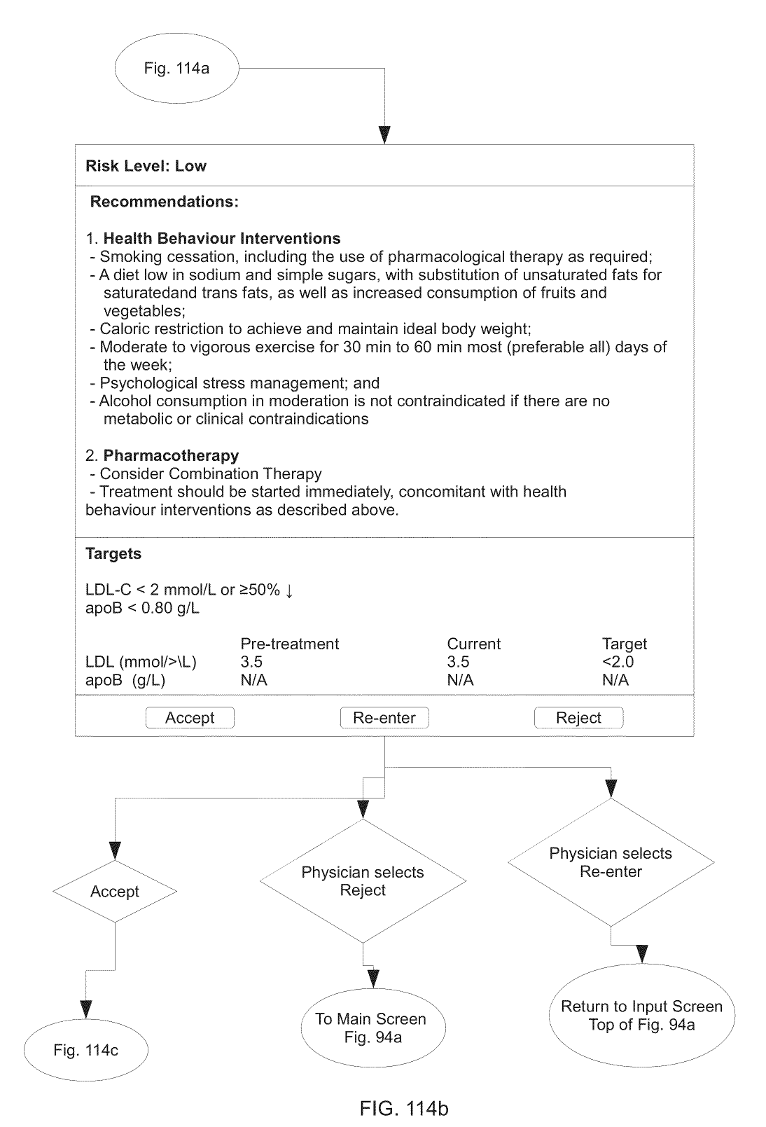

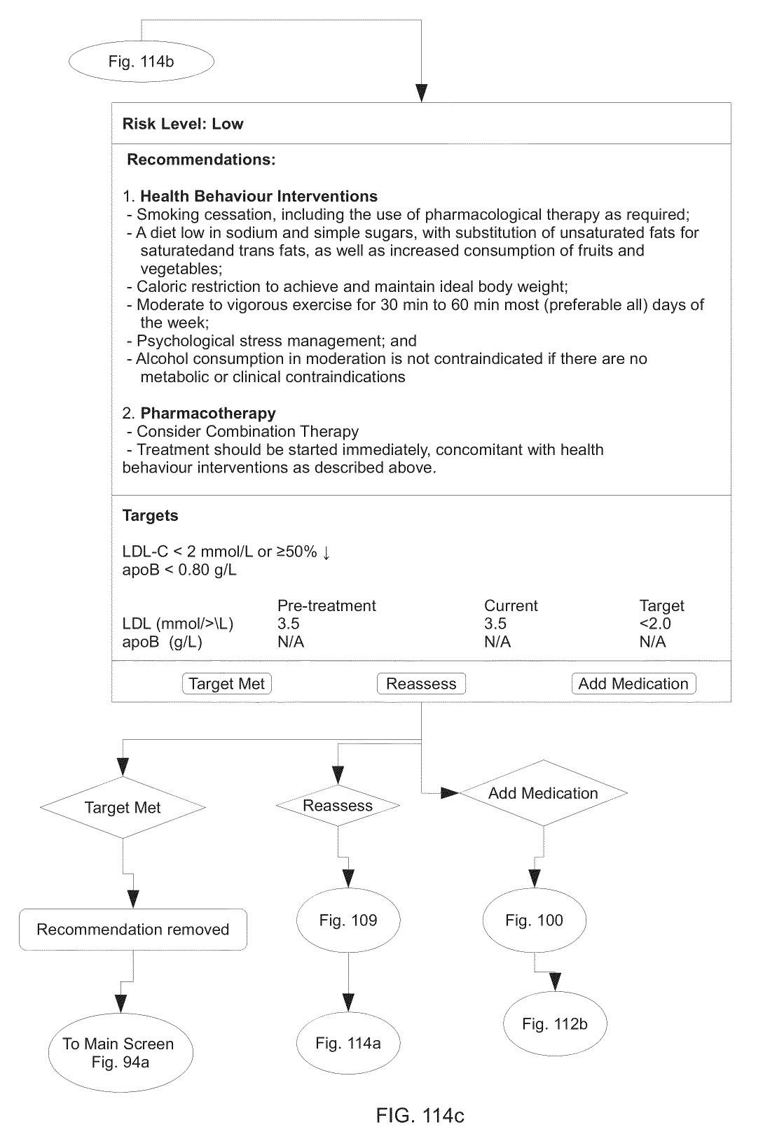

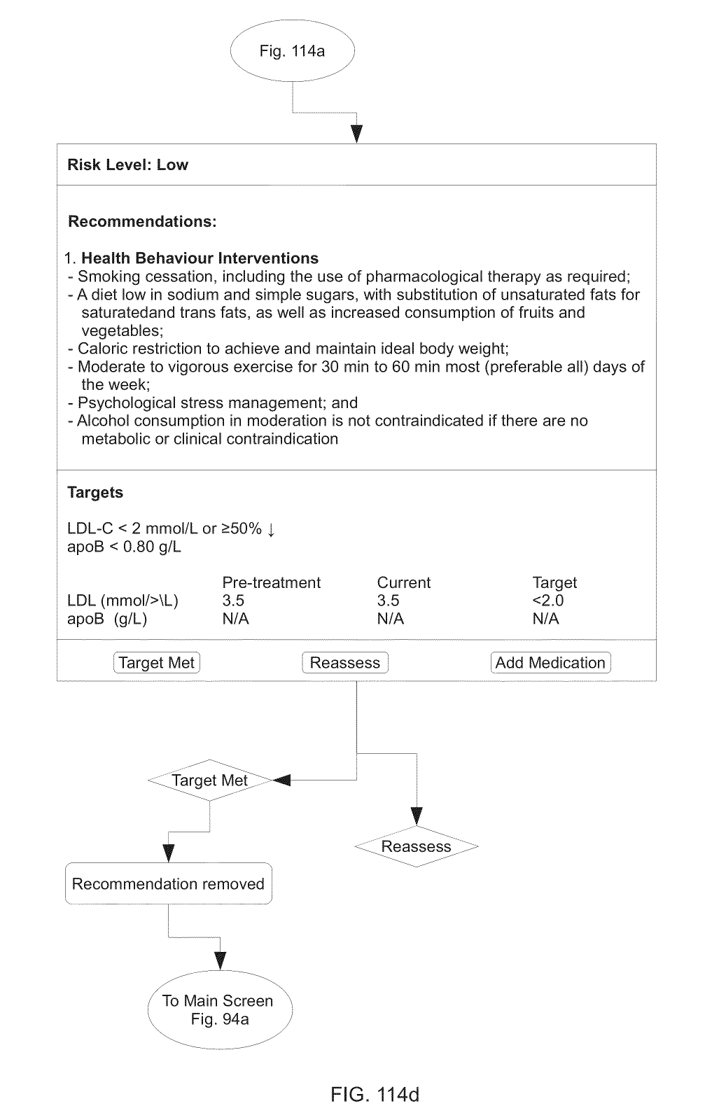

A flowchart showing an overview of an example method for implementation of the dyslipidemia CPGD by the disclosed system is shown in FIGS. 78-93b, with details of the implementation shown in FIGS. 94a-114d. The example method may be used for interactive implementation of the dyslipidemia CPGD where the user is a physician (or other appropriate medical personnel) interacting with an example of the disclosed systems through an example of the disclosed interfaces. This example method may be implemented using the example GUI described below. This example method may be updated and modified as appropriate. In the figures, examples of interface output GUIs are shown which include user options for accepting, rejecting, or requesting reassessment of recommendations, as described elsewhere in the present disclosure. The figures relate to each other, as indicated by references to other “pages”.

Although the example above describes implementation of a dyslipidemia CPGD by the disclosed system, it should be understood that other CPGDs may be implemented by the disclosed system. Algorithms and methods for other CPGDs may vary widely in their content and/or rules implemented in order to generate treatment recommendations.

### Indexing

Indexing of the rules of the CPGDs may be employed in the examples described below under the headings Automatically triggered employment of CPGDs and Routine surveillance. In the case of indexing with respect to Automatically triggered employment of CPGDs, the rules from the various CPGDs that are relevant to the patient are indexed to data input fields such that when data is entered into that field, the instructions from the indexed CPGs are executed. A CPGD may be relevant to the patient if it has been previously implemented for that patient. A CPGD may be relevant to the patient if it is related to a diagnosis on the patient that has been entered by the physician. The data fields may contain data values that are entered by the physician through any interface or by the patient or from the laboratory. The data fields may contain data values that are entered by the physician through the implementation of a CPGD. The data fields may contain data stating the use or non-use of certain medications. The data fields may contain data that is internally updated. The rules that are indexed to a data field may be the conduct of a test using the data that has been inputted into said data field. The rules that are indexed to a data field may be recommendations as described in the CPGDs that depend on the data entered into said field. The recommendations may depend on the outcome of a test using the data inputted into a data field.

In one example, CPGDs may be automatically triggered by input data from the physician. A data field may be populated by a data value that is entered by the physician through implementation of a CPGD or through another interface. In one example, the data field may be blood pressure and a value for blood pressure is entered into the data field by the physician. The test for diagnosis of hypertension from the hypertension CPGD may be indexed to the blood pressure data field. Depending on this result, recommendations from the hypertension CPGD may be presented to the physician. The test for risk stratification from the dyslipidemia CPGD may also be indexed to the blood pressure data field. Depending on this result, recommendations from the dylipidemia CPGD may be presented to the physician.

In one example, CPGDs may be automatically triggered by the output of another CPGD. A data field may be populated by the output of the implementation of a CPGD. In one example, the implementation of the CPGD for diabetes produces a diagnosis of diabetes as an output. The diagnosis of diabetes is entered into the data field which records the presence or absence of diabetes. The input of this data value causes the rules from other CPGDs indexed to that data field to be executed. In one example, the risk calculation in accordance with the indexed rule from the dyslipidemia CPGD is implemented. The risk calculation may result in a change in risk stratification and new recommendations based on the diagnosis of diabetes. The change in risk stratification and resultant recommendations may be presented to the physician.

In one example, CPGDs may be automatically triggered by entry of a prescription by the physician. A data field may contain information about the use or non-use of a particular medication. For each such data field, rules from the CPGDs that pertain to that medication have been indexed. These rules may be a contraindication or a warning against the medication. The concatenation of the medications together with their applicable rules for the appropriate patient may comprise the contraindication list as described previously. In one example, if a patient has diagnosis of asthma, a warning about the use of metoprolol in asthma from the CPGD for asthma would be indexed to the data field for use of metoprolol. If a prescription for metoprolol is entered by the physician, a warning regarding its use for the asthmatic patient in accordance with the CPGD would be displayed to the physician.

In one example, CPGDs may be automatically triggered by input data from the patient or laboratory. A data field may be populated by data that is entered by the patient or lab. In one example, the data field is blood glucose for which a value is entered into the data field by the patient or lab. The test and the recommendations for increase or decrease in insulin dose from the diabetes CPGD is indexed to the blood glucose data field. The recommendations from the diabetes CPGD may be presented to the physician.

In one example, CPGDs may be automatically triggered by a data value that is internally updated. A data field may be populated by data that is internally updated. In one example, the data field is age and the rule for risk stratification from the dyslipidemia CPGD is indexed to this data field. As age changes, the risk calculation in accordance with the indexed rule from the dyslipidemia CPGD is implemented. The risk calculation may result in a change in risk stratification and new recommendations based on this change. The change in risk stratification and resultant recommendations may be presented to the physician.

Indexing pertaining to the examples under the heading Routine surveillance is described in that section.

### Automatically Triggered Employment of CPGDs

Automatically triggered employment of a CPGD by the disclosed systems may occur in various circumstances. For example, multiple CPGDs may be considered on an ongoing basis. If an input value is entered (e.g. glucose values), the system may check all CPGDs as to whether the glucose value is relevant to each CPGD and may present recommendations generated from multiple guidelines based on the received input. The outputs (e.g., diagnoses and recommendations) generated by each CPGD may also be linked to the input of another CPGD. For example, if a diabetes CPGD has determined a diagnosis of diabetes, the system may check all other CPGDs as to whether the presence of diabetes is relevant to each CPGD and may present recommendations generated from multiple guidelines (e.g., in addition to any recommendations already generated by the diabetes CPGD) based on this output from the diabetes CPGD. A CPGD may also be automatically triggered upon a physician entering a prescribed medication, in order to check whether that medication is found in the contraindication list of that CPGD. Data input by a patient/laboratory may also automatically trigger employment of one or more CPGDs for which that data is applicable. The system may also monitor data values relevant to the CPGDs and generate new management recommendations based on spontaneous changes (i.e., not changes entered by a user but internally tracked by the system) in those data values. For example, an increase in age may cause a patient to move into the high risk category for a particular CPGD and may result in generation of a new set of management recommendations. These may be displayed as “New Recommendations” for that particular patient, as discussed further below.

In one example, the physician may enter data into one or more particular data fields in the input interface which may cause the guideline module to automatically apply that data to all applicable CPGDs. For example, one or more data fields may be flagged by the system as being relevant to certain applicable CPGDs. When data is entered in such flagged data field(s), the entered data may be automatically used to perform calculations according to all the applicable CPGDs. In some examples, such automatic implementation of all applicable CPGDs may only occur where the entered data is different from previously stored data and/or where all other data required for the calculations is available.

For example, a data field for inputting the patient's blood pressure value may be linked to the hypertension and dyslipidemia CPGDs as well as others. Input of a new (i.e., different form previously stored data) value for blood pressure may cause the guideline module to automatically recalculate values for both the hypertension and dyslipidemia CPGDs and generate updated recommendations for both if applicable. Recommendations that are generated from such automatically triggered CPGDs may be presented to the physician. The output interface may indicate which recommendations arise from which CPGD. In this manner, a patient may be monitored according to multiple CPGDs simultaneously.

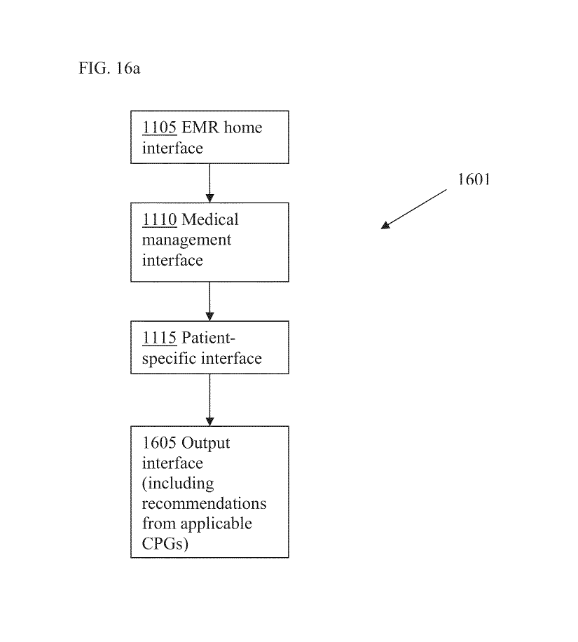

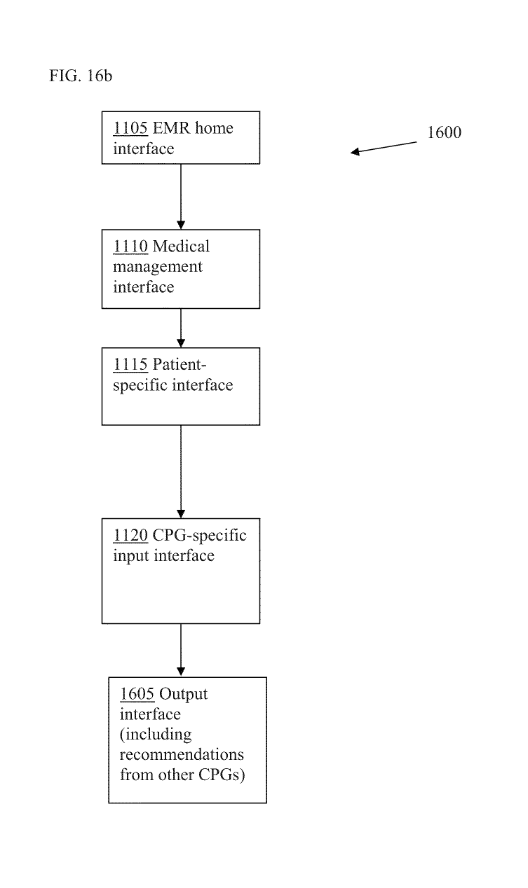

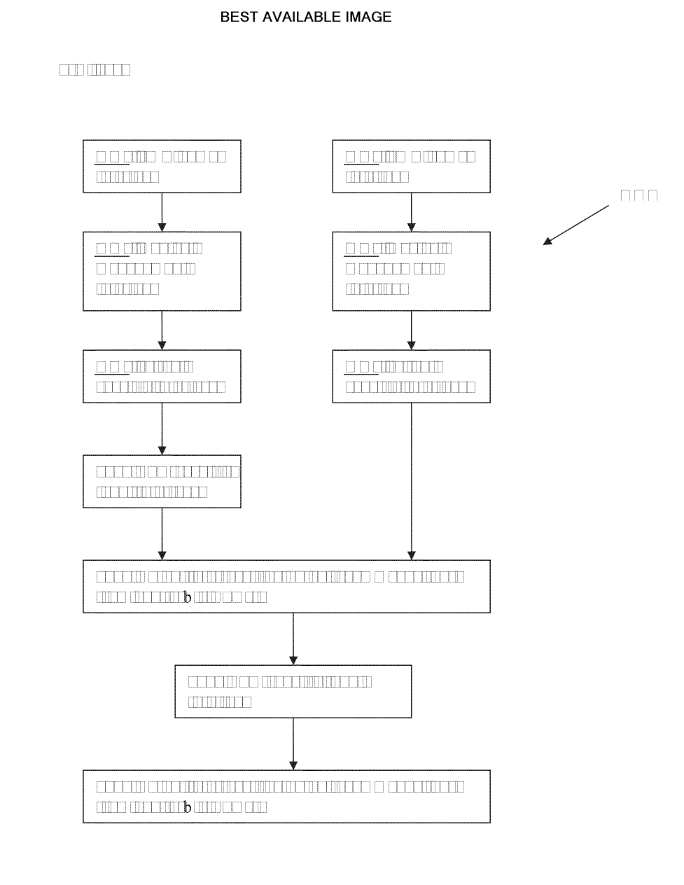

FIG. 16a illustrates an example progression of input/output GUIs that may be presented to a physician in which one or more CPGDs are automatically triggered by entry of data by the physician. In the example 1601, the system may be similar to the system 400, 500, 600 in which some of the interface may be provided by the EMR. The example 1601 may be similar to the example 1100.

The example 1601 may include steps 1105, 1110 and 1115 as described in the example 1100. However, in the example 1601, the system may, upon receipt of input data, automatically use the input data in calculations for all applicable CPGDs.

At 1605, the output interface provided to the physician may include recommendations generated from the automatically triggered CPGD(s).

In one example, the physician may select a particular CPGD to implement and enter data for that CPGD. Entry of data into one or more particular data fields in the input interface may cause the guideline module to automatically apply that data to other applicable CPGDs. For example, one or more data fields may be flagged by the system as being relevant to certain applicable CPGDs. When data is entered in such flagged data field(s), the entered data may be automatically used to perform calculations according to the other applicable CPGDs. In some examples, such automatic implementation of other applicable CPGDs may only occur where the entered data is different from previously stored data and/or where all other data required for the calculations is available.

For example, where the physician has selected implementation of hypertension CPGD and enters a new reading for blood pressure using the input interface for hypertension CPGD, the guideline module may automatically use the new data to perform calculations for the dyslipidemia CPGD in order to generate recommendations according to the dyslipidemia CPGD. Recommendations that are generated from such automatically triggered CPGDs may be presented to the physician in addition to recommendations for the physician-selected CPGD. The output interface may indicate which recommendations arise from which CPGD. In this manner, a patient may be monitored according to multiple CPGDs simultaneously.

FIG. 16b illustrates an example progression of input/output GUIs that may be presented to a physician in which one or more CPGDs are automatically triggered in addition to a physician-selected CPGD. In the example 1600, the system may be similar to the system 400, 500, 600 in which some of the interface may be provided by the EMR. The example 1600 may be similar to the example 1100.

The example 1600 may include steps 1105, 1110, 1115 and 1120 as described in the example 1100. However, in the example 1600, the system may, upon receipt of input data at the CPGD-specific input interface 1120, automatically use the input data in calculations for any other applicable CPGD.

At 1605, the output interface provided to the physician may include recommendations generated for the physician-selected CPGD as well as recommendations generated from the automatically triggered CPGD(s).

In another example, an automatically triggered implementation of a CPGD may occur in response to receipt of data from the patient or from the laboratory. In such a circumstance, implementation of one or more CPGDs may be automatically triggered without selection of any CPGD by a user (typically a physician).

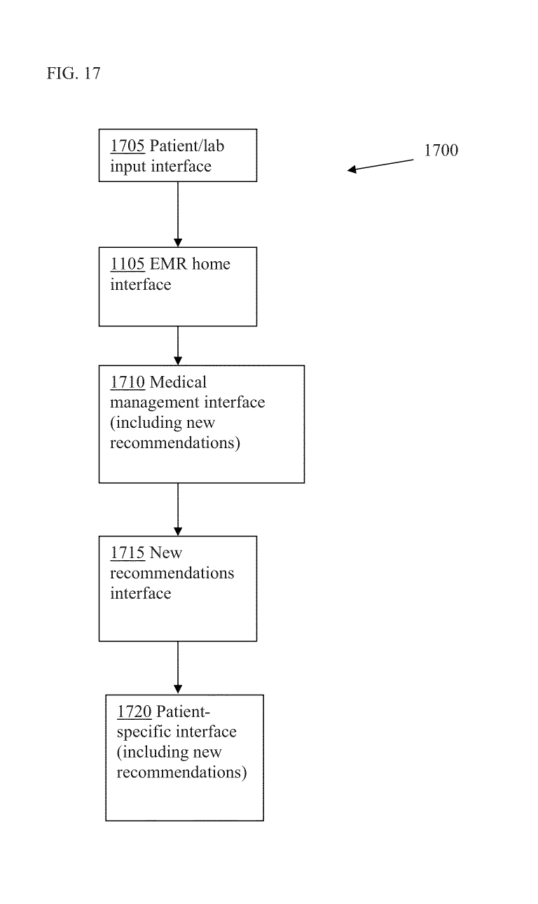

FIG. 17 shows an example progression of input/output GUIs that may be presented to various users in which one or more CPGDs are automatically triggered in response to data received from a patient or from the laboratory. In the example 1700, the system may be similar to the system 400, 500, 600 in which some of the interface may be provided by the EMR. The example 1700 may share commonalities with the exa pies 1100, 1600.m

At 1705, data may be received from the patient or the laboratory via an input interface as described above. The received data may be compared to any previously stored data for that patient in the patient database, where the data is different or new, the patient database may be updated accordingly. Where the data is found to be different or new, the guideline module may be triggered (e.g., via a notification from the patient database) that new data is available. The guideline module may determine any CPGDs that use the updated data and make calculations using the applicable CPGDs. Determination of applicable CPGD(s) may be based on links between the data fields of the input interface and any CPGDs to which those data fields are relevant, as described above. Where new recommendations and/or updated recommendations are generated as a result, such recommendations may be stored in the patient database in association with the respective patient and may be flagged as new.

At 1105, the physician may access the system via the EMR, where the physician is first presented with the EMR home interface. The physician may then select an option to proceed to the medical management interface.

At 1710, the medical management interface may be presented, where, if new recommendations have been automatically generated as described above, the interface may indicate that new recommendations are available for review. This indication may be present where there is at least one recommendation flagged as new in the patient database for the patients for which the physician is responsible. For example, a “New Recommendations” area may be highlighted, bolded, outlined or otherwise indicated to the physician. The “New Recommendations” area may be provided in a “Patient Search Column”, as described elsewhere in the present disclosure. The indication may be designed to attract the attention of the physician to the “New Recommendations” area when the medical management interface is displayed.

There may be an option provided in the interface 1710 for the physician to view all new recommendations for all patients if this option is selected, then at 1715 a new recommendations interface may be presented. The new recommendations interface may list all new recommendations generated by the system since the physician's last interaction with the system. These new recommendations may be retrieved from the patient database by retrieving all recommendations flagged as new in the patient database for all patients that are the responsibility of the physician. The new recommendations interface may group new recommendations by patient, allowing the physician to review the new recommendations patient by patient. The physician may be provided with options to confirm or reject each new recommendation. Once a new recommendation has been confirmed by the physician, that recommendation may no longer be flagged as new and may continue to be stored in association with the respective patient. If a new recommendation is rejected by the physician, that recommendation may be discarded from the patient database.

Alternatively or in addition, there may be an option provided in the interface 1710 for the physician to proceed to a patient-specific interface. If this option is selected, then at 1720 a patient-specific interface may be presented in which any new recommendations may be indicated (e.g., by highlight, outline, bold or any other method to draw the physician's attention). The new recommendations may be retrieved from the patient database by retrieving all recommendations flagged as new for the selected patient. The physician may be provided with options to confirm or reject each new recommendation. Once a new recommendation has been confirmed by the physician, that recommendation may no longer be flagged as new and may continue to be stored in association with the respective patient. If a new recommendation is rejected by the physician, that recommendation may be discarded from the patient database.

In another example, a triggered implementation of a CPGD may occur due to the linking of the diagnoses, conclusions and other outputs arrived at by the implementation of a first CPGD to the input of a second (or more) CPGD. This linking may be carried out by the system repeatedly comparing a diagnosis, conclusion or other output from a particular CPGD against all the inputs data fields of all the other CPGDs in the system. The output may then be provided into the matching data inputs of the applicable other CPGDs to implement those CPGDs, and any additional generated recommendations may be provided to the user. This linking may also be carried out by the system tagging or otherwise identifying all outputs from a first CPGD that may serve as input to a second (or more) CPGD. This may allow the system to determine if there is any data input field corresponding to the output from the first CPGD. If there is a second (or more) CPGD with data input fields matching the output of the first CPGD, the second (or more) CPGD may be implemented as described above. For example, the diagnosis of hypertension may be an input into the determination of risk level in the dyslipidemia CPGD. If a diagnosis of hypertension is arrived at by implementation of the hypertension CPGD, that output may be automatically fed as input into the dyslipidemia CPGD and any other CPGDs for which the diagnosis of hypertension is relevant as an input. Any recommendations that are produced from the relevant CPGDs as the result of this input may be provided to the physician as new recommendations and may be presented in an easily viewable manner. This method of triggered callup of a guideline is presented in the following FIG. 16C.

FIG. 16C illustrates an example progression of input/output GUIs that may be presented to a physician in which one or more CPGDs are automatically triggered by outputs from a first CPGD. In the example 1600c, the system may be similar to the system 400, 500, 600 in which some of the interface may be provided by the EMR. The example 1600c may be similar to the example 1100.

The example 1600c may include steps 1105, 1110, 1115 and 1120 as described in the example 1100. However, in the example 1600c, the system may, upon receipt of output data at step 1605, automatically apply that data to one or more applicable CPGDs at step 1608 to produce output at step 1609.

At 1609, the output interface provided to the physician may include recommendations generated from the automatically triggered CPGD(s).

In another example, a triggered callup of a guideline may occur as a result of the physician inputting a prescription of a medication which is contraindicated or strongly advised against for that patient according to other CPGDs (e.g., as listed in the contraindication lists of the other CPGDs). For example, the use of certain medications on a patient may be contraindicated or strongly advised against because of coexisting conditions.

An example is the contraindication of beta-blockers in patients with asthma. As the physician utilizes CPGDs for various conditions of the patient, the system may keep a record of all recommendations that include contraindications or advisories against various medications. This record may be stored in the contraindication list. This record may be associated with the patient and may be presented to the physician as part of the cumulative patient profile. Upon the physician inputting prescription of a medication, the contraindication module may work in conjunction with the patient manager and CPGD Database to compare then newly prescribed medication to the medications on the contraindication list and may generate a warning to the physician if the medication newly prescribed corresponds to an entry on the list.

A medication may also be contraindicated or strongly advised against due to a possibility of adverse drug-drug interactions with one or more medications being consumed by the patient.

An example of such an interaction is the antibiotic co-trimoxazole and the oral hypoglycemic glyburide. Co-trimoxazole typically decreases metabolism of glyburide causing its increased blood levels, resulting in potentially dangerous lowering of blood sugar levels. The system may automatically provide any medication that is prescribed by the physician as an input to the drug interaction CPGD. The drug interaction CPGD may then determine any adverse drug-drug interactions with current medications taken by the patient and if any adverse drug-drug interactions are present may generate a recommendation (e.g., a recommendation to avoid the particular medication and/or a recommendation to use another medication) to the physician accordingly. This method of triggered callup of a guideline is presented in FIG. 16A as discussed previously.

In another example, a triggered call-up of a guideline may occur in response to a data value for a patient changing spontaneously (i.e., an update or change that may be internally generated, without receiving external input of such change from a user or an external device). Such internally updated data include, for example, an update of a patient's age when the patient's next birthday is passed. Such internal updates may take place due to the system automatically keeping track of time, weather or other such general conditions.

For a given patient, the system may keep track of all recommendations that are present in CPGDs applicable to the patient, that depend on a changing data value in patient data related to the patient. Any data values that may trigger a new recommendation, as well as the recommendations that may be triggered by a change in the data value, may be indexed in order of the expected data values by the CPGD monitor into the monitoring list. The CPGD monitor may work in conjunction with the patient manager to associate each expected upcoming recommendation with the appropriate patient. As the value for the data value is updated, the value may be matched against the entries on the indexed list. When a match is found, the corresponding new recommendation may be generated for the appropriate patient. Such new recommendations may be provided to the physician in a manner similar to interfaces 1710, 1715 and 1720 described above.

If a new recommendation is generated, it may be presented (e.g., in a manner that easily and clearly identifies the recommendation as a new recommendation) to the physician a new recommendation. An example of such a changing data value may be patient age. As age increases, new recommendations may be produced based upon the rules of one or more CPGDs. For example, an increase in age may cause a patient to move into the high risk category for a particular CPGD and may result in a new set of management recommendations. These may be displayed as new recommendations for that particular patient.

Another example may be the case of a recommendation for the management of a patient that may be repeated on a routine basis. In this case, the changing data value may be the time since the last execution of the routine management recommendation. The system may store all patients requiring the same routine management in the monitoring list of a particular CPGD and may index the entries based on the time until the required routine management is required. The CPGD monitor may work in conjunction with the patient manager to generate recommendations and/or notifications for the appropriate patient at some time in advance of the due date for the routine management. The amount of advance notice provided to the physician may be adjustable (e.g., by the physician). An example may be immunization for pneumococcus which may need to be repeated on an annual basis for patients with COPD. The system may monitor the time interval since the last immunization for all patients requiring such regular immunization. Entries including this time interval along with the recommendation for re-immunization may be stored in the monitoring list for all applicable patients. These entries may be indexed based on the time interval to the next immunization. The generation of a recommendation and/or notification to call the patient for the immunization may be triggered at some time period in advance of their required immunization (which time period may be selectable by the physician).

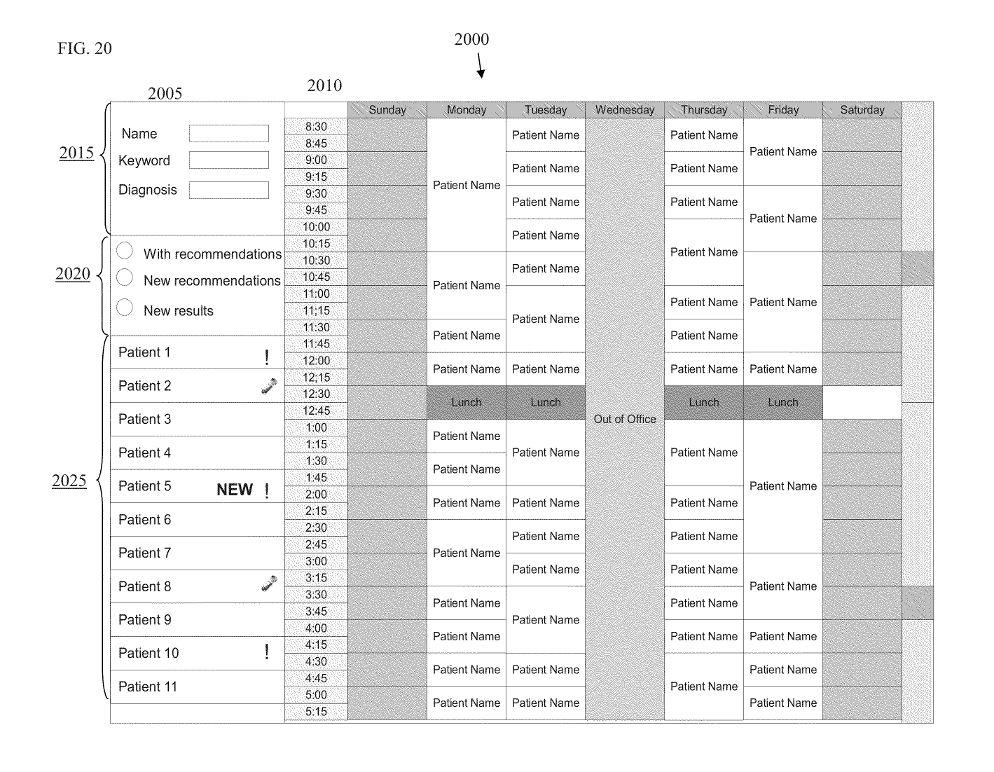

In an example patient-specific interface, such as the GUI shown in FIGS. 20-32, all recommendations generated by the system, whether old or new, may be displayed on the lower half of the screen, to the right of a “Patient Search Column”. Any new recommendations may be displayed with more prominence (e.g., at the top of the list, in text of a different color, highlighted, bolded and/or outlined). In the list, recommendations may be displayed in a summary format as opposed to the full format that may be displayed when a physician selects implementation of a particular CPGD. This summary format may help to increase the number of recommendations that may be displayed without scrolling. The physician may select (e.g., by a mouse click) a particular recommendation for further viewing. In response to such a selection, the summary format for the selected recommendation may expand to the full format for that recommendation.

The various methods of triggered call-up of CPGDs described above may work in concert with each other. For example, FIG. 35A shows an example where two types of triggered call-ups are used together: applying a single input to multiple CPGDs, and using the output of one CPGD as the input of another CPGD. As described previously, the CPGD scheduler may set the order of CPGD implementation for each patient and may resolve any conflicts that arise when two or more inputs are presented to a CPGD.

### Automatically Triggered Call-Up of Tools

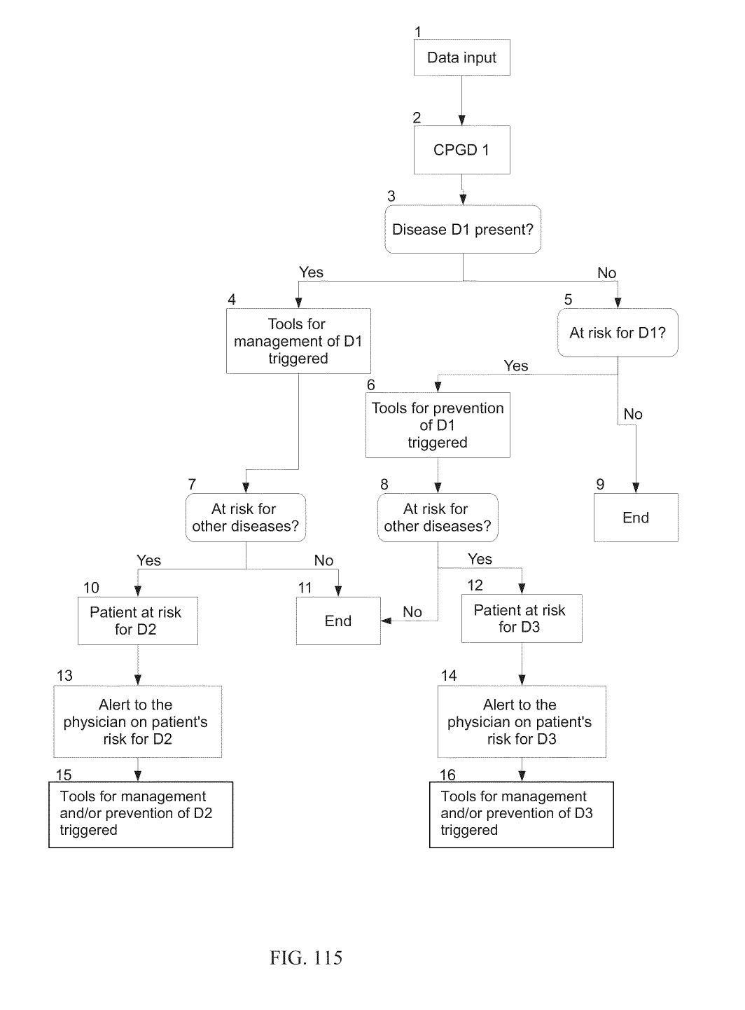

In some examples, the system may also implement triggered (e.g., automatically triggered) call-up of one or more tools that may be used by the system and/or the user for the management and prevention of disease. An example of this method of triggered call-up of tools is illustrated in FIG. 115. Box 1 represents data inputted by various means including, for example, input by the physician (e.g., via a keyboard), input from a laboratory, input from a patient, input by the system from another CPGD as well as other sources. The inputted data in this example is relevant to CPGD 1 and therefore may be entered by the system into CPGD 1 as represented by Box 2.

The inputted data is used, as shown in Box 3, to answer the question as to whether disease D1, which corresponds to CPGD 1, is present. This may be achieved by the implementation of the rules in CPGD 1. In the case in which D1 is present, along with appropriate recommendations derived from implementation of the rules in CPGD1 being presented to the physician, one or more relevant tools for the management of D1 may be automatically triggered and presented to the physician. This is illustrated in Box 4.

Subsequently, an evaluation may be further carried out by the system as to whether the diagnosis of D1 puts the patient at risk for other diseases. This is illustrated in Box 7. This evaluation may be performed by the implementation of the rules in CPGD 1, for example, which may state the disease(s) that a patient with a diagnosis of D1 may be at risk for. In some examples, the evaluation illustrated in Box 7 may be performed by the system inputting the diagnosis of D1 into one or more other relevant CPGDs which have the diagnosis of D1 as a data input. The implementation of the rules of these relevant CPGD(s) may lead to a determination that the patient is at risk for one or more of the diseases corresponding to those CPGD(s).

Box 10 illustrates a case in which the patient is at risk for another disease, in this example labeled D2. In this case, a notification may be generated to alert the physician that the patient is at risk for D2 as illustrated in Box 13.

One or more tools that may be useful for the management and/or prevention of D2 may automatically be triggered and called up (e.g., presented on a display) for the physician as illustrated in Box 15.

If the evaluation as illustrated in Box 7 determines that the patient is not at risk for other diseases, the method may conclude at this point. This is illustrated in Box 11.

If, at Box 3, it is determined that disease D1 is not present, then an assessment may be made by the system as to whether the patient is at risk for D1 as illustrated in Box 5. This may be achieved by the implementation of the rule(s) in CPGD 1, for example.

In the case in which the patient is not at risk for D1, output (e.g., a notification on a user interface) may be generated to inform the physician appropriately and the method may be concluded as illustrated in Box 9.

In the case in which the patient is at risk for D1, one or more relevant tools for the prevention of D1 may be automatically triggered and presented to the physician. This is illustrated in Box 6.

Subsequently, a determination may be performed by the system as to whether the patient being at risk of D1 puts the patient at risk for other diseases. This is illustrated in Box 8. This evaluation can be performed by the implementation of the rule(s) in CPGD 1, for example, which may state the disease(s) that the patient, who is at risk for D1, may be at risk for. In some examples, the evaluation illustrated in Box 8 may be carried out by inputting indication that the patient is at risk for D1 into one or more other relevant CPGDs which have the risk for D1 as a data input. The implementation of the rules of these relevant CPGD(s) lead to a determination that the patient is at risk for one or more of the diseases corresponding to those CPGDs.

Box 12 illustrates the circumstance in which the patient is at risk for another disease, in this example labeled D3. In this case, a notification may be generated to alert the physician that the patient is at risk for D3 as illustrated in Box 14.

One or more tools that may be useful for the management and/or prevention of D3 may automatically be triggered and called up (e.g., presented on a display) for the physician as illustrated in Box 16.

If the evaluation as illustrated in Box 8 determines that the patient is not at risk for other diseases, the method may conclude at this point. This is illustrated in Box 11.

For example, if input values are entered (e.g. height, weight, waist circumference), the system may use these values as input into a relevant CPGD (e.g., for obesity) which in this example may correspond to CPGD1 displayed in Box 2 of FIG. 115. By implementing the rule(s) of the CPGD for obesity, the system may produce a recommendation that the patient is obese, answering the question displayed in Box 3 of FIG. 115. Tool(s) for the management of the patient's obesity may be automatically triggered and called up for the physician as illustrated in Box 4 of FIG. 115. The system may perform the evaluation as to whether there is increased risk for other diseases as a result of the obesity diagnosis, as described in Box 7, by implementation of the rule(s) of the CPGD for obesity as well as other relevant CPGD(s), for example including the CPGD for diabetes. The system may determine that the patient is at increased risk for diabetes, which may correspond to D2 in Box 10. An alert of the increased risk of diabetes, as shown in Box 13, may be presented to the physician (e.g., via a displayed user interface). This may trigger an automatic call-up of tool(s) for weight loss and exercise, as shown in Box 15, which the physician may employ to aid the patient in the prevention of diabetes.

The example methods of triggered call-up of tools described above may work in concert with the various example methods of triggered employment of CPGDs disclosed. In examples of triggered employment of CPGDs, there may be a source of new data that may be automatically inputted into one or more applicable CPGDs by the system, with the system implementing the rules of the applicable CPGD(s) and, if applicable, producing recommendation(s) to the physician. Example methods of triggered employment of CPGD may serve as a source of the data input, for example as illustrated in Box 1 of FIG. 115. The CPGD that has been thus triggered may be represented as CPGD 1 in Box 2.

An example is the instance in which the output of a first CPGD, such as a diagnosis of the disease relevant to the first CPGD, may be automatically provided by the system as input to a second CPGD and therefore may trigger the employment of the second CPGD. This action may work in concert with an automatic triggered call-up of tool(s), as the first CPGD may serve as the source of data input as illustrated in Box 1 of FIG. 115. The data input may be the diagnosis of a disease relevant to the first CPGD, for example. The second CPGD that is triggered may be CPGD 1 as illustrated in Box 2 of FIG. 115.

Another example is the instance in which the system automatically inputs new data into multiple relevant CPGDs. In this example, multiple relevant CPGDs may be automatically triggered by the system. In this case, the new data may be represented by Box 1 in FIG. 115 and any of the multiple CPGDs which are triggered, to which data has been automatically inputted by the system, may be represented by CPGD 1 in Box 2 of FIG. 115.

In other examples, new data from patient input, laboratory input, contraindications to medications and/or spontaneously changing data values pertaining to the patient may constitute data input as illustrated in Box 1 of FIG. 115 with the resulting triggered CPGD(s) being represented as CPGD 1 in Box 2 of FIG. 115.

### Routine Surveillance

In some examples, the system may automatically generate notifications requesting input of new or updated data. These notifications may be provided via appropriate output interfaces to the appropriate user. For example, a physician may be provided with notification to schedule patient visits or assessments when the physician accesses the system. The interface may also generate communications (e.g., email, SMS, text or voice messages) to the appropriate devices used by various users. For example, a patient may be provided with an automated voice message reminder to schedule an assessment.

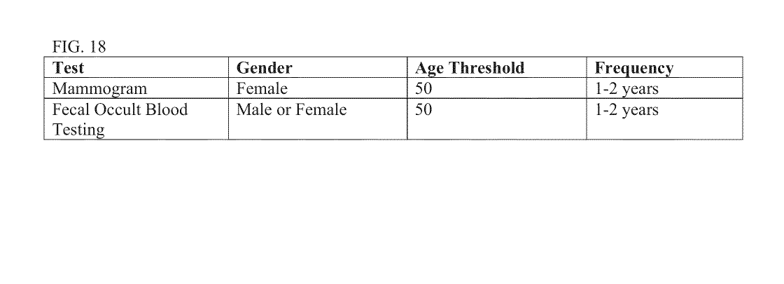

Such automatic notifications may be generated based on general CPGs that are universal for all patients, for example based on gender and/or age. These notifications may be generated once a patient reaches a certain age threshold and at a set frequency. For example, tests such as fecal occult blood testing and mammograms may be required for all patients of a certain gender and/or age. FIG. 18 is a table illustrating an example of guidelines implemented by the system to determine the frequency of data updates required for mammograms and fecal occult blood testing.

The time interval until the next routine test is due may be a changing data value (e.g., an internally updated value, without requiring external input). The data values that may trigger a new recommendation for a routine test, along with the recommendations that may be triggered, may be indexed in order of the data values by the CPGD monitor into the monitoring list. For example, a data value may be the time interval until a mammogram is required for a particular patient. The CPGD monitor may work in conjunction with the patient manager to associate each expected upcoming recommendation with the appropriate patient. As the data value is updated, it may be matched against entries on the indexed list. When a match is found, the corresponding new recommendations may be generated for the appropriate patient. If a new recommendation is produced, it may be presented (e.g., made clearly viewable) to the physician as a new recommendation.

The guidelines for all such routine testing may be particular instances of CPGs that may be referred to as surveillance guidelines. The system may review the data of all patients daily and may compare such data (e.g., age and/or gender) against the surveillance guidelines. Where the surveillance guidelines indicate that updated data for a particular patient is required (e.g., new test results or investigation is required, or a previously-performed test or investigation requires updating), the system may generate appropriate notifications to the appropriate user (e.g., physician and/or the patient) to provide updated data. Where such notifications are not immediately provided to the user (e.g., notifications may be only provided when the user next accesses the system), such notifications may be stored as a new recommendation for the respective patient and flagged as new, to be provided at the next possible opportunity.

Such notification may be provided to the physician as an indication of a new recommendation. Similar to the example 1700 described above, the physician may navigate to the medical management interface where “New Recommendations” may be indicated.

The physician may view the new recommendations for all patients or for a selected patient, as described above. The requirement for updated data may be indicated as a new recommendation for the respective patient. Until an update for that data has been received in the system, the recommendation for updated data may remain for that patient unless the physician rejects the recommendation (e.g., by selecting a “Reject” option for that recommendation).

If the physician accepts the recommendation for data update (e.g., by selecting an “Accept” option for that recommendation), the system may automatically generate a notification (e.g., an email, SMS, text or voice message) to the physician's assistant to schedule an assessment with the patient. Alternatively, the system may automatically generate the notification to the patient to schedule an assessment. This may be used to schedule routine surveillance of a patient, for example for general routine surveillance (e.g., annual physical examination) and/or CPG-specification routine surveillance (e.g., as required by the rules of one or more CPGD).

Once an update for a particular data has been received, the requirement for that particular data may be removed for that patient. Any updated data for a patient may be flagged as new data and stored in the patient database in association with that patient. The patient database may include old and new data for the patient, including old and new test results. Test results may include, for example, results of blood tests, x-rays, ultrasounds and consultants' reports, among others.

The physician may be provided with an option to enter a time interval for the next update of that data and/or to use the routine time interval as defined in the surveillance guidelines. The next notification for an update of that data may be generated when the specified time interval has passed.

In some examples, the notification of requirement for updated data may be generated in advance of the actual time for the required update. This may provide an advanced notification to allow the physician and/or patient enough time to schedule and obtain the necessary assessments for the data update. The advanced notification may further provide information indicating the actual date by which the update is required. In some examples, the physician may be provided with an option to select the amount of time in advance to generate an advanced notification.

In some examples, a surveillance schedule may be patient-specific, for example based on particular diagnoses and/or CPGDs applicable to the patient. For example, one or more CPGDs may include rules that require update of data at predefined time intervals.

For example, if a diagnosis of diabetes for a particular patient has been determined through implementation of the diabetes CPGD, the diabetes CPGD may further recommend that the HbA1c data be updated every 3 months when control is not well established and every 6 months when control is established. Thus, implementation of the diabetes CPGD for this patient may cause the system to generate notifications for HbA1c data update every 3 or 6 months, as appropriate.

The data values that may trigger a new recommendation for a follow-up assessment, along with the recommendations that may be triggered, may be indexed in order of the data values by the CPG monitor into the monitoring list of the diabetes CPGD. In the example above, the data value may be the time interval until the next HbA1C is required. The CPG monitor may work in conjunction with the patient manager to associate each expected upcoming recommendation with the appropriate patient. As the data value is changed, it may be matched against the entries on the indexed list. When a match is found, the corresponding new recommendations may be generated for the appropriate patient. If a new recommendation is generated, it may be presented (e.g., made clearly viewable) to the physician as a new recommendation.

As a further example, the implementation of the diabetes CPGD may require that a patient be seen by one or more specialists at specific time intervals. Such recommendations for consultations may be stored and presented to the physician (e.g., in an easily viewable manner) as new recommendations.

In some examples, a CPGD applicable to a patient may require routine updates upon satisfaction of some other criteria, for example a spontaneously or inherently changing data value (e.g., patient data that may be internally tracked by the system, without the patient undergoing any testing or investigation), such as the patient reaching an age threshold. As age increases, new recommendations for follow-up assessments may be produced based upon the rules of one or more CPGDs.

Notifications of required updates may be provided to the physician and/or the user as described above. For example, in the case of routine management measures (e.g. immunization) the system may generate an alert to the physician and may produce a list of patients which require immunization based on CPGD recommendations. An example of this may be the diagnosis of COPD in a patient, which may require that the patient be called in for influenza and pneumococcus vaccine.

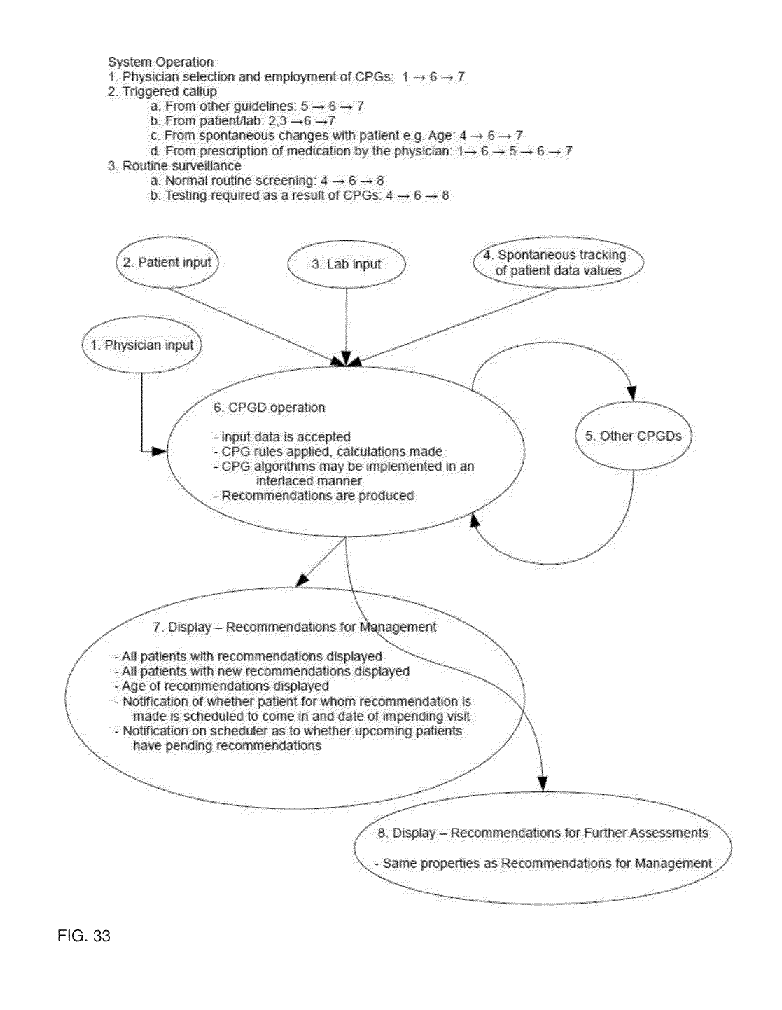

FIG. 33 illustrates an example overview of operation of the disclosed methods and systems for manual selection and employment of CPGDs; automatically triggered employment of CPGDs; and routine surveillance.

Input from the physician (1), patient (2), laboratory (3) and/or internally generated data (4) may be used as input for implementation of CPGDs.

For implementation of CPGDs (6), rules of an applicable CPGD are applied to the data and any suitable calculations are made. Recommendations are generated according to the applicable CPGD. Similarly, one or more other CPGDs may be implemented (5) (e.g., automatically triggered and/or interlaced, as described elsewhere in this disclosure).

Generated recommendations for patient management may be displayed (7). This may include, for example, display of all patients with existing and/or new recommendations, display of the age of each recommendation, generation of notification whether the patient associated with a recommendation is scheduled for a physician visit and if so the date of the visit, and notification (e.g., on a physician scheduler) whether a patient scheduled for an upcoming physician visit has any associated pending recommendation.

Generated recommendations for further assessments may also be displayed (8). This may be similar to the display of generated recommendations for patient management described above.

In an example of manual selection and employment of CPGDs, the method may follow the steps 1 to 6 to 7.

In an example of automatically triggered employment of CPGDs, the method may follow: the steps 5 to 6 to 7 where employment of the CPGD is triggered from implementation of another CPGD; the steps 2 and/or 3 to 6 to 7 where employment of the CPGD is triggered from patient and/or laboratory input; the steps 4 to 6 to 7 where employment of the CPGD is triggered from internally generated data; and the steps 1 to 6 to 5 to 6 to 7 where employment of a CPGD is triggered input of a prescribed medication by the physician.

In an example of routine surveillance, the method may follow: the steps 4 to 8 in the case of routine screening; and the steps 4 to 6 to 8 in the case of testing carried out as a result of a CPGD.

### Example Recommendations

Examples of recommendations that may be generated and provided by the disclosed methods and systems include treatment with various medications. For example, recommendations for a patient diagnosed with hypertension may include treatment with various anti-hypertensive medications including, for example, ACE inhibitors (e.g., lisinopril, ramipril or enalapril), beta blockers (e.g., metoprolol or atenolol), calcium channel blockers (e.g., nifidepine, verapamil or diltiazem), diuretics (e.g., hydrochlorthiazide or chlorthalidone) and/or angiotensin receptor blockers (e.g., valsartan, telmisartan or olmesartan), among others.

For a patient diagnosed with hypertension, the recommendations may also include treatment with any suitable anti-hypertensive drug, a particular class of drug or with a specific drug (which may be indicated by generic and/or proprietary drug name). The recommendations may also include a list of all the drugs that may be appropriate for the physician to consider in light of the patient's diagnosis.

In some examples, the drug database may be organized as individual drugs belonging to various drug classes. All recommendations for pharmacotherapy may identify the individual drug names and/or an entire drug class. The information for either the individual drugs and/or all the drugs in a class may be presented to the physician (e.g., in an easily viewable manner) in order that the physician may prescribe the appropriate drug.

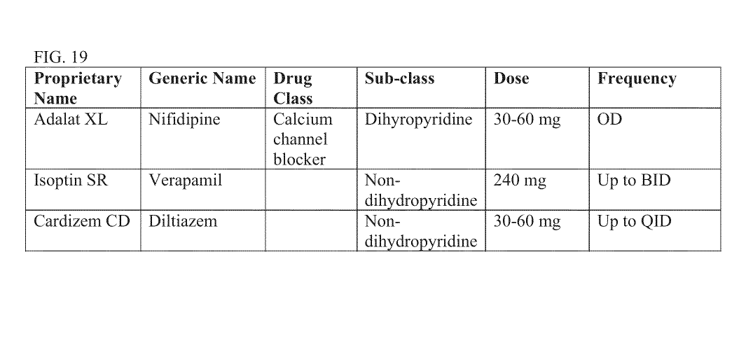

For example, if a recommendation is that the patient should be treated with a calcium channel blocker for hypertension, the recommendation may further include a list of all medications that are considered to be a calcium channel blocker. Such a recommendation may be provided to the physician as a table of suitable drugs, for example as shown in FIG. 19. The example of FIG. 19 is illustrative only and the list of recommended drugs may not be as shown.

The list of recommended drugs may be determined by the system by querying the drug database. The drug database may include information on drugs that may be relevant to the CPGDs implemented in the system. The guideline module may query the drug database in order to include appropriate drugs in the generated recommendations. Communication between the guideline module and the drug database may be as indicated in the systems 100, 300, 400, 500, 600.

In some examples, the drug database may store information about appropriate drugs including associated drug information such as drug indication and drug class. Such associated drug information may be used by the guideline module to determine appropriate drugs to include in a recommendation. For example, a generated recommendation may include one or more tags based on the condition being treated and/or the specific content of the recommendations. Such tags may be matched against drug information in the drug database to identify appropriate drugs to include in the generated recommendation. For example, implementation of the hypertension CPGD may generate a recommendation to treat the patient using an ACE Inhibitor, and may include a tag “Hypertension” for drug indication and a tag “ACE Inhibitor” for drug class. Such tags may be used to query the drug database to determine all drugs having drug indication and drug class matching those tags. In some examples, such tags may not be used, to avoid making such information accessible to other CPGDs. The determined drugs (and optionally additional information related to those drugs) may be included in the generated recommendation.

The recommended list of drugs may be provided within the same or as a separate recommendation. For example, a recommendation may be provided to the physician that a certain type of drug is recommended for a patient. The physician may be provided with an option to further view the list of drugs determined to be suitable.

In addition to listing the specific drugs that may be suitable, the recommendations may further include dosing information for each drug. Such dosing information may be determined based on drug information stored in the drug database, in combination with rules from the appropriate CPGD.

The inclusion of drug information in the system may allow the physician to be provided with information about appropriate drugs for treating the patient, and may thus reduce or eliminate the need for the physician to consult a separate drug reference to determine that information. This may help to increase the efficiency of the physician and/or enhance the quality of care for the patient.

### Reference to Static CPG Documents

In some examples, the system may store, as references, true reproductions for the sources of the implemented CPGDs. These references may be accessible by a user (typically a physician) in the event that the user wishes to consult the actual text of the guidelines. In some examples, a CPGD-specific input interface may include an option (e.g., a clickable link) for viewing a reference of the corresponding CPG. In some examples, recommendations generated for a particular CPGD may include an option (e.g., a clickable link) for viewing the reference CPG for the particular CPGD (e.g., to allow a physician to verify that the recommendations are in agreement with the reference CPG.

### Update of Clinical Practice Guidelines

At times, CPGs may undergo revisions as determined by the appropriate medical professional societies. The updates to the previous CPG revision may be made available to the physician through USB memory stick, CD, DVD, via online access or other suitable methods. The updates may result in appropriate changes to the rules of one or more CPGDs related to that CPG. Once the CPG has been revised, the system may update the rules of all related CPGDs to comply with the new revised CPG, and may apply all updated rules to all current recommendations for all patients. Any changes to existing recommendations as a result of the revised CPG(s) may be presented to the physician (e.g., displayed as new recommendations and made clearly viewable to the physician).

### Example Interface

Examples of input/output GUIs that may be provided to a physician are now described. These examples may be suitable as medical management interfaces, CPGD-specific input interfaces, patient-specific input interfaces and new recommendation interfaces, as appropriate. Some or all of these interfaces may be provided by the disclosed methods and systems, for example via the interface module and/or the communication interface.

In the example GUIs, the physician may be provided with options to select a patient (e.g., using various search methods), to view current recommendations with regards to a patient, to select a CPGD for medical management of the patient and to employ the selected CPGD to generate new recommendations for the patient.

As will be described further below, the GUI may allow the system to present the user (e.g., a physician) with a list of all patients with recommendations pending. For each patient, the system may produce a list of all recommendations pending. In this manner, the physician may be provided with a means to view all CPGD-generated recommendations for all the patients associated with the physician.

The system may also generate a list of all patients with new recommendations pending. For each patient, the system may also produce a list of all new recommendations pending. In the GUI, the new recommendations may be differentiated from any previous recommendation by being displayed at the top of the list and/or by being displayed in a different color, for example. In this manner, the physician may be provided with a means to view all CPGD-generated new recommendations for all the patients associated with the physician.

The GUI may provide options to allow the physician to remove any recommendations (e.g., by clicking on a button in the GUI), which may indicate the fulfillment of the recommendation.

The system may track and present to the physician all of the consultations that may required for the patient, as recommended by the CPGs.

The GUI may display recommendations generated as a result of the implementation of CPGDs. The system may tag or otherwise appropriately identify any patients who have one or more recommendations associated with them, and may display this accordingly. The system may create and update a list of all patients with recommendations pending, including removing patients who have had their last recommendation removed by the physician. The system may present a list of all patients with recommendations pending, in response to an input selecting a “With Recommendations” option presented by the GUI. The physician may then review that list and select, using options presented by the GUI, any patients who have recommendations pending.

The GUI may present new recommendations in a clear and easily viewable manner. The system may generate recommendations for patients as a result of the implementation of CPGDs. The newly generated recommendation may be identified as a new recommendation. The system may tag or otherwise appropriately identify any patients who have new recommendations associated with them. At the next instance when the physician opens the new recommendation window in the GUI, the system may remove the identification or tag that the particular opened recommendation is new.

The system may create and update a list of all patients with new recommendations pending, including the removal of any patients who have had a new recommendation removed by system in response to the physician opening the new recommendation in the GUI. The system may generate a list of all patients with new recommendations pending, in response to an input from the physician selecting a “With NEW Recommendations” option in the GUI. The physician may then review that list and, using options presented by the GUI, may select any patients who have new recommendations pending.

FIG. 20 shows an example GUI 2000 providing medical management interface for a physician.

The GUI 2000 may include a Patient Search Column 2005 (in this example displayed on the left hand side) providing options for searching by patient.

The GUI 2000 may include other information in the rest of the display. In the example shown, the area to the right of the Patient Search Column 2005 provides a schedule 2010 for the physician, including indication of patients that are booked to see the physician. The physician may select a patient using options provided in the Patient Search Column 2005 or by selecting a patient from the schedule 2010, for example.

The Patient Search Column 2005 in this example includes three sections. One section (displayed at the top in this example) is search section 2015 providing searchable fields (e.g., patient name, keyword and diagnosis) for searching for patients. Another section (displayed in the middle in this example) is a filter section 2020 providing options for filtering patients (e.g., according to patients with recommendations, patients with new recommendations and patients with new results). Another section (displayed at the bottom in this example) is a patient list 2025 providing a selectable list of all patients for which the physician is responsible.

In the example patient list 2025, icons may be shown next to patients with recommendations (e.g., an exclamation mark), patients with new recommendations (e.g., a “NEW” icon) and patients with new test results (e.g., a test tube icon). It should be understood that other icons or indications (e.g., text color, underline, highlight, bolding or outline) may be used to indicate those patients with recommendations, new recommendations or new test results. Determination of which patients have recommendations, new recommendations or new test results may be based on information retrieved from the patient database, for example as described above.

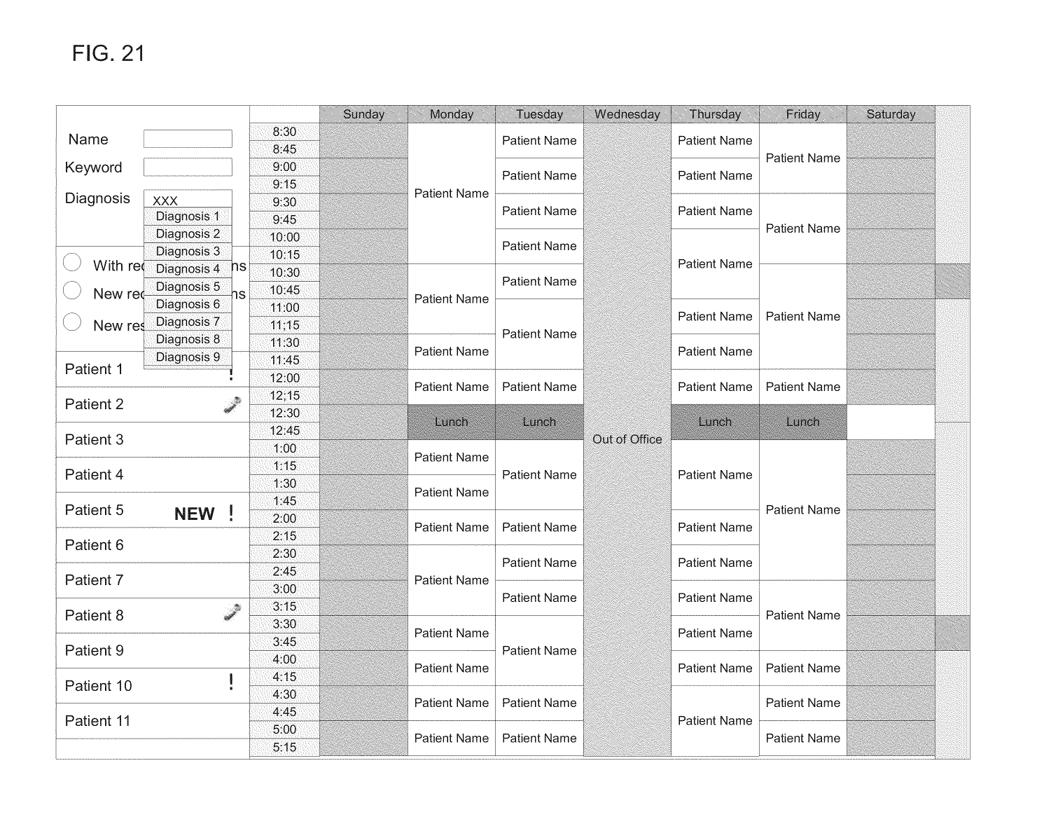

FIG. 21 shows an example of how the search section 2015 may be used to search for patients. In the example shown, the physician may enter text in a search field, which text may be used (e.g., using predictive text algorithms) to bring up a list of field values that the physician may search by. The patient list 2025 may then be updated to display only those patients satisfying the search value. For example, entry of the full or partial name and/or medical code number of a diagnosis in the diagnosis field may allow the physician to select the diagnosis to search by. In another example, input of text in the keyword field, may result in a search for all patients having that keyword in their patient record. For example, typing HbA1c into the keyword search field may produce search results showing all patients who have had an HbA1c test performed. In another example, typing in a drug name into the keyword search field may produce search results showing all patients who have been prescribed with that drug—this may be used in identifying patients who are currently taking a certain drug, for example in the event of a drug recall. In another example, if the physician enters the letters “Smi” in the name field may cause the display of a drop-down list will list all patients with either first or last name beginning with the letters “Smi”. The physician may select one of the entries on this drop-down list in order to select a patient to review. Alternatively, the physician may choose to search all patients with first or last name beginning with “Smi” without selecting a particular patient from the drop-down list.

Although the search fields shown include patient name, keyword and diagnosis, it should be understood that there may be more or less search fields provided, and the search fields may be different. Standard search techniques and search language may be used. It should be understood that where there is more than one search field provided in the search section 2015, two or more search fields may be used together.

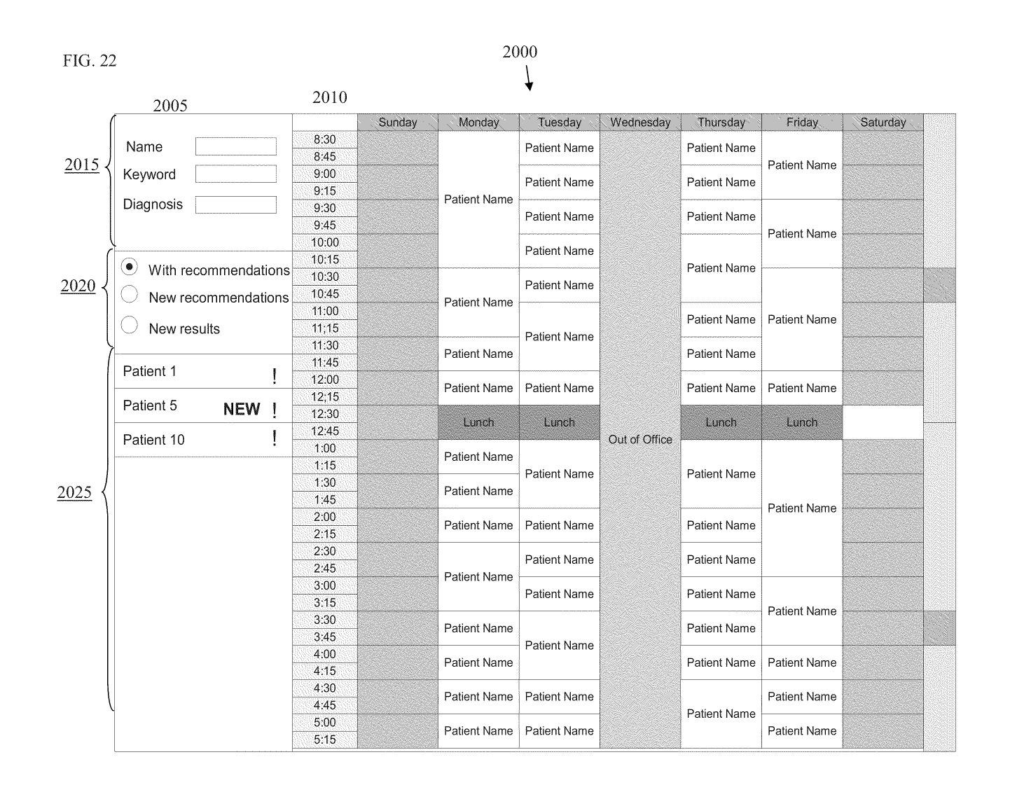

FIG. 22 shows an example of how the filter section 2020 may be used to filter the patient list 2025. Filtering of the patient list may be carried out using any suitable filtering technique. In the example shown, available filters include filtering by patients with recommendations, patients with new recommendations and patients with new test results. It should be understood that there may be more or less filters available, and different filters may be available. In some examples, the physician may be provided with options to define his/her own customized filter (e.g., the physician may define a filter in order to filter patients by gender, where such a filter is not available by default). In this example, the filters are selectable by radio buttons, such that only one filter may be applied at a time. In other examples, the filters may be selectable by other means (e.g., checkboxes) such that more than one filter may be applied at a time.

Where there are one or more patients with new recommendations, the “New Recommendations” label may be brought to the user's attention (e.g., by flashing font, different font color, highlight or any other suitable method). Similarly, when there are one or more patients with new results, the “New Results” label may be brought to the user's attention.

In FIG. 22, the filter “With Recommendations” has been selected, with the result that only patients with recommendations are displayed in the patient list 2025.

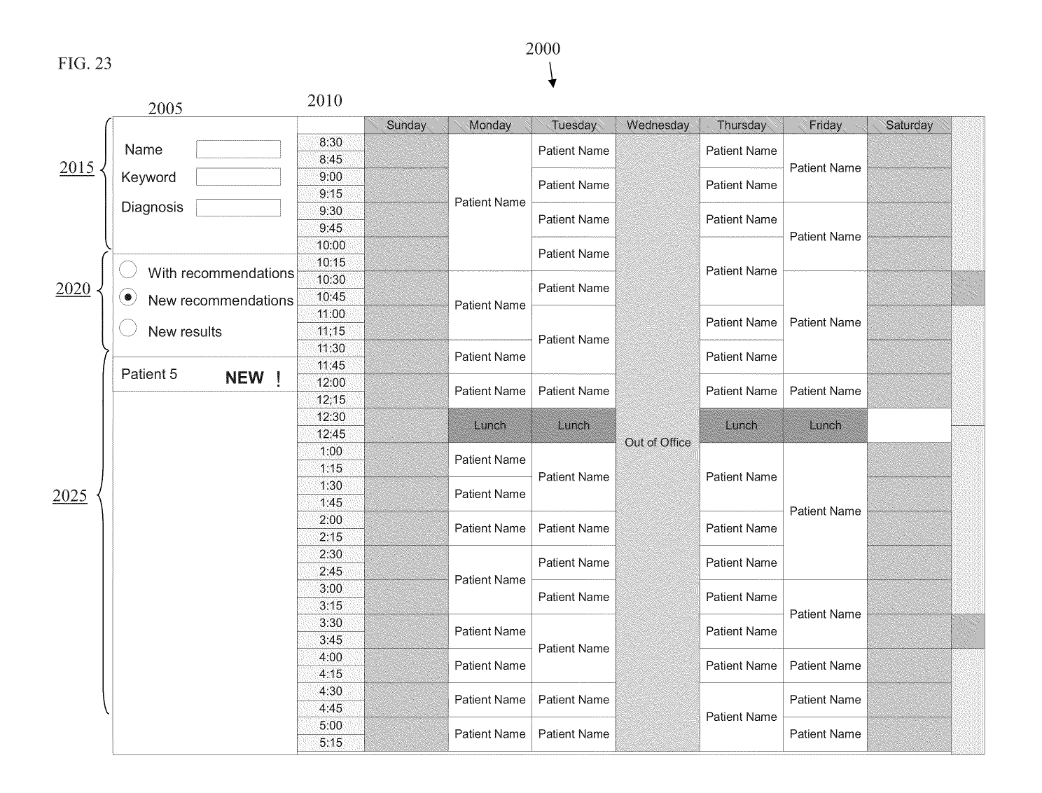

In FIG. 23, the filter “New Recommendations” has been selected, with the result that only patients with new recommendations are displayed in the patient list 2025. A new recommendation may be any generated recommendation that has not been previously selected for review by the physician, any generated recommendation since the physician's last log in to the system, any generated recommendation since the patient's last visit and/or any generated recommendation since the patient's record in the system was last viewed by the physician, for example.

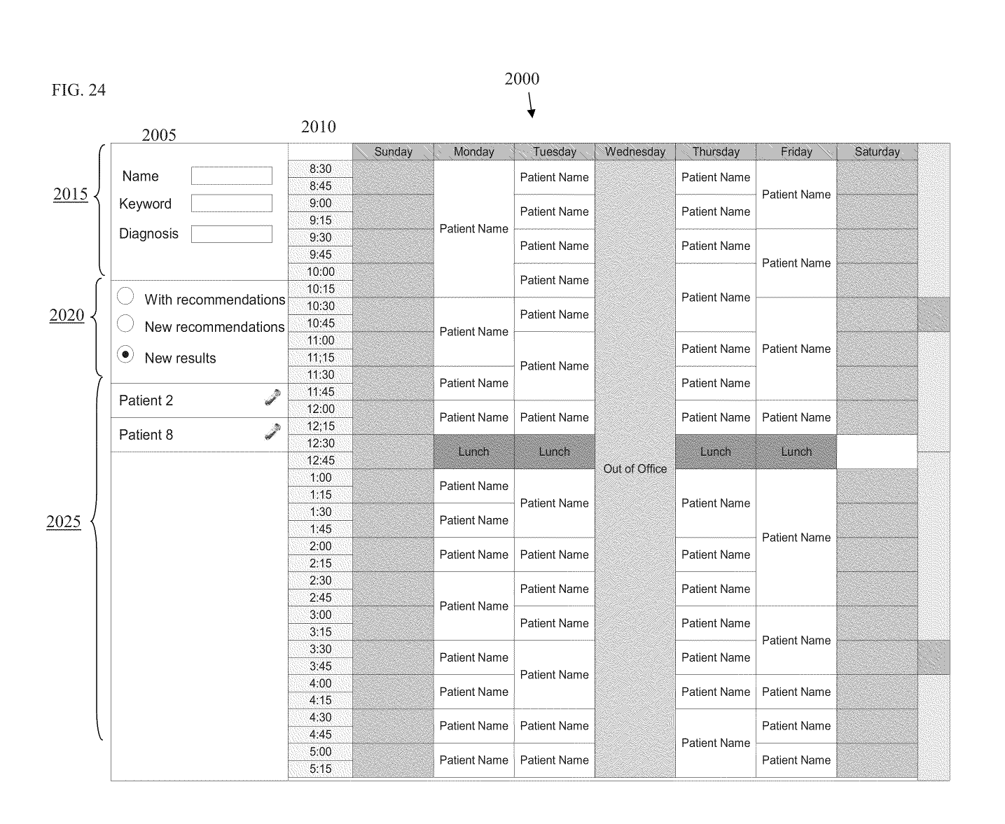

In FIG. 24, the filter “New Results” has been selected, with the result that only patients with new test results are displayed in the patient list 2025.

The patient list 2025 may be filtered using a combination of the search section 2015 and the filter section 2020 described above.

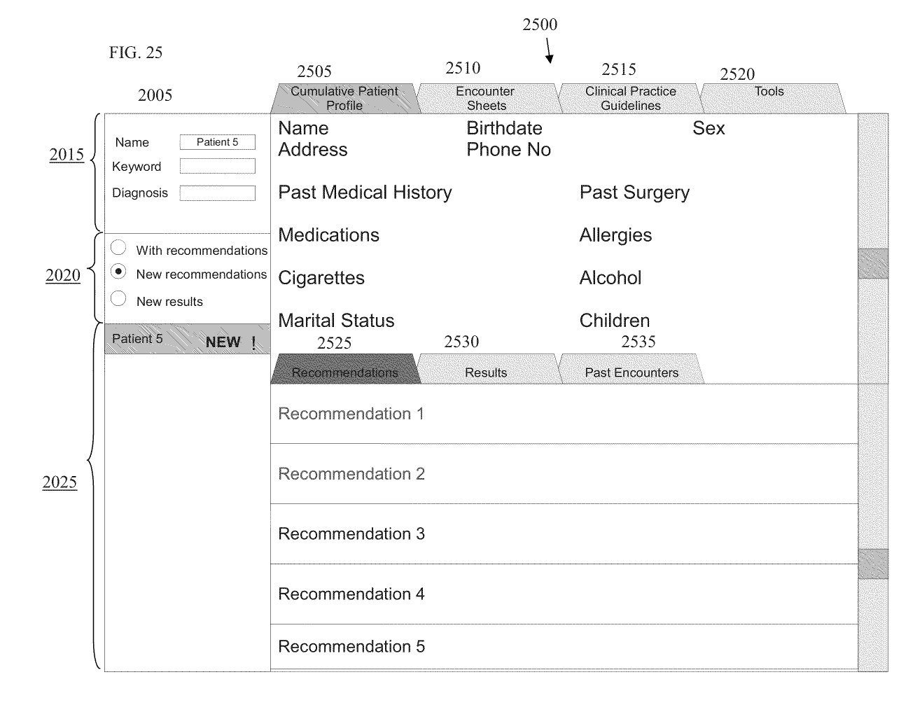

Once a patient has been selected (e.g., selected via the patient list 2025 or via the schedule 2010), a patient-specific interface may be displayed. FIG. 25 shows an example patient-specific interface 2500.

The interface 2500 may include the search Patient Search Column 2005, as described above. The schedule 2010 may be replaced with patient-specified data. The interface 2500 may include selectable tabs for: Cumulative Patient Profile 2505, Encounter Sheets 2510, Clinical Practice Guidelines 2515, Tools 2520, Recommendations 2525, Results 2530 and Past Encounters 2535, for example. These tabs may be customized by the user, for example, or may be fixed. More or less tabs may be presented in the interface 2500, as well as different tabs with other suitable functions.

The interface 2500 may, by default, present the Cumulative Patient Profile tab 2505 as active (e.g., displaying the cumulative patient profile in the upper portion of the display). The Cumulative Patient Profile tab 2505 may provide a summary record of patient data. Information provided in the Cumulative Patient Profile tab 2505 may include, for example: the past medical history, ongoing conditions, medications, allergies, family history, cigarette smoking, alcohol and drug consumption, among others

The Recommendations tab 2525 may be active by default (e.g., displaying any recommendations associated with the patient in the lower portion of the display), such as where the selected patient has been flagged as having one or more new recommendations. The Recommendations tab 2525 may display any associated recommendations in a summary or abbreviated format, and may present any new recommendations in a manner to bring these to the user's attention (e.g., by placing such recommendations at the top of the list, by use of highlighting, different font, red font color, flashing font, different font color, or any other suitable methods). In some examples, the Recommendations tab 2525 may be brought to the user's attention using any suitable method if there is any new recommendation for the patient. Each summary recommendation may be selectable to present the user with a full or detailed format of the recommendation, as will be described below. The summary format may enable a number of recommendations to fit onto one display page. The full format may include options for further action on the part of the user (e.g., as described above) including, for example, removal of the recommendation by indicating the completion thereof.

The upper and/or lower portions of the display may include scroll bars for navigating the interface 2500, for example where there is more information than can be displayed at one time in the upper and/or lower portions of the display.

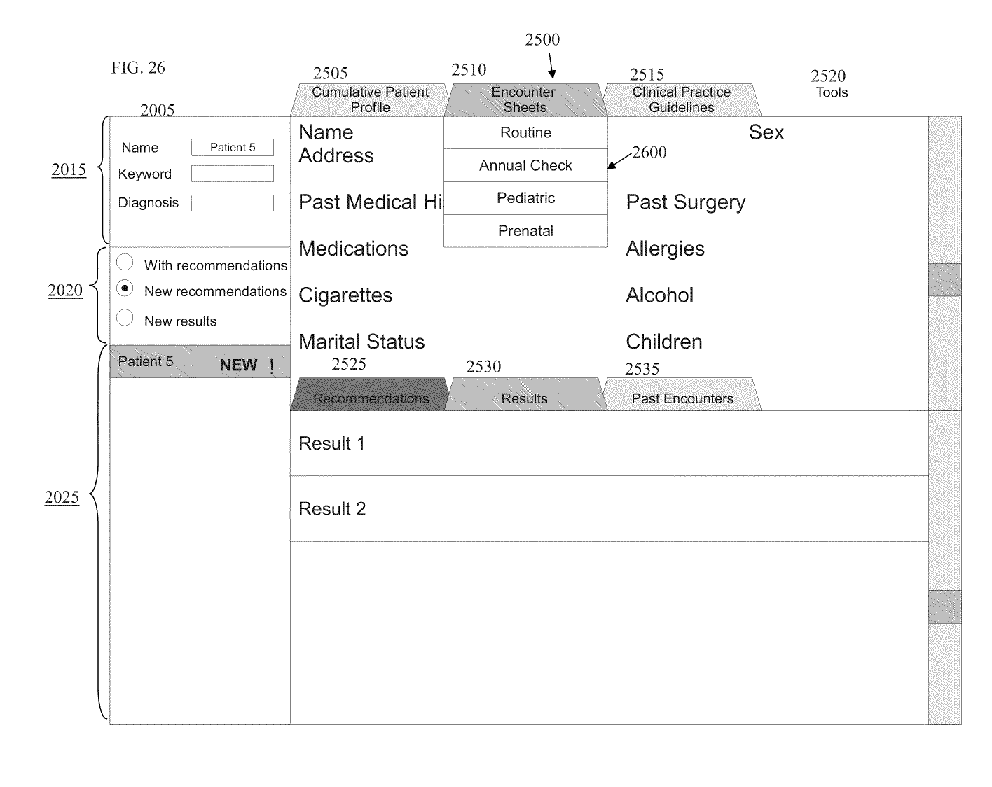

FIG. 26 shows the Encounter Sheets tab 2510 selected, making it the active tab in the upper portion of the display. A drop-down list 2600 may be displayed listing encounter sheets available for selection (in the example shown, the drop-down list 2600 may include Routine, Annual Check, Pediatric and Prenatal encounter sheets for selecting the routine sheet used for routine visits, the annual sheet used for annual physical exam, the pediatric sheet used for care of children and the pre-natal sheet used for care of pregnant women, respectively). Selecting one of these choices may result in a display of the selected encounter sheet.

The Results tab 2530 has also been selected, making it the active tab in the lower portion of the display. Any results associated with the patient may be displayed, and any new results may be presented in a suitable manner to bring these to the user's attention. In some examples, the Results tab 2530 may be active by default where the selected patient is associated with one or more new results. Results that may be displayed may include, for example, blood tests, x-ray and other imaging studies, other diagnostic tests and consultants' reports, among others.

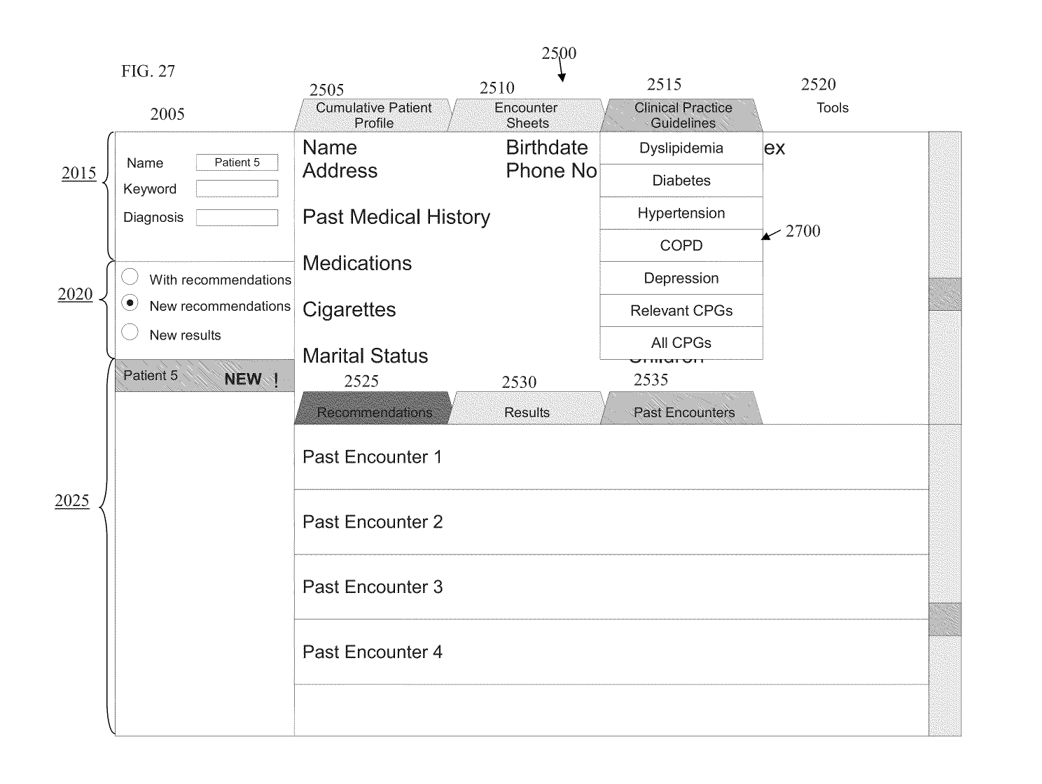

FIG. 27 shows the Clinical Practice Guidelines tab 2515 selected, making it the active tab in the upper portion of the display. A drop-down list 2700 may be displaying listing CPGDs available for selection to be implemented (in the example shown, the drop-down list 2700 may include Dyslipidemia, Diabetes, Hypertension, COPD, Depression, Relevant CPGs and All CPGs options for selecting the respective CPGD, CPGDs determined to be relevant to the patient and all CPGDs available for implementation). The Past Encounters tab 2535 has also been selected, making it the active tab in the lower portion of the display. Any data (e.g., the dates and assessments made at each encounter, and any other suitable information) associated with past encounters for the patient may be presented, for example in chronological order or reverse chronological order.

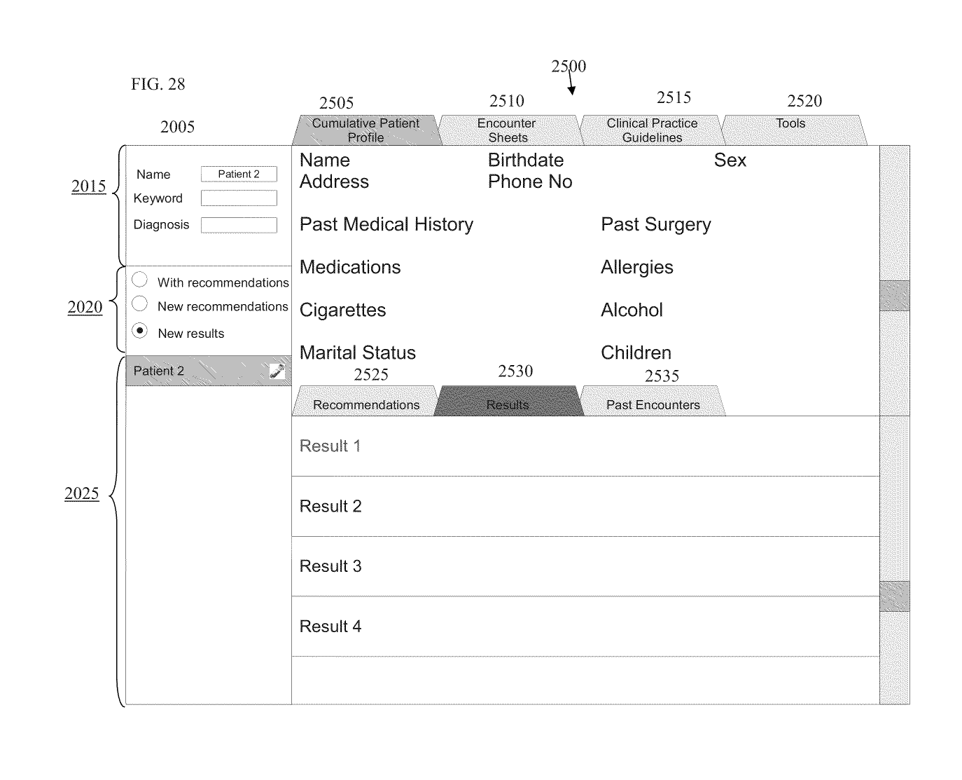

In FIG. 28, the selected patient may be flagged as having one or more new results. In this case, the interface 2500 may have the Results tab 2530 active by default. The Results tab 2530 may be brought to the user's attention by any suitable manner (e.g., highlighting, flashing, different font color or flashing font), and any new results may be brought to the user's attention by any suitable manner (e.g., as described above).

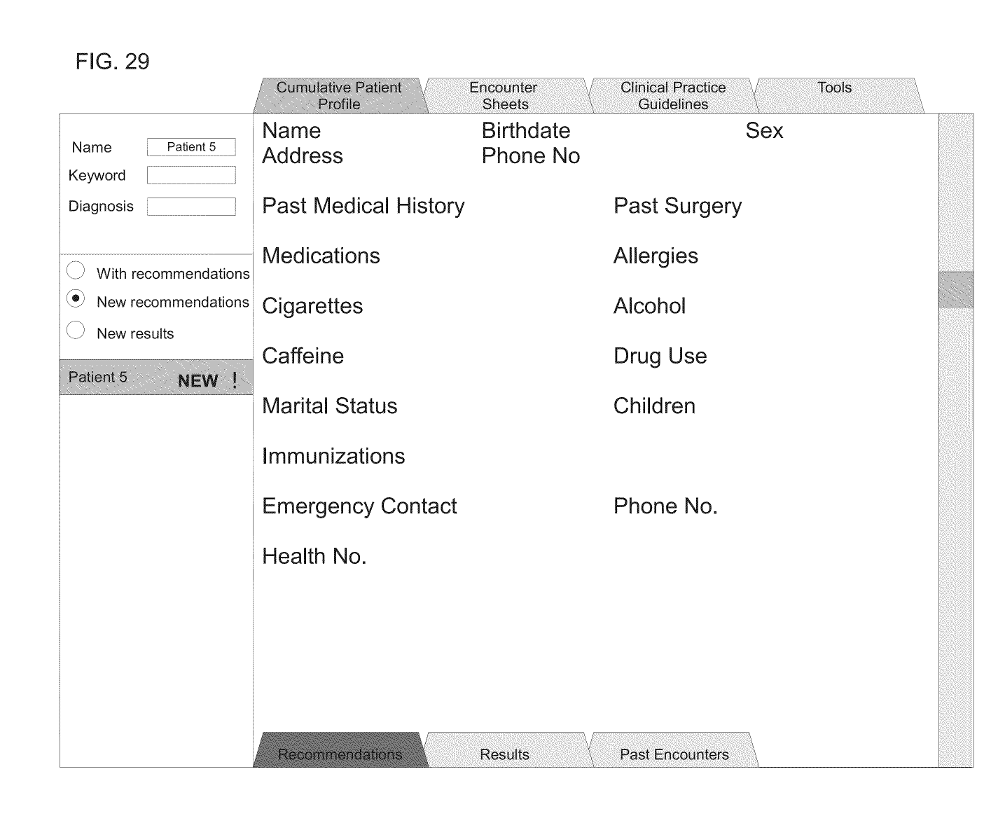

FIG. 29 shows the interface 2500 with the lower portion of the display minimized. This may allow the user to view more information in the upper portion of the display at one time. This minimization may be in response to the user clicking on any part of the upper portion of the display to the right of the Patient Search Column 2005, in response to the user clicking on the tabs associated with the upper portion of the display, and/or in response to the user clicking on a strip just above the lower portion of the display, for example. The lower portion of the display may be re-expanded by clicking or hovering a pointer over the minimized lower portion.

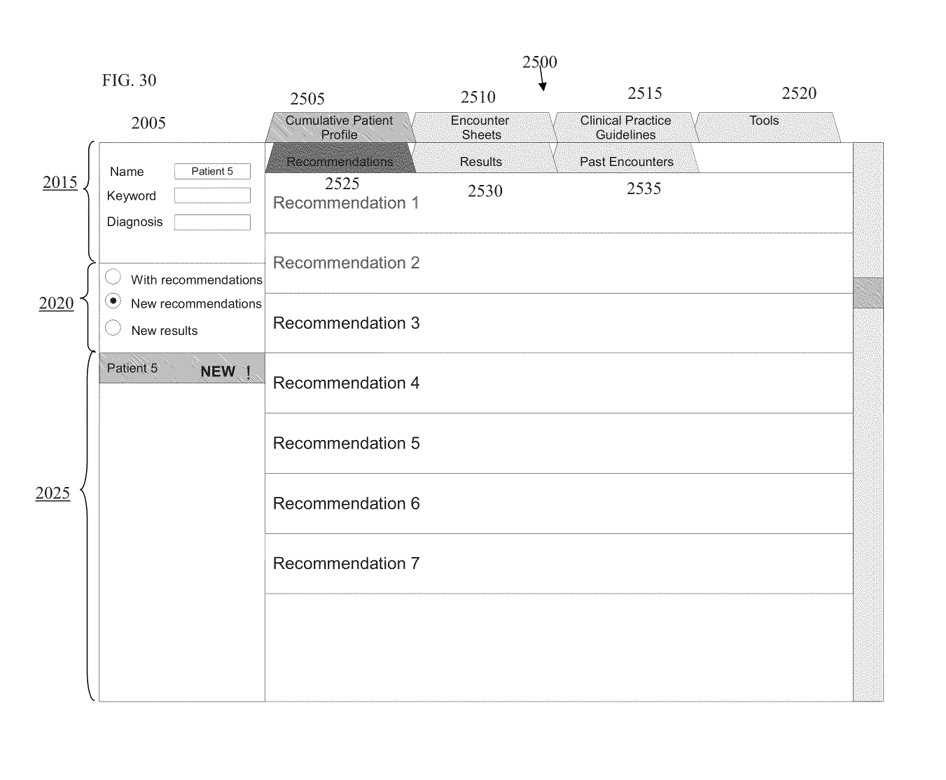

Similarly to FIG. 29, FIG. 30 shows the interface 2500 with the upper portion of the display minimized (e.g., in a manner similar to that described above). This may allow the user to view more information in the lower portion of the display at one time.

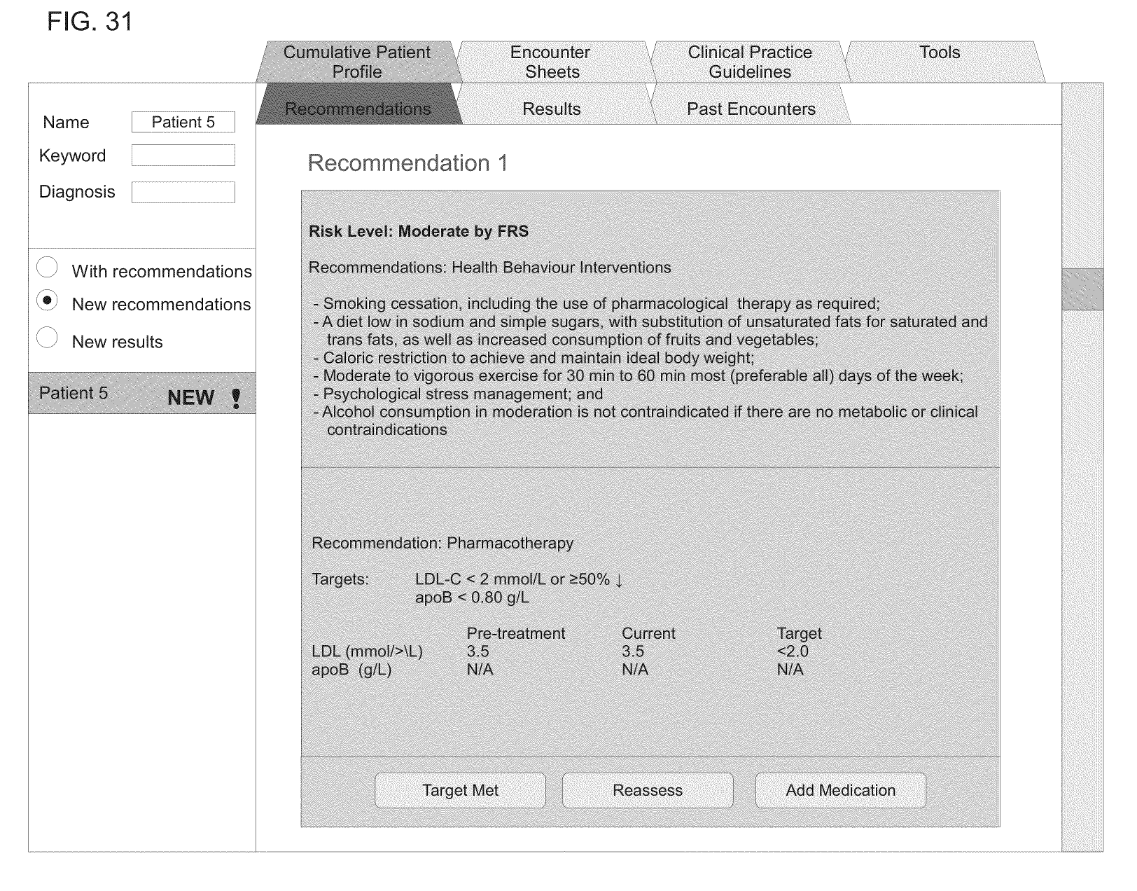

FIG. 31 shows the interface 2500 when the user has selected a recommendation (e.g., from the Recommendations tab 2525) for detailed viewing. The full format of the selected recommendation may be presented, and the user may be provided with options for managing the recommendation. In the example shown, the user may be provided with options for: indicating that the recommended target has been met; requesting reassessment of the patient; and to add a medication to the recommendation. For example, the user may be provided with a checkbox or similar interface object to allow the user to indicate fulfillment of the recommendation. Upon receiving input indicating such fulfillment, that recommendation may be disassociated with that patient. In some examples, the recommendation may not be cancelled unless fulfillment is indicated. In some examples, after fulfillment, a recommendation may still be stored in the patient database and associated with the patient as being a fulfilled recommendation.

A “Target Met” button presented in the GUI may be selected to indicate fulfillment of a recommendation and cause the system to remove that recommendation for the patient. In some examples, in which a follow-up assessment may be required, the removal of the recommendation may automatically trigger generation of a new recommendation for a follow-up assessment.

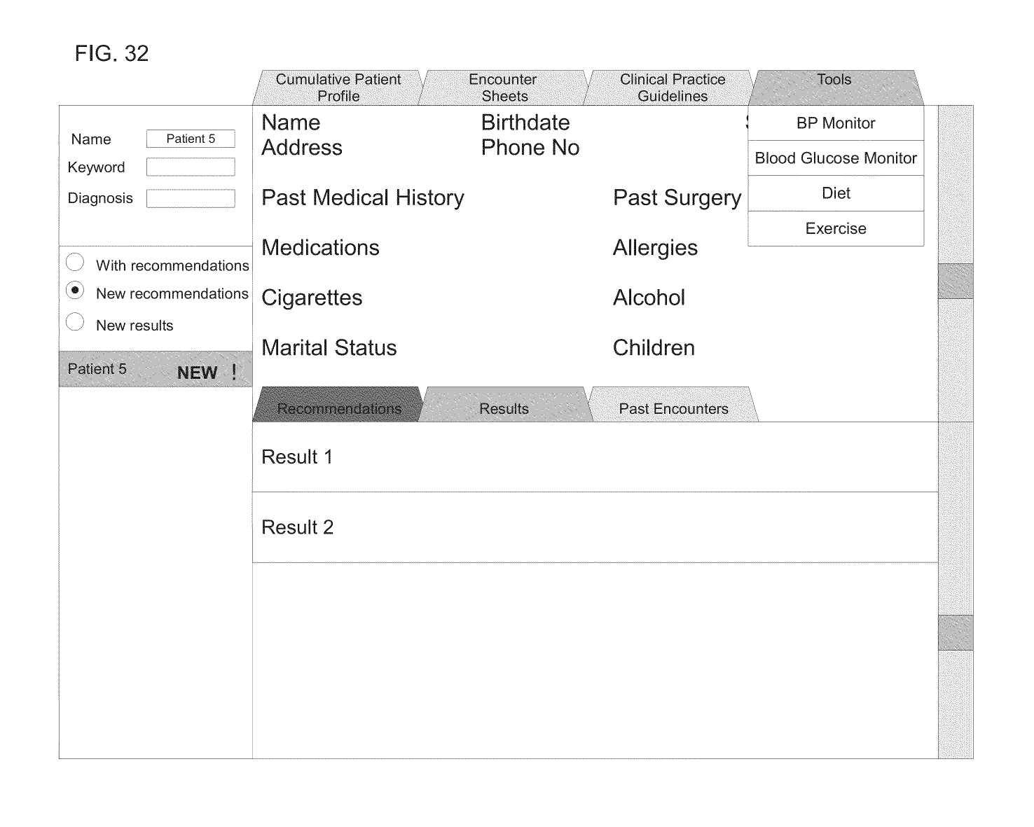

FIG. 32 shows the Tools tab 2520 selected, making it the active tab in the upper portion of the display. A drop down list 3200 may be displayed listing tools available for selection (in the example shown, the drop down list 3200 may include selection of BP Monitor, Blood Glucose Monitor, Diet and Exercise as selectable tools for management of blood pressure, blood glucose, diet and exercise, respectively). The selected tool may be used for input of patient data, as described elsewhere in the present disclosure.

Although the interface 2500 has been shown with certain tabs and configuration, it should be understood that other tabs and configurations may be used as suitable. The user may be provided with options for customizing the interface 2500 as appropriate (e.g., the tabs may be arranged by the user such that the one to the far left is the default for the upper portion of the display).

In some examples, the Patient Search Column 2005 may be minimized (e.g., collapsible to a thin strip at the far left of the display), for example by the user selecting an area of the screen to the right of the Patient Search Column 2005. The Patient Search Column 2005 may be re-expanded to full size, for example by the user clicking or hovering a pointer over the Patient Search Column 2005.

Other tabs that may be provided (in the upper and/or lower portions of the display, for example) in the interface 2500 include, for example, tabs for displaying other patient data such as vital signs on past encounters, immunization history or other such data.

### Example Insulin Prescription Tool

FIGS. 38-77 show interfaces illustrating the operation of an example insulin prescription tool that may be provided in an example of the disclosed methods and systems. This example algorithm may be based on the interlacing of the following CPGs, which will be referred to by number in the following description:
1. Canadian Diabetes Association 2008 Clinical Practice Guidelines for the Prevention and Management of Diabetes in Canada—Appendix 3.
2. Ontario College of Family Physicians: Insulin Initiation and Titration Suggestions (for type 2 diabetes).
3. Canadian Diabetes Association: Autumn 2011; Volume 24, No. 3.
4. Self-Monitoring of Blood Glucose (SMBG) in Type 2 Diabetes (T2DM); www.RxFiles.ca-February 2012.

The function of each interface and the progression through them during use of the tool by the physician is now described. Each interface has been described in association with its relevant reference, which may demonstrate that the CPG references may be implemented in an interlaced manner.

FIG. 38 shows a data screen showing the current insulin regimen, HbA1C value and blood glucose levels for patient. In FIG. 38, there is not yet any insulin being prescribed nor any blood glucose values for the patient. The physician may be provided the capability to edit using the “Edit” button. If the physician selects “Confirm”, the tool will go to the scheme for insulin initiation.

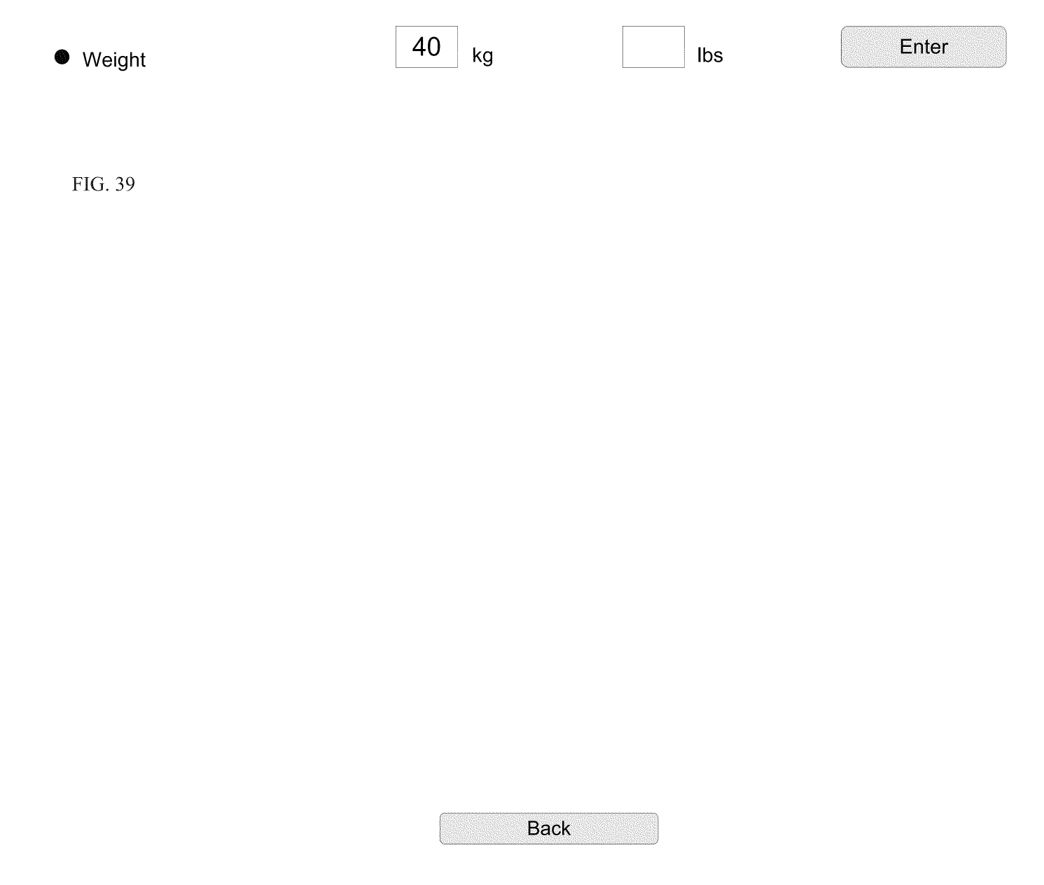

FIG. 39 may be arrived at from FIG. 38. In FIG. 39, the physician has selected “Confirm”. FIG. 39 may present the opening screen for insulin initiation. Weight of the patient may be required, which in this example the physician has entered as 40 kg. Physician may proceed by selecting “Enter”. The operations shown in FIG. 39 may be based on Reference 2.

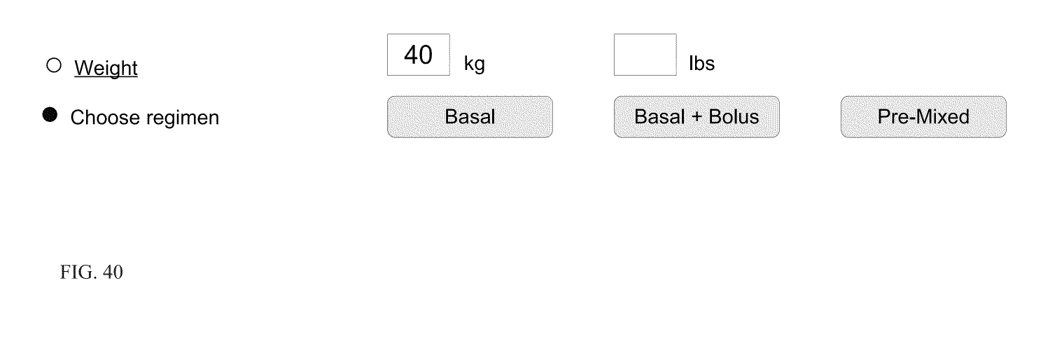

FIG. 40 may be arrived at from FIG. 39. FIG. 40 may present a screen for choosing a regimen for insulin initiation. The operations shown in FIG. 40 may be based on Reference 1.

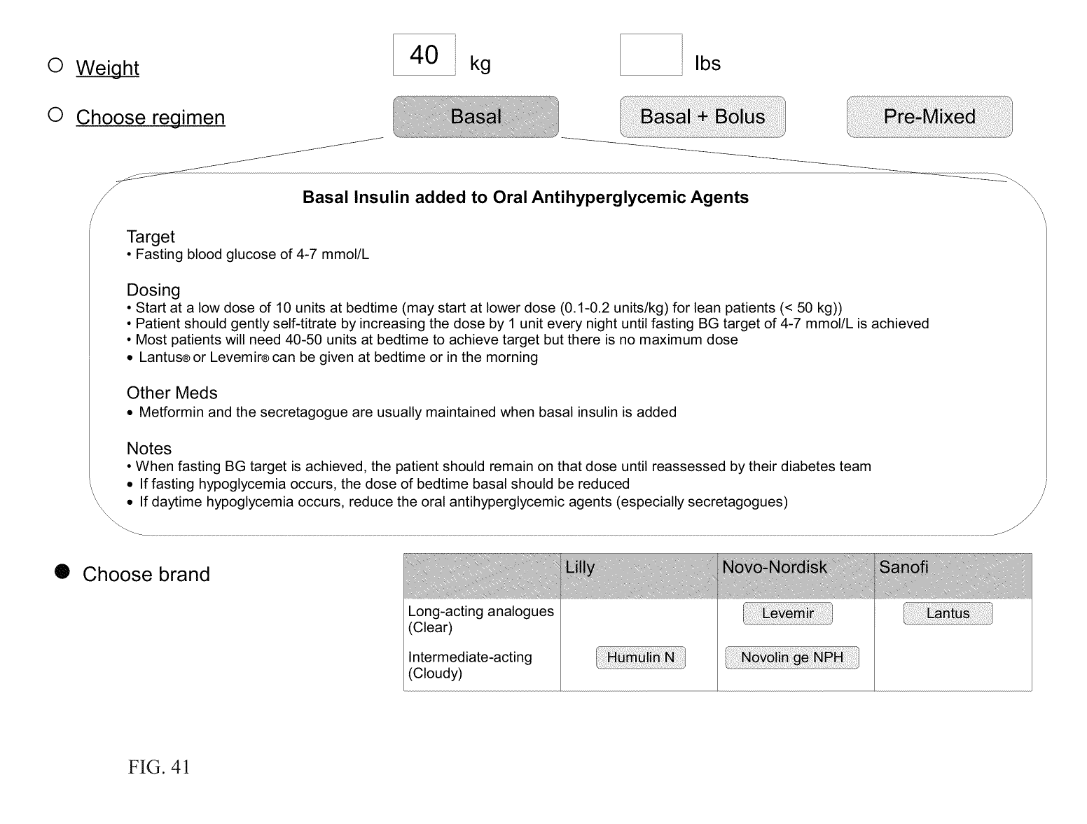

FIG. 41 may be arrived at from FIG. 40. In FIG. 41, the physician has selected “Basal”. Information may be provided for the initiation of basal insulin. Options may be presented for selection of a brand of insulin. The operations shown in FIG. 41 may be based on References 1 and 2.

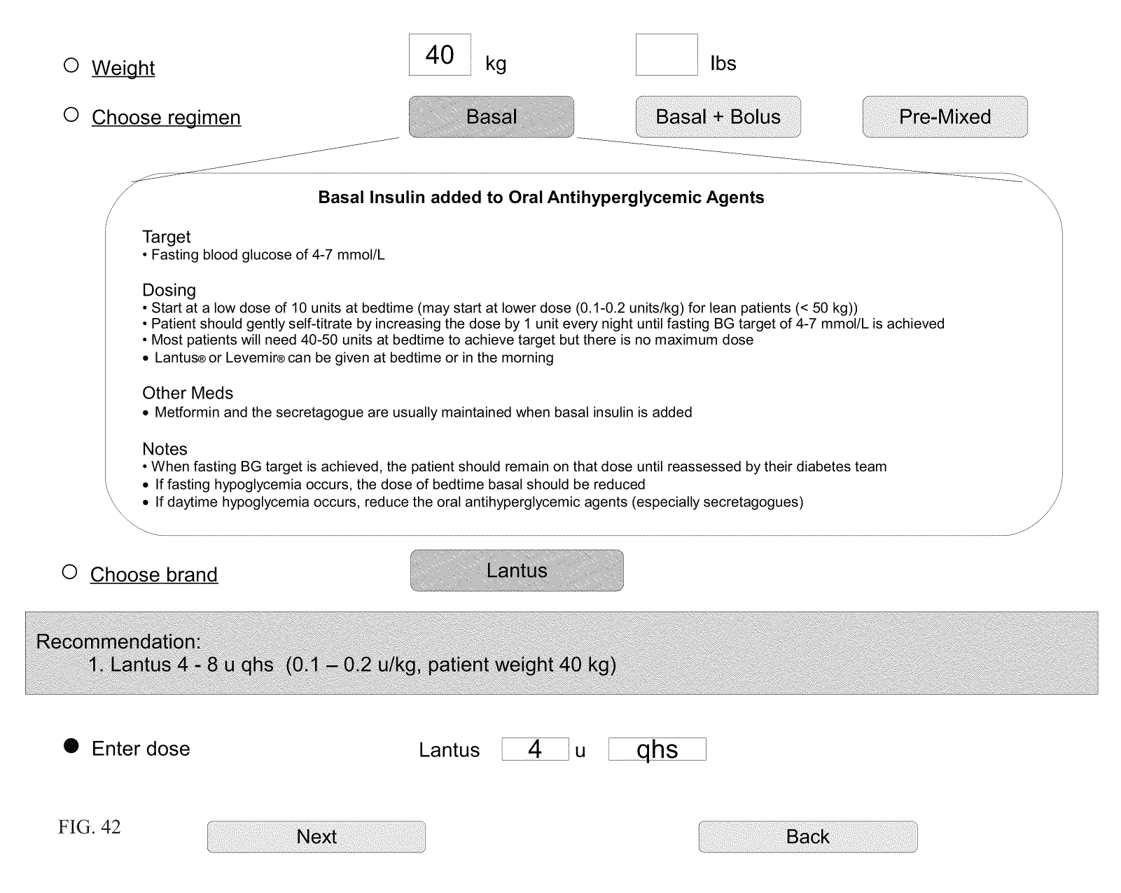

FIG. 42 may be arrived at from FIG. 41. In FIG. 42, the physician has selected “Lantus” as the brand of insulin. A recommendation may be generated and presented made for the dosing of Lantus. The physician may enter the dose of Lantus and may select “Next” to continue. The operations shown in FIG. 42 may be based on References 1 and 2.

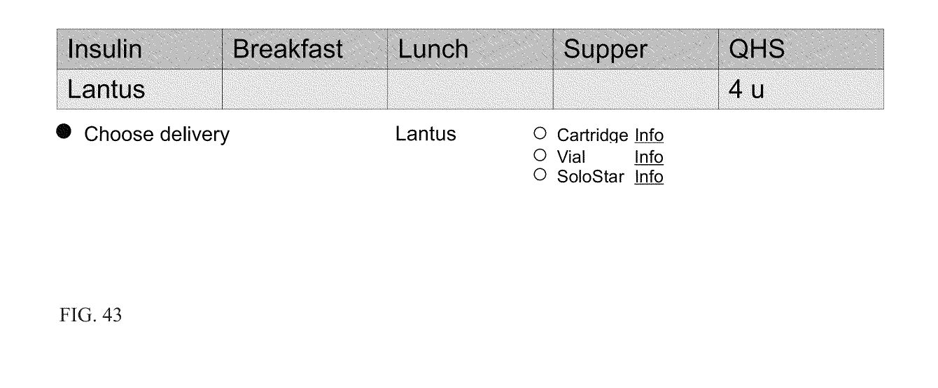

FIG. 43 may be arrived at from FIG. 42. In FIG. 43, the putative insulin dose may be presented in the table at the top of the screen. Choices may be made available to the physician for the delivery system. The operations shown in FIG. 43 may be based on Reference 2.

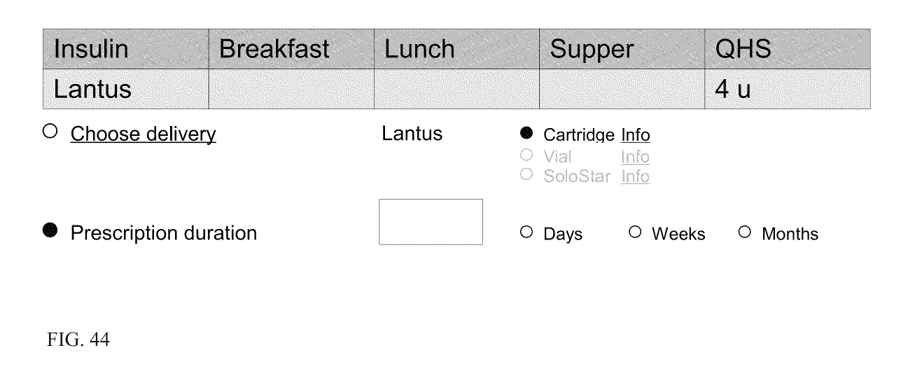

FIG. 44 may be arrived at from FIG. 43. In FIG. 43, the physician has selected “Cartridge” as the delivery system. Prescription duration may be entered by the physician. The operations shown in FIG. 44 may be based on Reference 2.

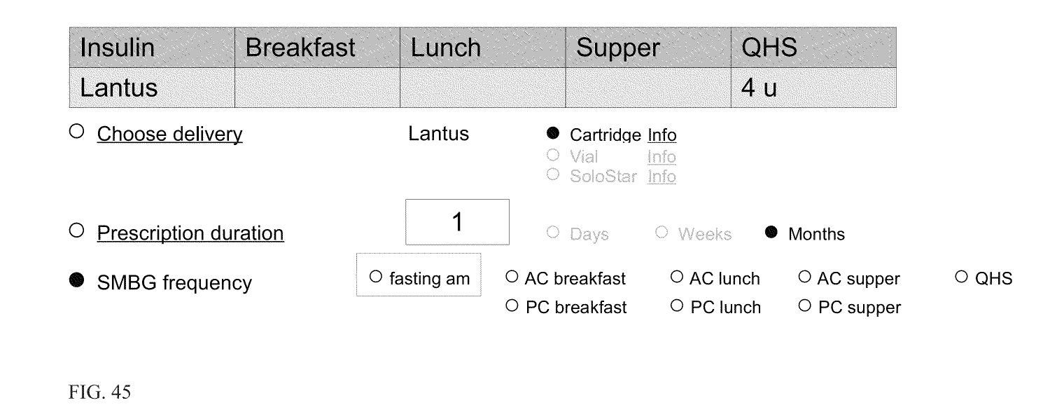

FIG. 45 may be arrived at from FIG. 44. In FIG. 45, the physician has entered “1 month” as the prescription duration. Frequency of self monitoring of blood glucose (SMBG) by the patient may be required. Fasting am may be highlighted as a recommendation. The operations shown in FIG. 45 may be based on Reference 1.

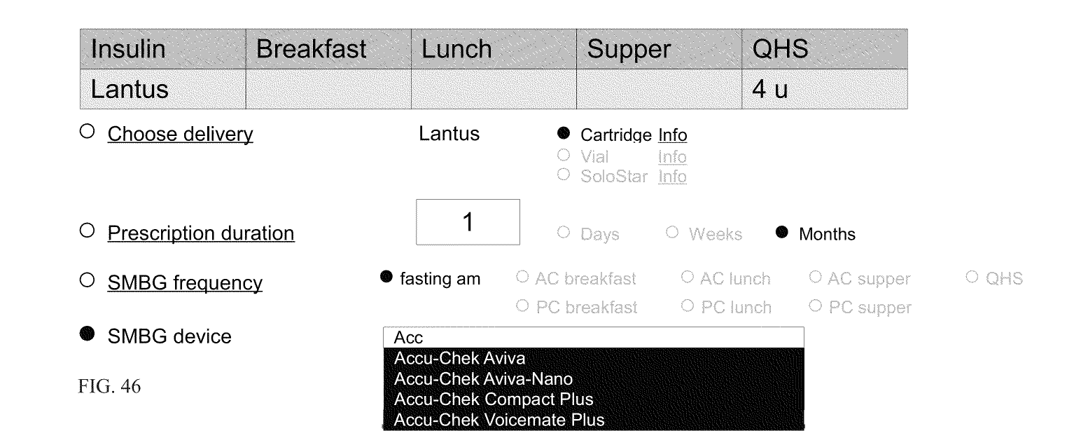

FIG. 46 may be arrived at from FIG. 45. In FIG. 46, the physician has selected “fasting am”. Choices may be presented for the SMBG device. The operations shown in FIG. 46 may be based on Reference 1.

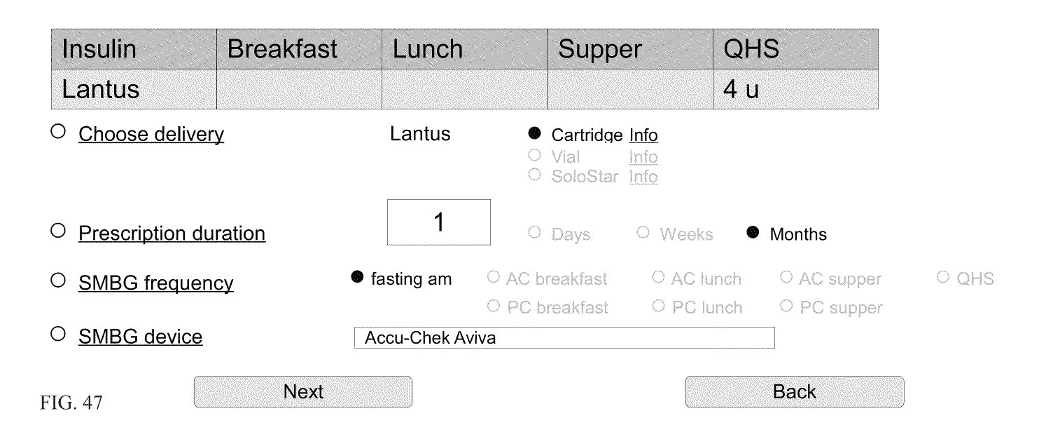

FIG. 47 may be arrived at from FIG. 46. In FIG. 47, the physician has selected “Accu-Chek Aviva” as the SMBG device. The physician may be prompted for confirmation of selections. Physician may do so by selecting “Next”. The operations shown in FIG. 47 may be based on Reference 4.

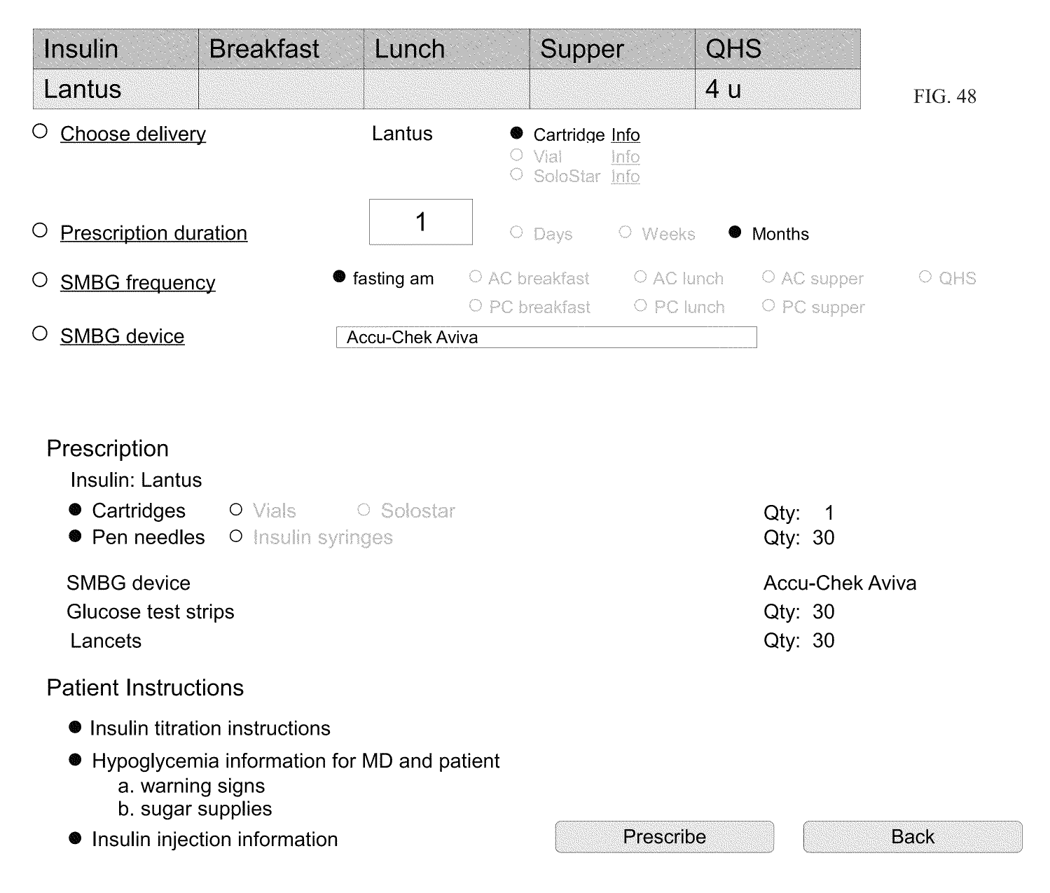

FIG. 48 may be arrived at from FIG. 47. In FIG. 48, the selected prescription along with patient instructions may be presented to the physician. The physician may proceed to print the prescription along with the patient information by selecting “Prescribe”. The operations shown in FIG. 48 may be based on Reference 2.

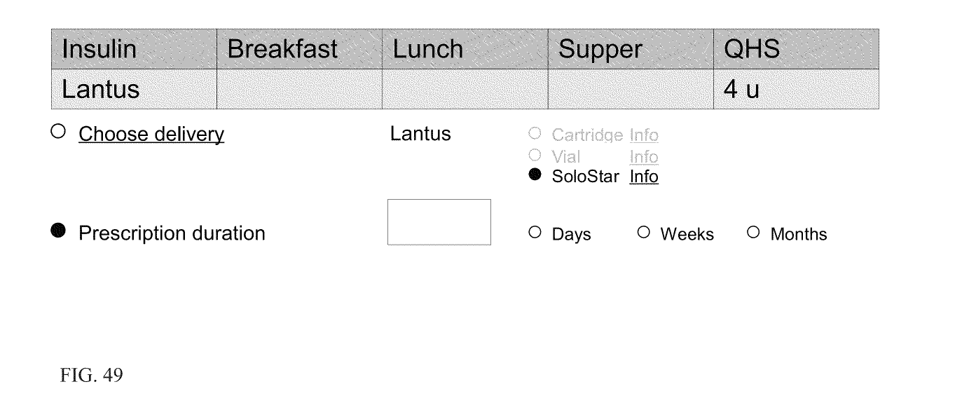

FIG. 49 may be arrived at from FIG. 43. In FIG. 49, the physician has selected “Solostar” as the delivery system. Prescription duration may be entered. The operations shown in FIG. 49 may be based on Reference 2.

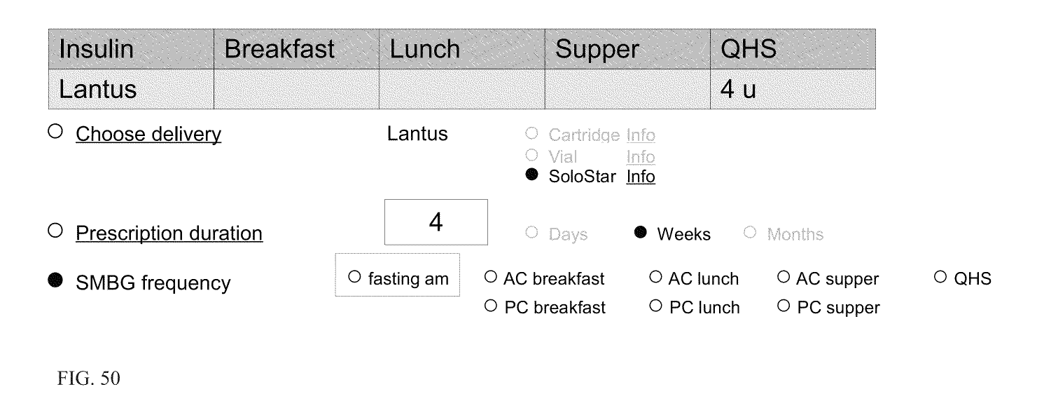

FIG. 50 may be arrived at from FIG. 49. In FIG. 50, the physician has entered “4 weeks” as the prescription duration. Frequency of SMBG by the patient may be required. “Fasting am” may be highlighted as a recommendation. The operations shown in FIG. 50 may be based on Reference 1.

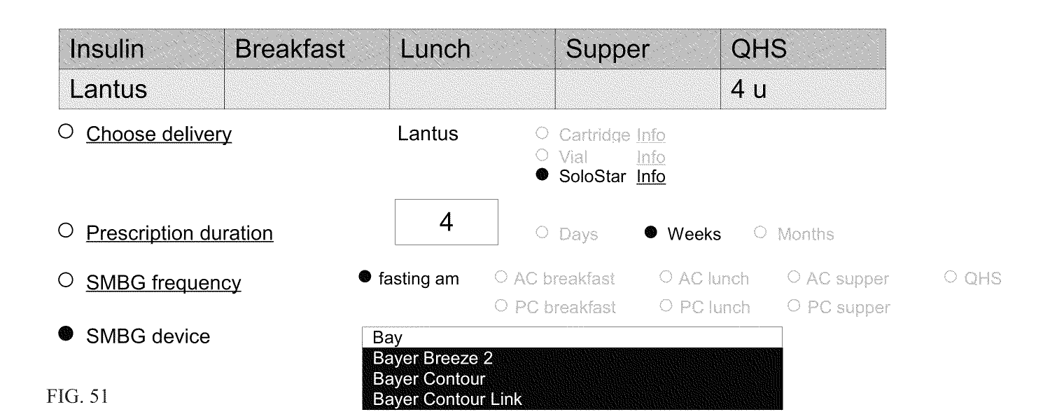

FIG. 51 may be arrived at from FIG. 50. In FIG. 51, the physician has selected “fasting am”. Choices may be presented for the SMBG device. The operations shown in FIG. 51 may be based on Reference 1.

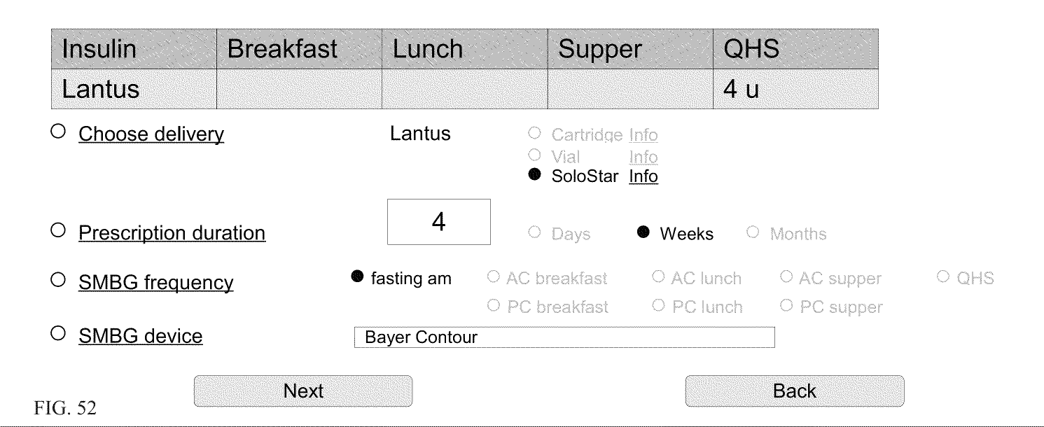

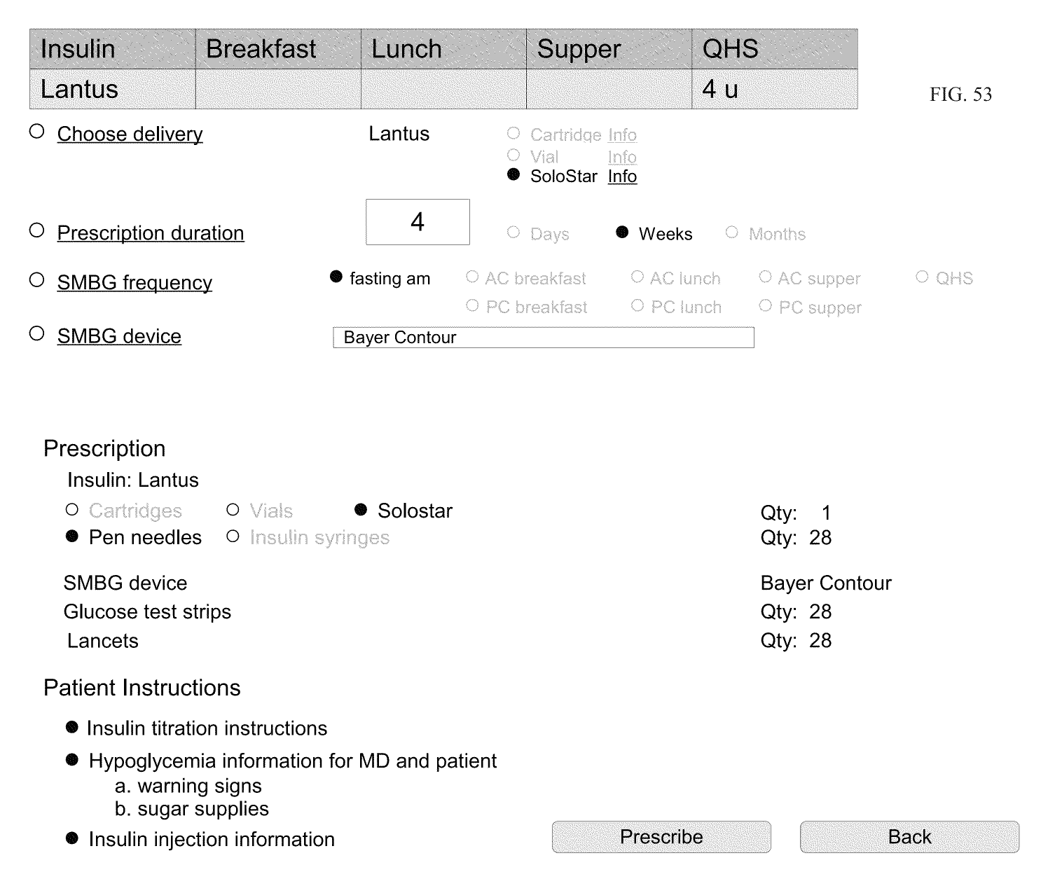

FIG. 52 may be arrived at from FIG. 51. In FIG. 52, the physician has selected “Bayer Contour” as the SMBG device. The physician may be prompted for confirmation of selections. The physician may do so by selecting “Next”. The operations shown in FIG. 52 may be based on Reference 4.

FIG. 53 may be arrived at from FIG. 52. In FIG. 53, the selected prescription along with patient instructions may be presented to physician. The physician may proceed to print the prescription along with the patient information by selecting “Prescribe”. The operations shown in FIG. 53 may be based on Reference 2.

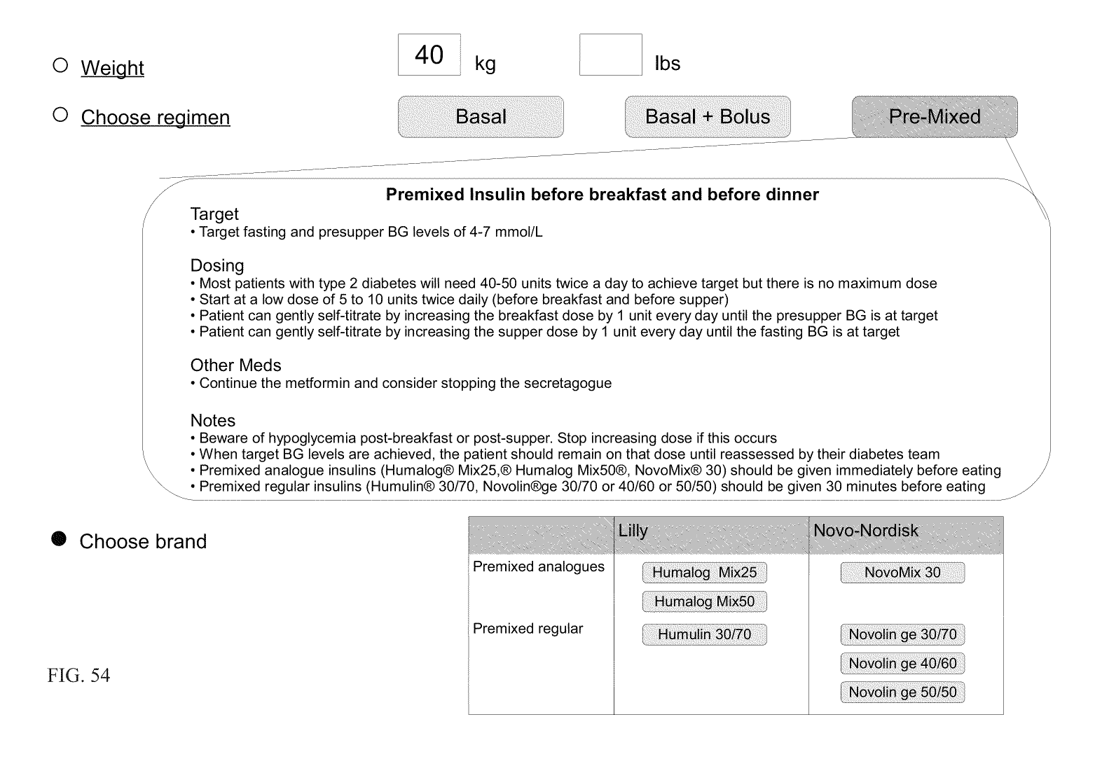

FIG. 54 may be arrived at from FIG. 40. In FIG. 54, the physician has selected “Pre-Mixed”. Information may be provided for the initiation of pre-mixed insulin. Options may be presented for selection of a brand of insulin. The operations shown in FIG. 54 may be based on References 1 and 2.

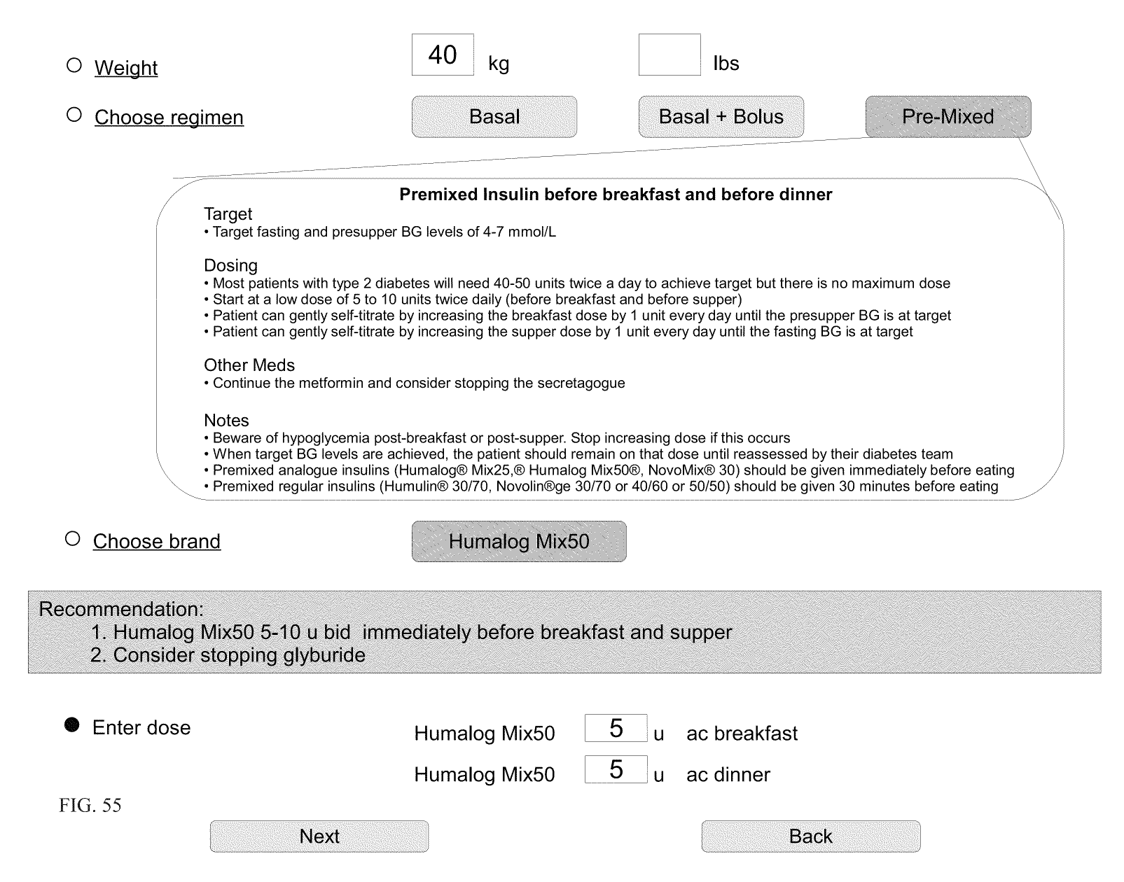

FIG. 55 may be arrived at from FIG. 54. In FIG. 55, the physician has selected “Humalog Mix50” as the brand of insulin. Recommendations may be generated and presented for the dosing of Humalog Mix50. The physician may enter the dose of Humalog Mix50 and may select “Next” to proceed. The operations shown in FIG. 55 may be based on References 1 and 2.

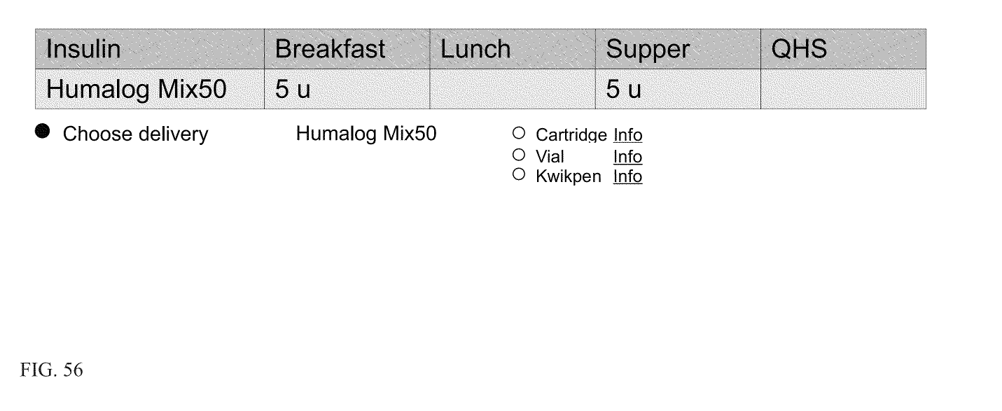

FIG. 56 may be arrived at from FIG. 55. In FIG. 56, the putative insulin dose may be presented in the table at the top of the screen. Choices may be made available to the physician for the delivery system. The operations shown in FIG. 56 may be based on Reference 2.

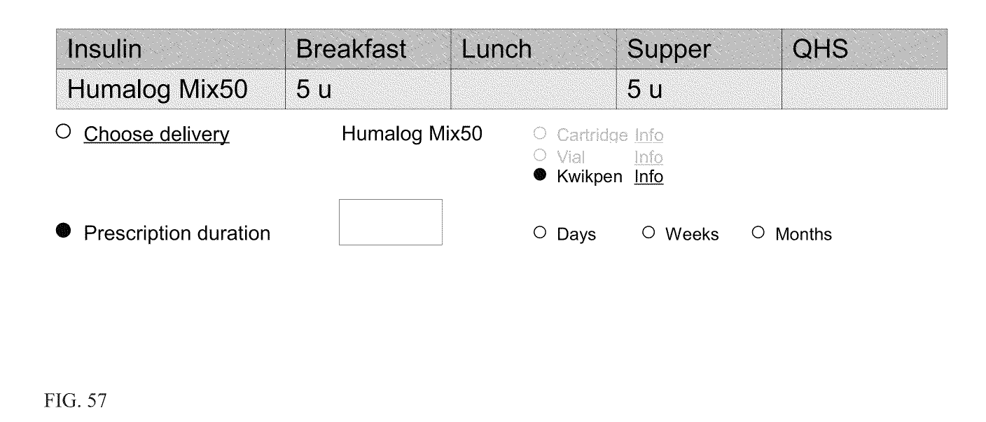

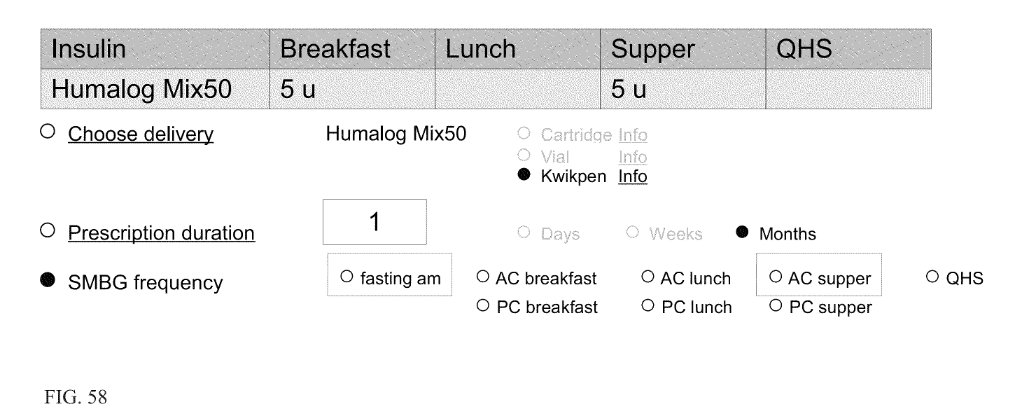

FIG. 57 may be arrived at from FIG. 58. In FIG. 57, the physician has selected “Kwikpen” as the delivery system. Prescription duration may be entered. The operations shown in FIG. 57 may be based on Reference 2.

FIG. 58 may be arrived at from FIG. 57. In FIG. 58, the physician has entered “1 month” as the prescription duration. Frequency of SMBG by the patient may be required. “Fasting am” and “AC supper” may be highlighted as recommendations. The operations shown in FIG. 58 may be based on Reference 1.

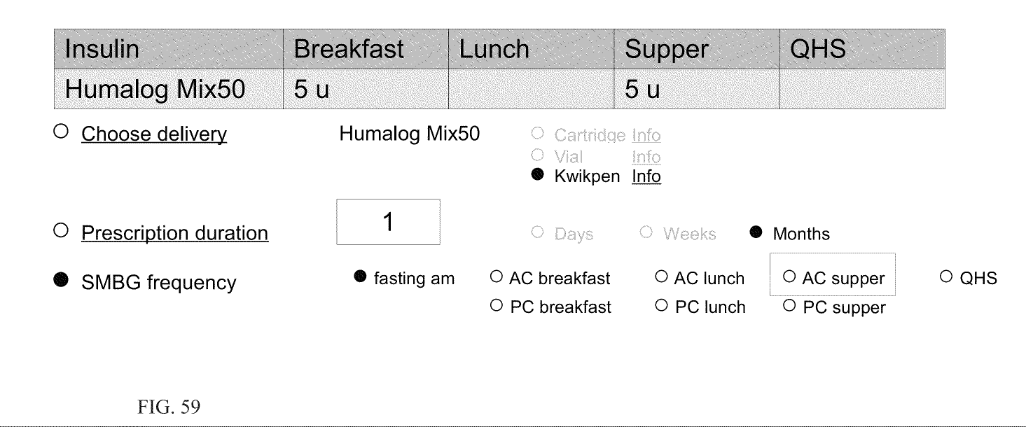

FIG. 59 may be arrived at from FIG. 58. In FIG. 59, the physician has selected “fasting am”. The operations shown in FIG. 59 may be based on Reference 1.

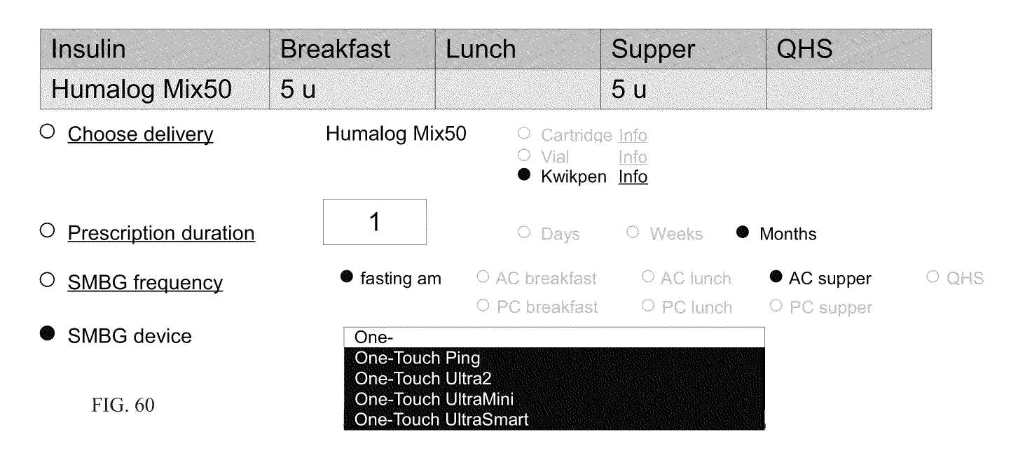

FIG. 60 may be arrived at from FIG. 59. In FIG. 60, the physician has selected “AC supper” along with “fasting am”. Choices may be presented for the SMBG device. The operations shown in FIG. 60 may be based on Reference 1.

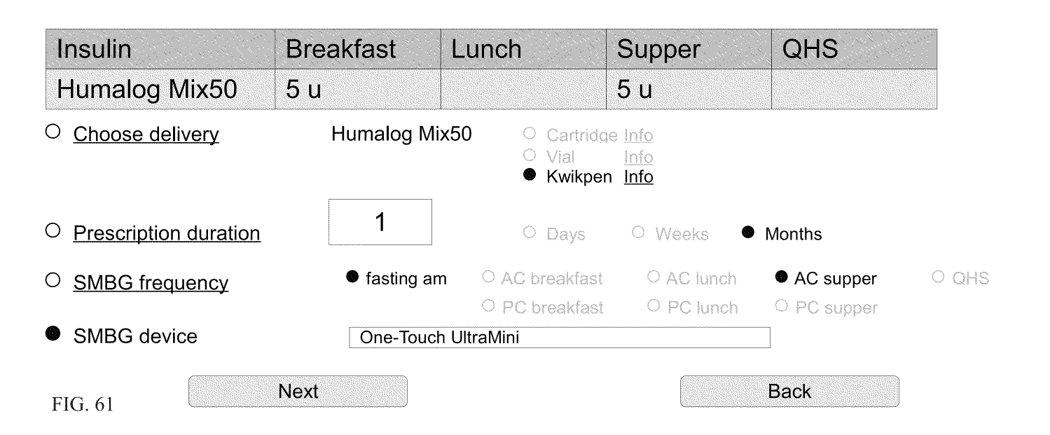

FIG. 61 may be arrived at from FIG. 60. In FIG. 61, the physician has selected “One-Touch UltraMini” as the SMBG device. The physician may be prompted for confirmation of selections. Physician may do so by selecting “Next”. The operations shown in FIG. 61 may be based on Reference 4.

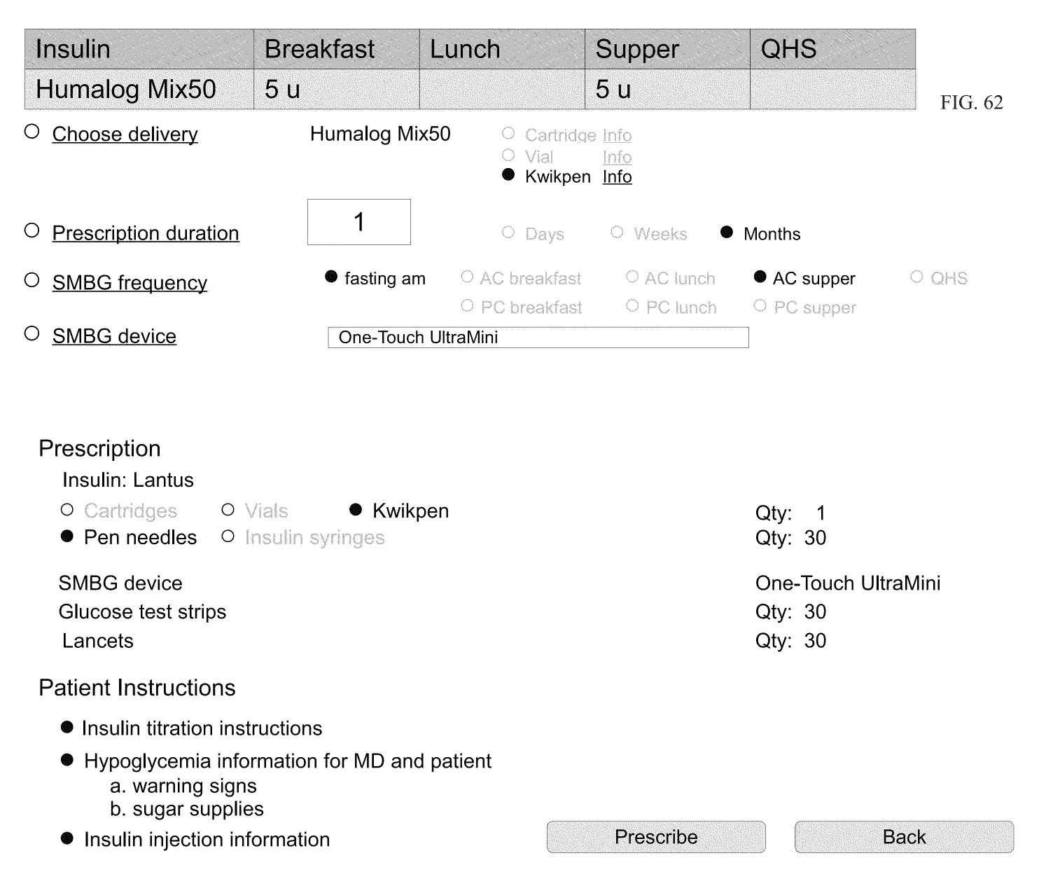

FIG. 62 may be arrived at from FIG. 61. In FIG. 62, the selected prescription along with patient instructions may be presented to the physician. The physician may proceed to print the prescription along with the patient information by selecting “Prescribe”. The operations shown in FIG. 62 may be based on Reference 2.

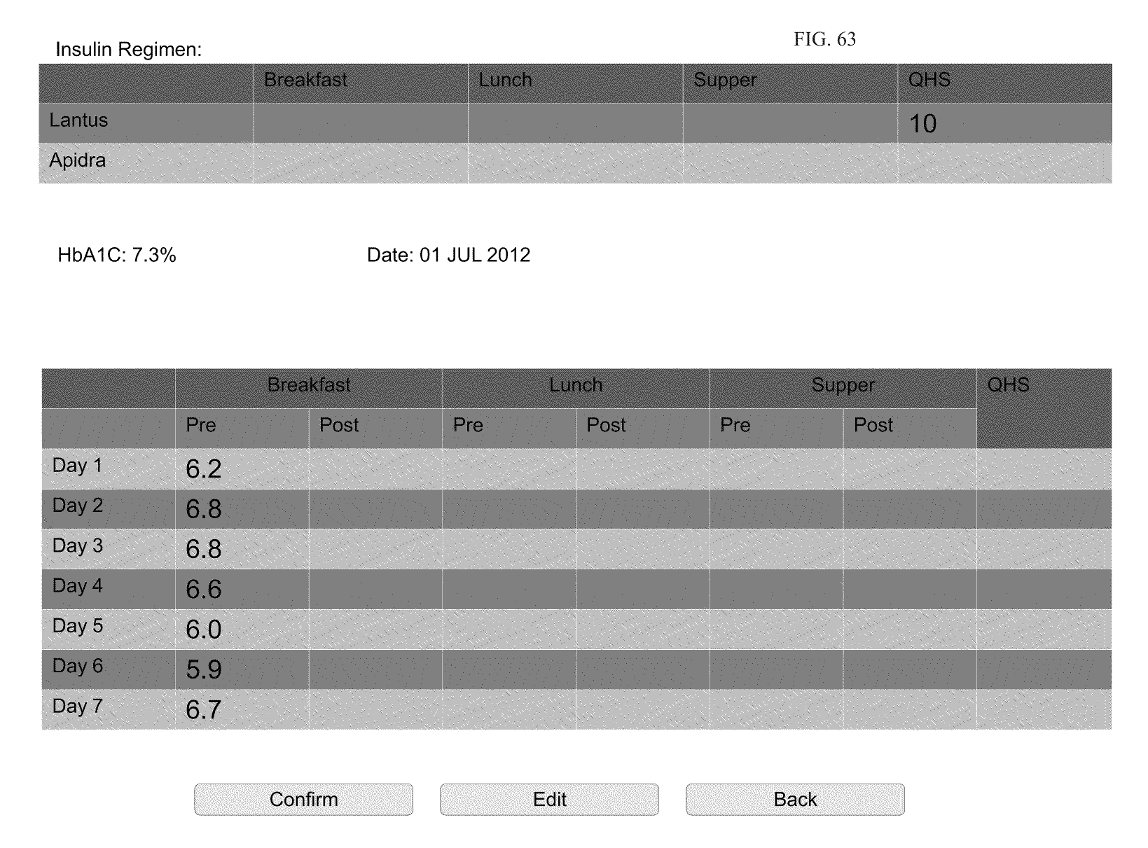

FIG. 63 shows a new data screen showing the current selected insulin regimen, HbA1C value and blood glucose levels for the patient. The physician may be provided with the capability to edit using an “Edit” option. If physician selects “Confirm”, the tool may proceed to the scheme for insulin titration.

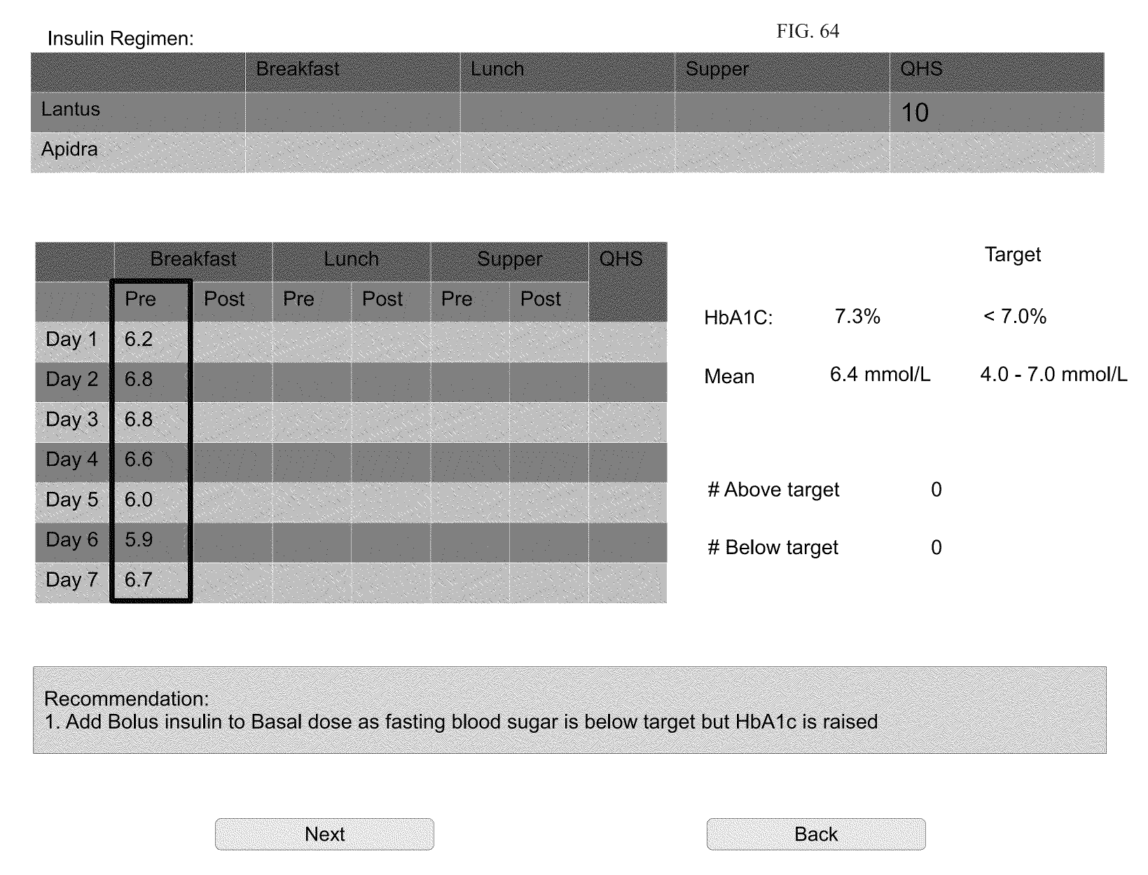

FIG. 64 may be arrived at from FIG. 63. In FIG. 64, the physician has selected “Confirm”. An analysis of the patient's blood sugar control may be presented at the right of the lower table. In this example, the analysis shows that the mean value for the blood sugar values taken at the Breakfast-Pre timing is within target and that there are no individual values below or above target. A recommendation to add bolus insulin to the basal dose may be generated and presented to the physician. The physician may accept this recommendation by selecting “Next”. The operations shown in FIG. 64 may be based on Reference 3.

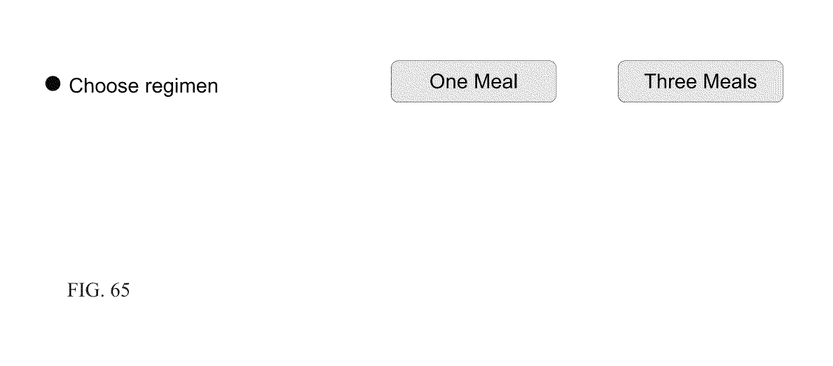

FIG. 65 may be arrived at from FIG. 64. In FIG. 65, the physician has selected “Next”. A choice may be offered to the physician to add bolus insulin to one meal or all three meals. The operations shown in FIG. 65 may be based on References 2 and 3.

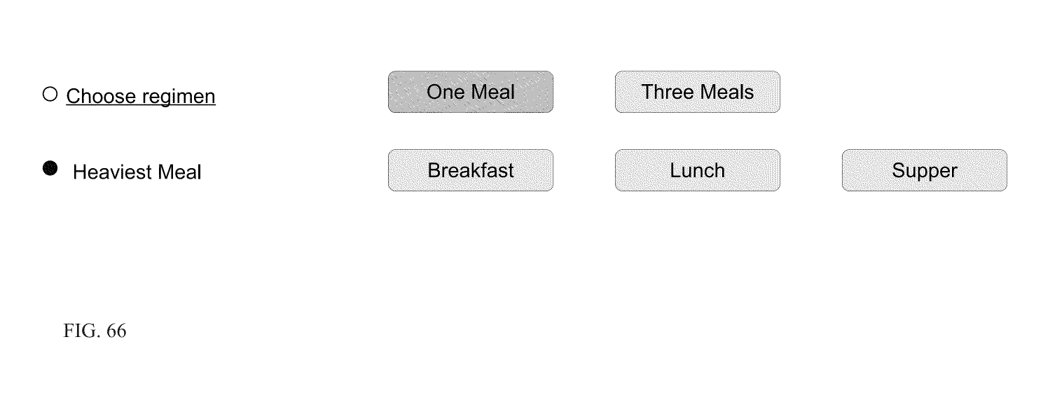

FIG. 66 may be arrived at from FIG. 65. In FIG. 66, the physician has selected “One Meal”. The physician may be offered the choice of breakfast, lunch or dinner. The operations shown in FIG. 66 may be based on Reference 3.

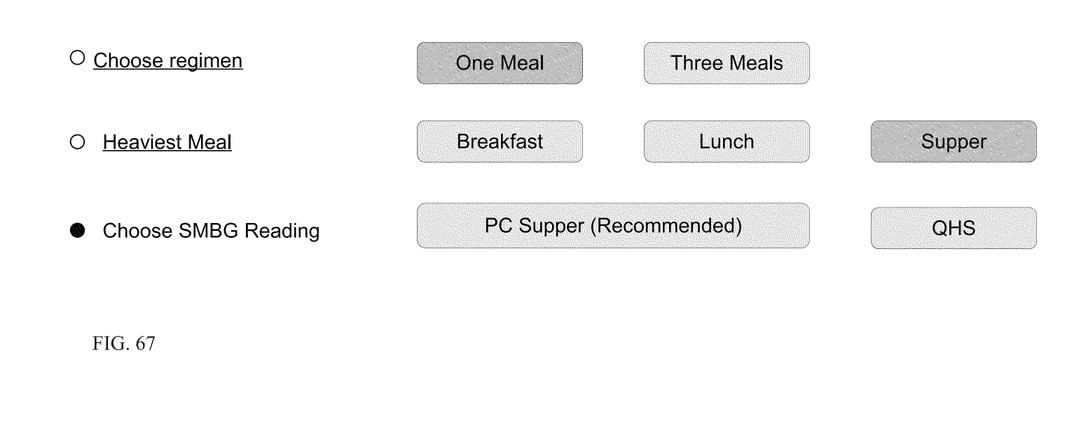

FIG. 67 may be arrived at from FIG. 66. In FIG. 67, the physician has selected “Supper”. A choice may be presented for the timing of the SMBG that is to be performed by the patient. In this instance the option to perform SMBG at “PC Supper” may be recommended. The operations shown in FIG. 67 may be based on Reference 3.

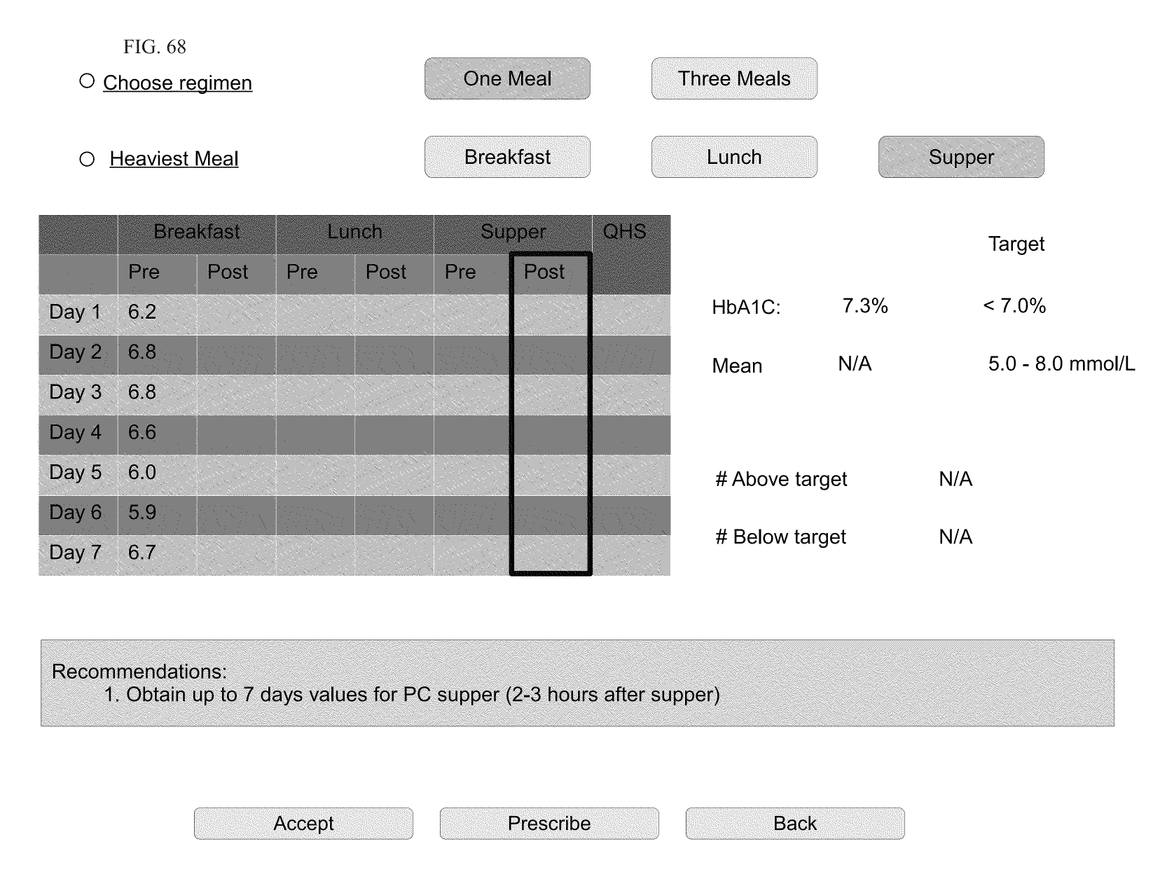

FIG. 68 may be arrived at from FIG. 67. In FIG. 68, the physician has selected “PC Supper”. A table may be presented which highlights the blood glucose values taken for the SMBG timing that the physician has selected. In this case, the Supper—Post column, which may be equivalent to PC supper, may be outlined in a heavy line. The table in this example indicates that there are no blood glucose values existing for the SMBG timing that the physician has selected. To the right of the table, an analysis of the patient's blood sugar control may be presented. In this example, the analysis is consistent with the fact that there are no blood sugar values for the Supper-Post timing. A recommendation may be made to obtain up to 7 days values for PC supper. The operations shown in FIG. 68 may be based on Reference 3.

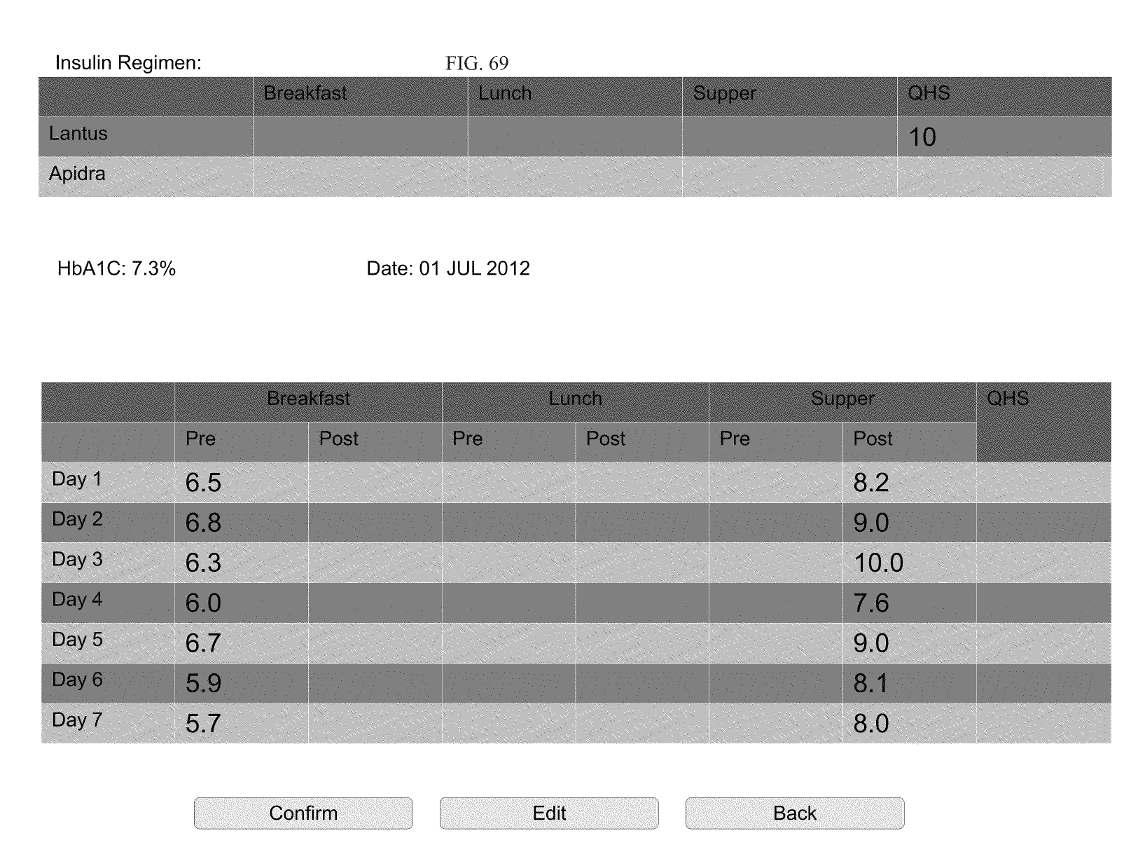

FIG. 69 may be arrived at from FIG. 68. In FIG. 69, the physician has selected “Accept”. FIG. 69 may represents data received by the physician seven days later, now containing blood sugar values for the Supper-Post timing and Breakfast-Pre timing. If the physician selects “Confirm”, the tool may proceed to the scheme for insulin titration. The operations shown in FIG. 69 may be based on Reference 3.

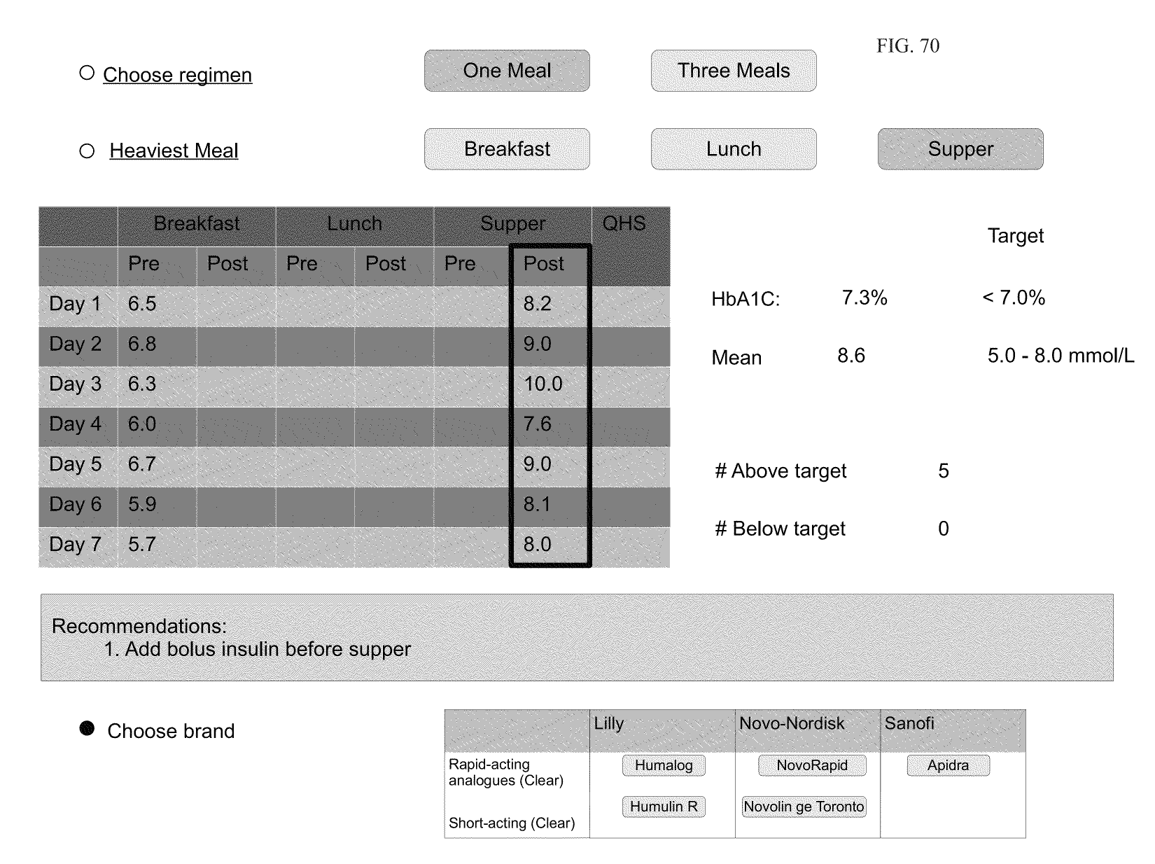

FIG. 70 may be arrived at from FIG. 69. In FIG. 70, the physician has selected “Confirm”. An analysis of the patient's blood sugar control may be presented at the right of the table. In this example, the analysis shows that the mean value for the blood sugar at the Supper-Post timing is above target and that 5 individual readings are also above target. A recommendation to add bolus insulin before supper may be generated and presented to the physician. Options may be presented for selection of a brand of insulin. The operations shown in FIG. 70 may be based on References 2 and 3.

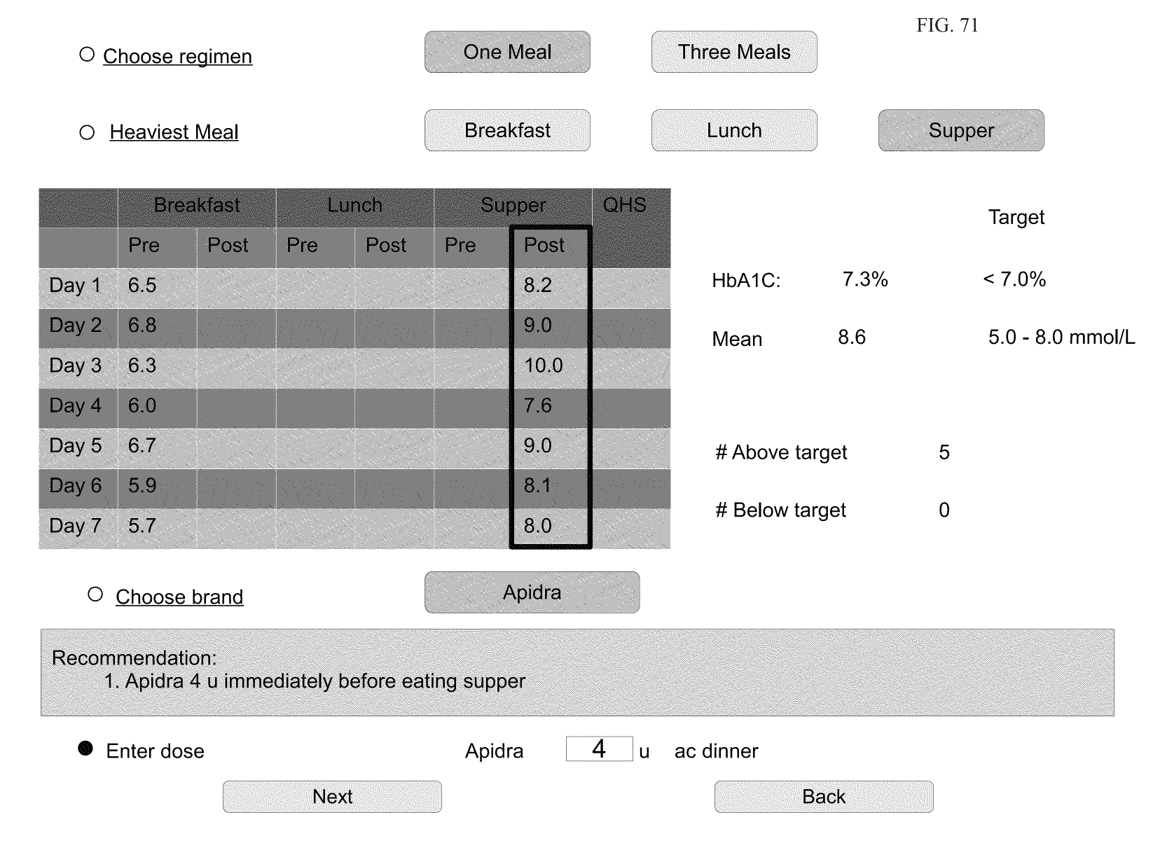

FIG. 71 may be arrived at from FIG. 70. In FIG. 71, the physician has selected “Apidra” as the brand of insulin. Recommendations may be generated and presented for the dosing of Apidra. The physician may enter the dose of Apidra and by selecting “Next”, the tool may proceed to produce the prescription and patient instructions, for example as described above. The operations shown in FIG. 71 may be based on Reference 3.

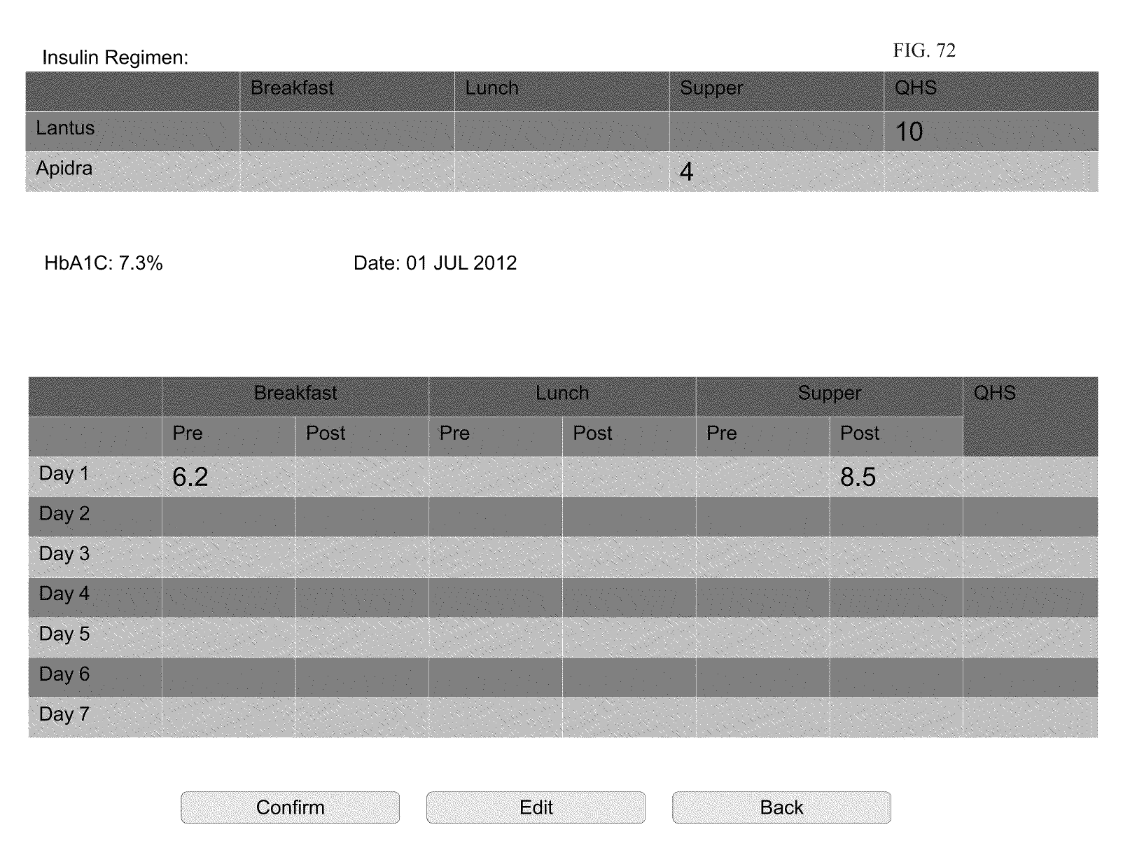

FIG. 72 may be arrived at from FIG. 71. FIG. 72 represents data received by the physician one day later containing blood sugar values for the Supper-Post timing and Breakfast-Pre timing. If the physician selects “Confirm”, the tool may proceed to the scheme for insulin titration.

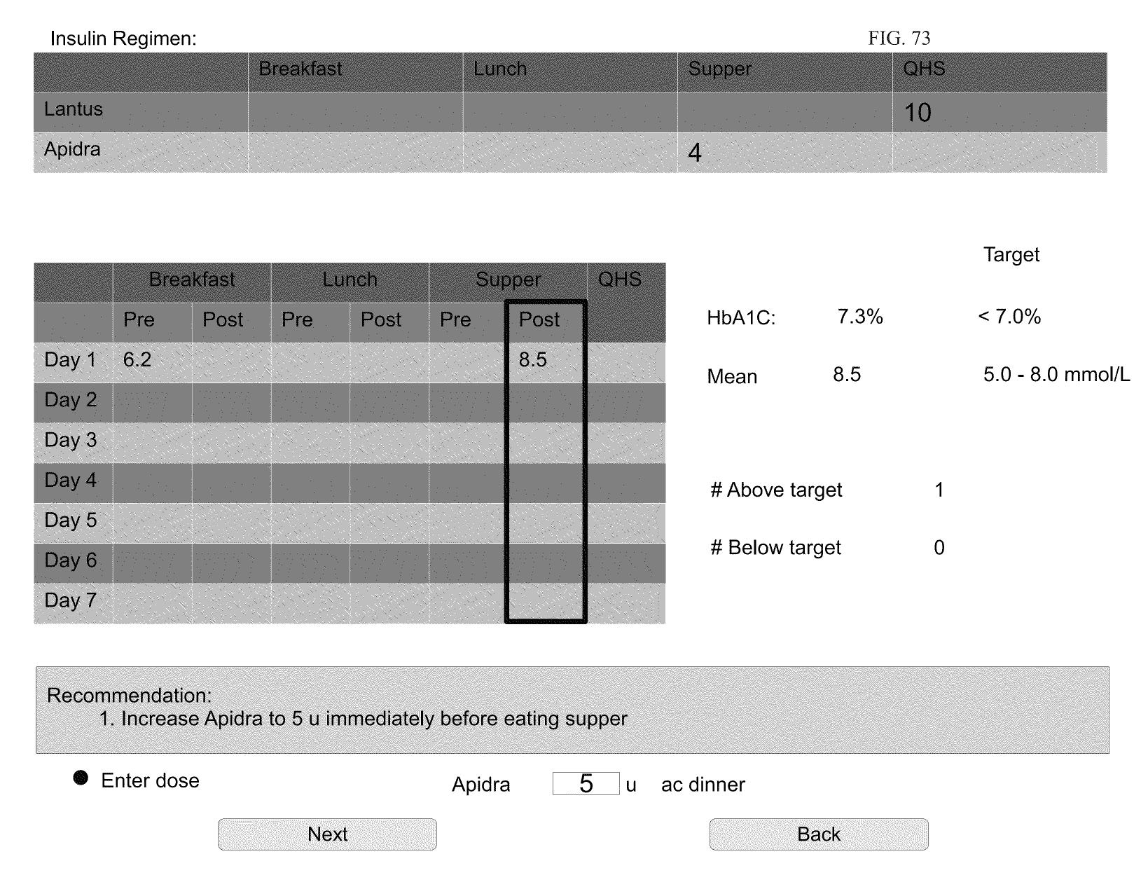

FIG. 73 may be arrived at from FIG. 72. In FIG. 73, the physician has selected “Confirm”. An analysis of the patient's blood sugar control may be presented at the right of the table. In this example, the analysis shows that the mean value for the blood sugar at the Supper-Post timing is above average. As there is only one reading the average is equal to the sole reading. Here, there is one individual value above target. A recommendation may be made to increase the dose of Apidra to 5 u immediately before eating supper. The physician may enter the dose of Apidra and by selecting “Next”, the tool may proceed to produce the prescription and patient instructions, for example as described above. The operations shown in FIG. 73 may be based on Reference 3.

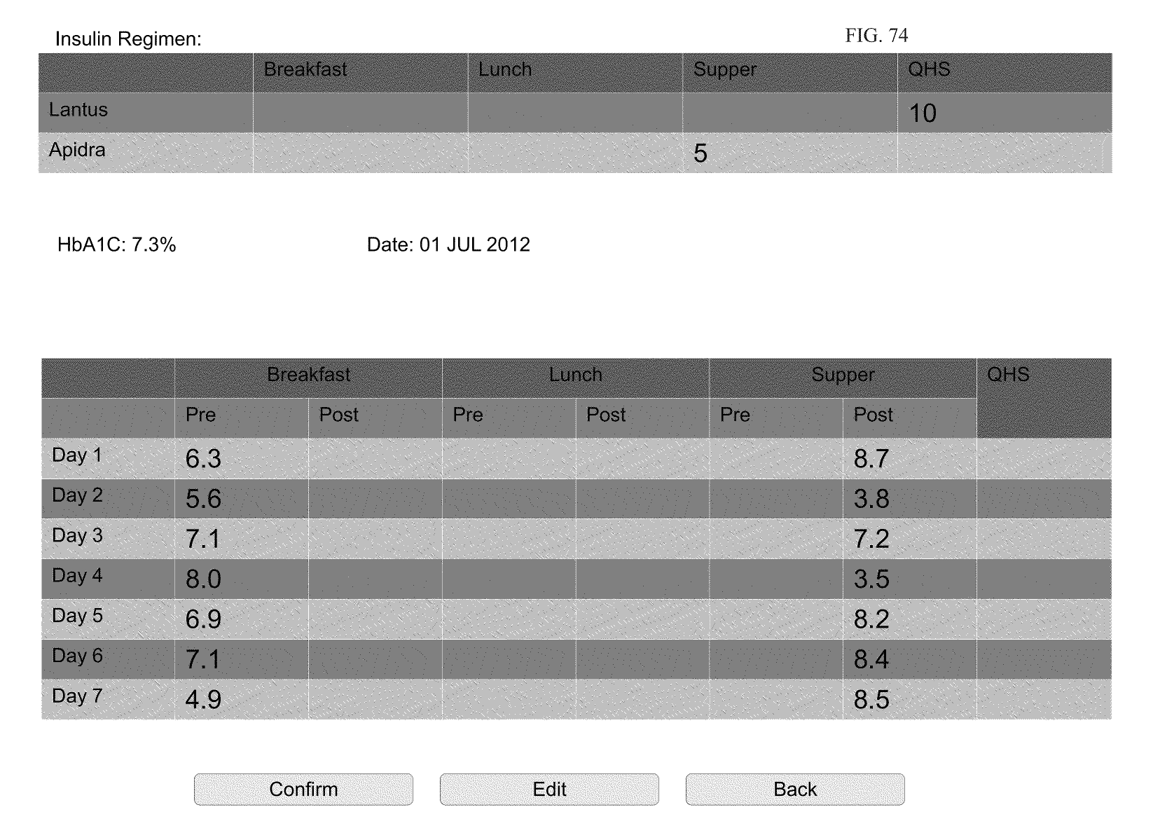

FIG. 74 may be arrived at from FIG. 73. FIG. 74 represents data received by the physician seven days later containing blood sugar values for the Supper-Post timing and Breakfast-Pre timing. If the physician selects “Confirm”, the tool may proceed to the scheme for insulin titration.

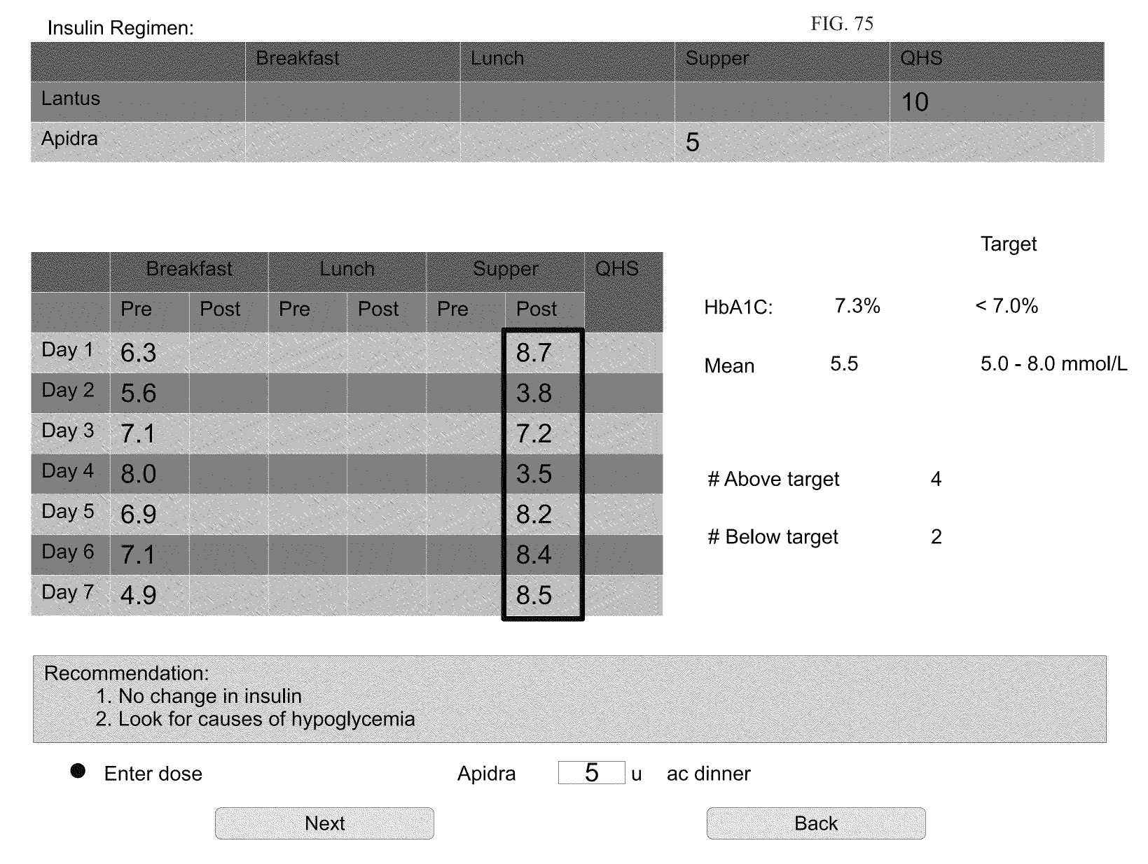

FIG. 75 may be arrived at from FIG. 74. In FIG. 75, the physician has selected “Confirm”. An analysis of the patient's blood sugar control may be presented at the right of the table. In this example, the analysis shows that the mean value of blood sugar for the Supper-Post timing is 5.5 or within the target range but that two values are below target. A recommendation may be made to not change the dosage of insulin and to look for causes of hypoglycemia. The physician may enter the dose of Apidra which in this case is unchanged and by selecting “Next”, the tool may proceed to produce the prescription and patient instructions, for example as described above. The operations shown in FIG. 75 may be based on References 1 and 3.

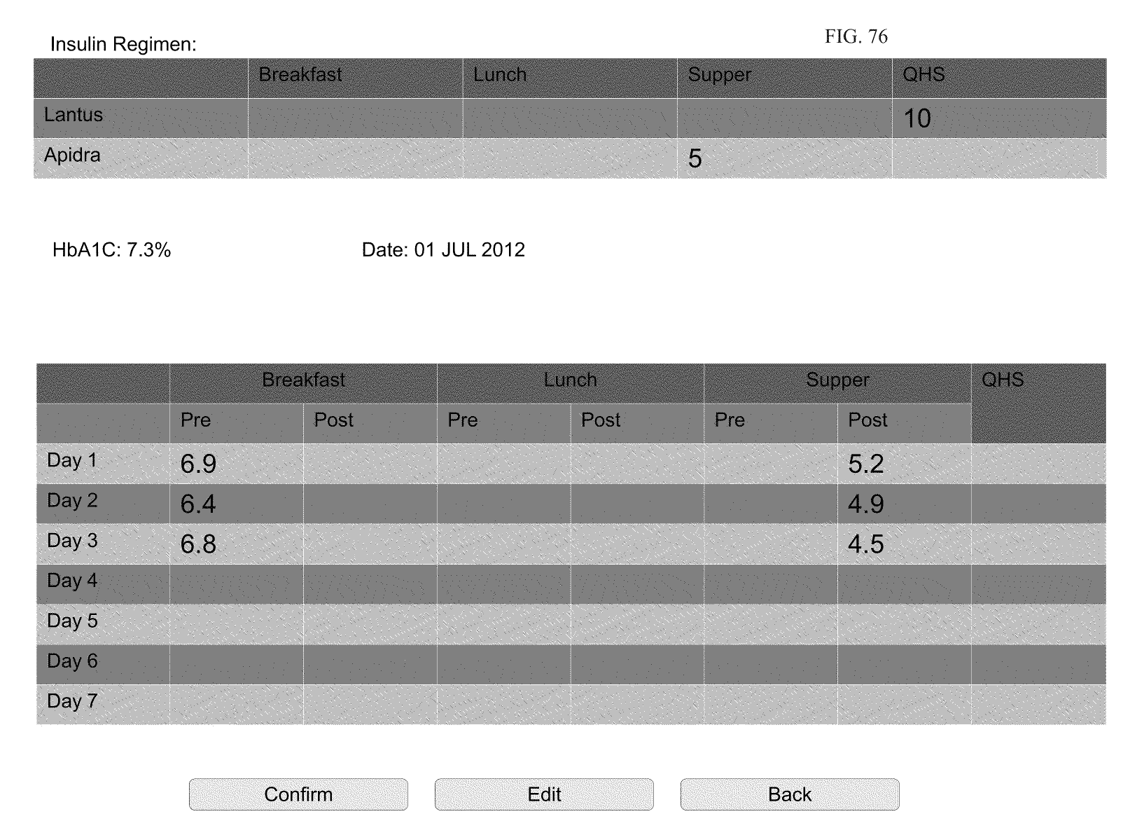

FIG. 76 may be arrived at from FIG. 75. FIG. 76 represents data received by the physician three days later containing blood sugar values for the Supper-Post timing and Breakfast-Pre timing. If the physician selects “Confirm”, the tool may proceed to the scheme for insulin titration.

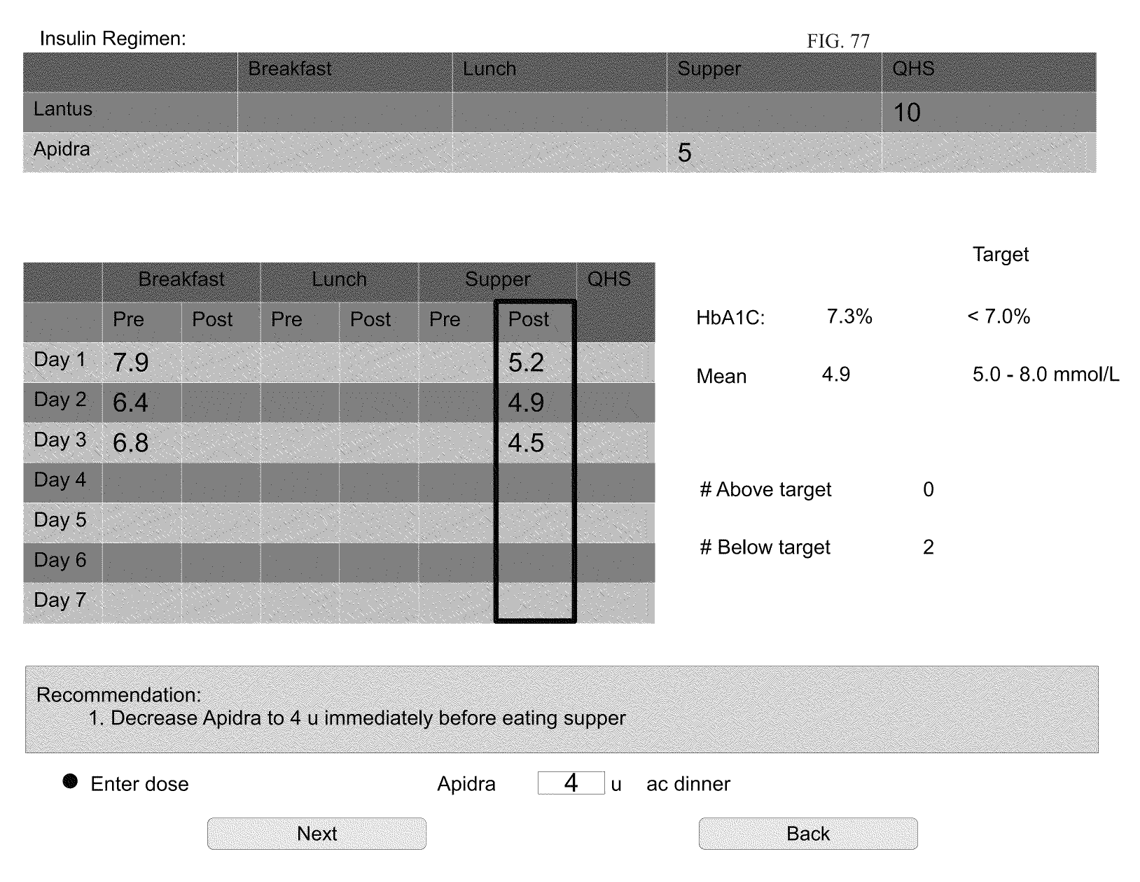

FIG. 77 may be arrived at from FIG. 76. In FIG. 77, the physician has selected “Confirm”. An analysis of the patient's blood sugar control may be presented at the right of the table. In this example, the analysis shows that the mean value of blood sugar for the Supper-Post timing is 4.9 or below the target range and that two values are below target. A recommendation may be made to decrease the dose of Apidra to 4 u immediately before eating supper. The physician may enter the dose of Apidra which in this case is decreased to 4 u and by selecting “Next”, the tool may proceed to produce the prescription and patient instructions, for example as described above. The operations shown in FIG. 77 may be based on References 1 and 3.

The disclosed methods and systems may provide one or more advantages over conventional paper-based or static implementation of CPGDs.

For example, the present disclosure may allow for two or more CPGDs to be implemented in synchrony. The patient database(s) may be unified or there may be a single patient database used by all the CPGDs implemented by the guideline module. Data may be simultaneously inputted and/or applied to multiple CPGDs and the resultant generated recommendations from all CPGDs relevant to the data may be provided to the physician.

The present disclosure may allow all CPGs to be accessible via a single interface (e.g., via the EMR program or an interface provided by the CPGD system). A physician may no longer be required to consult multiple sources (e.g., multiple conventional static CPG documents) for the CPGs. The physician may not be required to memorize any CPG.

The present disclosure may enable a processor to perform any calculations required by a CPG, which may help to reduce or eliminate human error.

The present disclosure may provide time savings as compared to the physician working through the various CPGs manually, as in the conventional method.

The present disclosure may enable patient recommendations to be prominently and repeatedly displayed to the physician, which may help to increase adherence to the CPGs on the part of the physician.

The present disclosure may enable automatic generation of notifications and reminders for follow-up examinations and lab tests as prescribed by the CPGs, and providing such notifications and reminders to the physician.

In the present disclosure, data input from laboratory and/or patient input may be automatically processed according to the CPGs to produce recommendations.

The present disclosure may enable data input by the patient. This may allow entry of data (e.g., ambulatory measurements of blood pressure, blood glucose and other such data) with greater convenience.

Although the present disclosure describes methods and systems pertaining to management of certain medical conditions, it should be understood that other conditions (including medical or non-medical conditions) may be managed according to the present disclosure. Although the present disclosure makes references to physicians and medical settings, it should be understood that the present disclosure is not limited to use by medical personnel nor use in medical settings.

The present disclosure may be embodied in any suitable system (e.g., servers, personal computing devices, networks), code, storage media (e.g., memories, CDs, DVDs), transitory media (e.g., transitory signals) or combination thereof.

The embodiments of the present disclosure described above are intended to be examples only and are not restrictive. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A system for interactive implementation of medical guidelines, the system comprising a processor;
wherein the processor is configured to implement a guideline module that, when executed, causes the system to:
apply at least one predefined medical guideline to a set of data associated with a patient to determine at least one medical condition of the patient, the at least one predefined medical guideline including at least one rule defining the medical condition and at least one rule defining a medical recommendation according to the defined medical condition;
determine at least one medical recommendation for the patient, based on the at least one medical condition of the patient and the at least one predefined medical guideline; and
generate output signals representing the at least one medical recommendation;
and wherein the processor is configured to implement an interface module that, when executed, causes the system to:
provide an interface for receiving input signals representing data associated with the patient; and
provide an interface for presenting the at least one medical recommendation.

2. The system of claim 1, further comprising a patient database for storing the set of data associated with the patient, wherein the processor is configured to receive the set of data from the patient database.

3. The system of claim 1, wherein the at least one medical guideline comprises at least one medical guideline for a medical condition selected from: Allergy, Alzheimer's disease, Atrial fibrillation, Cancer of various etiologies, Chronic, kidney disease, Chronic obstructive pulmonary disease, Congestive heart failure, Dementia, Depression, Diabetes, Drug interactions, Dyslipidemia, Hepatitis, HIV, Hypertension, Infectious diseases, Inflammatory bowel disease, Ischemic heart disease, Obesity, Osteoarthritis, Osteoporosis, Rheumatoid arthritis and Stroke.

4. The system of claim 1 wherein applying the at least one medical guideline comprises calculating a criteria for determining the medical condition according to at least one rule defined by the medical guideline.

5. The system of claim 1 wherein, when the data is insufficient to apply the medical guideline, the interface module causes the system to provide a prompt for requesting and receiving more input data.

6. The system of claim 1 wherein communication of input and output signals comprise communication of signals through at least one of: a wired connection, a wireless connection, a server, an intranet, the Internet and a local network.

7. The system of claim 1 wherein the at least one medical guideline is applied in response to input data received for at least one other medical guideline.

8. The system of claim 1 wherein the processor is configured to receive the set of data from a patient database of the same or another system.

9. The system of claim 1 wherein the interface module causes the system to provide an interface through another system.

10. The system of claim 2 wherein the at least one medical guideline is applied in response to an internally generated update of data stored in the patient database.

11. The system of claim 1 wherein data associated with the patient is received from an external device.

12. The system of claim 11 wherein communication between the external device and the system takes place over a secure communication channel.

13. A method in a processor for interactive implementation of a medical guideline, or a part thereof, the method comprising:
applying at least one predefined medical guideline to a set of data associated with a patient to determine at least one medical condition of the patient, the at least one predefined medical guideline including at least one rule defining the medical condition and at least one rule defining a medical recommendation according to the defined medical condition;
determining at least one medical recommendation for the patient, based on the at least one medical condition of the patient and the at least one predefined medical guideline; and
generating output signals representing the at least one medical recommendation.

14. The method of claim 13 further comprising receiving input signals representing data associated with the patient.

15. The method of claim 13 further comprising providing an interface for at least one of: receiving input signals representing data associated with the patient and presenting the at least one medical recommendation.

16. The method of claim 13, wherein the at least one medical guideline comprises at least one medical guideline for a medical condition selected from: Allergy, Alzheimer's disease, Atrial fibrillation, Cancer of various etiologies, Chronic, kidney disease, Chronic obstructive pulmonary disease, Congestive heart failure, Dementia, Depression, Diabetes, Drug interactions, Dyslipidemia, Hepatitis, HIV, Hypertension, Infectious diseases, Inflammatory bowel disease, Ischemic heart disease, Obesity, Osteoarthritis, Osteoporosis, Rheumatoid arthritis and Stroke.

17. The method of claim 13 wherein applying the at least one medical guideline comprises calculating a criteria for determining the medical condition according to at least one rule defined by the medical guideline.

18. The method of claim 13 further comprising, when the data is insufficient to apply the medical guideline, providing a prompt for requesting and receiving more input data.

19. The method of claim 13 wherein the at least one medical guideline is applied in response to input data received for at least one other medical guideline.

20. The method of claim 13 wherein the at least one medical guideline is applied in response to an internally generated update of the data associated with the patient.

21. The method of claim 13 further comprising logging in a user and providing the user with information about one or more patients associated with the user, including any medical recommendations for the one or more patients.

22. The method of claim 21 further comprising determining any new or updated medical recommendations for the one or more patients since a last log in of the user, and providing identification of any new or updated medical recommendations to the user.

23. The method of claim 22 further comprising removing the new or updated medical recommendations for the one or more patients on a subsequent log in of the user.

24. The method of claim 13 further comprising storing information about the at least one medical recommendation and associating the information about the at least one medical recommendation with the patient.

25. The method of claim 24 further comprising, in response to signals representing a received input indicating that the at least one medical recommendation has been fulfilled, removing the information about the at least one medical recommendation from storage.

26. The method of claim 24 further comprising, in response to signals representing a received input indicating rejection of the at least one medical recommendation, removing the information about the at least one medical recommendation from storage.

27. The method of claim 24 further comprising, in response to signals representing a received input indicating a request for a different medical recommendation, generating an alternative medical recommendation according to the request.

28. The method of claim 13 wherein the at least one medical recommendation comprises a recommendation for further patient assessment.

29. The method of claim 28 wherein the recommendation for further patient assessment comprises at least one of: a recommendation for a routine assessment based on a medical guideline defining a time interval for routine assessment; a recommendation for a follow-up assessment based on a medical guideline defining a requirement for follow-up assessment; and a recommendation for a follow-up assessment based on updated patient data meeting the criteria of a medical guideline.

30. The method of claim 28 wherein the recommendation for further patient assessment is a recommendation for a patient assessment at a future scheduled date, further comprising tracking the recommendation and generating a notification of the upcoming scheduled date.

31. The method of claim 13 wherein the at least one medical recommendation comprises at least one medication for treatment of the patient.

32. The method of claim 13 further comprising providing at least one generated recommendation as an input for a different predefined medical guideline.

33. The method of claim 13 wherein, when the at least one recommendation comprises a medication, determining whether the medication is in a list of contraindicated medications.

34. The method of claim 13, wherein data associated with the patient is indexed to rules of the at least one medical guideline or vice versa.

35. The method of claim 13, wherein data associated with the patient is indexed to rules of at least two medical guidelines or vice versa.

36. The method of claim 34, wherein the data associated with the patient is inputted by a user, patient or laboratory, an output of a rule from at least one medical guideline, or internally updated.

37. The method of claim 13, wherein a rule associated with the at least one medical guideline implements one or more rules from a second medical guideline.

38. The method of claim 37, wherein the one or more rules from the second medical guideline comprises all of rules associated with the second medical guideline.

39. The method of claim 37, wherein the one or more rules from the second medical guideline comprises a portion of the rules associated with the second medical guideline.

40. A method in a processor for interactive implementation of a medical tool, the medical tool for determining a medical recommendation, the method comprising:
applying at least one rule from each of a plurality of predefined medical guidelines to a set of data associated with a patient, each rule defining either a medical condition or a medical recommendation according to the defined medical condition;
determining at least one medical output for the patient, the medical output comprising a medical recommendation or a medical condition based on the at least one rule from each of the plurality of predefined medical guidelines; and
generating output signals representing the at least one medical output.
